(19) United States
(12) Patent Application Publication
(10) Pub. No.: US 2026/0370294 A1
(43) Pub. Date: Nov. 19, 2026

(54) METHOD, DEVICE AND COMPUTER STORAGE MEDIUM OF COMMUNICATION

(71) Applicant: NEC Corporation, Tokyo (JP)

(72) Inventors: Yukai GAO, Beijing (CN); Peng GUAN, Beijing (CN); Gang WANG, Beijing (CN)

(73) Assignee: NEC Corporation, Tokyo (JP)

(21) Appl. No.: 19/125,561

(22) PCT Filed: Oct. 31, 2022
(86) PCT No.: PCT/CN2022/128807

§ 371 Date: Apr. 29, 2025

(51) Int. Cl. H04B 7/06; H04W 72/232

(52) U.S. Cl. CPC H04B 7/0639; H04W 72/232

(57) ABSTRACT

Embodiments of the present disclosure relate to methods, devices, and computer readable medium for communication. According to embodiments of the present disclosure, a network device transmits first information associated with at least one first precoding matrix. The network device also provides second information associated with phase offset information. The terminal device determines a second precoding matrix based on the at least one first precoding matrix and the phase offset information. The terminal device performs a transmission to the network device on a PUSCH based on the second precoding matrix. In this way, the overhead can be reduced.

### TECHNICAL FIELD

Embodiments of the present disclosure generally relate to the field of telecommunication, and in particular, to methods, devices and computer storage media of communication for determining an uplink transmission codebook.

### BACKGROUND

Several technologies have been proposed to improve communication performances. For example, multi-input multi-output (MIMO) has been proposed. MIMO includes features that facilitate utilization of a large number of antenna elements at base station for both sub-6 GHz and over-6 GHz frequency bands. In this situation, a plurality of antennas at a transmitter and/or receiver can be used to achieve array and diversity gain instead of capacity gain. In this case, a same symbol weighted by a complex-valued scale factor is sent from each transmit antenna so that the input covariance matrix has unit rank. This scheme is referred to as beamforming. When the receiver has multiple antennas, the single-layer beamforming cannot simultaneously maximize the signal power at every receive antenna, hence, precoding is used for multi-layer beamforming in order to maximize the throughput of a multi-antenna system. Precoding is a generalized beamforming scheme to support multi-layer transmission in a MIMO system. Using precoding, multiple streams are transmitted from the transmit antennas with independent and appropriate weighting per antenna such that the throughput is maximized at the receiver output.

### SUMMARY

In general, embodiments of the present disclosure provide methods, devices and computer storage media for communication.

In a first aspect, there is provided a communication method. The method comprises: receiving, at a terminal device, from a network device, first information associated with at least one first precoding matrix; receiving, from the network device, second information associated with a set of phase offsets for the at least one first precoding matrix; determining a second precoding matrix based on the at least one first precoding matrix and the second information; and performing a transmission to the network device on a physical uplink shared channel (PUSCH) based on the second precoding matrix.

In a second aspect, there is provided a communication method. The method comprises: receiving, at a terminal device, from a network device, first information associated with a subset of precoding matrixes; receiving, from the network device, second information indicating a precoding matrix in the subset of precoding matrixes, wherein a bit size for indicating the second information is based on the number of precoding matrixes in the subset of first precoding matrixes; and performing a transmission to the network device on a physical uplink shared channel (PUSCH) based on the indicated precoding matrix.

In a third aspect, there is provided a communication method. The method comprises: receiving, at a terminal device, from a network device, downlink control information comprising a first field and a second field, wherein the first field indicates a first precoding matrix and the second field indicates a parameter that is based on the first field; determining a second precoding matrix based on the first precoding matrix and the parameter; and performing a transmission to the network device based on the second precoding matrix.

In a fourth aspect, there is provided a communication method. The method comprises: transmitting, at a network device, to a terminal device, first information associated with at least one first precoding matrix; transmitting, to the terminal device, second information associated with a set of phase offsets for the at least one first precoding matrix; and receiving, from the terminal device, a transmission on a physical uplink shared channel (PUSCH), wherein the transmission is based on a second precoding matrix which is determined based on the at least one first precoding matrix and the second information.

In a fifth aspect, there is provided a communication method. The method comprises: transmitting, at a network device, to a terminal device, first information associated with a subset of precoding matrixes; transmitting, to the terminal device, second information indicating a precoding matrix in the subset of precoding matrixes, wherein a bit size for indicating the second information is based on the number of precoding matrixes in the subset of first precoding matrixes; and receiving, from the terminal device, a transmission on a physical uplink shared channel (PUSCH), wherein the transmission is based on the indicated precoding matrix.

In a sixth aspect, there is provided a communication method. The method comprises: transmitting, at a network device, to a terminal device, downlink control information comprising a first field and a second field, wherein the first field indicates a first precoding matrix and the second field indicates a parameter that is based on the first field; and receiving, from the terminal device, a transmission based on a second precoding matrix that is based on the first precoding matrix and the parameter.

In a seventh aspect, there is provided a terminal device. The terminal device comprises at least one processor; and at least one memory coupled to the at least one processor and storing instructions thereon, the instructions, when executed by the at least one processor, causing the terminal device to perform the method according to the first, second, or third aspect.

In an eighth aspect, there is provided a network device. The network device comprises at least one processor; and at least one memory coupled to the at least one processor and storing instructions thereon, the instructions, when executed by the at least one processor, causing the network device to perform the method according to the fourth, fifth, or sixth aspect.

In a ninth aspect, there is provided a computer readable medium having instructions stored thereon, the instructions, when executed on at least one processor, causing the at least one processor to carry out the method according to the first, second, third, fourth, fifth, or sixth aspect.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for communications according to some embodiments of the present disclosure;

FIG. 3 illustrates a signaling flow for communications according to some embodiments of the present disclosure;

FIG. 4 illustrates a signaling flow for communications according to some embodiments of the present disclosure;

FIG. 5 illustrates a schematic diagram of downlink control information (DCI) according to some embodiments of the present disclosure;

FIG. 6 is a flowchart of an example method in accordance with an embodiment of the present disclosure;

FIG. 7 is a flowchart of an example method in accordance with an embodiment of the present disclosure;

FIG. 8 is a flowchart of an example method in accordance with an embodiment of the present disclosure;

FIG. 9 is a flowchart of an example method in accordance with an embodiment of the present disclosure;

FIG. 10 is a flowchart of an example method in accordance with an embodiment of the present disclosure;

FIG. 11 is a flowchart of an example method in accordance with an embodiment of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (TAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), FR2-2 (52.6 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In some embodiments, the terminal device may be connected with a first network device and a second network device. One of the first network device and the second network device may be a master node and the other one may be a secondary node. The first network device and the second network device may use different radio access technologies (RATs). In some embodiments, the first network device may be a first RAT device and the second network device may be a second RAT device. In some embodiments, the first RAT device is eNB and the second RAT device is gNB. Information related with different RATs may be transmitted to the terminal device from at least one of the first network device or the second network device. In some embodiments, first information may be transmitted to the terminal device from the first network device and second information may be transmitted to the terminal device from the second network device directly or via the first network device.

In some embodiments, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present application, the terms “transmission occasions”, “reception occasions”, “repetitions”, “transmission”, “reception”, “PDSCH transmission occasions”, “PDSCH repetitions”, “PUSCH transmission occasions”, “PUSCH repetitions”, “PUCCH occasions”, “PUCCH repetitions”, “repeated transmissions”, “repeated receptions”, “PDSCH transmissions”, “PDSCH receptions”, “PUSCH transmissions”, “PUSCH receptions”, “PUCCH transmissions”, “PUCCH receptions”, “RS transmission”, “RS reception”, “communication”, “transmissions” and “receptions” can be used interchangeably. The terms “TCI state”, “set of QCL parameter(s)”, “QCL parameter(s)”, “QCL assumption” and “QCL configuration” can be used interchangeably. The terms “TCI field”, “TCI state field”, and “transmission configuration indication” can be used interchangeably. The terms “transmission occasion”, “transmission”, “repetition”, “reception”, “reception occasion”, “monitoring occasion”, “PDCCH monitoring occasion”, “PDCCH transmission occasion”, “PDCCH transmission”, “PDCCH candidate”, “PDCCH reception occasion”, “PDCCH reception”, “search space”, “CORESET”, “multi-chance” and “PDCCH repetition” can be used interchangeably. In the following, the terms “PDCCH repetitions”, “repeated PDCCHs”, “repeated PDCCH signals”, “PDCCH candidates configured for same scheduling”, “PDCCH”, “PDCCH candidates” and “linked PDCCH candidates” can be used interchangeably. The terms “DCI” and “DCI format” can be used interchangeably. In some embodiments, the embodiments in this disclosure can be applied to PDSCH and PUSCH scheduling, and in the following, PDSCH scheduling is described as examples. For example, the embodiments in this disclosure can be applied to PUSCH by replacing “transmit” to “receive” and/or “receive” to “transmit”. The terms “PDSCH” and “PUSCH” can be used interchangeably. The terms “transmit” and “receive” can be used interchangeably. The terms “common beam”, “common beam update/indicate/indication”, “unified TCI state”, “unified TCI state update/indicate/indication”, “beam indication”, “TCI state(s) indication”, “TCI_state_r17”, “tci_StateId_r17”, “TCI_state_r17 indicating a unified TCI state”, “TCI state shared/applied for all or subset of CORESETs and UE-dedicated reception on PDSCH”, “Rel-17 TCI state”, “TCI state with tci_StateId_r17”, “TCI state configured for TCI state update in unified TCI framework”, “TCI state indicated in DCI for common beam update/indicate/indication” and “TCI state indicated in DCI and to be applied for all/subset of CORESETs and PDSCH” may be used interchangeably. The terms “subset of CORESETs”, “subset of TCI states”, “subset of unified TCI states”, “subset of downlink (unified) TCI states” and “subset of joint (unified) TCI states” may be used interchangeably. The terms “subset of PUCCHs”, “subset of TCI states”, “subset of unified TCI states”, “subset of uplink (unified) TCI states” and “subset of joint (unified) TCI states” may be used interchangeably. The terms “precoding matrix”, “precoding”, “beam”, “beamforming” and “precoder” may be used interchangeably. The terms “antenna” and “antenna port” may be used interchangeably. The terms “transmission”, “transmitting”, “Tx” and “TX” may be used interchangeably.

As mentioned above, precoding is a generalized beamforming scheme to support multi-layer transmission in a MIMO system. Precoding is a technique that exploits transmit diversity by weighting the information stream, i.e. the transmitter sends the coded information to the receiver to achieve pre-knowledge of the channel. Using precoding, multiple streams are transmitted from the transmit antennas with independent and appropriate weighting per antenna such that the throughput is maximized at the receiver output. The terms “precoding matrix” and “precoder” may be used interchangeably hereinafter. Moreover, it may be possible that uplink transmission with 8 antenna ports can support more than 4 layers.

According to some solutions, it proposes 8 transmission (TX) uplink (UL) coherent codebook based on two 4TX UL codebooks. However, it may need large overhead and in case of full coherent, for a give UE, many codebooks may not be useful. Specifically, for two 4TX codebooks, if φₙ∈{1, j, −1, −j}, there may be 1024 precoders. While for a given UE (with full coherent antennas), the number of available precoders is much less than the total number, and actually, the granularity is coarse than DFT precoder (with oversampling value >1). In addition, for UL codebook, timing alignment error (TAE) or phase error between antennas of UE may be randomized (for different UEs) but fixed (invariant in time) for a given UE (based on QC). Based on QC's solution (only considering unit of pi/2), the phase difference across antennas is in unit of pi/2, still can not meet the randomized phase error (−pi, pi).

Embodiments of the present disclosure provide a solution on uplink precoding matrixes. According to embodiments of the present disclosure, a network device transmits first information associated with at least one first precoding matrix. The network device also provides second information associated with phase offset information. The terminal device determines a second precoding matrix based on the at least one first precoding matrix and the phase offset information. The terminal device performs a transmission to the network device on a PUSCH based on the second precoding matrix. In this way, the overhead can be reduced and the TAE can be solved.

Principles and implementations of the present disclosure will be described in detail below with reference to the figures.

### Example of Communication Network

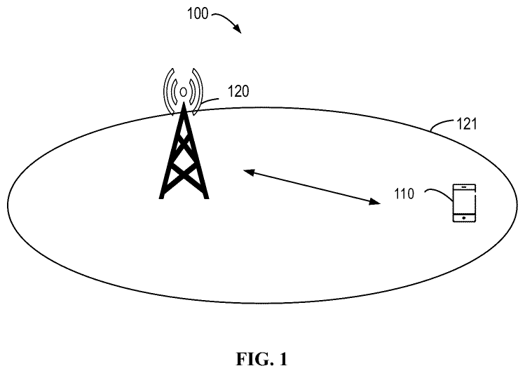

FIG. 1 illustrates a schematic diagram of an example communication network 100 in which some embodiments of the present disclosure can be implemented. As shown in FIG. 1, the communication network 100 may include a terminal device 110 and a network device 120. The network device 120 may provide a cell 121 to serve one or more terminal devices. In this example, the terminal device 110 is located in the cell 121 and is served by the network device 120.

It is to be understood that the number of devices and cells in FIG. 1 is given for the purpose of illustration without suggesting any limitations to the present disclosure. The communication network 100 may include any suitable number of network devices and/or terminal devices and/or cells adapted for implementing implementations of the present disclosure.

In some embodiments, the terminal device 110 and the network device 120 may communicate with each other via a channel such as a wireless communication channel on an air interface (e.g., Uu interface). The wireless communication channel may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH). Of course, any other suitable channels are also feasible.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the network device 120 may transmit information to the terminal device 110. The information may indicate that a PUSCH is scheduled associated with 8 antenna ports. For example, total number of antenna ports for the PUSCH transmission may be 8. In some embodiments, the information may indicate that the PUSCH is scheduled associated with a sounding reference signal (SRS) with 8 antenna ports.

In other words, the total number of antenna ports of a SRS associated with the PUSCH transmission is 8. In some embodiments, the information may be transmitted in a SRS configuration.

In some embodiments, for uplink (UL) codebook, the terminal device 110 may support 1 antenna port or 2 antenna ports or 4 antenna ports or 8 antenna ports. For single carrier frequency division multiple access (SC-FDMA) and OFDM, there may be at least one of full coherent, partial coherent and non-coherent (antenna selection) codebook. In some embodiments, for codebook based UL transmission, rank indicator (RI) and precoding matrix indicator (PMI) are jointly encoded, and different numbers of layers (RI values) may be indicated in same table/field. In some embodiments, for non-codebook based UL transmission, RI and SRS resource indication are jointly encoded. In some embodiments, for both codebook and non-codebook based UL transmission, number of demodulation reference signal (DMRS) ports is determined based on the number of layers, and the antenna port field (DMRS port) only indicates DMRS port index(es).

The term “slot” used herein refers to a dynamic scheduling unit. One slot comprises a predetermined number of symbols. For example, the number of symbols in one slot may be 12 or 14. The term “sub-slot” may refer to a number of symbols. For example, the number of symbols in one sub-slot may be 1, 2, 4, 7, 14. The sub-slot may comprise fewer symbols than one slot. The slot used herein may refer to a normal slot which comprises a predetermined number of symbols and also refer to a sub-slot which comprises fewer symbols than the predetermined number of symbols.

In some embodiments, the terminal device 110 may be configured or indicated with a number of layers (e.g. represented as v_ri) for the PUSCH transmission. For example, the number of layers v_ri may be at least one of {1,2,3,4,5,6,7,8}. In some embodiments, the terminal device 110 may be configured or indicated with a precoding matrix for the PUSCH transmission. In some embodiments, the size of the precoding matrix may be 8*v_ri or v_ri*8. In some embodiments, there may be v_ri columns or rows in the precoding matrix. In some embodiments, in a column or row of the precoding matrix, there may be 8 elements, and index of an element may be represented as idx, idx may be non-negative integer. For example, 0<=idx<=7. For another example, 1<=idx<=8.

In some embodiments, the terminal device 110 may transmit at least one capability information to the network device 120. In some embodiments, the at least one capability information may indicate at least one of: supporting uplink transmission with 8 antennas or 8 antenna ports, supporting PUSCH transmission with 8 antennas or 8 antenna ports, and a capability of precoding matrix supported by the terminal device 110. In some embodiments, the capability information of precoding matrix may indicate a type of precoding matrix supported by the terminal device 110. In some embodiments, the capability information of precoding matrix may comprise at least one of: supporting at least one full coherent of 8 transmission (Tx) precoder, supporting at least one partial coherent of 8 Tx precoder, supporting at least one first full coherent of 8 Tx precoder, supporting at least one second full coherent of 8 Tx precoder, supporting at least one first partial coherent of 8 Tx precoder, supporting at least one second partial coherent of 8 Tx precoder, and supporting at least one non coherent of 8 Tx precoder. In some embodiments, for first partial coherent, the 8 antennas may comprise two groups, and each group may comprise 4 antennas, and the 4 antennas in one group may be coherent to each other. For example, antennas in different groups may not be coherent or may be non-coherent. In some embodiments, for second partial coherent, the 8 antennas may comprise four groups, and each group may comprise 2 antennas, and the 2 antennas in one group may be coherent to each other. For example, antennas in different groups may not be coherent or may be non-coherent. In some embodiments, for non coherent, the 8 antennas may not be coherent or may be non coherent to each other.

In some embodiments, there may be at least one precoder for 8 Tx. In some embodiments, the at least one precoder for 8 Tx may comprise at least one of: at least one full coherent 8 Tx precoder, at least one first full coherent 8 Tx precoder, at least one second full coherent 8 Tx precoder, at least one partial coherent 8 Tx precoder, at least one first partial coherent 8 Tx precoder, at least one second partial coherent 8 Tx precoder and at least one non coherent 8 Tx precoder.

In some embodiments, the size of the at least one precoder may be 8*v_ri or v_ri*8. In some embodiments, there may be v_ri columns or rows in each of the at least one precoder. In some embodiments, in a column or row of each of the at least one precoder, there may be 8 elements, and index of an element may be represented as idx, idx may be non-negative integer. For example, 0<=idx<=7. For another example, 1<=idx<=8.

In some embodiments, there may be 8 antennas for 8 antenna transmission or 8 Tx, and the indexes of 8 antennas may be represented as {AP0, AP1, AP2, AP3, AP4, AP5, AP6, AP7}. In some embodiments, when there are two antenna groups (For example, a first antenna group with four antennas and a second antenna group with four antennas), and each antenna group comprises 4 antennas. In some embodiments, when there are four antenna groups (For example, a first antenna group with 2 antennas and a second antenna group with 2 antennas and a third antenna group with 2 antennas and a fourth antenna group with 2 antennas), and each antenna group comprises 2 antennas.

In some embodiments, each one of the index of an element or each one of the element in one of the column or one of the row of each of the at least one precoder may be associated with the index of one antenna of the 8 antennas. In some embodiments, the first element or the index of the first element in one of the column or one of the row of each of the at least one precoder may be associated with AP0. In some embodiments, the second element or the index of the second element in one of the column or one of the row of each of the at least one precoder may be associated with AP1. In some embodiments, the third element or the index of the third element in one of the column or one of the row of each of the at least one precoder may be associated with AP2. In some embodiments, the fourth element or the index of the fourth element in one of the column or one of the row of each of the at least one precoder may be associated with AP3. In some embodiments, the fifth element or the index of the fifth element in one of the column or one of the row of each of the at least one precoder may be associated with AP4. In some embodiments, the sixth element or the index of the sixth element in one of the column or one of the row of each of the at least one precoder may be associated with AP5. In some embodiments, the seventh element or the index of the seventh element in one of the column or one of the row of each of the at least one precoder may be associated with AP6. In some embodiments, the eighth element or the index of the eighth element in one of the column or one of the row of each of the at least one precoder may be associated with AP7.

In some embodiments, for uplink (UL) codebook, the terminal device 110 may support 1 antenna port or 2 antenna ports or 4 antenna ports or 8 antenna ports. For single carrier frequency division multiple access (SC-FDMA) and OFDM, there may be at least one of full coherent, partial coherent and non-coherent (antenna selection) codebook. In some embodiments, for codebook based UL transmission, rank indicator (RI) and precoding matrix indicator (PMI) are jointly encoded, and different numbers of layers (RI values) may be indicated in same table/field. In some embodiments, for non-codebook based UL transmission, RI and SRS resource indication are jointly encoded. In some embodiments, for both codebook and non-codebook based UL transmission, number of demodulation reference signal (DMRS) ports is determined based on the number of layers, and the antenna port field (DMRS port) only indicates DMRS port index(es).

In some embodiments, there may be at least one full coherent 8 Tx precoder for the terminal device 120. In some embodiments, there may be at least one first full coherent 8 Tx precoder for the terminal device 120. In some embodiments, there may be at least one second full coherent 8 Tx precoder for the terminal device 120. In some embodiments, there may be at least one partial coherent 8 Tx precoder for the terminal device 120. In some embodiments, there may be at least one first partial coherent 8 Tx precoder for the terminal device 120. In some embodiments, there may be at least one second partial coherent 8 Tx precoder for the terminal device 120. In some embodiments, there may be at least one non coherent 8 Tx precoder for the terminal device 120.

In some embodiments, the terminal device 120 may indicate or report the at least one capability that supporting at least one full coherent 8 Tx precoder. In some embodiments, the terminal device 120 may be configured with the at least one full coherent 8 Tx precoder. In some embodiments, the terminal device 120 may be configured with the at least one full coherent 8 Tx precoder (or at least one first full coherent 8 Tx precoder or at least one second full coherent 8 Tx precoder) and at least one partial coherent 8 Tx precoder and/or at least one non coherent 8 Tx precoder. In some embodiments, the terminal device 120 may be configured with the at least one full coherent 8 Tx precoder (or at least one first full coherent 8 Tx precoder or at least one second full coherent 8 Tx precoder) and at least one first partial coherent 8 Tx precoder and at least one second partial coherent 8 Tx precoder and/or at least one non coherent 8 Tx precoder. In some embodiments, the terminal device 120 may be configured with the at least one full coherent 8 Tx precoder (or at least one first full coherent 8 Tx precoder or at least one second full coherent 8 Tx precoder) and at least one first partial coherent 8 Tx precoder and/or at least one non coherent 8 Tx precoder. In some embodiments, the terminal device 120 may be configured with the at least one full coherent 8 Tx precoder (or at least one first full coherent 8 Tx precoder or at least one second full coherent 8 Tx precoder) and at least one second partial coherent 8 Tx precoder and/or at least one non coherent 8 Tx precoder.

In some embodiments, the terminal device 120 may indicate or report the at least one capability that supporting at least one first full coherent 8 Tx precoder. In some embodiments, the terminal device 120 may be configured with the at least one first full coherent 8 Tx precoder. In some embodiments, the terminal device 120 may be configured with the at least one first full coherent 8 Tx precoder and at least one partial coherent 8 Tx precoder and/or at least one non coherent 8 Tx precoder. In some embodiments, the terminal device 120 may be configured with the at least one first full coherent 8 Tx precoder and at least one first partial coherent 8 Tx precoder and at least one second partial coherent 8 Tx precoder and/or at least one non coherent 8 Tx precoder. In some embodiments, the terminal device 120 may be configured with the at least one first full coherent 8 Tx precoder and at least one first partial coherent 8 Tx precoder and/or at least one non coherent 8 Tx precoder. In some embodiments, the terminal device 120 may be configured with the at least one first full coherent 8 Tx precoder and at least one second partial coherent 8 Tx precoder and/or at least one non coherent 8 Tx precoder.

In some embodiments, the terminal device 120 may indicate or report the at least one capability that supporting at least one second full coherent 8 Tx precoder. In some embodiments, the terminal device 120 may be configured with the at least one second full coherent 8 Tx precoder. In some embodiments, the terminal device 120 may be configured with the at least one second full coherent 8 Tx precoder and at least one partial coherent 8 Tx precoder and/or at least one non coherent 8 Tx precoder. In some embodiments, the terminal device 120 may be configured with the at least one second full coherent 8 Tx precoder and at least one first partial coherent 8 Tx precoder and at least one second partial coherent 8 Tx precoder and/or at least one non coherent 8 Tx precoder. In some embodiments, the terminal device 120 may be configured with the at least one second full coherent 8 Tx precoder and at least one first partial coherent 8 Tx precoder and/or at least one non coherent 8 Tx precoder. In some embodiments, the terminal device 120 may be configured with the at least one second full coherent 8 Tx precoder and at least one second partial coherent 8 Tx precoder and/or at least one non coherent 8 Tx precoder.

In some embodiments, the terminal device 120 may indicate or report the at least one capability that supporting at least one partial coherent 8 Tx precoder. In some embodiments, the terminal device 120 may be configured with the at least one partial coherent 8 Tx precoder. In some embodiments, the terminal device 120 may be configured with the at least one partial coherent 8 Tx precoder and/or at least one non coherent 8 Tx precoder. In some embodiments, the terminal device 120 may be configured with the at least one first partial coherent 8 Tx precoder and at least one second partial coherent 8 Tx precoder and/or at least one non coherent 8 Tx precoder. In some embodiments, the terminal device 120 may be configured with the at least one first partial coherent 8 Tx precoder and/or at least one non coherent 8 Tx precoder. In some embodiments, the terminal device 120 may be configured with the at least one second partial coherent 8 Tx precoder and/or at least one non coherent 8 Tx precoder.

In some embodiments, the terminal device 120 may indicate or report the at least one capability that supporting at least one first partial coherent 8 Tx precoder. In some embodiments, the terminal device 120 may be configured with the at least one first partial coherent 8 Tx precoder. In some embodiments, the terminal device 120 may be configured with the at least one first partial coherent 8 Tx precoder and at least one second partial coherent 8 Tx precoder. In some embodiments, the terminal device 120 may be configured with the at least one first partial coherent 8 Tx precoder and/or at least one non coherent 8 Tx precoder. In some embodiments, the terminal device 120 may be configured with the at least one first partial coherent 8 Tx precoder and at least one second partial coherent 8 Tx precoder and/or at least one non coherent 8 Tx precoder. In some embodiments, the terminal device 120 may be configured with the at least one second partial coherent 8 Tx precoder and/or at least one non coherent 8 Tx precoder.

In some embodiments, the terminal device 120 may indicate or report the at least one capability that supporting at least one second partial coherent 8 Tx precoder. In some embodiments, the terminal device 120 may be configured with the at least one second partial coherent 8 Tx precoder. In some embodiments, the terminal device 120 may be configured with the at least one first partial coherent 8 Tx precoder and at least one second partial coherent 8 Tx precoder. In some embodiments, the terminal device 120 may be configured with the at least one first partial coherent 8 Tx precoder and/or at least one non coherent 8 Tx precoder. In some embodiments, the terminal device 120 may be configured with the at least one first partial coherent 8 Tx precoder and at least one second partial coherent 8 Tx precoder and/or at least one non coherent 8 Tx precoder. In some embodiments, the terminal device 120 may be configured with the at least one second partial coherent 8 Tx precoder and/or at least one non coherent 8 Tx precoder.

In some embodiments, the terminal device 120 may indicate or report the at least one capability that supporting at least one non coherent 8 Tx precoder. In some embodiments, the terminal device 120 may be configured with the at least one non coherent 8 Tx precoder.

In some embodiments, for each one of the full coherent 8 Tx precoders and/or each one of the first full coherent 8 Tx precoders and/or each one of the second full coherent 8 Tx precoders, the 8 elements in each column or in each row of the precoding matrix may be non-zero value. For example, the value may be at least one of {1, −1, j, −j} or at least one of {1, e^{j*2π/8}, e^{j*2*2π/8}, e^{j*3*2π/8}, e^{j*4*2π/8}, e^{j*5*2π/8}, e^{j*6*2π/8}, e^{j*7*2π/8}}.

In some embodiments, for each one of the partial coherent 8 Tx precoders and/or each one of the first partial coherent 8 Tx precoders, for the 8 elements in each column or in each row of the precoding matrix, there may be 4 elements with non-zero values, and the other 4 elements are with value 0. For example, the value for the 4 elements with non-zero values may be at least one of {1, −1, j, −j} or at least one of {1, e^{j*2π/8}, e^{j*2*2π/8}, e^{j*3*2π/8}, e^{j*4*2π/8}, e^{j*5*2π/8}, e^{j*6*2π/8}, e^{j*7*2π/8}}.

In some embodiments, for each one of the partial coherent 8 Tx precoders and/or each one of the second partial coherent 8 Tx precoders, for the 8 elements in each column or in each row of the precoding matrix, there may be 2 elements with non-zero values, and the other 6 elements are with value 0. For example, the value for the 2 elements with non-zero values may be at least one of {1, −1, j, −j} or at least one of {1, e^{j*2π/8}, e^{j*2*2π/8}, e^{j*3*2π/8}, e^{j*4*2π/8}, e^{j*5*2π/8}, e^{j*6*2π/8}, e^{j*7*2π/8}}.

In some embodiments, for each one of the non coherent 8 Tx precoders, for the 8 elements in each column or in each row of the precoding matrix, there may be only 1 element with non-zero values, and the other 7 elements are with value 0. For example, the value for the 1 element with non-zero values may be 1.

For example, there may be a set of precoding matrixes for 8 transmitting (TX) uplink transmission or for PUSCH transmission associated with 8-port SRS. In some embodiments, the set of precoding matrix may comprise one or more full coherent precoding matrixes. Alternatively or in addition, the set of precoding matrix may comprise one or more partial-coherent precoding matrixes. Alternatively or in addition, the set of precoding matrix may comprise one or more non-coherent precoding matrixes. Alternatively or in addition, the set of precoding matrix may comprise one or more mixed partial and non-coherent precoding matrixes. In some embodiments, the set of precoding matrix may comprise one or more partial-coherent precoding matrixes. Alternatively or in addition, the set of precoding matrix may comprise one or more mixed partial and non-coherent precoding matrixes. Alternatively or in addition, the set of precoding matrix may comprise one or more non-coherent precoding matrixes. In some embodiments, the set of precoding matrix may comprise one or more non-coherent precoding matrixes.

In some embodiments, there may be a parameter “N₁”, and “N₁” may represent a number of ports in a first dimension. For example, “N₁” may be at least one of {1, 2, 4, 8}. For another example, “N₁” may be 2 or 4. In some embodiments, there may be a parameter “N2”, and “N2” may represent a number of ports in a second dimension. For example, “N₂” may be at least one of {1, 2, 4, 8}. For another example, “N₂” may be 1 or 2. In some embodiments, a product of N1 and N2 may be 8. For example, the antenna structure may be linear array with one dimension. For example, the antenna structure may be single-polarized configuration. For example, N1=1, N2=8. For another example, N1=2, N2=4. For another example, N1=4, N2=2. For another example, N1=8, N2=1. In some embodiments, a product of N1 and N2 may be 4. For example, the antenna structure may be linear array with two dimensions. For example, the antenna structure may be dual-polarized or cross-polarized configuration. For example, N1=1, N2=4. For another example, N1=2, N2=2. For another example, N1=4, N2=1. In some embodiments, there may be a parameter “O₁”, and “O₁” may represent a first discrete fourier transform (DFT) oversampling in the first dimension. For example, “O₁” may be at least one of {1, 2, 4}. For another example, “O₁” may be 2 or 4. In some embodiments, there may be a parameter “O₂”, and “O₂” may represent a second DFT oversampling in the second dimension. For example, “O₂” may be at least one of {1, 2, 4}. For another example, “O₂” may be 2 or 4. In some embodiments, the first dimension may be horizontal dimension and the second dimension may be vertical dimension. In some embodiments, the first dimension may be vertical dimension and the second dimension may be horizontal dimension. In some embodiments, the first dimension may be horizontal dimension and the second dimension may be vertical dimension with a tilt. In some embodiments, the first dimension may be vertical dimension with a tilt and the second dimension may be horizontal dimension.

In some embodiments, there may be a first vector uₘ. In some embodiments, uₘ may be a DFT vector. In some embodiments, if N₂>1,

$${u}_{m} = [ 1 , {e}^{j \frac{2 π m}{{O}_{2} {N}_{2}}} , … , {e}^{j \frac{2 π m ( {N}_{2} - 1 )}{{O}_{2} {N}_{2}}} ] .$$

In some embodiments, if N₂=2,

$${u}_{m} = [ 1 , {e}^{j \frac{2 π m}{{O}_{2} {N}_{2}}} ] .$$

In some embodiments, if N₂=1, uₘ=1. In some embodiments, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0 or 2. For another example, m may be 0.

In some embodiments, there may be a second vector v_{l,m}. In some embodiments,

$${v}_{l , m} = {[ {u}_{m} , {u}_{m} , {e}^{j \frac{2 π l}{{O}_{1} {N}_{1}}} , … , {u}_{m} ⋆ {e}^{j \frac{2 π l ( {N}_{1} - 1 )}{{O}_{1} {N}_{1}}} ]}^{T} .$$

In some embodiments, if N₁=2 and N₂=2,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, if N₁=4 and N₂=1,

$${v}_{lmm} = {[ 1 , {e}^{j \frac{2 π l}{{O}_{1} {N}_{1}}} , {e}^{j \frac{2 π l ⋆ 2}{{O}_{1} {N}_{1}}} , {e}^{j \frac{2 π l ⋆ 3}{{O}_{1} {N}_{1}}} ]}^{T} .$$

In some embodiments, l may be a non-negative integer. For example, 0≤l≤O₁N₁. For another example, l may be at least one of {0, 2, 4, 6}. For another example, l may be at least one of {0, 2, 4, 6, 8, 10, 12, 14}. For another example, l may be at least one of {0, 1, 2, 3}. For another example, l may be 0 or 1. For another example, l may be 0 or 2. For another example, l may be 0. In some embodiments, [ ]^{T} may represent a transposition of a vector or a matrix.

In some embodiments, j may be imaginary unit. In some embodiments, j²=−1. In some embodiments, i may be imaginary unit. In some embodiments, i²=−1.

In some embodiments, there may be a factor φₙ. In some embodiments,

$${φ}_{n} = {e}^{j \frac{π n}{2}} .$$

In some embodiments, n may be a non-negative integer. For example, n may be at least one of {0, 1, 2, 3}. For another example, n may be 0 or 1. For another example, n may be 0 or 2. For another example, n may be 0.

In some embodiments, if the terminal device 110 is indicated with the number of layers as 8, there may be a first set of precoding matrixes corresponding to 8 layers (e.g. a first set of full coherent precoding matrixes).

In some embodiments, there may be a first set of vectors (For example, represented as v_{4,1,1}) corresponding to 1 layer, and the first set of vectors corresponding to 1 layer may be applied for 8 Tx full coherent precoders with 1 layer and/or 8 Tx partial coherent precoders with 1 layer. For example, the 8 Tx partial coherent precoders may be a first partial coherent precoders. For example, for first partial coherent precoders, the 8 Tx antennas may be comprised with two groups, and each group may comprise 4 antennas. For example, the 4 antennas in one group may be coherent. In some embodiments, the first set of vectors corresponding to 1 layer may be at least one of:

$${\frac{1}{2} [ 1 , 1 , 1 , − 1 ]}^{T} , {\frac{1}{2} [ 1 , 1 , j , j ]}^{T} , {\frac{1}{2} [ 1 , 1 , − 1 , 1 ]}^{T} , {\frac{1}{2} [ 1 , 1 , − j , − j ]}^{T} , {\frac{1}{2} [ 1 , j , 1 , j ]}^{T} , {\frac{1}{2} [ 1 , j , j , 1 ]}^{T} , {\frac{1}{2} [ 1 , j , − 1 , − j ]}^{T} , {\frac{1}{2} [ 1 , j , − j , − 1 ]}^{T} , {\frac{1}{2} [ 1 , − 1 , 1 , 1 ]}^{T} , {\frac{1}{2} [ 1 , − 1 , j , − j ]}^{T} , {\frac{1}{2} [ 1 , − 1 , − 1 , − 1 ]}^{T} , {\frac{1}{2} [ 1 , − 1 , − j , j ]}^{T} , {\frac{1}{2} [ 1 , − j , 1 , − j ]}^{T} , {\frac{1}{2} [ 1 , − j , j , − 1 ]}^{T} , {\frac{1}{2} [ 1 , − j , − 1 , j ]}^{T} and {\frac{1}{2} [ 1 , - j , - j , 1 ]}^{T} ,$$

In some embodiments, the first set of vectors corresponding to 1 layer may be at least one of:

$${\frac{1}{2} [ 1 , 1 , 1 , 1 ]}^{T} , {\frac{1}{2} [ 1 , 1 , j , j ]}^{T} , {\frac{1}{2} [ 1 , 1 , − 1 , − 1 ]}^{T} , {\frac{1}{2} [ 1 , 1 , − j , − j ]}^{T} , {\frac{1}{2} [ 1 , j , 1 , j ]}^{T} , {\frac{1}{2} [ 1 , j , j , − 1 ]}^{T} , {\frac{1}{2} [ 1 , j , − 1 , − j ]}^{T} , {\frac{1}{2} [ 1 , j , − j , 1 ]}^{T} , {\frac{1}{2} [ 1 , − 1 , 1 , − 1 ]}^{T} , {\frac{1}{2} [ 1 , − 1 , j , − j ]}^{T} , {\frac{1}{2} [ 1 , − 1 , − 1 , 1 ]}^{T} , {\frac{1}{2} [ 1 , − 1 , − j , j ]}^{T} , {\frac{1}{2} [ 1 , − j , 1 , − j ]}^{T} , {\frac{1}{2} [ 1 , − j , j , 1 ]}^{T} , {\frac{1}{2} [ 1 , − j , − 1 , j ]}^{T} and {\frac{1}{2} [ 1 , − j , − j , − 1 ]}^{T} .$$

In some embodiments, the first set of vectors corresponding to 1 layer may be at least one of:

$${\frac{1}{2} [ 1 , 1 , 1 , - 1 ]}^{T} , {\frac{1}{2} [ 1 , 1 , j , j ]}^{T} , {\frac{1}{2} [ 1 , 1 , - 1 , 1 ]}^{T} , {\frac{1}{2} [ 1 , 1 , - j , - j ]}^{T} , {\frac{1}{2} [ 1 , j , 1 , j ]}^{T} , {\frac{1}{2} [ 1 , j , j , 1 ]}^{T} , {\frac{1}{2} [ 1 , j , - 1 , - j ]}^{T} , {\frac{1}{2} [ 1 , j , - j , - 1 ]}^{T} , {\frac{1}{2} [ 1 , - 1 , 1 , 1 ]}^{T} , {\frac{1}{2} [ 1 , - 1 , j , - j ]}^{T} , {\frac{1}{2} [ 1 , - 1 , - 1 , - 1 ]}^{T} , {\frac{1}{2} [ 1 , - 1 , - j , j ]}^{T} , {\frac{1}{2} [ 1 , - j , 1 , - j ]}^{T} , {\frac{1}{2} [ 1 , - j , j , - 1 ]}^{T} , {\frac{1}{2} [ 1 , - j , - 1 , j ]}^{T} , {\frac{1}{2} [ 1 , - j , - j , 1 ]}^{T} , {\frac{1}{2} [ 1 , 1 , - 1 , - 1 ]}^{T} , {\frac{1}{2} [ 1 , 1 , - 1 , - 1 ]}^{T} , {\frac{1}{2} [ 1 , j , j , - 1 ]}^{T} , {\frac{1}{2} [ 1 , j , - j , 1 ]}^{T} , {\frac{1}{2} [ 1 , - 1 , 1 , - 1 ]}^{T} , {\frac{1}{2} [ 1 , - 1 , - 1 , 1 ]}^{T} , {\frac{1}{2} [ 1 , - j , j , 1 ]}^{T} and {\frac{1}{2} [ 1 , - j , - j , - 1 ]}^{T} .$$

In some embodiments, the number of vectors in the first set of vectors corresponding to 1 layer may be St_{1,1}, and St_{1,1} may be a positive integer. For example, 1≤St_{1,1}≤32. For example, St_{1,1} may be 16 or 24. In some embodiments, one vector in the first set of vectors corresponding to 1 layer may be represented as

$${v}_{4 , 1 , 1} ( s ) = {\frac{1}{2} [ {p}_{4 , 1 , 1} ( s , 0 ) , {p}_{4 , 1 , 1} ( s , 1 ) , {p}_{4 , 1 , 1} ( s , 2 ) , {p}_{4 , 1 , 1} ( s , 3 ) ]}^{T} .$$

In some embodiments, s may be a non-negative integer, and 0≤s≤St_{1,1}−1. In some embodiments, the value of p_{4,1,1}(s, 0) and/or the value of p_{4,1,1} (s, 1) and/or the value of p_{4,1,1}(s, 2) and/or the value of p_{4,1,1}(s, 3) may be at least one of {1, −1, j, −j} or at least one of {1, e^{j*2π/8}, e^{j*2*2π/8}, e^{j*3*2π/8}, e^{j*4*2π/8}, e^{j*5*2π/8}, e^{j*6*2π/8}, e^{j*7*2π/8}}.

In some embodiments, the at least one full coherent 8 Tx precoders and/or the at least one second full coherent 8 Tx precoders may comprise at least one of:

$$\frac{1}{2} [ \begin{matrix}{v}_{4 , 1 , 1} ( s 1 ) \\ {φ}_{g} * {v}_{4 , 1 , 1} ( s2 )\end{matrix} ] .$$

In some embodiments, v_{4,1,1}(s1) may be one vector from the first set of vectors corresponding to 1 layer. In some embodiments, v_{4,1,1}(s2) may be one vector from the first set of vectors corresponding to 1 layer. In some embodiments, v_{4,1,1}(s1) may be same or different from v_{4,1,1}(s2).

In some embodiments, φ_{g} may be e^{j*2π*g/G}, and where G may be at least one of {4, 8, 12, 16}, and g may be an integer from 0 to G−1.

In some embodiments, the first antenna group with 4 antennas may comprise antennas with {AP0, AP2, AP4, AP6} and the second antenna group with 4 antennas may comprise antennas with {AP1, AP3, AP5, AP7}. In some embodiments, the at least one full coherent 8 Tx precoders and/or the at least one second full coherent 8 Tx precoders may comprise at least one of:

$${\frac{1}{\sqrt{8}} [ {p}_{4 , 1 , 1} ( s 1 , 0 ) , {φ}_{g} * {p}_{4 , 1 , 1} ( s 2 , 0 ) , {p}_{4 , 1 , 1} ( s 1 , 1 ) , {φ}_{g} * {p}_{4 , 1 , 1} ( s 2 , 1 ) , {p}_{4 , 1 , 1} ( s 1 , 2 ) , {φ}_{g} * {p}_{4 , 1 , 1} ( s 2 , 2 ) , {p}_{4 , 1 , 1} ( s 1 , 3 ) , {φ}_{g} * {p}_{4 , 1 , 1} ( s 2 , 3 ) ]}^{T} .$$

$${\frac{1}{\sqrt{8}} [ {p}_{4 , 1 , 1} ( s 1 , 0 ) , {p}_{4 , 1 , 1} ( s 1 , 1 ) , {φ}_{g} * {p}_{4 , 1 , 1} ( s 2 , 0 ) , {φ}_{g} * {p}_{4 , 1 , 1} ( s 2 , 1 ) , {p}_{4 , 1 , 1} ( s 1 , 2 ) , {p}_{4 , 1 , 1} ( s 1 , 3 ) , {φ}_{g} * {p}_{4 , 1 , 1} ( s 2 , 2 ) , {φ}_{g} * {p}_{4 , 1 , 1} ( s 2 , 3 ) ]}^{T} .$$

$${\frac{1}{\sqrt{8}} [ {p}_{4 , 1 , 1} ( s 1 , 0 ) , {p}_{4 , 1 , 1} ( s 1 , 1 ) , {p}_{4 , 1 , 1} ( s 1 , 2 ) , \\ {p}_{4 , 1 , 1} ( s 1 , 3 ) , {φ}_{g} * {p}_{4 , 1 , 1} ( s 2 , 0 ) , \\ {φ}_{g} * {p}_{4 , 1 , 1} ( s 2 , 1 ) , {φ}_{g} * {p}_{4 , 1 , 1} ( s 2 , 2 ) , {φ}_{g} * {p}_{4 , 1 , 1} ( s 2 , 3 ) ]}^{T} .$$

In some embodiments, the at least one partial coherent 8 Tx precoders and/or the at least one first partial coherent 8 Tx precoders may comprise at least one of:

$$\frac{1}{\sqrt{2}} [ \begin{matrix}{v}_{4 , 1 , 1} ( s 1 ) \\ 0\end{matrix} ] and \frac{1}{\sqrt{2}} [ \begin{matrix}0 \\ {v}_{4 , 1 , 1} ( s 1 )\end{matrix} ] .$$

In some embodiments, v_{4,1,1}(s1) may be one vector from the first set of vectors corresponding to 1 layer. In some embodiments, “0” in the

$$\frac{1}{\sqrt{2}} [ \begin{matrix}{v}_{4 , 1 , 1} ( s 1 ) \\ 0\end{matrix} ] and / or \frac{1}{\sqrt{2}} [ \begin{matrix}0 \\ {v}_{4 , 1 , 1} ( s 1 )\end{matrix} ]$$

may represent a vector with 4 elements. For example, a vector of [0, 0, 0, 0]^{T}. In some embodiments, for a first group of antennas or the first group of antennas is configured or indicated, the at least one partial coherent 8 Tx precoders and/or the at least one first partial coherent 8 Tx precoders may comprise at least one of:

$$\frac{1}{\sqrt{2}} [ \begin{matrix}{v}_{4 , 1 , 1} ( s 1 ) \\ 0\end{matrix} ] .$$

In some embodiments, for a second group of antennas or the second group of antennas is configured or indicated, the at least one partial coherent 8 Tx precoders and/or the at least one first partial coherent 8 Tx precoders may comprise at least one of:

$$\frac{1}{\sqrt{2}} [ \begin{matrix}0 \\ {v}_{4 , 1 , 1} ( s 1 )\end{matrix} ] .$$

In some embodiments, the first antenna group with 4 antennas may comprise antennas with {AP0, AP2, AP4, AP6} and the second antenna group with 4 antennas may comprise antennas with {AP1, AP3, AP5, AP7}. In some embodiments, the at least one partial coherent 8 Tx precoders and/or the at least one first partial coherent 8 Tx precoders may comprise at least one of:

$${\frac{1}{\sqrt{8}} [ {p}_{4 , 1 , 1} ( s 1 , 0 ) , 0 , {p}_{4 , 1 , 1} ( s 1 , 1 ) , 0 , {p}_{4 , 1 , 1} ( s 1 , 2 ) , 0 , \\ {p}_{4 , 1 , 1} ( s 1 , 3 ) , 0 ]}^{T} and {\frac{1}{\sqrt{8}} [ 0 , {p}_{4 , 1 , 1} ( s 1 , 0 ) , \\ 0 , {p}_{4 , 1 , 1} ( s 1 , 1 ) , 0 , {p}_{4 , 1 , 1} ( s 1 , 2 ) , 0 , {p}_{4 , 1 , 1} ( s 1 , 3 ) ]}^{T} .$$

In some embodiments, for a first group of antennas or the first group of antennas is configured or indicated, the at least one partial coherent 8 Tx precoders and/or the at least one first partial coherent 8 Tx precoders may comprise at least one of:

$${\frac{1}{\sqrt{8}} [ {p}_{4 , 1 , 1} ( s 1 , 0 ) , 0 , {p}_{4 , 1 , 1} ( s 1 , 1 ) , 0 , {p}_{4 , 1 , 1} ( s 1 , 2 ) , 0 , {p}_{4 , 1 , 1} ( s 1 , 3 ) , 0 ]}^{T} .$$

In some embodiments, for a second group of antennas or the second group of antennas is configured or indicated, the at least one partial coherent 8 Tx precoders and/or the at least one first partial coherent 8 Tx precoders may comprise at least one of:

$${\frac{1}{\sqrt{8}} [ 0 , {p}_{4 , 1 , 1} ( s 1 , 0 ) , 0 , {p}_{4 , 1 , 1} ( s 1 , 1 ) , 0 , {p}_{4 , 1 , 1} ( s 1 , 2 ) , 0 , {p}_{4 , 1 , 1} ( s 1 , 3 ) ]}^{T} .$$

In some embodiments, the first antenna group with 4 antennas may comprise antennas with {AP0, AP1, AP4, AP5} and the second antenna group with 4 antennas may comprise antennas with {AP2, AP3, AP6, AP7}. In some embodiments, the at least one partial coherent 8 Tx precoders and/or the at least one first partial coherent 8 Tx precoders may comprise at least one of:

$${\frac{1}{\sqrt{8}} [ {p}_{4 , 1 , 1} ( s 1 , 0 ) , {p}_{4 , 1 , 1} ( s 1 , 1 ) , 0 , 0 , {p}_{4 , 1 , 1} ( s 1 , 2 ) , {p}_{4 , 1 , 1} ( s 1 , 3 ) , \\ 0 , 0 ]}^{T} \text{} and {\frac{1}{\sqrt{8}} [ 0 , 0 , {p}_{4 , 1 , 1} ( s 1 , 0 ) , {p}_{4 , 1 , 1} ( s 1 , 1 ) , \\ 0 , 0 , {p}_{4 , 1 , 1} ( s 1 , 2 ) , {p}_{4 , 1 , 1} ( s 1 , 3 ) ]}^{T} .$$

In some embodiments, for a first group of antennas or the first group of antennas is configured or indicated, the at least one partial coherent 8 Tx precoders and/or the at least one first partial coherent 8 Tx precoders may comprise at least one of:

$${\frac{1}{\sqrt{8}} [ {p}_{4 , 1 , 1} ( s 1 , 0 ) , {p}_{4 , 1 , 1} ( s 1 , 1 ) , 0 , 0 , {p}_{4 , 1 , 1} ( s 1 , 2 ) , {p}_{4 , 1 , 1} ( s 1 , 3 ) , 0 , 0 ]}^{T} .$$

$${\frac{1}{\sqrt{8}} [ 0 , 0 , {p}_{4 , 1 , 1} ( s 1 , 0 ) , {p}_{4 , 1 , 1} ( s 1 , 1 ) , 0 , 0 , {p}_{4 , 1 , 1} ( s 1 , 2 ) , {p}_{4 , 1 , 1} ( s 1 , 3 ) ]}^{T} .$$

In some embodiments, the first antenna group with 4 antennas may comprise antennas with {AP0, AP1, AP2, AP3} and the second antenna group with 4 antennas may comprise antennas with {AP4, AP5, AP6, AP7}. In some embodiments, the at least one partial coherent 8 Tx precoders and/or the at least one first partial coherent 8 Tx precoders may comprise at least one of:

$${\frac{1}{\sqrt{8}} [ {p}_{4 , 1 , 1} ( s 1 , 0 ) , {p}_{4 , 1 , 1} ( s 1 , 1 ) , {p}_{4 , 1 , 1} ( s 1 , 2 ) , \\ {p}_{4 , 1 , 1} ( s 1 , 3 ) , 0 , 0 , 0 , 0 ]}^{T} and {\frac{1}{\sqrt{8}} [ 0 , 0 , \\ 0 , 0 , {p}_{4 , 1 , 1} ( s 1 , 0 ) , {p}_{4 , 1 , 1} ( s 1 , 1 ) , {p}_{4 , 1 , 1} ( s 1 , 2 ) , {p}_{4 , 1 , 1} ( s 1 , 3 ) ]}^{T} .$$

In some embodiments, for a first group of antennas or the first group of antennas is configured or indicated, the at least one partial coherent 8 Tx precoders and/or the at least one first partial coherent 8 Tx precoders may comprise at least one of:

$${\frac{1}{\sqrt{8}} [ {p}_{4 , 1 , 1} ( s 1 , 0 ) , {p}_{4 , 1 , 1} ( s 1 , 1 ) , {p}_{4 , 1 , 1} ( s 1 , 2 ) , {p}_{4 , 1 , 1} ( s 1 , 3 ) , 0 , 0 , 0 , 0 ]}^{T} .$$

In some embodiments, for a second group of antennas or the second group of antennas is configured or indicated, the at least one partial coherent 8 Tx precoders and/or the at least one first partial coherent 8 Tx precoders may comprise at least one of:

$${\frac{1}{\sqrt{8}} [ 0 , 0 , 0 , 0 , {p}_{4 , 1 , 1} ( s 1 , 0 ) , {p}_{4 , 1 , 1} ( s 1 , 1 ) , {p}_{4 , 1 , 1} ( s 1 , 2 ) , {p}_{4 , 1 , 1} ( s 1 , 3 ) ]}^{T} .$$

In some embodiments, s1 may be a non-negative integer, and 0≤s1≤St_{1,1}−1. In some embodiments, s2 may be a non-negative integer, and 0≤s2≤St_{1,1}−1.

In some embodiments, there may be a second set of vectors (For example, represented as v_{4,1,2}) corresponding to 1 layer, and the second set of vectors corresponding to 1 layer may be applied for 8 Tx partial coherent precoders with 1 layer. For example, the 8 Tx partial coherent precoders may be a first partial coherent precoders and/or a second partial coherent precoders. For example, for first partial coherent precoders, the 8 Tx antennas may be comprised with two groups, and each group may comprise 4 antennas. For example, the 4 antennas in one group may be coherent. For another example, for second partial coherent precoders, the 8 Tx antennas may be comprised with four groups, and each group may comprise 2 antennas. For example, the 2 antennas in one group may be coherent. In some embodiments, the second set of vectors corresponding to 1 layer may be at least one of:

$${\frac{1}{2} [ 1 , 0 , 1 , 0 ]}^{T} , {\frac{1}{2} [ 1 , 0 , - 1 , 0 ]}^{T} , {\frac{1}{2} [ 1 , 0 , j , 0 ]}^{T} , {\frac{1}{2} [ 1 , 0 , - j , 0 ]}^{T} ,$$

$${\frac{1}{2} [ 0 , 1 , 0 , 1 ]}^{T} , {\frac{1}{2} [ 0 , 1 , 0 , - 1 ]}^{T} , {\frac{1}{2} [ 0 , 1 , 0 , - j ]}^{T} and {\frac{1}{2} [ 0 , 1 , 0 , - j ]}^{T} .$$

In some embodiments, the number of vectors in the second set of vectors corresponding to 1 layer may be St_{1,2}, and St_{1,2} may be a positive integer. For example, 1≤St_{1,2}≤16. For example, St_{1,2} may be 4 or 8 or 16. In some embodiments, one vector in the second set of vectors corresponding to 1 layer may be represented as

$${v}_{4 , 1 , 2} ( {s}_{4 , 1 , 2} ) = \frac{1}{2} {[ {p}_{4 , 1 , 2} ( {s}_{4 , 1 , 2} , 0 ) , {p}_{4 , 1 , 2} ( {s}_{4 , 1 , 2} , 1 ) , {p}_{4 , 1 , 2} ( {s}_{4 , 1 , 2} , 2 ) , {p}_{4 , 1 , 2} ( {s}_{4 , 1 , 2} , 3 ) ]}^{T} .$$

In some embodiments, s_{4,1,2} may be a non-negative integer, and 0≤s_{4,1,2}≤St_{1,2}−1. In some embodiments, two value of the value of p_{4,1,2}(s_{4,1,2}, 0) and/or the value of p_{4,1,2}(s_{4,1,2}, 1) and/or the value of p_{4,1,2}(s_{4,1,2}, 2) and/or the value of p_{4,1,2}(s_{4,1,2}, 3) may be at least one of {1, −1, j, −j} or at least one of {1, e^{j*2π/8}, e^{j*2*2π/8}, e^{j*3*2π/8}, e^{j*4*2π/8}, e^{j*5*2π/8}, e^{j*6*2π/8}, e^{j*8*2π/8}}. In some embodiments, the other two value of the value of p_{4,1,2} (s_{4,1,2}, 0) and/or the value of p_{4,1,2}(s_{4,1,2}, 1) and/or the value of p_{4,1,2}(s_{4,1,2}, 2) and/or the value of p_{4,1,2}(s_{4,1,2}, 3) may be 0.

In some embodiments, the at least one partial coherent 8 Tx precoders and/or the at least one first partial coherent 8 Tx precoders may comprise at least one of:

$$\frac{1}{\sqrt{8}} [ \begin{matrix}{v}_{4 , 1 , 2} ( {s}_{4 , 1 , 2 , 1} ) \\ {φ}_{g} * {v}_{4 , 1 , 2} ( {s}_{4 , 1 , 2 , 2} )\end{matrix} ] .$$

In some embodiments, v_{4,1,2}(s_{4,1,2,1}) may be one vector from the second set of vectors corresponding to 1 layer. In some embodiments, v_{4,1,2}(s_{4,1,2,2}) may be one vector from the second set of vectors corresponding to 1 layer. In some embodiments, v_{4,1,2}(s_{4,1,2,1}) may be same or different from v_{4,1,2}(s_{4,1,2,2}).

In some embodiments, φ_{g} may be e^{j*2π*g/G}, and where G may be at least one of {4, 8, 12, 16}, and g may be an integer from 0 to G−1.

In some embodiments, the first antenna group with 4 antennas may comprise antennas with {AP0, AP2, AP4, AP6} and the second antenna group with 4 antennas may comprise antennas with {AP1, AP3, AP5, AP7}. In some embodiments, the at least one partial coherent 8 Tx precoders and/or the at least one first partial coherent 8 Tx precoders may comprise at least one of:

$$\frac{1}{\sqrt{8}} [ {p}_{4 , 1 , 2} ( {s}_{4 , 1 , 2 , 1} , 0 ) , {φ}_{g} ⋆ {p}_{4 , 1 , 2} ( {s}_{4 , 1 , 2 , 2} , 0 ) ,$$

$${p}_{4 , 1 , 2} ( {s}_{4 , 1 , 2 , 1} , 1 ) , {φ}_{g} ⋆ {p}_{4 , 1 , 2} ( {s}_{4 , 1 , 2 , 2} , 1 ) , {p}_{4 , 1 , 2} ( {s}_{4 , 1 , 2 , 1} , 2 ) , {φ}_{g} ⋆$$

$${{p}_{4 , 1 , 2} ( {s}_{4 , 1 , 2 , 2} , 2 ) , {p}_{4 , 1 , 2} ( {s}_{4 , 1 , 2 , 1} , 3 ) , {φ}_{g} ⋆ {p}_{4 , 1 , 2} ( {s}_{4 , 1 , 2 , 2} , 3 ) ]}^{T} .$$

In some embodiments, the first antenna group with 4 antennas may comprise antennas with {AP0, AP1, AP4, AP5} and the second antenna group with 4 antennas may comprise antennas with {AP2, AP3, AP6, AP7}. In some embodiments, the at least one partial coherent 8 Tx precoders and/or the at least one first partial coherent 8 Tx precoders may comprise at least one of:

$$\frac{1}{\sqrt{8}} [ {p}_{4 , 1 , 2} ( {s}_{4 , 1 , 2 , 1} , 0 ) , {p}_{4 , 1 , 2} ( {s}_{4 , 1 , 2 , 1} , 1 ) , {φ}_{g} ⋆ {p}_{4 , 1 , 2} ( {s}_{4 , 1 , 2 , 2} , 0 ) , {φ}_{g} ⋆$$

$${p}_{4 , 1 , 2} ( {s}_{4 , 1 , 2 , 2} , 0 ) , {φ}_{g} ⋆ {p}_{4 , 1 , 2} ( {s}_{4 , 1 , 2 , 2} , 1 ) , {p}_{4 , 1 , 2} ( {s}_{4 , 1 , 2 , 1} , 2 ) , {p}_{4 , 1 , 2} ( {s}_{4 , 1 , 2 , 1} , 3 ) ,$$

$${{φ}_{g} ⋆ {p}_{4 , 1 , 2} ( {s}_{4 , 1 , 2 , 2} , 2 ) , {φ}_{g} ⋆ {p}_{4 , 1 , 2} ( {s}_{4 , 1 , 2 , 2} , 3 ) ]}^{T} .$$

In some embodiments, the first antenna group with 4 antennas may comprise antennas with {AP0, AP1, AP2, AP3} and the second antenna group with 4 antennas may comprise antennas with {AP4, AP5, AP6, AP7}. In some embodiments, the at least one partial coherent 8 Tx precoders and/or the at least one first partial coherent 8 Tx precoders may comprise at least one of:

$$\frac{1}{\sqrt{8}} [ {p}_{4 , 1 , 2} ( {s}_{4 , 1 , 2 , 1} , 0 ) , {p}_{4 , 1 , 2} ( {s}_{4 , 1 , 2 , 1} , 1 ) , {p}_{4 , 1 , 2} ( {s}_{4 , 1 , 2 , 1} , 2 ) ,$$

$${p}_{4 , 1 , 2} ( {s}_{4 , 1 , 2 , 1} , 3 ) , {φ}_{g} ⋆ {p}_{4 , 1 , 2} ( {s}_{4 , 1 , 2 , 2} , 0 ) , {φ}_{g} ⋆ {p}_{4 , 1 , 2} ( {s}_{4 , 1 , 2 , 2} , 1 ) ,$$

$${{φ}_{g} ⋆ {p}_{4 , 1 , 2} ( {s}_{4 , 1 , 2 , 2} , 2 ) , {φ}_{g} ⋆ {p}_{4 , 1 , 2} ( {s}_{4 , 1 , 2 , 2} , 3 ) ]}^{T} .$$

In some embodiments, the at least one partial coherent 8 Tx precoders and/or the at least one second partial coherent 8 Tx precoders may comprise at least one of:

$$\frac{1}{\sqrt{2}} [ \begin{matrix}{v}_{4 , 1 , 2} ( {s}_{4 , 1 , 2 , 1} ) \\ 0\end{matrix} ] and \frac{1}{\sqrt{2}} [ \begin{matrix}0 \\ {v}_{4 , 1 , 2} ( {s}_{4 , 1 , 2 , 1} )\end{matrix} ] .$$

In some embodiments, v_{4,1,2}(s_{4,1,2,1}) may be one vector from the second set of vectors corresponding to 1 layer. In some embodiments, “0” in the

$$\frac{1}{\sqrt{2}} [ \begin{matrix}{v}_{4 , 1 , 2} ( {s}_{4 , 1 , 2 , 1} ) \\ 0\end{matrix} ] and \frac{1}{\sqrt{2}} [ \begin{matrix}0 \\ {v}_{4 , 1 , 2} ( {s}_{4 , 1 , 2 , 1} )\end{matrix} ]$$

may represent a vector with 4 elements. For example, a vector of [0, 0, 0, 0]^{T}. In some embodiments, for a first group of antennas or the first group of antennas is configured or indicated, the at least one partial coherent 8 Tx precoders and/or the at least one second partial coherent 8 Tx precoders may comprise at least one of:

$$\frac{1}{\sqrt{2}} [ \begin{matrix}{v}_{4 , 1 , 2} ( {s}_{4 , 1 , 2 , 1} ) \\ 0\end{matrix} ] .$$

In some embodiments, for a second group of antennas or the second group of antennas is configured or indicated, the at least one partial coherent 8 Tx precoders and/or the at least one second partial coherent 8 Tx precoders may comprise at least one of:

$$\frac{1}{\sqrt{2}} [ \begin{matrix}0 \\ {v}_{4 , 1 , 2} ( {s}_{4 , 1 , 2 , 1} )\end{matrix} ] .$$

In some embodiments, the first antenna group with 4 antennas may comprise antennas with {AP0, AP2, AP4, AP6} and the second antenna group with 4 antennas may comprise antennas with {AP1, AP3, AP5, AP7}. In some embodiments, the at least one partial coherent 8 Tx precoders and/or the at least one second partial coherent 8 Tx precoders may comprise at least one of:

$$\frac{1}{\sqrt{8}} [ {p}_{4 , 1 , 2} ( {s}_{4 , 1 , 2 , 1} , 0 ) , 0 , {p}_{4 , 1 , 2} ( {s}_{4 , 1 , 2 , 1} , 1 ) , 0 ,$$

$${{p}_{4 , 1 , 2} ( {s}_{4 , 1 , 2 , 1} , 2 ) , 0 , {p}_{4 , 1 , 2} ( {s}_{4 , 1 , 2 , 1} , 3 ) , 0 ]}^{T}$$

$$and$$

$$\frac{1}{\sqrt{8}} [ 0 , {p}_{4 , 1 , 2} ( {s}_{4 , 1 , 2 , 1} , 0 ) , 0 , {p}_{4 , 1 , 2} ( {s}_{4 , 1 , 2 , 1} , 1 ) , 0 ,$$

$${{p}_{4 , 1 , 2} ( {s}_{4 , 1 , 2 , 1} , 2 ) , 0 , {p}_{4 , 1 , 2} ( {s}_{4 , 1 , 2 , 1} , 3 ) ]}^{T} .$$

In some embodiments, for a first group of antennas or the first group of antennas is configured or indicated, the at least one partial coherent 8 Tx precoders and/or the at least one second partial coherent 8 Tx precoders may comprise at least one of:

$$\frac{1}{\sqrt{8}} [ {p}_{4 , 1 , 2} ( {s}_{4 , 1 , 2 , 1} , 0 ) , 0 , {p}_{4 , 1 , 2} ( {s}_{4 , 1 , 2 , 1} , 1 ) , 0 ,$$

$${{p}_{4 , 1 , 2} ( {s}_{4 , 1 , 2 , 1} , 2 ) , 0 , {p}_{4 , 1 , 2} ( {s}_{4 , 1 , 2 , 1} , 3 ) , 0 ]}^{T} .$$

In some embodiments, for a second group of antennas or the second group of antennas is configured or indicated, the at least one partial coherent 8 Tx precoders and/or the at least one second partial coherent 8 Tx precoders may comprise at least one of:

$$\frac{1}{\sqrt{8}} [ 0 , {p}_{4 , 1 , 2} ( {s}_{4 , 1 , 2 , 1} , 0 ) , 0 , {p}_{4 , 1 , 2} ( {s}_{4 , 1 , 2 , 1} , 1 ) , 0 ,$$

$${{p}_{4 , 1 , 2} ( {s}_{4 , 1 , 2 , 1} , 2 ) , 0 , {p}_{4 , 1 , 2} ( {s}_{4 , 1 , 2 , 1} , 3 ) ]}^{T} .$$

In some embodiments, the first antenna group with 4 antennas may comprise antennas with {AP0, AP1, AP4, AP5} and the second antenna group with 4 antennas may comprise antennas with {AP2, AP3, AP6, AP7}. In some embodiments, the at least one partial coherent 8 Tx precoders and/or the at least one second partial coherent 8 Tx precoders may comprise at least one of:

$$\frac{1}{\sqrt{8}} [ {p}_{4 , 1 , 2} ( {s}_{4 , 1 , 2 , 1} , 0 ) , {p}_{4 , 1 , 2} ( {s}_{4 , 1 , 2 , 1} , 1 ) , 0 ,$$

$${0 , {p}_{4 , 1 , 2} ( {s}_{4 , 1 , 2 , 1} , 2 ) , {p}_{4 , 1 , 2} ( {s}_{4 , 1 , 2 , 1} , 3 ) , 0 , 0 ]}^{T}$$

$$and$$

$$\frac{1}{\sqrt{8}} [ 0 , 0 , {p}_{4 , 1 , 2} ( {s}_{4 , 1 , 2 , 1} , 0 ) , {p}_{4 , 1 , 2} ( {s}_{4 , 1 , 2 , 1} , 1 ) , 0 , 0 ,$$

$${{p}_{4 , 1 , 2} ( {s}_{4 , 1 , 2 , 1} , 2 ) , {p}_{4 , 1 , 2} ( {s}_{4 , 1 , 2 , 1} , 3 ) ]}^{T} .$$

In some embodiments, for a first group of antennas or the first group of antennas is configured or indicated, the at least one partial coherent 8 Tx precoders and/or the at least one second partial coherent 8 Tx precoders may comprise at least one of:

$$\frac{1}{\sqrt{8}} [ {p}_{4 , 1 , 2} ( {s}_{4 , 1 , 2 , 1} , 0 ) , {p}_{4 , 1 , 2} ( {s}_{4 , 1 , 2 , 1} , 1 ) , {0 , 0 , {p}_{4 , 1 , 2} ( {s}_{4 , 1 , 2 , 1} , 2 ) , {p}_{4 , 1 , 2} ( {s}_{4 , 1 , 2 , 1} , 3 ) , 0 , 0 ]}^{T} .$$

In some embodiments, for a second group of antennas or the second group of antennas is configured or indicated, the at least one partial coherent 8 Tx precoders and/or the at least one second partial coherent 8 Tx precoders may comprise at least one of:

$$\frac{1}{\sqrt{8}} [ 0 , 0 , {p}_{4 , 1 , 2} ( {s}_{4 , 1 , 2 , 1} , 0 ) , {p}_{4 , 1 , 2} ( {s}_{4 , 1 , 2 , 1} , 1 ) , 0 , {0 , {p}_{4 , 1 , 2} ( {s}_{4 , 1 , 2 , 1} , 2 ) , {p}_{4 , 1 , 2} ( {s}_{4 , 1 , 2 , 1} , 3 ) ]}^{T} .$$

In some embodiments, the first antenna group with 4 antennas may comprise antennas with {AP0, AP1, AP2, AP3} and the second antenna group with 4 antennas may comprise antennas with {AP4, AP5, AP6, AP7}. In some embodiments, the at least one partial coherent 8 Tx precoders and/or the at least one second partial coherent 8 Tx precoders may comprise at least one of:

$$\frac{1}{\sqrt{8}} [ {p}_{4 , 1 , 2} ( {s}_{4 , 1 , 2 , 1} , 0 ) , {p}_{4 , 1 , 2} ( {s}_{4 , 1 , 2 , 1} , 1 ) ,$$

$${{p}_{4 , 1 , 2} ( {s}_{4 , 1 , 2 , 1} , 2 ) , {p}_{4 , 1 , 2} ( {s}_{4 , 1 , 2 , 1} , 3 ) , 0 , 0 , 0 , 0 ]}^{T}$$

$$and$$

$$\frac{1}{\sqrt{8}} [ 0 , 0 , 0 , 0 , {p}_{4 , 1 , 2} ( {s}_{4 , 1 , 2 , 1} , 0 ) , {p}_{4 , 1 , 2} ( {s}_{4 , 1 , 2 , 1} , 1 ) , {p}_{4 , 1 , 2} ( {s}_{4 , 1 , 2 , 1} , 2 ) , {p}_{4 , 1 , 2} ( {s}_{4 , 1 , 2 , 1} , 3 ) ] .$$

In some embodiments, for a first group of antennas or the first group of antennas is configured or indicated, the at least one partial coherent 8 Tx precoders and/or the at least one second partial coherent 8 Tx precoders may comprise at least one of:

$$\frac{1}{\sqrt{8}} [ {p}_{4 , 1 , 2} ( {s}_{4 , 1 , 2 , 1} , 0 ) , {p}_{4 , 1 , 2} ( {s}_{4 , 1 , 2 , 1} , 1 ) ,$$

$${{p}_{4 , 1 , 2} ( {s}_{4 , 1 , 2 , 1} , 2 ) , {p}_{4 , 1 , 2} ( {s}_{4 , 1 , 2 , 1} , 3 ) , 0 , 0 , 0 , 0 ]}^{T} .$$

In some embodiments, for a second group of antennas or the second group of antennas is configured or indicated, the at least one partial coherent 8 Tx precoders and/or the at least one second partial coherent 8 Tx precoders may comprise at least one of:

$$\frac{1}{\sqrt{8}} [ 0 , 0 , 0 , 0 , {{p}_{4 , 1 , 2} ( {s}_{4 , 1 , 2 , 1} , 0 ) , {p}_{4 , 1 , 2} ( {s}_{4 , 1 , 2 , 1} , 1 ) , {p}_{4 , 1 , 2} ( {s}_{4 , 1 , 2 , 1} , 2 ) , {p}_{4 , 1 , 2} ( {s}_{4 , 1 , 2 , 1} , 3 ) ]}^{T} .$$

In some embodiments, s_{4,1,2,1} may be a non-negative integer, and 0≤s_{4,1,2,1}≤St_{1,2}−1. In some embodiments, s_{4,1,2,2} may be a non-negative integer, and 0≤s_{4,1,2,2}≤St_{1,2}−1.

In some embodiments, there may be a third set of vectors (For example, represented as (v_{4,1,3}) corresponding to 1 layer, and the third set of vectors corresponding to 1 layer may be applied for 8 Tx partial coherent precoders with 1 layer and/or 8 Tx non coherent precoders with 1 layer. For example, the 8 Tx partial coherent precoders may be a second partial coherent precoders. For example, for the second partial coherent precoders, the 8 Tx antennas may be comprised with four groups, and each group may comprise 2 antennas. For example, the 2 antennas in one group may be coherent. In some embodiments, the third set of vectors corresponding to 1 layer may be at least one of:

$${\frac{1}{2} [ 1 , 0 , 0 , 0 ]}^{T} , {\frac{1}{2} [ 0 , 1 , 0 , 0 ]}^{T} , {\frac{1}{2} [ 0 , 0 , 1 , 0 ]}^{T}$$

$$and$$

$${\frac{1}{2} [ 0 , 0 , 0 , 1 ]}^{T} .$$

In some embodiments, the number of vectors in the third set of vectors corresponding to 1 layer may be St_{1,3}, and St_{1,3} may be a positive integer. For example, 1≤St_{1,3}≤4. For example, St_{1,3} may be 2 or 4 or. In some embodiments, one vector in the third set of vectors corresponding to 1 layer may be represented as

$${v}_{4 , 1 , 3} ( {s}_{4 , 1 , 3} ) = \frac{1}{2} {[ {p}_{4 , 1 , 3} ( {s}_{4 , 1 , 3} , 0 ) , {p}_{4 , 1 , 2} ( {s}_{4 , 1 , 3} , 1 ) , {p}_{4 , 1 , 2} ( {s}_{4 , 1 , 3} , 2 ) , {p}_{4 , 1 , 2} ( {s}_{4 , 1 , 3} , 3 ) ]}^{T} .$$

In some embodiments, s_{4,1,3} may be a non-negative integer, and 0≤s_{4,1,3}≤St_{1,3}−1. In some embodiments, one value of the value of p_{4,1,3}(s_{4,1,3}, 0) and/or the value of p_{4,1,3}(s_{4,1,3}, 1) and/or the value of p_{4,1,3}(s_{4,1,3}, 2) and/or the value of p_{4,1,3}(s_{4,1,3}, 3) may be 1. In some embodiments, the other three values of the value of p_{4,1,3}(s_{4,1,3}, 0) and/or the value of p_{4,1,3}(s_{4,1,3}, 1) and/or the value of p_{4,1,3}(s_{4,1,3}, 2) and/or the value of p_{4,1,3}(s_{4,1,3}, 3) may be 0.

In some embodiments, the at least one partial coherent 8 Tx precoders and/or the at least one second partial coherent 8 Tx precoders may comprise at least one of:

$$\frac{1}{\sqrt{2}} [ \begin{matrix}{v}_{4 , 1 , 3} ( {s}_{4 , 1 , 3 , 1} ) \\ {φ}_{g} * {v}_{4 , 1 , 3} ( {s}_{4 , 1 , 3 , 2} )\end{matrix} ] .$$

In some embodiments, v_{4,1,3}(s_{4,1,3,1}) may be one vector from the third set of vectors corresponding to 1 layer. In some embodiments, v_{4,1,3}(s_{4,1,3,2}) may be one vector from the third set of vectors corresponding to 1 layer. In some embodiments, v_{4,1,3}(s_{4,1,3,1}) may be same or different from v_{4,1,3}(s_{4,1,3,2}).

In some embodiments, φ_{g} may be e^{j*2π*g/G}, and where G may be at least one of {4, 8, 12, 16}, and g may be an integer from 0 to G−1.

In some embodiments, the first antenna group with 4 antennas may comprise antennas with {AP0, AP2, AP4, AP6} and the second antenna group with 4 antennas may comprise antennas with {AP1, AP3, AP5, AP7}. In some embodiments, the at least one partial coherent 8 Tx precoders and/or the at least one second partial coherent 8 Tx precoders may comprise at least one of:

$$\frac{1}{\sqrt{8}} [ {P}_{4 , 1 , 3} ( {s}_{4 , 1 , 3 , 1} , 0 ) , {φ}_{g} * {φ}_{g} * {p}_{4 , 1 , 3} ( {s}_{4 , 1 , 3 , 2} , 0 ) , {p}_{4 , 1 , 3} ( {s}_{4 , 1 , 3 , 1} , 1 ) , {φ}_{g} ⋆ {p}_{4 , 1 , 3} ( {s}_{4 , 1 , 3 , 2} , 1 ) , {p}_{4 , 1 , 3} ( {s}_{4 , 1 , 3 , 1} , 2 ) , {φ}_{g} {{p}_{4 , 1 , 3} ( {s}_{4 , 1 , 3 , 2} , 2 ) , {p}_{4 , 1 , 3} ( {s}_{4 , 1 , 3 , 1} , 3 ) , {φ}_{g} ⋆ {p}_{4 , 1 , 3} ( {s}_{4 , 1 , 3 , 2} , 3 ) ]}^{T} .$$

In some embodiments, the first antenna group with 4 antennas may comprise antennas with {AP0, AP1, AP4, AP5} and the second antenna group with 4 antennas may comprise antennas with {AP2, AP3, AP6, AP7}. In some embodiments, the at least one partial coherent 8 Tx precoders and/or the at least one second partial coherent 8 Tx precoders may comprise at least one of:

$$\frac{1}{\sqrt{8}} [ {P}_{4 , 1 , 3} ( {s}_{4 , 1 , 3 , 1} , 0 ) , {p}_{4 , 1 , 3} ( {s}_{4 , 1.3 , 1} , 1 ) , {φ}_{g} * {p}_{4 , 1 , 3} ( {s}_{4 , 1 , 3 , 2} , 0 ) , {φ}_{g} ⋆ {p}_{4 , 1 , 3} ( {s}_{4 , 1 , 3 , 2} , 1 ) , {p}_{4 , 1 , 3} ( {s}_{4 , 1 , 3 , 1} , 2 ) , {p}_{4 , 1 , 3} ( {s}_{4 , 1 , 3 , 1} , 3 ) , {φ}_{g} ⋆ {{p}_{4 , 1 , 3} ( {s}_{4 , 1 , 3 , 2} , 2 ) , {φ}_{g} ⋆ {p}_{4 , 1 , 3} ( {s}_{4 , 1 , 3 , 2} , 3 ) ]}^{T} .$$

In some embodiments, the first antenna group with 4 antennas may comprise antennas with {AP0, AP1, AP2, AP3} and the second antenna group with 4 antennas may comprise antennas with {AP4, AP5, AP6, AP7}. In some embodiments, the at least one partial coherent 8 Tx precoders and/or the at least one second partial coherent 8 Tx precoders may comprise at least one of:

$$\frac{1}{8} [ {p}_{4 , 1 , 3} ( {s}_{4 , 1 , 3 , 1} , 0 ) , {p}_{4 , 1 , 3} ( {s}_{4 , 1 , 3 , 1} , 1 ) , {p}_{4 , 1 , 3} ( {s}_{4 , 1 , 3 , 1} , 2 ) ,$$

$${p}_{4 , 1 , 3} ( {s}_{4 , 1 , 3 , 1} , 3 ) , {φ}_{g} ⋆ {p}_{4 , 1 , 3} ( {s}_{4 , 1 , 3 , 2} , 0 ) , {φ}_{g} ⋆ {p}_{4 , 1 , 3} ( {s}_{4 , 1 , 3 , 2} , 1 ) ,$$

$${{φ}_{g} ⋆ {p}_{4 , 1 , 3} ( {s}_{4 , 1 , 3 , 2} , 2 ) , {φ}_{g} ⋆ {p}_{4 , 1 , 3} ( {s}_{4 , 1 , 3 , 2} , 3 ) ]}^{T} .$$

In some embodiments, the at least one non coherent 8 Tx precoders may comprise at least one of:

$$\frac{1}{\sqrt{2}} [ \begin{matrix}{v}_{4 , 1 , 3} ( {s}_{4 , 1 , 3 , 1} ) \\ 0\end{matrix} ] and \frac{1}{\sqrt{2}} [ \begin{matrix}0 \\ {v}_{4 , 1 , 3} ( {s}_{4 , 1 , 3 , 1} )\end{matrix} ] .$$

In some embodiments, v_{4,1,3}(s_{4,1,3,1}) may be one vector from the third set of vectors corresponding to 1 layer. In some embodiments, “0” in the

$$\frac{1}{\sqrt{2}} [ \begin{matrix}{v}_{4 , 1 , 3} ( {s}_{4 , 1 , 3 , 1} ) \\ 0\end{matrix} ] and \frac{1}{\sqrt{2}} [ \begin{matrix}0 \\ {v}_{4 , 1 , 3} ( {s}_{4 , 1 , 3 , 1} )\end{matrix} ]$$

may represent a vector with 4 elements. For example, a vector of [0, 0, 0, 0]^{T}. In some embodiments, for a first group of antennas or the first group of antennas is configured or indicated, the at least one non coherent 8 Tx precoders may comprise at least one of:

$$\frac{1}{\sqrt{2}} [ \begin{matrix}{v}_{4 , 1 , 3} ( {s}_{4 , 1 , 3 , 1} ) \\ 0\end{matrix} ] .$$

In some embodiments, for a second group of antennas or the second group of antennas is configured or indicated, the at least one non coherent 8 Tx precoders may comprise at least one of:

$$\frac{1}{\sqrt{2}} [ \begin{matrix}0 \\ {v}_{4 , 1 , 3} ( {s}_{4 , 1 , 3 , 1} )\end{matrix} ] .$$

In some embodiments, the first antenna group with 4 antennas may comprise antennas with {AP0, AP2, AP4, AP6} and the second antenna group with 4 antennas may comprise antennas with {AP1, AP3, AP5, AP7}. In some embodiments, the at least one non coherent 8 Tx precoders may comprise at least one of:

$$\frac{1}{\sqrt{8}} [ {p}_{4 , 1 , 3} ( {s}_{4 , 1 , 3 , 1} , 0 ) , 0 ,$$

$${{p}_{4 , 1 , 3} ( {s}_{4 , 1 , 3 , 1} , 1 ) , 0 , {p}_{4 , 1 , 3} ( {s}_{4 , 1 , 3 , 1} , 2 ) , 0 , {p}_{4 , 1 , 3} ( {s}_{4 , 1 , 3 , 1} , 3 ) , 0 ]}^{T}$$

$$and$$

$$\frac{1}{\sqrt{8}} [ 0 , {p}_{4 , 1 , 3} ( {s}_{4 , 1 , 3 , 1} , 0 ) , 0 , {p}_{4 , 1 , 3} ( {s}_{4 , 1 , 3 , 1} , 1 ) ,$$

$${0 , {p}_{4 , 1 , 3} ( {s}_{4 , 1 , 3 , 1} , 2 ) , 0 , {p}_{4 , 1 , 3} ( {s}_{4 , 1 , 3 , 1} , 3 ) ]}^{T} .$$

In some embodiments, for a first group of antennas or the first group of antennas is configured or indicated, the at least one non partial coherent 8 Tx precoders may comprise at least one of:

$$\frac{1}{\sqrt{8}} [ {p}_{4 , 1 , 3} ( {s}_{4 , 1 , 3 , 1} , 0 ) , 0 , {p}_{4 , 1 , 3} ( {s}_{4 , 1 , 3 , 1} , 1 ) ,$$

$${0 , {p}_{4 , 1 , 3} ( {s}_{4 , 1 , 3 , 1} , 2 ) , 0 , {p}_{4 , 1 , 3} ( {s}_{4 , 1 , 3 , 1} , 3 ) , 0 ]}^{T} .$$

In some embodiments, for a second group of antennas or the second group of antennas is configured or indicated, the at least one non coherent 8 Tx precoders may comprise at least one of:

$$\frac{1}{\sqrt{8}} [ 0 , {p}_{4 , 1 , 3} ( {s}_{4 , 1 , 3 , 1} , 0 ) , 0 , {p}_{4 , 1 , 3} ( {s}_{4 , 1 , 3 , 1} , 1 ) ,$$

$${0 , {p}_{4 , 1 , 3} ( {s}_{4 , 1 , 3 , 1} , 2 ) , 0 , {p}_{4 , 1 , 3} ( {s}_{4 , 1 , 3 , 1} , 3 ) ]}^{T} .$$

In some embodiments, the first antenna group with 4 antennas may comprise antennas with {AP0, AP1, AP4, AP5} and the second antenna group with 4 antennas may comprise antennas with {AP2, AP3, AP6, AP7}. In some embodiments, the at least one non coherent 8 Tx precoders may comprise at least one of:

$$\frac{1}{\sqrt{8}} [ {p}_{4 , 1 , 3} ( {s}_{4 , 1 , 3 , 1} , 0 ) , {p}_{4 , 1 , 3} ( {s}_{4 , 1 , 3 , 1} , 1 ) ,$$

$${0 , 0 , {p}_{4 , 1 , 3} ( {s}_{4 , 1 , 3 , 1} , 2 ) , {p}_{4 , 1 , 3} ( {s}_{4 , 1 , 3 , 1} , 3 ) , 0 , 0 ]}^{T}$$

$$and$$

$$\frac{1}{\sqrt{8}} [ 0 , 0 , {p}_{4 , 1 , 3} ( {s}_{4 , 1 , 3 , 1} , 0 ) , {{p}_{4 , 1 , 3} ( {s}_{4 , 1 , 3 , 1} , 1 ) , 0 , 0 , {p}_{4 , 1 , 3} ( {s}_{4 , 1 , 3 , 1} , 2 ) , {p}_{4 , 1 , 3} ( {s}_{4 , 1 , 3 , 1} , 3 ) ]}^{T} .$$

In some embodiments, for a first group of antennas or the first group of antennas is configured or indicated, the at least one non coherent 8 Tx precoders may comprise at least one of:

$$\frac{1}{\sqrt{8}} [ {P}_{4 , 1 , 3} ( {s}_{4 , 1 , 3 , 1} , 0 ) , {p}_{4 , 1 , 3} ( {s}_{4 , 1 , 3 , 1} , 1 ) ,$$

$${0 , 0 , {p}_{4 , 1 , 3} ( {s}_{4 , 1 , 3 , 1} , 2 ) , {p}_{4 , 1 , 3} ( {s}_{4 , 1 , 3 , 1} , 3 ) , 0 , 0 ]}^{T} .$$

In some embodiments, for a second group of antennas or the second group of antennas is configured or indicated, the at least one non coherent 8 Tx precoders may comprise at least one of:

$$\frac{1}{\sqrt{8}} [ 0 , 0 , {p}_{4 , 1 , 3} ( {s}_{4 , 1 , 3 , 1} , 0 ) , {{p}_{4 , 1 , 3} ( {s}_{4 , 1 , 3 , 1} , 1 ) , 0 , 0 , {p}_{4 , 1 , 3} ( {s}_{4 , 1 , 3 , 1} , 2 ) , {p}_{4 , 1 , 3} ( {s}_{4 , 1 , 3 , 1} , 3 ) ]}^{T} .$$

In some embodiments, the first antenna group with 4 antennas may comprise antennas with {AP0, AP1, AP2, AP3} and the second antenna group with 4 antennas may comprise antennas with {AP4, AP5, AP6, AP7}. In some embodiments, the at least one non coherent 8 Tx precoders may comprise at least one of:

$$\frac{1}{\sqrt{8}} [ {p}_{4 , 1 , 3} ( {s}_{4 , 1 , 3 , 1} , 0 ) , {p}_{4 , 1 , 3} ( {s}_{4 , 1 , 3 , 1} , 1 ) ,$$

$${{p}_{4 , 1 , 3} ( {s}_{4 , 1 , 3 , 1} , 2 ) , {p}_{4 , 1 , 3} ( {s}_{4 , 1 , 3 , 1} , 3 ) , 0 , 0 , 0 , 0 ]}^{T}$$

$$and$$

$$\frac{1}{\sqrt{8}} [ 0 , 0 , 0 , {0 , {p}_{4 , 1 , 3} ( {s}_{4 , 1 , 3 , 1} , 0 ) , {p}_{4 , 1 , 3} ( {s}_{4 , 1 , 3 , 1} , 1 ) , {p}_{4 , 1 , 3} ( {s}_{4 , 1 , 3 , 1} , 2 ) , {p}_{4 , 1 , 3} ( {s}_{4 , 1 , 3 , 1} , 3 ) ]}^{T} .$$

In some embodiments, for a first group of antennas or the first group of antennas is configured or indicated, the at least one non coherent 8 Tx precoders may comprise at least one of:

$$\frac{1}{\sqrt{8}} [ {p}_{4 , 1 , 3} ( {s}_{4 , 1 , 3 , 1} , 0 ) , {p}_{4 , 1 , 3} ( {s}_{4 , 1 , 3 , 1} , 1 ) ,$$

$${{p}_{4 , 1 , 3} ( {s}_{4 , 1 , 3 , 1} , 2 ) , {p}_{4 , 1 , 3} ( {s}_{4 , 1 , 3 , 1} , 3 ) , 0 , 0 , 0 , 0 ]}^{T} .$$

In some embodiments, for a second group of antennas or the second group of antennas is configured or indicated, the at least one non coherent 8 Tx precoders may comprise at least one of:

$$\frac{1}{\sqrt{8}} [ 0 , 0 , 0 , 0 , {p}_{4 , 1 , 3} ( {s}_{4 , 1 , 3 , 1} , 0 ) ,$$

$${{p}_{4 , 1 , 3} ( {s}_{4 , 1.3 , 1} , 1 ) , {p}_{4 , 1 , 3} ( {s}_{4 , 1 , 3 , 1} , 2 ) , {p}_{4 , 1 , 3} ( {s}_{4 , 1 , 3 , 1} , 3 ) ]}^{T .}$$

In some embodiments, s_{4,1,3,1} may be a non-negative integer, and 0≤s_{4,1,3,1}≤St_{1,3}−1. In some embodiments, s_{4,1,3,2} may be a non-negative integer, and 0≤s_{4,1,3,2}≤St_{1,3}−1.

In some embodiments, there may be a fourth set of vectors (For example, represented as v_{4,1,4}) corresponding to 1 layer, and the fourth set of vectors corresponding to 1 layer may be applied for 8 Tx full coherent precoders and/or 8 Tx second full coherent precoders and/or 8 Tx partial coherent precoders and/or 8 Tx first partial coherent precoders and/or 8 Tx second partial coherent precoders with 1 layer. For example, for first partial coherent precoders, the 8 Tx antennas may be comprised with two groups, and each group may comprise 4 antennas. For example, the 4 antennas in one group may be coherent. For another example, for second partial coherent precoders, the 8 Tx antennas may be comprised with four groups, and each group may comprise 2 antennas. For example, the 2 antennas in one group may be coherent. In some embodiments, the fourth set of vectors corresponding to 1 layer may be at least one of:

$${\frac{1}{\sqrt{2}} [ 1 , 1 ]}^{T} , {\frac{1}{\sqrt{2}} [ 1 , - 1 ]}^{T} , {\frac{1}{\sqrt{2}} [ 1 , j ]}^{T} and {\frac{1}{\sqrt{2}} [ 1 , - j ]}^{T} .$$

In some embodiments, the number of vectors in the fourth set of vectors corresponding to 1 layer may be St_{1,4}, and St_{1,4} may be a positive integer. For example, 1≤St_{1,4}≤4. For example, St_{1,4} may be 2 or 4. In some embodiments, one vector in the fourth set of vectors corresponding to 1 layer may be represented as

$${v}_{4 , 1 , 4} ( {s}_{4 , 1 , 4} ) = {\frac{1}{\sqrt{2}} [ {p}_{4 , 1 , 4} ( {s}_{4 , 1 , 4 ,} 0 ) , {p}_{4 , 1 , 4} ( {s}_{4 , 1 , 4.} 1 ) ]}^{T} .$$

In some embodiments, s_{4,1,4} may be a non-negative integer, and 0≤s_{4,1,4}≤St_{1,4}−1. In some embodiments, the value of p_{4,1,4}(s_{4,1,4}, 0) and/or the value of p_{4,1,4}(s_{4,1,4}, 1) may be at least one of {1, −1, j, −j} or at least one of {1, e^{j*2π/8}, e^{j*2*2π/8}, e^{j*3*2π/8}, e^{j*4*2π/8}, e^{j*5*2π/8}, e^{j*6*2π/8}, e^{j*7*2π/8}}.

In some embodiments, the at least one full coherent 8 Tx precoders and/or the at least one second full coherent 8 Tx precoders may comprise at least one of:

$$\frac{1}{2} [ \begin{matrix}{v}_{4 , 1 , 4} ( {s}_{4 , 1 , 4 , 1} ) \\ {φ}_{g 1} ⋆ {v}_{4 , 1 , 4} ( {s}_{4 , 1 , 4 , 2} ) \\ {φ}_{g 2} ⋆ {v}_{4 , 1 , 4} ( {s}_{4 , 1 , 4 , 3} ) \\ {φ}_{g 3} ⋆ {v}_{4 , 1 , 4} ( {s}_{4 , 1 , 4 , 4} )\end{matrix} ] .$$

In some embodiments, v_{4,1,4}(s_{4,1,4,1}) and/or v_{4,1,4}(s_{4,1,4,2}) and/or v_{4,1,4}(s_{4,1,4,3}) and/or v_{4,1,4}(s_{4,1,4,4}) may be one vector from the fourth set of vectors corresponding to 1 layer. In some embodiments, v_{4,1,4}(s_{4,1,4,1}) and/or v_{4,1,4}(s_{4,1,4,2}) and/or v_{4,1,4}(s_{4,1,4,3}) and/or v_{4,1,4}(s_{4,1,4,4}) may be same or different from each other.

In some embodiments, φ_{g1} may be e^{j*2π*g1/G}, and where G may be at least one of {4, 8, 12, 16}, and g1 may be an integer from 0 to G−1. In some embodiments, φ_{g2} may be e^{j*2π*g2/G}, and where G may be at least one of {4, 8, 12, 16}, and g2 may be an integer from 0 to G−1. In some embodiments, φ_{g3} may be e^{j*2π*g3/G}, and where G may be at least one of {4, 8, 12, 16}, and g3 may be an integer from 0 to G−1.

In some embodiments, the first antenna group with 2 antennas may comprise antennas with {AP0, AP4} and the second antenna group with 2 antennas may comprise antennas with {AP1, AP5} and the third antenna group with 2 antennas may comprise antennas with {AP2, AP6} and the fourth antenna group with 2 antennas may comprise antennas with {AP3, AP7}. In some embodiments, the at least one full coherent 8 Tx precoders and/or the at least one second full coherent 8 Tx precoders may comprise at least one of:

$$\frac{1}{\sqrt{8}} [ {p}_{4 , 1 , 4} ( {s}_{4 , 1 , 4 , 1} , 0 ) , {φ}_{g 1} ⋆ {p}_{4 , 1 , 4} ( {s}_{4 , 1 , 4 , 2} , 0 ) , {φ}_{g 2} ⋆ {p}_{4 , 1 , 4} ( {s}_{4 , 1 , 4 , 3} , 0 ) , {φ}_{g 3} ⋆$$

$${p}_{4 , 1 , 4} ( {s}_{4 , 1 , 4 , 4} , 0 ) , {p}_{4 , 1 , 4} ( {s}_{4 , 1 , 4 , 3} , 1 ) , {φ}_{g 1} ⋆ {p}_{4 , 1 , 4} ( {s}_{4 , 1 , 4 , 2} , 1 ) ,$$

$${{φ}_{g 2} ⋆ {p}_{4 , 1 , 4} ( {s}_{4 , 1 , 4 , 2} , 1 ) , {φ}_{g 3} ⋆ {p}_{4 , 1 , 4} ( {s}_{4 , 1 , 4 , 4} , 1 ) ]}^{T} .$$

In some embodiments, the first antenna group with 2 antennas may comprise antennas with {AP0, AP1} and the second antenna group with 2 antennas may comprise antennas with {AP2, AP3} and the third antenna group with 2 antennas may comprise antennas with {AP4, AP5} and the fourth antenna group with 2 antennas may comprise antennas with {AP6, AP7}. In some embodiments, the at least one full coherent 8 Tx precoders and/or the at least one second full coherent 8 Tx precoders may comprise at least one of:

$$\frac{1}{\sqrt{8}} [ {p}_{4 , 1 , 4} ( {s}_{4 , 1 , 4 , 1} , 0 ) , {p}_{4 , 1 , 4} ( {s}_{4 , 1 , 4 , 1} , 1 ) ,$$

$${φ}_{g 1} ⋆ {p}_{4 , 1 , 4} ( {s}_{4 , 1 , 4 , 1} , 0 ) , {φ}_{g 1} ⋆ {p}_{4 , 1 , 4} ( {s}_{4 , 1 , 4 , 2} , 1 ) , {φ}_{g 2} ⋆ {p}_{4 , 1 , 4} ( {s}_{4 , 1 , 4 , 3} , 0 ) ,$$

$${{φ}_{g 2} ⋆ {p}_{4 , 1 , 4} ( {s}_{4 , 1 , 4 , 3} , 1 ) , {φ}_{g 3} ⋆ {p}_{4 , 1 , 4} ( {s}_{4 , 1 , 4 , 4} , 0 ) , {φ}_{g 3} ⋆ {p}_{4 , 1 , 4} ( {s}_{4 , 1 , 4 , 4} , 1 ) ]}^{T} .$$

In some embodiments, the first antenna group with 2 antennas may comprise antennas with {AP0, AP2} and the second antenna group with 2 antennas may comprise antennas with {AP4, AP6} and the third antenna group with 2 antennas may comprise antennas with {AP1, AP5} and the fourth antenna group with 2 antennas may comprise antennas with {AP3, AP7}. In some embodiments, the at least one full coherent 8 Tx precoders and/or the at least one second full coherent 8 Tx precoders may comprise at least one of:

$$\frac{1}{\sqrt{8}} [ {p}_{4 , 1 , 4} ( {s}_{4 , 1 , 4 , 1} , 0 ) , {φ}_{g 2} ⋆ {p}_{4 , 1 , 4} ( {s}_{4 , 1 , 4 , 3} , 0 ) , {p}_{4 , 1 , 4} ( {s}_{4 , 1 , 4 , 1} , 1 ) , {φ}_{g 3} ⋆ {p}_{4 , 1 , 4} ( {s}_{4 , 1 , 4 , 4} , 0 ) , {φ}_{g 1} ⋆ {p}_{4 , 1 , 4} ( {s}_{4 , 1 , 4 , 2} , 0 ) , {φ}_{g 2} ⋆ {p}_{4 , 1 , 4} ( {s}_{4 , 1 , 4 , 3} , 1 ) , {φ}_{g 1} ⋆ {{p}_{4 , 1 , 4} ( {s}_{4 , 1 , 4 , 2} , 1 ) , {φ}_{g 3} ⋆ {p}_{4 , 1 , 4} ( {s}_{4 , 1 , 4 , 4} , 1 ) ]}^{T} .$$

In some embodiments, the at least one partial coherent 8 Tx precoders and/or the at least one second partial coherent 8 Tx precoders may comprise at least one of:

$$\frac{1}{2} [ \begin{matrix}{v}_{4 , 1 , 4} ( {s}_{4 , 1 , 4 , 1} ) \\ 0\end{matrix} ] and \frac{1}{2} [ \begin{matrix}0 \\ {v}_{4 , 1 , 4} ( {s}_{4 , 1 , 4 , 1} )\end{matrix} ] .$$

In some embodiments, v_{4,1,4}(s_{4,1,4,1}) may be one vector from the fourth set of vectors corresponding to 1 layer. In some embodiments, “0” in the

$$\frac{1}{2} [ \begin{matrix}{v}_{4 , 1 , 4} ( {s}_{4 , 1 , 4 , 1} ) \\ 0\end{matrix} ] and \frac{1}{2} [ \begin{matrix}0 \\ {v}_{4 , 1 , 4} ( {s}_{4 , 1 , 4 , 1} )\end{matrix} ]$$

may represent a vector with 6 elements. For example, a vector of [0, 0, 0, 0, 0, 0]^{T}. In some embodiments, for a first group of antennas with 2 antennas or the first group of antennas with 2 antennas is configured or indicated, the at least one partial coherent 8 Tx precoders and/or the at least one second partial coherent 8 Tx precoders may comprise at least one of:

$$\frac{1}{2} [ \begin{matrix}{v}_{4 , 1 , 4} ( {s}_{4 , 1 , 4 , 1} ) \\ 0\end{matrix} ] .$$

In some embodiments, for a fourth group of antennas with 2 antennas or the fourth group of antennas with 2 antennas is configured or indicated, the at least one partial coherent 8 Tx precoders and/or the at least one second partial coherent 8 Tx precoders may comprise at least one of:

$$\frac{1}{2} [ \begin{matrix}0 \\ {v}_{4 , 1 , 4} ( {s}_{4 , 1 , 4 , 1} )\end{matrix} ] .$$

In some embodiments, the first antenna group with 2 antennas may comprise antennas with {AP0, AP4} and the second antenna group with 2 antennas may comprise antennas with {AP1, AP5} and the third antenna group with 2 antennas may comprise antennas with {AP2, AP6} and the fourth antenna group with 2 antennas may comprise antennas with {AP3, AP7}. In some embodiments, the at least one partial coherent 8 Tx precoders and/or the at least one second partial coherent 8 Tx precoders may comprise at least one of:

$${\frac{1}{\sqrt{8}} [ {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 , 0 , 0 ]}^{T} ,$$

$${\frac{1}{\sqrt{8}} [ 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 , 0 ]}^{T} ,$$

$${\frac{1}{\sqrt{8}} [ 0 , 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 , ]}^{T} and$$

$${\frac{1}{\sqrt{8}} [ 0 , 0 , 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) ]}^{T} .$$

In some embodiments, for a first group of antennas with 2 antennas or the first group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 , 0 , 0 ]}^{T} .$$

In some embodiments, for a second group of antennas with 2 antennas or the second group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 , 0 ]}^{T} .$$

In some embodiments, for a third group of antennas with 2 antennas or the third group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 ]}^{T} .$$

In some embodiments, for a fourth group of antennas with 2 antennas or the third group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , 0 , 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) ]}^{T} .$$

In some embodiments, the first antenna group with 2 antennas may comprise antennas with {AP0, AP1} and the second antenna group with 2 antennas may comprise antennas with {AP2, AP3} and the third antenna group with 2 antennas may comprise antennas with {AP4, AP5} and the fourth antenna group with 2 antennas may comprise antennas with {AP6, AP7}. In some embodiments, the at least one partial coherent 8 Tx precoders and/or the at least one second partial coherent 8 Tx precoders may comprise at least one of:

$${\frac{1}{\sqrt{8}} [ {p}_{4 , 1 , 4} ( {s}_{4 , 1 , 4 , 1} , 0 ) , {p}_{4 , 1 , 4} ( {s}_{4 , 1 , 4 , 1} , 1 ) , 0 , 0 , 0 , 0 , 0 , 0 ]}^{T} ,$$

$${\frac{1}{\sqrt{8}} [ 0 , 0 , {p}_{4 , 1 , 4} ( {s}_{4 , 1 , 4 , 1} , 0 ) , {p}_{4 , 1 , 4} ( {s}_{4 , 1 , 4 , 1} , 1 ) , 0 , 0 , 0 , 0 ]}^{T} ,$$

$${\frac{1}{\sqrt{8}} [ 0 , 0 , 0 , 0 , {p}_{4 , 1 , 4} ( {s}_{4 , 1 , 4 , 1} , 0 ) , {p}_{4 , 1 , 4} ( {s}_{4 , 1 , 4 , 1} , 1 ) , 0 , 0 ]}^{T} and$$

$${\frac{1}{\sqrt{8}} [ 0 , 0 , 0 , 0 , 0 , 0 , {p}_{4 , 1 , 4} ( {s}_{4 , 1 , 4 , 1} , 0 ) , {p}_{4 , 1 , 4} ( {s}_{4 , 1 , 4 , 1} , 1 ) ]}^{T} .$$

In some embodiments, for a first group of antennas with 2 antennas or the first group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ {p}_{4 , 1 , 4} ( {s}_{4 , 1 , 4 , 1} , 0 ) , {p}_{4 , 1 , 4} ( {s}_{4 , 1 , 4 , 1} , 1 ) , 0 , 0 , 0 , 0 , 0 , 0 ]}^{T} .$$

In some embodiments, for a second group of antennas with 2 antennas or the second group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , 0 , {p}_{4 , 1 , 4} ( {s}_{4 , 1 , 4 , 1} , 0 ) , {p}_{4 , 1 , 4} ( {s}_{4 , 1 , 4 , 1} , 1 ) , 0 , 0 , 0 , 0 ]}^{T} .$$

In some embodiments, for a third group of antennas with 2 antennas or the third group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , 0 , 0 , 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 , 0 ]}^{T} .$$

In some embodiments, for a fourth group of antennas with 2 antennas or the third group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , 0 , 0 , 0 , 0 , 0 , {p}_{4 , 1 , 4} ( {s}_{4 , 1 , 4 , 1} , 0 ) , {p}_{4 , 1 , 4} ( {s}_{4 , 1 , 4 , 1} , 1 ) ]}^{T} .$$

In some embodiments, the first antenna group with 2 antennas may comprise antennas with {AP0, AP2} and the second antenna group with 2 antennas may comprise antennas with {AP4, AP6} and the third antenna group with 2 antennas may comprise antennas with {AP1, AP5} and the fourth antenna group with 2 antennas may comprise antennas with {AP3, AP7}. In some embodiments, the at least one partial coherent 8 Tx precoders and/or the at least one second partial coherent 8 Tx precoders may comprise at least one of:

$${\frac{1}{\sqrt{8}} [ {p}_{4 , 1 , 4} ( {s}_{4 , 1 , 4 , 1} , 0 ) , 0 , {p}_{4 , 1 , 4} ( {s}_{4 , 1 , 4 , 1} , 1 ) , 0 , 0 , 0 , 0 , 0 ]}^{T} ,$$

$${\frac{1}{\sqrt{8}} [ 0 , 0 , 0 , 0 , {p}_{4 , 1 , 4} ( {s}_{4 , 1 , 4 , 1} , 0 ) , 0 , {p}_{4 , 1 , 4} ( {s}_{4 , 1 , 4 , 1} , 1 ) , 0 ]}^{T} ,$$

$${\frac{1}{\sqrt{8}} [ 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 , 0 , 0 ]}^{T} and$$

$${\frac{1}{\sqrt{8}} [ 0 , 0 , 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) ]}^{T} .$$

In some embodiments, for a first group of antennas with 2 antennas or the first group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ {p}_{4 , 1 , 4} ( {s}_{4 , 1 , 4 , 1} , 0 ) , 0 , {p}_{4 , 1 , 4} ( {s}_{4 , 1 , 4 , 1} , 1 ) , 0 , 0 , 0 , 0 , 0 ]}^{T} .$$

In some embodiments, for a second group of antennas with 2 antennas or the second group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , 0 , 0 , 0 , {p}_{4 , 1 , 4} ( {s}_{4 , 1 , 4 , 1} , 0 ) , 0 , {p}_{4 , 1 , 4} ( {s}_{4 , 1 , 4 , 1} , 1 ) , 0 ]}^{T} .$$

In some embodiments, for a third group of antennas with 2 antennas or the third group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) , 0 , 0 ]}^{T} .$$

In some embodiments, for a fourth group of antennas with 2 antennas or the third group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , 0 , 0 , {p}_{4 , 1 , 4} ( {s}_{4 , 1 , 4 , 1} , 0 ) , 0 , 0 , 0 , {p}_{4 , 1 , 4} ( {s}_{4 , 1 , 4 , 1} , 1 ) ]}^{T} .$$

In some embodiments, s_{4,1,4,1} may be a non-negative integer, and 0≤s_{4,1,4,1}≤St_{1,4}−1. In some embodiments, s_{4,1,4,2} may be a non-negative integer, and 0≤s_{4,1,4,2}≤St_{1,4}−1. In some embodiments, s_{4,1,4,3} may be a non-negative integer, and 0≤s_{4,1,4,3}≤St_{1,4}−1. In some embodiments, s_{4,1,4,4} may be a non-negative integer, and 0≤s_{4,1,4,4}≤St_{1,4}−1.

In some embodiments, there may be a fifth set of vectors (For example, represented as v_{4,1,5}) corresponding to 1 layer, and the fifth set of vectors corresponding to 1 layer may be applied for 8 Tx partial coherent precoders and/or 8 Tx first partial coherent precoders and/or 8 Tx second partial coherent precoders and/or 8 Tx non coherent precoders with 1 layer. For example, for first partial coherent precoders, the 8 Tx antennas may be comprised with two groups, and each group may comprise 4 antennas. For example, the 4 antennas in one group may be coherent. For another example, for second partial coherent precoders, the 8 Tx antennas may be comprised with four groups, and each group may comprise 2 antennas. For example, the 2 antennas in one group may be coherent. In some embodiments, the fifth set of vectors corresponding to 1 layer may be at least one of:

$${\frac{1}{2} [ 1 , 0 ]}^{T} , {\frac{1}{2} [ 0 , 1 ]}^{T} .$$

In some embodiments, the number of vectors in the fifth set of vectors corresponding to 1 layer may be St_{1,5}, and St_{1,5} may be a positive integer. For example, 1≤St_{1,5}≤2. For example, St_{1,5} may be 2. In some embodiments, one vector in the fifth set of vectors corresponding to 1 layer may be represented as

$${v}_{4 , 1 , 5} ( {s}_{4 , 1 , 5} ) = {\frac{1}{\sqrt{2}} [ {p}_{4 , 1 , 5} ( {s}_{4 , 1 , 5} , 0 ) , {p}_{4 , 1 , 5} ( {s}_{4 , 1 , 5} , 1 ) ]}^{T} .$$

In some embodiments, s_{4,1,5} may be a non-negative integer, and 0≤s_{4,1,5}≤St_{1,5}−1. In some embodiments, the value of p_{4,1,5} (s_{4,1,5}, 0) and/or the value of p_{4,1,5} (s_{4,1,5}, 1) may be either 0 or 1.

In some embodiments, the at least one partial coherent 8 Tx precoders and/or the at least one first partial coherent 8 Tx precoders may comprise at least one of:

$$\frac{1}{2} [ \begin{matrix}{v}_{4 , 1 , 5} ( {s}_{4 , 1 , 5 , 1} ) \\ {φ}_{g 1} * {v}_{4 , 1 , 5} ( {s}_{4 , 1 , 5 , 2} ) \\ {φ}_{g 2} * {v}_{4 , 1 , 5} ( {s}_{4 , 1 , 5 , 3} ) \\ {φ}_{g 3} * {v}_{4 , 1 , 5} ( {s}_{4 , 1 , 5 , 4} )\end{matrix} ] .$$

In some embodiments, v_{4,1,5}(s_{4,1,5,1}) and/or v_{4,1,5}(s_{4,1,5,2}) and/or v_{4,1,5}(s_{4,1,5,3}) and/or v_{4,1,5}(s_{4,1,5,4}) may be one vector from the fifth set of vectors corresponding to 1 layer. In some embodiments, v_{4,1,5}(s_{4,1,5,1}) and/or v_{4,1,5}(s_{4,1,5,2}) and/or v_{4,1,5}(s_{4,1,5,3}) and/or v_{4,1,5}(s_{4,1,5,4}) may be same or different from each other.

In some embodiments, φ_{g1} may be e^{j*2π*g1/G}, and where G may be at least one of {4, 8, 12, 16}, and g1 may be an integer from 0 to G−1. In some embodiments, φ_{g2} may be e^{j*2π*g2/G}, and where G may be at least one of {4, 8, 12, 16}, and g2 may be an integer from 0 to G−1. In some embodiments, PO₃ may be e^{j*2π*g3/G}, and where G may be at least one of {4, 8, 12, 16}, and g3 may be an integer from 0 to G−1.

In some embodiments, the first antenna group with 2 antennas may comprise antennas with {AP0, AP4} and the second antenna group with 2 antennas may comprise antennas with {AP1, AP5} and the third antenna group with 2 antennas may comprise antennas with {AP2, AP6} and the fourth antenna group with 2 antennas may comprise antennas with {AP3, AP7}. In some embodiments, the at least one partial coherent 8 Tx precoders and/or the at least one first partial coherent 8 Tx precoders may comprise at least one of:

$$\frac{1}{\sqrt{8}} [ {p}_{4 , 1 , 5} ( {s}_{4 , 1 , 5 , 1} , 0 ) , {φ}_{g 1} * {p}_{4 , 1 , 5} ( {s}_{4 , 1 , 5 , 2} , 0 ) , {φ}_{g 2} *$$

$${p}_{4 , 1 , 5} ( {s}_{4 , 1 , 5 , 3} , 0 ) , {φ}_{g 3} * {p}_{4 , 1 , 5} ( {s}_{4 , 1 , 5 , 4} , 0 ) , {p}_{4 , 1 , 5} ( {s}_{4 , 1 , 5 , 1} , 1 ) , {φ}_{g 1} *$$

$${{p}_{4 , 1 , 5} ( {s}_{4 , 1 , 5 , 2} , 1 ) , {φ}_{g 2} * {p}_{4 , 1 , 5} ( {s}_{4 , 1 , 5 , 3} , 1 ) , {φ}_{q 3} * {p}_{4 , 1 , 5} ( {s}_{4 , 1 , 5 , 4} , 1 ) ]}^{T} .$$

In some embodiments, the first antenna group with 2 antennas may comprise antennas with {AP0, AP1} and the second antenna group with 2 antennas may comprise antennas with {AP2, AP3} and the third antenna group with 2 antennas may comprise antennas with {AP4, AP5} and the fourth antenna group with 2 antennas may comprise antennas with {AP6, AP7}. In some embodiments, the at least one partial coherent 8 Tx precoders and/or the at least one first partial coherent 8 Tx precoders may comprise at least one of:

$$\frac{1}{\sqrt{8}} [ {p}_{4 , 1 , 5} ( {s}_{4 , 1 , 5 , 1} , 0 ) , {p}_{4 , 1 , 5} ( {s}_{4 , 1 , 5 , 1} , 1 ) , {φ}_{g 1} * {p}_{4 , 1 , 5} ( {s}_{4 , 1 , 5 , 2} , 0 ) , {φ}_{g 1} *$$

$${p}_{4 , 1 , 5} ( {s}_{4 , 1 , 5 , 2} , 1 ) , {φ}_{g 2} * {p}_{4 , 1 , 5} ( {s}_{4 , 1 , 5 , 3} , 0 ) , {φ}_{g 2} * {p}_{4 , 1 , 5} ( {s}_{4 , 1 , 5 , 3} , 1 ) , {φ}_{g 3} *$$

$${{p}_{4 , 1 , 5} ( {s}_{4 , 1 , 5 , 4} , 0 ) , {φ}_{g 3} * {p}_{4 , 1 , 5} ( {s}_{4 , 1 , 5 , 4} , 1 ) ]}^{T} .$$

In some embodiments, the first antenna group with 2 antennas may comprise antennas with {AP0, AP2} and the second antenna group with 2 antennas may comprise antennas with {AP4, AP6} and the third antenna group with 2 antennas may comprise antennas with {AP1, AP5} and the fourth antenna group with 2 antennas may comprise antennas with {AP3, AP7}. In some embodiments, the at least one partial coherent 8 Tx precoders and/or the at least one first partial coherent 8 Tx precoders may comprise at least one of:

$$\frac{1}{\sqrt{8}} [ {p}_{4 , 1 , 5} ( {s}_{4 , 1 , 5 , 1} , 0 ) , {φ}_{g 2} * {p}_{4 , 1 , 5} ( {s}_{4 , 1 , 5 , 3} , 0 ) , {p}_{4 , 1 , 5} ( {s}_{4 , 1 , 5 , 1} , 1 ) , {φ}_{g 3} *$$

$${p}_{4 , 1 , 5} ( {s}_{4 , 1 , 5 , 4} , 0 ) , {φ}_{g 1} * {p}_{4 , 1 , 5} ( {s}_{4 , 1 , 5 , 2} , 0 ) , {φ}_{g 2} * {p}_{4 , 1 , 5} ( {s}_{4 , 1 , 5 , 3} , 1 ) , {φ}_{g 1} *$$

$${{p}_{4 , 1 , 5} ( {s}_{4 , 1 , 5 , 2} , 1 ) , {φ}_{g 3} * {p}_{4 , 1 , 5} ( {s}_{4 , 1 , 5 , 4} , 1 ) ]}^{T} .$$

In some embodiments, the at least one non coherent 8 Tx precoders may comprise at least one of:

$$\frac{1}{2} [ \begin{matrix}{v}_{4 , 1 , 5} ( {s}_{4 , 1 , 5 , 1} ) \\ 0\end{matrix} ] and \frac{1}{2} [ \begin{matrix}0 \\ {v}_{4 , 1 , 5} ( {s}_{4 , 1 , 5 , 1} )\end{matrix} ] .$$

In some embodiments, v_{4,1,5}(s_{4,1,5,1}) may be one vector from the fourth set of vectors corresponding to 1 layer. In some embodiments, “0” in the

$$\frac{1}{2} [ \begin{matrix}{v}_{4 , 1 , 5} ( {s}_{4 , 1 , 5 , 1} ) \\ 0\end{matrix} ] and \frac{1}{2} [ \begin{matrix}0 \\ {v}_{4 , 1 , 5} ( {s}_{4 , 1 , 5 , 1} )\end{matrix} ]$$

may represent a vector with 6 elements. For example, a vector of [0, 0, 0, 0, 0, 0]^{T}. In some embodiments, for a first group of antennas with 2 antennas or the first group of antennas with 2 antennas is configured or indicated, the at least one non coherent 8 Tx precoders may comprise at least one of:

$$\frac{1}{2} [ \begin{matrix}{v}_{4 , 1 , 5} ( {s}_{4 , 1 , 5 , 1} ) \\ 0\end{matrix} ] .$$

In some embodiments, for a fourth group of antennas with 2 antennas or the fourth group of antennas with 2 antennas is configured or indicated, the at least one non coherent 8 Tx precoders may comprise at least one of:

$$\frac{1}{2} [ \begin{matrix}0 \\ {v}_{4 , 1 , 5} ( {s}_{4 , 1 , 5 , 1} )\end{matrix} ] .$$

In some embodiments, the first antenna group with 2 antennas may comprise antennas with {AP0, AP4} and the second antenna group with 2 antennas may comprise antennas with {AP1, AP5} and the third antenna group with 2 antennas may comprise antennas with {AP2, AP6} and the fourth antenna group with 2 antennas may comprise antennas with {AP3, AP7}. In some embodiments, the at least one non coherent 8 Tx precoders may comprise at least one of:

$${\frac{1}{\sqrt{8}} [ {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) , 0 , 0 , 0 ]}^{T} ,$$

$${\frac{1}{\sqrt{8}} [ 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) , 0 , 0 ]}^{T} ,$$

$${\frac{1}{\sqrt{8}} [ 0 , 0 , {p}_{4 , 1 , 5} ( {s}_{4 , 1 , 5 , 1} , 0 ) , 0 , 0 , {p}_{4 , 1 , 5} ( {s}_{4 , 1 , 5 , 1} , 1 ) , 0 ]}^{T} and$$

$${\frac{1}{\sqrt{8}} [ 0 , 0 , 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) ]}^{T} .$$

In some embodiments, for a first group of antennas with 2 antennas or the first group of antennas with 2 antennas is configured or indicated, the at least one non coherent 8 Tx precoders may comprise at least one of:

$${\frac{1}{\sqrt{8}} [ {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) , 0 , 0 , 0 ]}^{T} .$$

In some embodiments, for a second group of antennas with 2 antennas or the second group of antennas with 2 antennas is configured or indicated, the at least one non coherent 8 Tx precoders may comprise at least one of:

$${\frac{1}{\sqrt{8}} [ 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) , 0 , 0 ]}^{T} .$$

In some embodiments, for a third group of antennas with 2 antennas or the third group of antennas with 2 antennas is configured or indicated, the at least one non coherent 8 Tx precoders may comprise at least one of:

$${\frac{1}{\sqrt{8}} [ 0 , 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) , 0 ]}^{T} .$$

In some embodiments, for a fourth group of antennas with 2 antennas or the third group of antennas with 2 antennas is configured or indicated, the at least one non coherent 8 Tx precoders may comprise at least one of:

$${\frac{1}{\sqrt{8}} [ 0 , 0 , 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) ]}^{T} .$$

In some embodiments, the first antenna group with 2 antennas may comprise antennas with {AP0, AP1} and the second antenna group with 2 antennas may comprise antennas with {AP2, AP3} and the third antenna group with 2 antennas may comprise antennas with {AP4, AP5} and the fourth antenna group with 2 antennas may comprise antennas with {AP6, AP7}. In some embodiments, the at least one non coherent 8 Tx precoders may comprise at least one of:

$${\frac{1}{\sqrt{8}} [ {p}_{4 , 1 , 5} ( {s}_{4 , 1 , 5 , 1} , 0 ) , {p}_{4 , 1 , 5} ( {s}_{4 , 1 , 5 , 1} , 1 ) , 0 , 0 , 0 , 0 , 0 , 0 ]}^{T} ,$$

$${\frac{1}{\sqrt{8}} [ 0 , 0 , {p}_{4 , 1 , 5} ( {s}_{4 , 1 , 5 , 1} , 0 ) , {p}_{4 , 1 , 5} ( {s}_{4 , 1 , 5 , 1} , 1 ) , 0 , 0 , 0 , 0 ]}^{T} ,$$

$${\frac{1}{\sqrt{8}} [ 0 , 0 , 0 , 0 , {p}_{4 , 1 , 5} ( {s}_{4 , 1 , 5 , 1} , 0 ) , {p}_{4 , 1 , 5} ( {s}_{4 , 1 , 5 , 1} , 1 ) , 0 , 0 ]}^{T} and$$

$${\frac{1}{\sqrt{8}} [ 0 , 0 , 0 , 0 , 0 , 0 , {p}_{4 , 1 , 5} ( {s}_{4 , 1 , 5 , 1} , 0 ) , {p}_{4 , 1 , 5} ( {s}_{4 , 1 , 5 , 1} , 1 ) ]}^{T} .$$

In some embodiments, for a first group of antennas with 2 antennas or the first group of antennas with 2 antennas is configured or indicated, the at least one non coherent 8 Tx precoders may comprise at least one of:

$${\frac{1}{\sqrt{8}} [ {p}_{4 , 1 , 5} ( {s}_{4 , 1 , 5 , 1} , 0 ) , {p}_{4 , 1 , 5} ( {s}_{4 , 1 , 5 , 1} , 1 ) , 0 , 0 , 0 , 0 , 0 , 0 ]}^{T} .$$

In some embodiments, for a second group of antennas with 2 antennas or the second group of antennas with 2 antennas is configured or indicated, the at least one non coherent 8 Tx precoders may comprise at least one of:

$${\frac{1}{\sqrt{8}} [ 0 , 0 , {p}_{4 , 1 , 5} ( {s}_{4 , 1 , 5 , 1} , 0 ) , {p}_{4 , 1 , 5} ( {s}_{4 , 1 , 5 , 1} , 1 ) , 0 , 0 , 0 , 0 ]}^{T} .$$

In some embodiments, for a third group of antennas with 2 antennas or the third group of antennas with 2 antennas is configured or indicated, the at least one non coherent 8 Tx precoders may comprise at least one of:

$${\frac{1}{\sqrt{8}} [ 0 , 0 , 0 , 0 , {p}_{4 , 1 , 5} ( {s}_{4 , 1 , 5 , 1} , 0 ) , {p}_{4 , 1 , 5} ( {s}_{4 , 1 , 5 , 1} , 1 ) , 0 , 0 ]}^{T} .$$

In some embodiments, for a fourth group of antennas with 2 antennas or the fourth group of antennas with 2 antennas is configured or indicated, the at least one non coherent 8 Tx precoders may comprise at least one of:

$${\frac{1}{\sqrt{8}} [ 0 , 0 , 0 , 0 , 0 , 0 , {p}_{4 , 1 , 5} ( {s}_{4 , 1 , 5 , 1} , 0 ) , {p}_{4 , 1 , 5} ( {s}_{4 , 1 , 5 , 1} , 1 ) ]}^{T} .$$

In some embodiments, the first antenna group with 2 antennas may comprise antennas with {AP0, AP2} and the second antenna group with 2 antennas may comprise antennas with {AP4, AP6} and the third antenna group with 2 antennas may comprise antennas with {AP1, AP5} and the fourth antenna group with 2 antennas may comprise antennas with {AP3, AP7}. In some embodiments, the at least one non coherent 8 Tx precoders may comprise at least one of:

$$\frac{1}{\sqrt{8}} [ {p}_{4 , 1 , 5} ( {s}_{4 , 1 , 5 , 1} , 0 ) , 0 , {p}_{4 , 1 , 5} ( {s}_{4 , 1 , 5 , 1} , 1 ) , 0 , 0 , 0 , {0 , 0 ]}^{T} ,$$

$${\frac{1}{\sqrt{8}} [ 0 , 0 , 0 , 0 , {p}_{4 , 1 , 5} ( {s}_{4 , 1 , 5 , 1} , 0 ) , 0 , {p}_{4 , 1 , 5} ( {s}_{4 , 1 , 5 , 1} , 1 ) , 0 ]}^{T} ,$$

$${\frac{1}{\sqrt{8}} [ 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) ]}^{T} and$$

$${\frac{1}{\sqrt{8}} [ 0 , 0 , 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) ]}^{T} .$$

In some embodiments, for a first group of antennas with 2 antennas or the first group of antennas with 2 antennas is configured or indicated, the at least one non coherent 8 Tx precoders may comprise at least one of:

$${\frac{1}{\sqrt{8}} [ {p}_{4 , 1 , 5} ( {s}_{4 , 1 , 5 , 1} , 0 ) , 0 , {p}_{4 , 1 , 5} ( {s}_{4 , 1 , 5 , 1} , 1 ) , 0 , 0 , 0 , 0 , 0 ]}^{T} .$$

In some embodiments, for a second group of antennas with 2 antennas or the second group of antennas with 2 antennas is configured or indicated, the at least one non coherent 8 Tx precoders may comprise at least one of:

$${\frac{1}{\sqrt{8}} [ 0 , 0 , 0 , 0 , {p}_{4 , 1 , 5} ( {s}_{4 , 1 , 5 , 1} , 0 ) , 0 , {p}_{4 , 1 , 5} ( {s}_{4 , 1 , 5 , 1} , 1 ) , 0 ]}^{T} .$$

In some embodiments, for a third group of antennas with 2 antennas or the third group of antennas with 2 antennas is configured or indicated, the at least one partial coherent 8 Tx precoders and/or the at least one second partial coherent 8 Tx precoders may comprise at least one of:

$${\frac{1}{\sqrt{8}} [ 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) , 0 , 0 ]}^{T} .$$

In some embodiments, for a fourth group of antennas with 2 antennas or the fourth group of antennas with 2 antennas is configured or indicated, the at least one non coherent 8 Tx precoders may comprise at least one of:

$${\frac{1}{\sqrt{8}} [ 0 , 0 , 0 , {p}_{4 , 1 , 5} ( {s}_{4 , 1 , 5 , 1} , 0 ) , 0 , 0 , 0 , {p}_{4 , 1 , 5} ( {s}_{4 , 1 , 5 , 1} , 1 ) ]}^{T} .$$

In some embodiments, s_{4,1,5,1} may be a non-negative integer, and 0≤s_{4,1,5,1}≤St_{1,5}−1. In some embodiments, s_{4,1,5,2} may be a non-negative integer, and 0≤s_{4,1,5,2}≤St_{1,5}−1. In some embodiments, s_{4,1,5,3} may be a non-negative integer, and 0≤s_{4,1,5,3}≤St_{1,5}−1. In some embodiments, s_{4,1,5,4} may be a non-negative integer, and 0≤s_{4,1,5,4}≤St_{1,5}−1.

In some embodiments, there may be a first set of vectors corresponding to 2 columns or rows, and the first set of vectors corresponding to 2 columns or rows may be applied for 8 Tx full coherent precoders with 2 layers or 5 layers and/or 8 Tx partial coherent precoders with 2 layers or 5 layers and/or 8 Tx first partial coherent precoders with 2 layers or 5 layers. In some embodiments, the first set of vectors corresponding to 2 columns or rows may be at least one of:

$${\frac{1}{2 \sqrt{2}} [ \begin{matrix}1 , 1 , 1 , 1 \\ 1 , 1 , - 1 , - 1\end{matrix} ]}^{T} , {\frac{1}{2 \sqrt{2}} [ \begin{matrix}1 , 1 , j , j \\ 1 , 1 , - j , - j\end{matrix} ]}^{T} ,$$

$${\frac{1}{2 \sqrt{2}} [ \begin{matrix}1 , j , 1 , j \\ 1 , j , - 1 , - j\end{matrix} ]}^{T} , {\frac{1}{2 \sqrt{2}} [ \begin{matrix}1 , 1 , j , - 1 \\ 1 , j , - j , 1\end{matrix} ]}^{T} ,$$

$${\frac{1}{2 \sqrt{2}} [ \begin{matrix}1 , - 1 , 1 , - 1 \\ 1 , - 1 , - 1 , 1\end{matrix} ]}^{T} , {\frac{1}{2 \sqrt{2}} [ \begin{matrix}1 , - 1 , j , - j \\ 1 , - 1 , - j , j\end{matrix} ]}^{T} ,$$

$${\frac{1}{2 \sqrt{2}} [ \begin{matrix}1 , - j , 1 , - j \\ 1 , - j , - 1 , j\end{matrix} ]}^{T} and {\frac{1}{2 \sqrt{2}} [ \begin{matrix}1 , - j , j , 1 \\ 1 , - j , - j , - 1\end{matrix} ]}^{T} .$$

In some embodiments, there may be a second set of vectors corresponding to 2 columns or rows, and the second set of vectors corresponding to 2 columns or rows may be applied for 8 Tx partial coherent precoders with 2 layer or 5 layers and/or 8 Tx first partial coherent precoders with 2 layers or 5 layers and/or 8 Tx second partial coherent precoders with 2 layers or 5 layers. In some embodiments, the second set of vectors corresponding to 2 columns or rows may be at least one of:

$${\frac{1}{2} [ \begin{matrix}1 , 0 , 1 , 0 \\ 0 , 1 , 0 , - j\end{matrix} ]}^{T} , {\frac{1}{2} [ \begin{matrix}1 , 0 , 1 , 0 \\ 0 , 1 , 0 , j\end{matrix} ]}^{T} , {\frac{1}{2} [ \begin{matrix}1 , 0 , - j , 0 \\ 0 , 1 , 0 , 1\end{matrix} ]}^{T} , {\frac{1}{2} [ \begin{matrix}1 , 0 , - j , 0 \\ 0 , 1 , 0 , - 1\end{matrix} ]}^{T} , {\frac{1}{2} [ \begin{matrix}1 , 0 , - 1 , 0 \\ 0 , 1 , 0 , - j\end{matrix} ]}^{T} , {\frac{1}{2} [ \begin{matrix}1 , 0 , - 1 , 0 \\ 0 , 1 , 0 , j\end{matrix} ]}^{T} , {\frac{1}{2} [ \begin{matrix}1 , 0 , j , 0 \\ 0 , 1 , 0 , 1\end{matrix} ]}^{T} , and {\frac{1}{2} [ \begin{matrix}1 , 0 , j , 0 \\ 0 , 1 , 0 , - 1\end{matrix} ]}^{T} .$$

In some embodiments, there may be a third set of vectors corresponding to 2 columns or rows, and the third set of vectors corresponding to 2 columns or rows may be applied for 8 Tx partial coherent precoders with 2 layer or 5 layers and/or 8 Tx non coherent precoders with 2 layers or 5 layers and/or 8 Tx second partial coherent precoders with 2 layers or 5 layers. In some embodiments, the third set of vectors corresponding to 2 columns or rows may be at least one of:

$${\frac{1}{2} [ \begin{matrix}1 , 0 , 0 , 0 \\ 0 , 1 , 0 , 0\end{matrix} ]}^{T} , {\frac{1}{2} [ \begin{matrix}1 , 0 , 0 , 0 \\ 0 , 1 , 0 , 0\end{matrix} ]}^{T} , {\frac{1}{2} [ \begin{matrix}1 , 0 , 0 , 0 \\ 0 , 1 , 0 , 0\end{matrix} ]}^{T} , {\frac{1}{2} [ \begin{matrix}1 , 0 , 0 , 0 \\ 0 , 1 , 0 , 0\end{matrix} ]}^{T} , {\frac{1}{2} [ \begin{matrix}1 , 0 , 0 , 0 \\ 0 , 1 , 0 , 0\end{matrix} ]}^{T} , and {\frac{1}{2} [ \begin{matrix}1 , 0 , 0 , 0 \\ 0 , 1 , 0 , 0\end{matrix} ]}^{T} .$$

In some embodiments, there may be a fourth set of vectors corresponding to 2 columns or rows, and the fourth set of vectors corresponding to 2 columns or rows may be applied for 8 Tx partial coherent precoders with 2 layer or 5 layers and/or 8 Tx full coherent precoders with 2 layers or 5 layers and/or 8 Tx second full coherent precoders with 2 layers or 5 layers and/or 8 Tx second partial coherent precoders with 2 layers or 5 layers and/or 8 Tx first partial coherent precoders with 2 layers or 5 layers. In some embodiments, the third set of vectors corresponding to 2 columns or rows may be at least one of:

$${\frac{1}{2} [ \begin{matrix}1 , 1 \\ 1 , - 1\end{matrix} ]}^{T} , and {\frac{1}{2} [ \begin{matrix}1 , j \\ 1 , - j\end{matrix} ]}^{T} .$$

In some embodiments, there may be a fifth set of vectors corresponding to 2 columns or rows, and the fifth set of vectors corresponding to 2 columns or rows may be applied for 8 Tx partial coherent precoders with 2 layer or 5 layers and/or 8 Tx full coherent precoders with 2 layers or 5 layers and/or 8 Tx second full coherent precoders with 2 layers or 5 layers and/or 8 Tx second partial coherent precoders with 2 layers or 5 layers and/or 8 Tx first partial coherent precoders with 2 layers or 5 layers. In some embodiments, the third set of vectors corresponding to 2 columns or rows may be at least one of:

$${\frac{1}{2} [ \begin{matrix}1 , 0 \\ 0 , 1\end{matrix} ]}^{T} .$$

In some embodiments, for at least one of full coherent and/or first full coherent and/or second full coherent and/or first partial coherent and/or second partial coherent and/or partial coherent and/or non coherent precoders for 2 layers or 5 layers, at least one of the first set of vectors corresponding to 2 columns or rows, the second set of vectors corresponding to 2 columns or rows and the third set of vectors corresponding to 2 columns or rows may be substituted into the embodiments for at least one of the first set of vectors corresponding to 1 layer, the second set of vectors corresponding to 1 layer, the third set of vectors corresponding to 1 layer, the fourth set of vectors corresponding to 1 layer and the fifth set of vectors corresponding to 1 layer. In some embodiments, each of the at least one of the first set of vectors corresponding to 2 columns or rows, the second set of vectors corresponding to 2 columns or rows and the third set of vectors corresponding to 2 columns or rows may be applied for 2 columns or 2 rows of the precoders for 2 layers or 5 layers.

In some embodiments, there may be a first set of vectors corresponding to 3 columns or rows, and the first set of vectors corresponding to 3 columns or rows may be applied for 8 Tx full coherent precoders with 3 layers or 6 layers or 5 layers or 7 layers and/or 8 Tx partial coherent precoders with 3 layers or 6 layers or 5 layers or 7 layers and/or 8 Tx first partial coherent precoders with 3 layers or 6 layers or 5 layers or 7 layers. In some embodiments, the first set of vectors corresponding to 3 columns or rows may be at least one of:

$${\frac{1}{2 \sqrt{3}} [ \begin{matrix}1 , 1 , 1 , 1 \\ 1 , - 1 , 1 , - 1 \\ 1 , 1 , - 1 , - 1\end{matrix} ]}^{T} , {\frac{1}{2 \sqrt{3}} [ \begin{matrix}1 , 1 , j , j \\ 1 , - 1 , j , - j \\ 1 , 1 , - j , - j\end{matrix} ]}^{T} , {\frac{1}{2 \sqrt{3}} [ \begin{matrix}1 , - 1 , 1 , - 1 \\ 1 , 1 , 1 , 1 \\ 1 , - 1 , - 1 , 1\end{matrix} ]}^{T} , {\frac{1}{2 \sqrt{3}} [ \begin{matrix}1 , - 1 , j , - j \\ 1 , 1 , j , j \\ 1 , - 1 , - j , j\end{matrix} ]}^{T} .$$

In some embodiments, there may be a second set of vectors corresponding to 3 columns or rows, and the second set of vectors corresponding to 3 columns or rows may be applied for 8 Tx partial coherent precoders with 3 layers or 6 layers or 5 layers or 7 layers and/or 8 Tx first partial coherent precoders with 3 layers or 6 layers or 5 layers or 7 layers and/or 8 Tx second partial coherent precoders with 3 layers or 6 layers or 5 layers or 7 layers. In some embodiments, the second set of vectors corresponding to 3 columns or rows may be at least one of:

$${\frac{1}{2} [ \begin{matrix}1 , 0 , 1 , 0 \\ 0 , 1 , 0 , 0 \\ 0 , 0 , 0 , 1\end{matrix} ]}^{T} , and {\frac{1}{2} [ \begin{matrix}1 , 0 , - 1 , 0 \\ 0 , 1 , 0 , 0 \\ 0 , 0 , 0 , 1\end{matrix} ]}^{T} .$$

In some embodiments, there may be a third set of vectors corresponding to 3 columns or rows, and the third set of vectors corresponding to 3 layers or 6 layers or 5 layers or 7 layers may be applied for 8 Tx partial coherent precoders with 3 layers or 6 layers or 5 layers or 7 layers and/or 8 Tx non coherent precoders with 3 layers or 6 layers or 5 layers or 7 layers and/or 8 Tx second partial coherent precoders with 3 layers or 6 layers or 5 layers or 7 layers. In some embodiments, the third set of vectors corresponding to 3 columns or rows may be at least one of:

$${\frac{1}{2} [ \begin{matrix}1 , 0 , 0 , 0 \\ 0 , 1 , 0 , 0 \\ 0 , 0 , 1 , 0\end{matrix} ]}^{T} .$$

In some embodiments, for at least one of full coherent and/or first full coherent and/or second full coherent and/or first partial coherent and/or second partial coherent and/or partial coherent and/or non coherent precoders for 3 layers or 6 layers or 5 layers or 7 layers, at least one of the first set of vectors corresponding to 3 columns or 3 rows, the second set of vectors corresponding to 3 columns or 3 rows and the third set of vectors corresponding to 3 columns or 3 rows may be substituted into the embodiments for at least one of the first set of vectors corresponding to 1 layer, the second set of vectors corresponding to 1 layer, the third set of vectors corresponding to 1 layer, the fourth set of vectors corresponding to 1 layer and the fifth set of vectors corresponding to 1 layer. In some embodiments, each of the at least one of the first set of vectors corresponding to 3 columns or rows, the second set of vectors corresponding to 3 columns or rows and the third set of vectors corresponding to 3 columns or rows may be applied for 3 columns or 3 rows of the precoders for 3 layers or 6 layers or 5 layers or 7 layers.

In some embodiments, there may be a first set of vectors corresponding to 4 columns or rows, and the first set of vectors corresponding to 4 columns or rows may be applied for 8 Tx full coherent precoders with 4 layers or 8 layers or 7 layers and/or 8 Tx partial coherent precoders with 4 layers or 8 layers or 7 layers and/or 8 Tx first partial coherent precoders with 4 layers or 8 layers or 7 layers. In some embodiments, the first set of vectors corresponding to 4 columns or rows may be at least one of:

$${\frac{1}{4} [ \begin{matrix}1 , 1 , 1 , 1 \\ 1 , - 1 , 1 , - 1 \\ 1 , 1 , - 1 , - 1 \\ 1 , - 1 , - 1 , 1\end{matrix} ]}^{T} , {\frac{1}{4} [ \begin{matrix}1 , 1 , j , j \\ 1 , - 1 , j , - j \\ 1 , 1 , - j , - j \\ 1 , - 1 , - j , j\end{matrix} ]}^{T} .$$

In some embodiments, there may be a second set of vectors corresponding to 4 columns or rows, and the second set of vectors corresponding to 4 columns or rows may be applied for 8 Tx partial coherent precoders with 4 layers or 7 layers or 8 layers and/or 8 Tx first partial coherent precoders with 4 layers or 7 layers or 8 layers and/or 8 Tx second partial coherent precoders with 4 layers or 7 layers or 8 layers. In some embodiments, the second set of vectors corresponding to 4 columns or rows may be at least one of:

$${\frac{1}{2 \sqrt{2}} [ \begin{matrix}1 , 0 , 1 , 0 \\ 1 , 0 , - 1 , 0 \\ 0 , 1 , 0 , 1 \\ 0 , 1 , 0 , - 1\end{matrix} ]}^{T} , {\frac{1}{2 \sqrt{2}} [ \begin{matrix}1 , 0 , j , 0 \\ 1 , 0 , - j , 0 \\ 0 , 1 , 0 , j \\ 0 , 1 , 0 , - j\end{matrix} ]}^{T} .$$

In some embodiments, there may be a third set of vectors corresponding to 4 columns or rows, and the third set of vectors corresponding to 4 columns or rows may be applied for 8 Tx partial coherent precoders with 4 layers or 7 layers or 8 layers and/or 8 Tx non coherent precoders with 4 layers or 7 layers or 8 layers and/or 8 Tx second partial coherent precoders with 4 layers or 7 layers or 8 layers. In some embodiments, the third set of vectors corresponding to 4 columns or rows may be at least one of:

$${\frac{1}{2} [ \begin{matrix}1 , 0 , 0 , 0 \\ 0 , 1 , 0 , 0 \\ 0 , 0 , 1 , 0 \\ 0 , 0 , 0 , 1\end{matrix} ]}^{T} .$$

In some embodiments, for at least one of full coherent and/or first full coherent and/or second full coherent and/or first partial coherent and/or second partial coherent and/or partial coherent and/or non coherent precoders for 4 layers or 7 layers or 8 layers, at least one of the first set of vectors corresponding to 4 columns or 4 rows, the second set of vectors corresponding to 4 columns or 4 rows and the third set of vectors corresponding to 4 columns or 4 rows may be substituted into the embodiments for at least one of the first set of vectors corresponding to 1 layer, the second set of vectors corresponding to 1 layer, the third set of vectors corresponding to 1 layer, the fourth set of vectors corresponding to 1 layer and the fifth set of vectors corresponding to 1 layer. In some embodiments, each of the at least one of the first set of vectors corresponding to 4 columns or rows, the second set of vectors corresponding to 4 columns or rows and the third set of vectors corresponding to 4 columns or rows may be applied for 4 columns or 4 rows of the precoders for 4 layers or 7 layers or 8 layers.

In some embodiments, for the precoders for 5 layers, 2 columns or rows of the precoder may comprise the first and/or second and/or third and/or fourth and/or fifth set of vectors corresponding to 2 columns or rows, and other 3 columns or rows of the precoder may comprise the first and/or the second and/or the third set of vectors corresponding to 3 columns or rows.

In some embodiments, for the precoders for 5 layers, 1 columns or rows of the precoder may comprise the first and/or second and/or third and/or fourth and/or fifth set of vectors corresponding to 1 layer, and other 4 columns or rows of the precoder may comprise the first and/or the second and/or the third set of vectors corresponding to 4 columns or rows.

In some embodiments, for the precoders for 6 layers, 2 columns or rows of the precoder may comprise the first and/or second and/or third and/or fourth and/or fifth set of vectors corresponding to 2 columns or rows, and other 4 columns or rows of the precoder may comprise the first and/or the second and/or the third set of vectors corresponding to 4 columns or rows.

In some embodiments, for the precoders for 6 layers, 1 columns or rows of the precoder may comprise the first and/or second and/or third and/or fourth and/or fifth set of vectors corresponding to 1 layer, and other 4 columns or rows of the precoder may comprise the first and/or the second and/or the third set of vectors corresponding to 4 columns or rows.

In some embodiments, for the precoders for 6 layers, 3 columns or rows of the precoder may comprise the first and/or second and/or third and/or fourth and/or fifth set of vectors corresponding to 3 columns or rows, and other 3 columns or rows of the precoder may comprise the first and/or the second and/or the third set of vectors corresponding to 3 columns or rows.

In some embodiments, for the precoders for 7 layers, 3 columns or rows of the precoder may comprise the first and/or second and/or third and/or fourth and/or fifth set of vectors corresponding to 3 columns or rows, and other 4 columns or rows of the precoder may comprise the first and/or the second and/or the third set of vectors corresponding to 4 columns or rows.

In some embodiments, for the precoders for 8 layers, 4 columns or rows of the precoder may comprise the first and/or second and/or third and/or fourth and/or fifth set of vectors corresponding to 4 columns or rows, and other 4 columns or rows of the precoder may comprise the first and/or the second and/or the third set of vectors corresponding to 4 columns or rows.

In some embodiments, for example, for the first full coherent precoders,

$${W}_{l , {l}^{′} , {l}^{″} , {l}^{′′′} , m , {m}^{′} , {m}^{″} , {m}^{′′′} , n}^{( 8 )}$$

may be

$$\frac{1}{\sqrt{8 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}} & {φ}_{n} * {v}_{{l}^{′′′} , {m}^{′′′}} & - {φ}_{n} * {v}_{{l}^{′′′} , {m}^{′′′}}\end{matrix} ]$$

In some embodiments, for example, for the first full coherent precoders,

$${W}_{l , {l}^{′} , {l}^{″} , {l}^{′′′} , m , {m}^{′} , {m}^{″} , {m}^{′′′} , n}^{( 8 )}$$

may

$$be \frac{1}{\sqrt{8 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {v}_{{l}^{″} , {m}^{″}} & - {v}_{{l}^{″} , {m}^{″}} & {v}_{{l}^{′′′} , {m}^{′′′}} & - {v}_{{l}^{′′′} , {m}^{′′′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6}. For another example, l may be at least one of {0, 1, 2, 3}. For another example, l may be 0 or 1. For another example, l may be 0 or 2. In some embodiments, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0 or 2. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, l′″=l+3O₁. In some embodiments, m and m′ and m″ and m′″ may be 0. In some embodiments, l′=l+O₁. In some embodiments, l″=l. In some embodiments, l′″=l+O₁. In some embodiments, m′=m. In some embodiments, m″=m+O₂. In some embodiments, m′″=m+O₂.

In some embodiments, there may be more than one subset of precoding matrixes corresponding to 8 layers. In some embodiments, the first set of precoding matrixes corresponding to 8 layers may comprise more than one subset. For example, there may be two subsets of precoding matrixes.

In some embodiments, there may be a first subset of precoding matrixes corresponding to 8 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ and m″ and m′″ may be 0. In some embodiments, corresponding to the first subset, l′=+O₁, l″=l+2O₁ and l′″=l+3O₁. In some embodiments, corresponding to the first subset, l may be a non-negative integer, 0≤l≤O₁N₁. For example, 1 may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 8 layers may be 32 or 16 or 8 or 4 or 2.

In some embodiments, there may be a second subset of precoding matrixes corresponding to 8 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l and l′″=l+O₁. In some embodiments, corresponding to the second subset, m′=m, m″=m+O₂ and m′″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 8 layers may be 128 or 32 or 16 or 8 or 4 or 2.

In some embodiments, the parameter “N₁” represents a number of ports in a first dimension. The parameter “N2” represents a number of ports in a second dimension. The parameter “O₁” represents a first discrete fourier transform (DFT) oversampling in the first dimension and the parameter “O₂” represents a second DFT oversampling in the second dimension. The parameter “i” represents an element in the precoding matrix.

In some embodiments, N₁ may equal to 4, N₂ equals to 1, O₁ may equal to 2 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. In some embodiments, the first subset of full coherent precoding matrixes corresponding to 8 layers “Set_f8_1” may comprise 16 precoding matrixes. In some embodiments, the subset of precoding matrixes “Set_f8_1” may comprise 8 precoding matrixes. Alternatively, the subset of precoding matrixes “Set_f8_1” may comprise 4 precoding matrixes. In other embodiments, the subset of precoding matrixes “Set_f8_1” may comprise 2 precoding matrixes.

Alternatively, N₁ may equal to 2, N₂ equals to 2, O₁ may equal to 1 or 4, and O₂ may equal to 2 or 4, i_{1,1} or i_{1, 2} may be one of {0, . . . 7} or {0, 2, 4, 6} or {0, 4} or {0, . . . 3} or {0, 2} or {0,1} or 0. In some embodiments, the second subset of full coherent precoding matrixes corresponding to 8 layers “Set_f8_2” may comprise 128 precoding matrixes. In some embodiments, the subset of precoding matrixes “Set_f8_2” may comprise 32 precoding matrixes. Alternatively, the subset of precoding matrixes “Set_f8_2” may comprise 8 precoding matrixes. In other embodiments, the subset of precoding matrixes “Set_f8_2” may comprise 2 precoding matrixes.

In some embodiments, if the terminal device 110 is indicated with the number of layers as 8, there may be a second set of precoding matrixes (e.g. a second set of partial coherent precoding matrixes) corresponding to 8 layers. For example, if the terminal device 110 has 8 antenna ports or if a PUSCH transmission of the terminal device 110 is associated with 8 antenna ports or if a PUSCH transmission of the terminal device 110 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 8 layers, for example, represented as “Set_p8_1”, and the size of a partial coherent precoding matrix may be 8 multiplies 8. In some embodiments, there may be 8 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent precoding matrix may be with non-zero value. And the other 4 elements in the partial coherent precoding matrix may be with value of 0. In some embodiments, there may be 4 columns or rows out of the 8 columns or rows (e.g. a first set of 4 columns or rows) in the precoding matrix, and in each column or row, non-zero values may be mapped on 4 out of 8 elements and 0 may be mapped on the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of antenna ports in the first group with 4 antenna ports. In some embodiments, for the other 4 columns or rows out of the 8 columns or rows (e.g. a second set of 4 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 4 columns or rows. For example, the indexes of the 4 elements with non-zero values may be idx_2, and idx_2 may be 4 values out of {0,1,2,3,4,5,6,7} or {1,2,3,4,5,6,7,8}. For example, idx_2 may be {4,5,6,7} or {1,3,5,7} or {5,6,7,8} or {2,4,6,8}. In some embodiments, the 4 values of idx_2 may be based on the indexes of antenna ports in the second group with 4 antenna ports. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the set of precoding matrixes “Set_p8_1” may comprise 280 precoding matrixes which is C(2,1)*C(2,1)*C(8,4). In some embodiments, C(x,y) may represent permutation and combination. For example, C(x,y) may represent number of possibilities of selecting y values out of x values.

For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f3, f4], [g1, g2, g3, g4] and [h1, h2, h3, h4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1; −1; −1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4], [f1, f2, f3, f4], [g1, g2, g3, g4] and [h1, h2, h3, h4] may be [1; 1; 1; 1], [1; −1; 1; −1], [1; 1; −1; −1] and [1; −1; −1; 1], respectively. For another example, [e1, e2, e3, e4], [f1, f2, f3, f4], [g1, g2, g3, g4] and [h1, h2, h3, h4] may be [1; 1; j; j], [1; −1; j; −j], [1; 1; −j; −j] and [1; −1; −j; j], respectively.

In some embodiments, s₈ may a positive integer. For example, 1≤s₈≤64. For example, s₈ may be 64 or 32 or 16 or 8 or 4 or 2.

In some embodiments, if the terminal device 110 is indicated with the number of layers as 8, there may be a third set of precoding matrixes (e.g. a third set of partial coherent precoding matrixes) corresponding to 8 layers. For example, the structure of 8 ports may be 2+2+2+2, which means that there are 4 groups, each group including 2 antenna ports and in each group, the 2 antenna ports can be coherent. For example, between the groups, the antenna ports may not be coherent. In some embodiments, there may be a third set of precoding matrixes (e.g. a third set of partial coherent precoding matrixes) corresponding to 8 layers, for example, represented as “Set_p8_2”, and the size of a precoding matrix may be 8 multiplies 8. In some embodiments, there may be 8 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 8 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 8 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of the other two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 2 columns or rows out of the 8 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 2 columns or rows out of the 8 columns or rows (e.g. a fourth set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of the other two of the 4 antenna ports in the first group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other.

In some embodiments, there may be a set of 4 length-2 vectors, and each one of the length-2 vector may be applied as the two non-zero values in a column or row of the precoding matrix. In some embodiments, for the third set of precoding matrix Set_p8_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in a column or row of the precoding matrix.

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, each of [g1, g2] and [h1, h2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [g1, g2] and [h1, h2] may be [1; 1], [1; −1], respectively. For another example, [g1, g2] and [h1, h2] may be [1; j], [1; −j], respectively.

In some embodiments, if the terminal device 110 is indicated with the number of layers as 8, there may be a fourth set of precoding matrixes (e.g. a fourth set of non-coherent precoding matrixes) corresponding to 8 layers. For example, each one of 8 antenna ports may be non-coherent with each other. In some embodiments, there may be a fourth set of precoding matrixes corresponding to 8 layers (e.g. a fourth set of non-coherent precoding matrixes), for example, represented as “Set_n8_1”, and the size of a precoding matrix may be 8 multiplies 8. In some embodiments, there may be 8 columns or rows of the precoding matrix. In some embodiments, there may be 8 elements in a column or row of the precoding matrix. In some embodiments, for a column or a row of the precoding matrix, 1 element out of 8 elements in the precoding matrix may be with non-zero value. For example, the non-zero value may be 1. And the other 7 elements in the precoding matrix may be with value of 0. In some embodiments, for each column or row of the 8 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5, idx_6, idx_7, idx_8 for the first, second, third, fourth, fifth, sixth, seventh, eighth column or row of the precoding matrix, respectively, and for each one of idx_1, idx_2, idx_3, idx_4, idx_5, idx_6, idx_7, idx_8, the value may be 1 value out of {0,1,2,3,4,5,6,7} or {1,2,3,4,5,6,7,8}. For example, the value of idx_1, idx_2, idx_3, idx_4, idx_5, idx_6, idx_7, idx_8 may be 0, 1, 2, 3, 4, 5, 6, 7, respectively. For another example, the value of idx_1, idx_2, idx_3, idx_4, idx_5, idx_6, idx_7, idx_8 may be 1, 2, 3, 4, 5, 6, 7, 8, respectively. In some embodiments, the value of idx_1, idx_2, idx_3, idx_4, idx_5, idx_6, idx_7, idx_8 may be different from each other.

In some embodiments, if the terminal device 110 is indicated with number of layers is indicated as 8, there may be a fourth set of precoding matrixes corresponding to 8 layers. For example, there may be only one precoding matrix in the fourth set (e.g. non-coherent precoding matrix) corresponding to 8 layers.

In some embodiments, if the terminal device 110 is indicated with the number of layers as 8, there may be a fifth set of precoding matrixes (for example, mixed partial coherent precoding matrixes) corresponding to 8 layers. For example, the structure of the 8 ports may be 4+2+2, which means that 4 antenna ports can be coherent, 2 antenna ports can be coherent, and the other 2 antenna ports can be coherent. In some embodiments, there may be a fifth set of precoding matrixes corresponding to 8 layers (e.g. mixed partial coherent precoding matrix), for example, represented as “Set_p8_3”, and the size of a partial coherent precoding matrix may be 8 multiplies 8. In some embodiments, there may be 8 columns or rows of the precoding matrix. In some embodiments, there may be 8 elements in a column or row of the precoding matrix. In some embodiments, there may be 4 columns or rows out of the 8 columns or rows (e.g. a first set of 4 columns or rows) in the precoding matrix, and in each column or row, non-zero values may be mapped on 4 out of 8 elements and 0 may be mapped on the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, there may be 2 columns or rows out of the 8 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. For example, idx_2 may be {4, 5} or {1, 3} or {5, 6} or {2, 4}. In some embodiments, there may be 2 columns or rows out of the 8 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. For example, idx_3 may be {6, 7} or {5, 7} or {7, 8} or {6, 8}. In some embodiments, any value of idx_1, any value of idx_2 and any value of idx_3 may be different from each other. In some embodiments, the values in a length-4 vector of the first set of length-4 vectors or of the second set of length-4 vectors may be applied for the 4 non-zero values mapping on 4 elements in a column or row in the first set of 4 columns or rows of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the two values in a length-2 vector of the first set of length-2 vectors or of the second set of length-2 vectors may be applied as the two non-zero values mapping on 2 elements in a column or row of the second set of 2 columns or rows of the precoding matrix. In some embodiments, the two values in a length-2 vector of the first set of length-2 vectors or of the second set of length-2 vectors may be applied as the two non-zero values mapping on 2 elements in a column or row of the third set of 2 columns or rows of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in a column or row of the precoding matrix.

In some embodiments, 4 out of 8 columns may be mapped with length-4 vectors, and for 2 out of remaining 4 columns, each column may be mapped with length-2 vectors, and f remaining 3 columns, each column may be mapped with length-2 vectors.

For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1; −1; −1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2], [f1, f2] may be [1; 1], [1; −1], respectively. For another example, [e1, e2], [f1, f2] may be [1; j], [1; −j], respectively. For example, [g1, g2] and [h1, h2] may be [1; 1], [1; −1], respectively. For another example, [g1, g2] and [h1, h2] may be [1; j], [1; −j], respectively.

In other embodiments, if the terminal device 110 is indicated with the number of layers as 8, there may be a sixth set of precoding matrixes (for example, mixed partial and non coherent precoding matrixes) corresponding to 8 layers. For example, the structure of 8 antenna ports may be 4+1+1+1+1, which means that 4 antenna ports can be coherent, and remaining 4 antenna ports may be non-coherent. For example, rows or columns rows can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1; −1; −1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively.

In some embodiments, if the terminal device 110 is indicated with the number of layers as 8, there may be a seventh set of precoding matrixes (for example, mixed partial and non coherent precoding matrixes) corresponding to 8 layers. For example, the structure of the 8 ports may be 4+2+1+1, which means that 4 antenna ports can be coherent and 2 antenna ports can be coherent. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1; −1; −1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2], [f1, f2] may be [1; 1], [1; −1], respectively. For another example, [e1, e2], [f1, f2] may be [1; j], [1; −j], respectively.

In some other embodiments, if the terminal device 110 is indicated with the number of layers as 8, there may be an eighth set of precoding matrixes (for example, mixed partial and non coherent precoding matrixes) corresponding to 8 layers. For example, the structure of the 8 ports may be 2+2+1+1+1+1, which means that 2 antenna ports can be coherent and 2 antenna ports can be coherent. In some other embodiments, the antenna structure may be 2+1+1+1+1+1+1. Alternatively, the antenna structure may be 2+2+2+1+1. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively.

In some embodiments, the terminal device 110 is indicated with the number of layers as 7, there may be a first set of precoding matrixes corresponding to 7 layers (e.g. a first set of full coherent precoding matrixes), and a full coherent precoding matrix may be represented as

$${W}_{l , {l}^{′} , {l}^{″} , {l}^{′′′} , m , {m}^{′} , {m}^{″} , {m}^{′′′} , n}^{( 7 )} .$$

In some embodiments,

$${W}_{l , {l}^{′} , {l}^{″} , {l}^{′′′} , m , {m}^{′} , {m}^{″} , {m}^{′′′} , n}^{( 7 )}$$

may be

$$\frac{1}{\sqrt{7 * P}} [ \begin{matrix}{v}_{l , m} & {v}_{l , m} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}} & {φ}_{n} * {v}_{{l}^{′′′} , {m}^{′′′}} & - {φ}_{n} * {v}_{{l}^{′′′} , {m}^{′′′}}\end{matrix} ]$$

In some embodiments,

$${W}_{l , {l}^{′} , {l}^{″} , {l}^{′′′} , m , {m}^{′} , {m}^{″} , {m}^{′′′} , n}^{( 7 )}$$

may be

$$\frac{1}{\sqrt{7 * P}} [ \begin{matrix}{v}_{l , m} & {v}_{l , m} & {v}_{{l}^{′} , {m}^{′}} & {v}_{{l}^{″} , {m}^{″}} & {v}_{{l}^{″} , {m}^{″}} & {v}_{{l}^{′′′} , {m}^{′′′}} & {v}_{{l}^{′′′} , {m}^{′′′}} \\ {φ}_{n} * {v}_{l , m} & - {φ}_{n} * {v}_{l , m} & {φ}_{n} * {v}_{{l}^{′} , {m}^{′}} & {v}_{{l}^{″} , {m}^{″}} & - {v}_{{l}^{″} , {m}^{″}} & {v}_{{l}^{′′′} , {m}^{′′′}} & - {v}_{{l}^{′′′} , {m}^{′′′}}\end{matrix} ] .$$

In some embodiments, P may be 8 or 12 or 16. In some embodiments, 1 may be a non-negative integer. For example, 0≤l≤O₁N₁. For another example, 0≤l≤O₁N₁/2. For another example, 1 may be at least one of {0, 2, 4, 6, 8}. For another example, 1 may be at least one of {0, 1, 2, 3}. For another example, 1 may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, l′″=l+3O₁. In some embodiments, m and m′ and m″ and m′″ may be 0. In some embodiments, l′=l+O₁. In some embodiments, l″=l. In some embodiments, l′″=l+O₁. In some embodiments, m′=m. In some embodiments, m″=m+O₂. In some embodiments, m′″=m+O₂.

In some embodiments, there may be more than one subset of precoding matrixes corresponding to 7 layers. In some embodiments, the first set of precoding matrixes corresponding to 7 layers may comprise more than one subset. For example, there may be two subsets of precoding matrixes.

In some embodiments, there may be a first subset of precoding matrixes corresponding to 7 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ and m″ and m′″ may be 0. In some embodiments, corresponding to the first subset, l′=l+O₁, l″=l+2O₁ and l′″=l+3O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 7 layers may be 32 or 16 or 8 or 4 or 2.

In some embodiments, there may be a second subset of precoding matrixes corresponding to 7 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l and l′″=l+O₁. In some embodiments, corresponding to the second subset, m′=m, m″=m+O₂ and m′″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 7 layers may be 128 or 32 or 16 or 8 or 4 or 2.

In some embodiments, N₁ may equal to 4, N₂ equals to 1, O₁ may equal to 2 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The first subset of precoding matrixes corresponding to 7 layers (e.g. “Set_f7_1”) may comprise 16 precoding matrixes. In some embodiments, the first subset of precoding matrixes “Set_f7_1” may comprise 8 precoding matrixes. Alternatively, the first subset of precoding matrixes “Set_f7_1” may comprise 4 precoding matrixes. In other embodiments, the first subset of precoding matrixes “Set_f7_1” may comprise 2 precoding matrixes.

Alternatively, N₁ may equal to 2, N₂ equals to 2, O₁ may equal to 1 or 4, and O₂ may equal to 2 or 4, i_{1,1} or i_{1, 2} may be one of {0, . . . 7} or {0, 2, 4, 6} or {0, 4} or {0, . . . 3} or {0, 2} or {0,1} or 0. The second subset of precoding matrixes corresponding to 7 layers (e.g. “Set_f7_2”) may comprise 128 precoding matrixes. In some embodiments, the second subset of precoding matrixes “Set_f7_2” may comprise 32 precoding matrixes. Alternatively, the second subset of precoding matrixes “Set_f7_2” may comprise 8 precoding matrixes. In other embodiments, the second subset of precoding matrixes “Set_f7_2” may comprise 2 precoding matrixes.

In some embodiments, the terminal device 110 is indicated with the number of layers as 7, there may be a second set of precoding matrixes corresponding to 7 layers (e.g. a second set of partial coherent precoding matrixes). For example, if the terminal device 110 has 8 antenna ports or if a PUSCH transmission of the terminal device 110 is associated with 8 antenna ports or if a PUSCH transmission of the terminal device 110 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 7 layers, for example, represented as “Set_p7_1”, and the size of a partial coherent precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be 4 columns or rows out of the 7 columns or rows (e.g. a first set of 4 columns or rows) in the precoding matrix, and in each column or row, the non-zero values may be mapped on 4 out of 8 elements and 0 for the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of the 4 antenna ports in the first group. In some embodiments, for the other 3 columns or rows out of the 7 columns or rows (e.g. a second set of 3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, the set of precoding matrixes “Set_p7_1” may comprise C(2,1)*C(7,4)*C(2,1)*C(4,3) precoding matrixes.

In some embodiments, examples of a precoding matrix of the second set of precoding matrixes corresponding to 7 layers may be as:

$$\frac{1}{\sqrt{{s}_{7}}} [ \begin{matrix}a 1 & b 1 & c 1 & d 1 & 0 & 0 & 0 \\ a 2 & b 2 & c 2 & d 2 & 0 & 0 & 0 \\ a 3 & b 3 & c 3 & d 3 & 0 & 0 & 0 \\ a 4 & b 4 & c 4 & d 4 & 0 & 0 & 0 \\ 0 & 0 & 0 & 0 & e 1 & f 1 & g 1 \\ 0 & 0 & 0 & 0 & e 2 & f 2 & g 2 \\ 0 & 0 & 0 & 0 & e 3 & f 3 & g 3 \\ 0 & 0 & 0 & 0 & e 4 & f 4 & g 4\end{matrix} ] or$$

$$\frac{1}{\sqrt{{s}_{7}}} [ \begin{matrix}a 1 & b 1 & c 1 & d 1 & 0 & 0 & 0 \\ 0 & 0 & 0 & 0 & e 1 & f 1 & g 1 \\ a 2 & b 2 & c 2 & d 2 & 0 & 0 & 0 \\ 0 & 0 & 0 & 0 & e 2 & f 2 & g 2 \\ a 3 & b 3 & c 3 & d 3 & 0 & 0 & 0 \\ 0 & 0 & 0 & 0 & e 3 & f 3 & g 3 \\ a 4 & b 4 & c 4 & d 4 & 0 & 0 & 0 \\ 0 & 0 & 0 & 0 & e 4 & f 4 & g 4\end{matrix} ] .$$

For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f3, f4], [g1, g2, g3, g4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1; −1; −1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4], [f1, f2, f3, f4], [g1, g2, g3, g4] may be 3 vectors out of [1; 1; 1; 1], [1; −1; 1; −1], [1; 1; −1; −1] and [1; −1; −1; 1]. For another example, [e1, e2, e3, e4], [f1, f2, f3, f4], [g1, g2, g3, g4] may be 3 vectors out of [1; 1; j; j], [1; −1; j; −j], [1; 1; −j; −j] and [1; −1; −j; j].

In some embodiments, s₇ may a positive integer. For example, 1≤s₇≤64. For example, s₇ may be 64 or 32 or 16 or 8 or 4 or 2 or 56 or 28 or 14.

In some embodiments, if the terminal device 110 is indicated with the number of layers as 7, there may be a third set of precoding matrixes (e.g. a third set of partial coherent precoding matrixes) corresponding to 7 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p7_2”, and the size of a precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 7 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 7 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of the other two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 2 columns or rows out of the 7 columns or rows (e.g. a third set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 column or row out of the 7 columns or rows (e.g. a fourth set of 1 column or row) in the precoding matrix, and in each column or row, non-zero values may be mapped on 2 out of 8 elements and 0 may be mapped on the other 6 elements. For example, the indexes of the 2 elements with non-zero values may be same in the fourth set of 1 column or row. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other.

In some embodiments, there may be a set of 4 length-2 vectors, and each one of the length-2 vector may be applied as the two non-zero values in a column or row of the precoding matrix. In some embodiments, for the third set of precoding matrix corresponding to 7 layers, e.g. Set_p7_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in a column or row of the precoding matrix.

In some embodiments, for the first set of 2 columns or rows and/or for the second set of 2 columns or rows and/or for the third set of 2 columns or rows and/or for the fourth set of 1 column or row, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 7 layers may be as:

$$\frac{1}{\sqrt{{s}_{7}}} [ \begin{matrix}a 1 & b 1 & 0 & 0 & 0 & 0 & 0 \\ a 2 & b 2 & 0 & 0 & 0 & 0 & 0 \\ 0 & 0 & c 1 & d 1 & 0 & 0 & 0 \\ 0 & 0 & c 2 & d 2 & 0 & 0 & 0 \\ 0 & 0 & 0 & 0 & e 1 & f 1 & 0 \\ 0 & 0 & 0 & 0 & e 2 & f 2 & 0 \\ 0 & 0 & 0 & 0 & 0 & 0 & g 1 \\ 0 & 0 & 0 & 0 & 0 & 0 & g 2\end{matrix} ] or$$

$$\frac{1}{\sqrt{{s}_{7}}} [ \begin{matrix}a 1 & b 1 & 0 & 0 & 0 & 0 & 0 \\ 0 & 0 & c 1 & d 1 & 0 & 0 & 0 \\ a 2 & b 2 & 0 & 0 & 0 & 0 & 0 \\ 0 & 0 & c 2 & d 2 & 0 & 0 & 0 \\ 0 & 0 & 0 & 0 & e 1 & f 1 & 0 \\ 0 & 0 & 0 & 0 & 0 & 0 & g 1 \\ 0 & 0 & 0 & 0 & e 2 & f 2 & 0 \\ 0 & 0 & 0 & 0 & 0 & 0 & g 2\end{matrix} ] .$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, [g1, g2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [g1, g2] may be one of [1; 1], [1; −1]. For another example, [g1, g2] may be one of [1; j], [1; −j], respectively.

In some embodiments, if the terminal device 110 is indicated with the number of layers as 7, there may be a fourth set of precoding matrixes (e.g. a fourth set of non-coherent precoding matrixes) corresponding to 7 layers. For example, each one of 8 antenna ports may be non-coherent with each other. In some embodiments, there may be a fourth set of precoding matrixes (e.g. a fourth set of non-coherent precoding matrixes), for example, represented as “Set_n7_1”, and the size of a precoding matrix may be 7 multiplies 8 or 8 multiplies 7. In some embodiments, there may be 7 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 7 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5, idx_6, idx_7 for the first, second, third, fourth, fifth, sixth, seventh column or row of the precoding matrix, respectively, and for each one of idx_1, idx_2, idx_3, idx_4, idx_5, idx_6, idx_7, the value may be 1 value out of {0,1,2,3,4,5,6,7} or {1,2,3,4,5,6,7,8}. For example, the value of idx_1, idx_2, idx_3, idx_4, idx_5, idx_6, idx_7 may be 0, 1, 2, 3, 4, 5, 6, respectively. For another example, the value of idx_1, idx_2, idx_3, idx_4, idx_5, idx_6, idx_7 may be 1, 2, 3, 4, 5, 6, 7, respectively. In some embodiments, the values of idx_1, idx_2, idx_3, idx_4 may be based on the indexes of the 4 antenna ports in the first group. In some embodiments, the values of idx_5, idx_6 and idx_7 may be based on the indexes of three out of the 4 antenna ports in the second group. In some embodiments, the values of idx_1, idx_2 may be based on the indexes of the 2 antenna ports in the third group. In some embodiments, the values of idx_3, idx_4 may be based on the indexes of the 2 antenna ports in the fourth group. In some embodiments, the values of idx_5, idx_6 may be based on the indexes of the 2 antenna ports in the fifth group. In some embodiments, the values of idx_7 may be based on the indexes of one out of the 2 antenna ports in the sixth group. For example, the value of idx_1, idx_2, idx_3, idx_4, idx_5, idx_6, idx_7 may be different from each other.

In some embodiments, if the terminal device 110 is indicated with number of layers is indicated as 7, there may be a fourth set of precoding matrixes corresponding to 7 layers. For example, there may be only one precoding matrix in the fourth set (e.g. non-coherent precoding matrix) corresponding to 7 layers.

In some embodiments, if the terminal device 110 is indicated with the number of layers as 7, there may be a fifth set of precoding matrixes (for example, mixed partial coherent precoding matrixes) corresponding to 7 layers. For example, the structure of the 8 ports may be 4+2+2, which means that 4 antenna ports can be coherent, 2 antenna ports can be coherent, and the other 2 antenna ports can be coherent. In this case, 4 out of 8 columns may be mapped with length-4 vectors, and for remaining 3 columns, each column may be mapped with length-2 vectors, and with ports swapped.

In other embodiments, if the terminal device 110 is indicated with the number of layers as 7, there may be a sixth set of precoding matrixes (for example, mixed partial and non coherent precoding matrixes) corresponding to 7 layers. For example, the structure of 8 antenna ports may be 4+1+1+1+1, which means that 4 antenna ports can be coherent.

In some embodiments, if the terminal device 110 is indicated with the number of layers as 7, there may be a seventh set of precoding matrixes (for example, mixed partial and non coherent precoding matrixes) corresponding to 7 layers. For example, the structure of the 8 ports may be 4+2+1+1, which means that 4 antenna ports can be coherent and 2 antenna ports can be coherent.

In some other embodiments, if the terminal device 110 is indicated with the number of layers as 7, there may be an eighth set of precoding matrixes (for example, mixed partial and non coherent precoding matrixes) corresponding to 7 layers. For example, the structure of the 8 ports may be 2+2+1+1+1+1, which means that 2 antenna ports can be coherent and 2 antenna ports can be coherent.

In some embodiments, the terminal device 110 is indicated with the number of layers as 6, there may be a first set of precoding matrixes corresponding to 6 layers (e.g. a first set of full coherent precoding matrixes), and a full coherent precoding matrix may be represented as

$${W}_{l , {l}^{′} , {l}^{″} , m , {m}^{′} , {m}^{″} , , n}^{( 6 )} .$$

In some embodiments,

$${W}_{l , {l}^{′} , {l}^{″} , m , {m}^{′} , {m}^{″} , , n}^{( 6 )}$$

may be

$$\frac{1}{\sqrt{6 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}} & - {φ}_{n} * {v}_{{l}^{″} , {m}^{″}}\end{matrix} ] .$$

In some embodiments,

$${W}_{l , {l}^{′} , {l}^{″} , m , {m}^{′} , {m}^{″} , , n}^{( 6 )}$$

may be

$$\frac{1}{\sqrt{6 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {v}_{{l}^{″} , {m}^{″}} & - {v}_{{l}^{″} , {m}^{″}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, m and m′ and m″ may be 0. In some embodiments, l′=l+O₁. In some embodiments, l″=l+O₁. In some embodiments, m′=m. In some embodiments, m″=m+O₂.

In some embodiments, there may be more than one subset of precoding matrixes corresponding to 6 layers. In some embodiments, the first set of precoding matrixes corresponding to 6 layers may comprise more than one subset. For example, there may be two subsets of precoding matrixes.

In some embodiments, there may be a first subset of precoding matrixes corresponding to 6 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ and m″ may be 0. In some embodiments, corresponding to the first subset, l′=l+O₁, l″=l+2O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 6 layers may be 32 or 16 or 8 or 4 or 2.

In some embodiments, there may be a second subset of precoding matrixes corresponding to 6 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l+O₁. In some embodiments, corresponding to the second subset, m′=m, m″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 6 layers may be 128 or 32 or 16 or 8 or 4 or 2.

In some embodiments, N₁ may equal to 4, N₂ equals to 1, O₁ may equal to 2 and O₂ may equal to 1 and i_{1,1} may be one of {0, . . . N101-1} or {0, 2, 4, 6} or {0, 4} or {0, 1} or 0 or {0, . . . N₁O₁/2−1} or {0, 2}. The first subset of precoding matrixes corresponding to 6 layers, e.g. “Set_f6_1” may comprise 16 precoding matrixes. In some embodiments, the first subset of precoding matrixes “Set_f6_1” may comprise 8 precoding matrixes. Alternatively, the first subset of precoding matrixes “Set_f6_1” may comprise 4 precoding matrixes. In other embodiments, the first subset of precoding matrixes “Set_f6_1” may comprise 2 precoding matrixes.

Alternatively, N₁ may equal to 2, N₂ equals to 2, O₁ may equal to 1 or 4, and O₂ may equal to 2 or 4, i_{1,1} or i_{1, 2} may be one of {0, . . . 7} or {0, 2, 4, 6} or {0, 4} or {0, . . . 3} or {0, 2} or {0,1} or 0. The second subset of precoding matrixes corresponding to 6 layers, e.g. “Set_f6_2” may comprise 128 precoding matrixes. In some embodiments, the second subset of precoding matrixes “Set_f6_2” may comprise 32 precoding matrixes. Alternatively, the second subset of precoding matrixes “Set_f6_2” may comprise 8 precoding matrixes. In other embodiments, the second subset of precoding matrixes “Set_f6_2” may comprise 2 precoding matrixes.

In some embodiments, the terminal device 110 is indicated with the number of layers as 6, there may be a second set of precoding matrixes corresponding to 6 layers (e.g. a second set of partial coherent precoding matrixes). For example, if the terminal device 110 has 8 antenna ports or if a PUSCH transmission of the terminal device 110 is associated with 8 antenna ports or if a PUSCH transmission of the terminal device 110 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 6 layers, for example, represented as “Set_p6_1”, and the size of a partial coherent precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be 4 columns or rows out of the 6 columns or rows (e.g. a first set of 4 columns or rows) in the precoding matrix, and in each column, the non-zero value may be mapped on 4 out of 8 elements and 0 for the other 4 elements. For example, the indexes of the 4 elements with non-zero values may be same in the first set of 4 columns or rows. For example, the indexes of the 4 elements with non-zero values may be idx_1, and idx_1 may be 4 values out of {0,1,2,3,4,5,6,7} or {1,2,3,4,5,6,7,8}. For example, idx_1 may be {0,1,2,3} or {0,2,4,6} or {1,2,3,4} or {1,3,5,7}. In some embodiments, the 4 values of idx_1 may be based on the indexes of the 4 antenna ports in the first group. In some embodiments, for other 2 columns, 2 of the first set or the second set of length-4 vectors may be selected. In some embodiments, for the other 2 columns or rows out of the 6 columns or rows (e.g. a second set of 2 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 2 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of two out of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, alternatively, 3 columns or rows out of the 6 columns or rows (e.g. a first set of 3 columns or rows) may be selected. In each column, the non-zero value may be mapped on 4 out of 8 elements, and 0 may be mapped for other 4 elements. For example, the indexes of the 4 elements with non-zero values may be same in the first set of 3 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group. For example, idx_1 may be {0,1,2,3} or {0,2,4,6} or {1,2,3,4} or {1,3,5,7}. In some embodiments, for other 3 columns or rows, 3 length-4 vectors of the first set or second set of length-4 vectors may be selected. In some embodiments, for other 3 columns, 3 of the first set or the second set of length-4 vectors may be selected. In some embodiments, for the other 3 columns or rows out of the 6 columns or rows (e.g. a second set of 3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group. For example, idx_2 may be {4,5,6,7} or {1,3,5,7} or {5,6,7,8} or {2,4,6,8}. In some embodiments, any value of idx_1 may be different from any value of idx_2.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix.

In some embodiments, examples of a precoding matrix of the second set of precoding matrixes corresponding to 6 layers may be as:

$$\frac{1}{\sqrt{{s}_{6}}} [ \begin{matrix}a 1 & b 1 & c 1 & d 1 & 0 & 0 \\ a 2 & b 2 & c 2 & d 2 & 0 & 0 \\ a 3 & b 3 & c 3 & d 3 & 0 & 0 \\ a 4 & b 4 & c 4 & d 4 & 0 & 0 \\ 0 & 0 & 0 & 0 & e 1 & f 1 \\ 0 & 0 & 0 & 0 & e 2 & f 2 \\ 0 & 0 & 0 & 0 & e 3 & f 3 \\ 0 & 0 & 0 & 0 & e 4 & f 4\end{matrix} ] or \frac{1}{\sqrt{{s}_{6}}} [ \begin{matrix}a 1 & b 1 & c 1 & 0 & 0 & 0 \\ a 2 & b 2 & c 2 & 0 & 0 & 0 \\ a 3 & b 3 & c 3 & 0 & 0 & 0 \\ a 4 & b 4 & c 4 & 0 & 0 & 0 \\ 0 & 0 & 0 & d 1 & e 1 & f 1 \\ 0 & 0 & 0 & d 2 & e 2 & f 2 \\ 0 & 0 & 0 & d 3 & e 3 & f 3 \\ 0 & 0 & 0 & d 4 & e 4 & f 4\end{matrix} ] .$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, each of [e1, e2, e3, e4], [f1, f2, f3, f4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1; −1; −1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4], [f1, f2, f3, f4] may be 2 vectors out of [1; 1; 1; 1], [1; −1; 1; −1], [1; 1; −1; −1] and [1; −1; −1; 1]. For another example, [e1, e2, e3, e4], [f1, f2, f3, f4] may be 2 vectors out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, each of [d1, d2, d3, d4], [e1, e2, e3, e4], [f1, f2, f3, f4] may be one of the length-4 vectors in the first set of length-4 vectors or in the second set of length-4 vectors. For example, [a1, a2, a3, a4], [b1, b2, b3, b4], [c1, c2, c3, c4] may be three vectors out of [1; 1; 1; 1], [1; −1; 1; −1], [1; 1; −1; −1] and [1; −1; −1; 1]. For another example, [a1, a2, a3, a4], [b1, b2, b3, b4], [c1, c2, c3, c4] may be three of [1; 1; j; j], [1; −1; j; −j], [1; 1; −j; −j] and [1; −1; −j; j]. For example, [d1, d2, d3, d4], [e1, e2, e3, e4], [f1, f2, f3, f4] may be 3 vectors out of [1; 1; 1; 1], [1; −1; 1; −1], [1; 1; −1; −1] and [1; −1; −1; 1]. For another example, [d1, d2, d3, d4], [e1, e2, e3, e4], [f1, f2, f3, f4] may be 3 vectors out of [1; 1; j; j], [1; −1; j; −j], [1; 1; −j; −j] and [1; −1; −j; j].

In some embodiments, s₆ may a positive integer. For example, 1≤s₆≤64. For example, s₆ may be 64 or 32 or 16 or 8 or 4 or 2 or 48 or 24 or 12.

In some embodiments, if the terminal device 110 is indicated with the number of layers as 6, there may be a third set of precoding matrixes (e.g. a third set of partial coherent precoding matrixes) corresponding to 6 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p6_2”, and the size of a precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 6 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 2 columns or rows out of the 6 columns or rows (e.g. a second set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 6 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_1 may be based on the indexes of two out of the 4 antenna ports in the second group. In some embodiments, the 2 values of idx_1 may be based on the indexes of the 2 antenna ports in the fifth group. For example, idx_3 may be {4,5} or {4,6} or {5,6} or {5,7} or {2,6} or {3,7}. In some embodiments, there may be 1 or 2 columns or rows out of the 6 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 6. In some embodiments, there may be the first set, the second set and the third set, and each set with 2 columns or rows. In some embodiments, there may be the first set, the second set and the third set and fourth set, and each of two of the four sets with 2 columns or rows, and each of other two of the four sets with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 6 layers, e.g. Set_p6_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in a column or row of the precoding matrix.

In some embodiments, for the first set of 2 columns or rows and/or for the second set of 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 6 layers may be as:

$$\frac{1}{\sqrt{{s}_{6}}} [ \begin{matrix}a 1 & b 1 & 0 & 0 & 0 & 0 \\ a 2 & b 2 & 0 & 0 & 0 & 0 \\ 0 & 0 & c 1 & d 1 & 0 & 0 \\ 0 & 0 & c 2 & d 2 & 0 & 0 \\ 0 & 0 & 0 & 0 & e 1 & f 1 \\ 0 & 0 & 0 & 0 & e 2 & f 2 \\ 0 & 0 & 0 & 0 & 0 & 0 \\ 0 & 0 & 0 & 0 & 0 & 0\end{matrix} ] or \frac{1}{\sqrt{{s}_{6}}} [ \begin{matrix}a 1 & b 1 & 0 & 0 & 0 & 0 \\ a 2 & b 2 & 0 & 0 & 0 & 0 \\ 0 & 0 & c 1 & d 1 & 0 & 0 \\ 0 & 0 & c 2 & d 2 & 0 & 0 \\ 0 & 0 & 0 & 0 & e 1 & 0 \\ 0 & 0 & 0 & 0 & e 2 & 0 \\ 0 & 0 & 0 & 0 & 0 & f 1 \\ 0 & 0 & 0 & 0 & 0 & f 2\end{matrix} ] .$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, each of [e1, e2], [f1, f2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [e1, e2], [f1, f2] may be [1; 1], [1; −1], respectively. For another example, [e1, e2], [f1, f2] may be [1; j], [1; −j], respectively. For example, [e1, e2] may be one of [1; 1], [1; −1], [1; j], [1; −j]. For example, [f1, f2] may be one of [1; 1], [1; −1], [1; j], [1; −j].

In some embodiments, if the terminal device 110 is indicated with the number of layers as 6, there may be a fourth set of precoding matrixes (e.g. a fourth set of non-coherent precoding matrixes) corresponding to 6 layers. For example, each one of 8 antenna ports may be non-coherent with each other. In some embodiments, there may be a fourth set of precoding matrixes (e.g. a fourth set of non-coherent precoding matrixes), for example, represented as “Set_n6_1”, and the size of a precoding matrix may be 6 multiplies 8 or 8 multiplies 6. In some embodiments, there may be 6 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 6 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5, idx_6 for the first, second, third, fourth, fifth, sixth column or row of the precoding matrix, respectively, and for each one of idx_1, idx_2, idx_3, idx_4, idx_5, idx_6 the value may be 1 value out of {0,1,2,3,4,5,6,7} or {1,2,3,4,5,6,7,8}. In some embodiments, the values of idx_1, idx_2, idx_3, idx_4 may be based on the indexes of the 4 antenna ports in the first group. In some embodiments, the values of idx_1, idx_2, idx_3 may be based on the indexes of the three out of 4 antenna ports in the first group. In some embodiments, the values of idx_1 and idx_2 may be based on the indexes of 2 antenna ports in the third group. In some embodiments, the values of idx_3 and idx_4 may be based on the indexes of the 2 antenna ports in the fourth group. In some embodiments, the values of idx_5, idx_6 may be based on the indexes of two out of the 4 antenna ports in the second group. In some embodiments, the values of idx_5, idx_6 may be based on the indexes of the 2 antenna ports in the fifth group. In some embodiments, the values of idx_5, idx_6 may be based on the indexes of the 2 antenna ports in the sixth group. For example, the value of idx_1, idx_2, idx_3, idx_4, idx_5, idx_6 may be 0, 1, 2, 3, 4, 5, respectively. For another example, the value of idx_1, idx_2, idx_3, idx_4, idx_5, idx_6 may be 1, 2, 3, 4, 5, 6, respectively. For example, the value of idx_1, idx_2, idx_3, idx_4, idx_5, idx_6 may be different from each other.

In some embodiments, if the terminal device 110 is indicated with number of layers is indicated as 6, there may be a fourth set of precoding matrixes corresponding to 6 layers. For example, there may be only one precoding matrix in the fourth set (e.g. non-coherent precoding matrix) corresponding to 6 layers.

In some embodiments, if there are 6 layers at the terminal device 110, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 2, 3, or 4) columns may be mapped with length-4 vectors, and 6-r1 column may be mapped with length-2 vectors, and with ports swapped.

In other embodiments, the antenna structure may be 4+1+1+1+1, which means that 4 antenna ports can be coherent. In this case, r1 (for example, 2 or 3 or 4) columns may be with length-4 vectors, 6-r1 columns may be with 1 on one element, and rows can be swap.

In some embodiments, the antenna structure may be 4+2+1+1, which means that 4 antenna ports can be coherent and 2 antenna ports can be coherent. For example, r1 (for example, 2 or 3 or 4) columns may be with length-4 vectors, and r2 (for example, 0,1,2) columns may be with length-2 vectors, and 6-r1-r2 columns may be with 1 on one element.

In some other embodiments, the antenna structure may be 2+2+1+1+1+1, which means that 2 antenna ports can be coherent and 2 antenna ports can be coherent. For example, r1 (for example, 2 or 3 or 4) columns may be with length-2 vectors, and 6-r1 columns may be with 1 on one element.

In some embodiments, the terminal device 110 is indicated with the number of layers as 5, there may be a first set of precoding matrixes corresponding to 5 layers (e.g. a first set of full coherent precoding matrixes), and a full coherent precoding matrix may be represented as

$${W}_{l , {l}^{′} , {l}^{″} , m , {m}^{′} , {m}^{″} , n}^{( 5 )} .$$

In some embodiments,

$${W}_{l , {l}^{′} , {l}^{″} , m , {m}^{′} , {m}^{″} , n}^{( 5 )}$$

may be

$$\frac{1}{\sqrt{5 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} * {v}_{l , m} & - {φ}_{n} * {v}_{l , m} & {φ}_{n} * {v}_{{l}^{′} , {m}^{′}} & - {φ}_{n} * {v}_{{l}^{′} , {m}^{′}} & {φ}_{n} * {v}_{{l}^{″} , {m}^{″}}\end{matrix} ] .$$

In some embodiments,

$${W}_{l , {l}^{′} , {l}^{″} , m , {m}^{′} , {m}^{″} , n}^{( 5 )}$$

may be

$$\frac{1}{\sqrt{5 * P}} [ \begin{matrix}{v}_{l , m} & {v}_{l , m} & {v}_{{l}^{′} , {m}^{′}} & {v}_{{l}^{′} , {m}^{′}} & {v}_{{l}^{″} , {m}^{″}} \\ {φ}_{n} * {v}_{l , m} & - {φ}_{n} * {v}_{l , m} & {v}_{{l}^{′} , {m}^{′}} & - {v}_{{l}^{′} , {m}^{′}} & {v}_{{l}^{″} , {m}^{″}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+O₁. In some embodiments, l″=l+2O₁. In some embodiments, m and m′ and m″ may be 0. In some embodiments, l′=l+O₁. In some embodiments, l″=l+O₁. In some embodiments, m′=m. In some embodiments, m″=m+O₂.

In some embodiments, there may be more than one subset of precoding matrixes corresponding to 5 layers. In some embodiments, the first set of precoding matrixes corresponding to 5 layers may comprise more than one subset. For example, there may be two subsets of precoding matrixes.

In some embodiments, there may be a first subset of precoding matrixes corresponding to 5 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ and m″ may be 0. In some embodiments, corresponding to the first subset, l′=l+O₁, l″=l+2O₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 5 layers may be 32 or 16 or 8 or 4 or 2.

In some embodiments, there may be a second subset of precoding matrixes corresponding to 5 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+O₁, l″=l+O₁. In some embodiments, corresponding to the second subset, m′=m, m″=m+O₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, the number of precoding matrixes in the second subset corresponding to 5 layers may be 128 or 32 or 16 or 8 or 4 or 2.

In some embodiments, N₁ may equal to 4, N2 equals to 1, O₁ may equal to 2 and O₂ may equal to 1 and i_{1,1} may be one of {0, . . . N101-1} or {0, 2, 4, 6} or {0, 4} or {0, 1} or 0 or {0, . . . N₁O₁/2−1} or {0, 2}. The first subset of precoding matrixes corresponding to 5 layers, e.g. “Set_f5_1” may comprise 16 precoding matrixes. In some embodiments, the first subset of precoding matrixes “Set_f5_1” may comprise 8 precoding matrixes. Alternatively, the first subset of precoding matrixes “Set_f5_1” may comprise 4 precoding matrixes. In other embodiments, the first subset of precoding matrixes “Set_f5_1” may comprise 2 precoding matrixes.

Alternatively, N₁ may equal to 2, N₂ equals to 2, O₁ may equal to 1 or 4, and O₂ may equal to 2 or 4, i_{1,1} or i_{1, 2} may be one of {0, . . . 7} or {0, 2, 4, 6} or {0, 4} or {0, . . . 3} or {0, 2} or {0,1} or 0. The second subset of precoding matrixes corresponding to 5 layers, e.g. “Set_f5_2” may comprise 128 precoding matrixes. In some embodiments, the second subset of precoding matrixes “Set_f5_2” may comprise 32 precoding matrixes. Alternatively, the second subset of precoding matrixes “Set_f5_2” may comprise 8 precoding matrixes. In other embodiments, the second subset of precoding matrixes “Set_f5_2” may comprise 2 precoding matrixes.

In some embodiments, the terminal device 110 is indicated with the number of layers as 5, there may be a second set of precoding matrixes corresponding to 5 layers (e.g. a second set of partial coherent precoding matrixes). For example, if the terminal device 110 has 8 antenna ports or if a PUSCH transmission of the terminal device 110 is associated with 8 antenna ports or if a PUSCH transmission of the terminal device 110 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 5 layers, for example, represented as “Set_p5_1”, and the size of a partial coherent precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C1 columns or rows out of the 5 columns or rows (e.g. a first set of C1 columns or rows. For example, C1 may be 1 or 2 or 3 or 4) in the precoding matrix, and in each column, the non-zero value may be mapped on 4 out of 8 elements and 0 for the other 4 elements. For example, the indexes of the 4 elements with non-zero values may be same in the first set of C1 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group. For example, idx_1 may be {0,1,2,3} or {0,2,4,6} or {1,2,3,4} or {1,3,5,7}. In some embodiments, for the other 5-C1 column, 5-C1 of the first set or second set of length-4 vectors may be selected. In some embodiments, for the other 5-C1 columns or rows out of the 5 columns or rows (e.g. a second set of 5-C1 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 5-C1 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, alternatively, 3 columns may be selected. In each column, the non-zero value may be mapped on 4 out of 8 elements, and 0 may be mapped for other 4 elements. For other 2 columns, one matrix and 2 vectors may be selected.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix.

In some embodiments, examples of a precoding matrix of the second set of precoding matrixes corresponding to 5 layers may be as:

$$\frac{1}{\sqrt{{s}_{5}}} [ \begin{matrix}a 1 & b 1 & c 1 & d 1 & 0 \\ a 2 & b 2 & c 2 & d 2 & 0 \\ a 3 & b 3 & c 3 & d 3 & 0 \\ a 4 & b 4 & c 4 & d 4 & 0 \\ 0 & 0 & 0 & 0 & e 1 \\ 0 & 0 & 0 & 0 & e 2 \\ 0 & 0 & 0 & 0 & e 3 \\ 0 & 0 & 0 & 0 & e 4\end{matrix} ] or \frac{1}{\sqrt{{s}_{5}}} [ \begin{matrix}a 1 & b 1 & c 1 & 0 & 0 \\ a 2 & b 2 & c 2 & 0 & 0 \\ a 3 & b 3 & c 3 & 0 & 0 \\ a 4 & b 4 & c 4 & 0 & 0 \\ 0 & 0 & 0 & d 1 & e 1 \\ 0 & 0 & 0 & d 2 & e 2 \\ 0 & 0 & 0 & d 3 & e 3 \\ 0 & 0 & 0 & d 4 & e 4\end{matrix} ] .$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [e1, e2, e3, e4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1; −1; −1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, [e1, e2, e3, e4] may be 1 vector out of [1; 1; 1; 1], [1; −1; 1; −1], [1; 1; −1; −1] and [1; −1; −1; 1]. For another example, [e1, e2, e3, e4] may be 1 vector out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, each of [d1, d2, d3, d4], [e1, e2, e3, e4] may be one of the length-4 vectors in the first set of length-4 vectors or in the second set of length-4 vectors. For example, [a1, a2, a3, a4], [b1, b2, b3, b4], [c1, c2, c3, c4] may be three vectors out of [1; 1; 1; 1], [1; −1; 1; −1], [1; 1; −1; −1] and [1; −1; −1; 1]. For another example, [a1, a2, a3, a4], [b1, b2, b3, b4], [c1, c2, c3, c4] may be three of [1; 1; j; j], [1; −1; j; −j], [1; 1; −j; −j] and [1; −1; −j; j]. For example, [d1, d2, d3, d4], [e1, e2, e3, e4] may be 2 vectors out of [1; 1; 1; 1], [1; −1; 1; −1], [1; 1; −1; −1] and [1; −1; −1; 1]. For another example, [d1, d2, d3, d4], [e1, e2, e3, e4] may be 2 vectors out of [1; 1; j; j], [1; −1; j; −j], [1; 1; −j; −j] and [1; −1; −j; j].

In some embodiments, s₅ may a positive integer. For example, 1≤s₅≤64. For example, s₅ may be 64 or 32 or 16 or 8 or 4 or 2 or 40 or 20 or 10.

In some embodiments, if the terminal device 110 is indicated with the number of layers as 5, there may be a third set of precoding matrixes (e.g. a third set of partial coherent precoding matrixes) corresponding to 5 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p5_2”, and the size of a precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 2 columns or rows out of the 5 columns or rows (e.g. a first set of 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 1 or 2 columns or rows out of the 5 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 5 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 or 2 columns or rows out of the 5 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 5. In some embodiments, there may be the first set, the second set and the third set, and each of two of the three sets with 2 columns or rows, and one of the three sets with 1 column or row. In some embodiments, there may be the first set, the second set, the third set and the fourth set, and one of the four sets with 2 columns or rows, and each of three of the fourth sets with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 5 layers, e.g. Set_p5_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in a column or row of the precoding matrix.

In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 5 layers may be as:

$$\frac{1}{\sqrt{{s}_{5}}} [ \begin{matrix}a 1 & b 1 & 0 & 0 & 0 \\ a 2 & b 2 & 0 & 0 & 0 \\ 0 & 0 & c 1 & d 1 & 0 \\ 0 & 0 & c 2 & d 2 & 0 \\ 0 & 0 & 0 & 0 & e 1 \\ 0 & 0 & 0 & 0 & e 2 \\ 0 & 0 & 0 & 0 & 0 \\ 0 & 0 & 0 & 0 & 0\end{matrix} ] or \frac{1}{\sqrt{{s}_{5}}} [ \begin{matrix}a 1 & b 1 & 0 & 0 & 0 \\ a 2 & b 2 & 0 & 0 & 0 \\ 0 & 0 & c 1 & 0 & 0 \\ 0 & 0 & c 2 & 0 & 0 \\ 0 & 0 & 0 & d 1 & 0 \\ 0 & 0 & 0 & d 2 & 0 \\ 0 & 0 & 0 & 0 & e 1 \\ 0 & 0 & 0 & 0 & e 2\end{matrix} ] .$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, [e1, e2], may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2]may be [1; j], [1; −j], respectively. For example, [c1, c2], [d1, d2], [e1, e2] may be any one of [1; 1], [1; −1], [1; j][1; −j].

In some embodiments, if the terminal device 110 is indicated with the number of layers as 5, there may be a fourth set of precoding matrixes (e.g. a fourth set of non-coherent precoding matrixes) corresponding to 5 layers. For example, each one of 8 antenna ports may be non-coherent with each other. In some embodiments, there may be a fourth set of precoding matrixes (e.g. a fourth set of non-coherent precoding matrixes), for example, represented as “Set_n5_1”, and the size of a precoding matrix may be 5 multiplies 8 or 8 multiplies 5. In some embodiments, there may be 5 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 5 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4, idx_5 for the first, second, third, fourth, fifth column or row of the precoding matrix, respectively, and for each one of idx_1, idx_2, idx_3, idx_4, idx_5 the value may be 1 value out of {0,1,2,3,4,5,6,7} or {1,2,3,4,5,6,7,8}. For example, the value of idx_1, idx_2, idx_3, idx_4, idx_5 may be 0, 1, 2, 3, 4, respectively. For another example, the value of idx_1, idx_2, idx_3, idx_4, idx_5, may be 1, 2, 3, 4, 5, respectively. For example, the value of idx_1, idx_2, idx_3, idx_4, idx_5 may be different from each other.

In some embodiments, if the terminal device 110 is indicated with number of layers is indicated as 5, there may be a fourth set of precoding matrixes corresponding to 5 layers. For example, there may be only one precoding matrix in the fourth set (e.g. non-coherent precoding matrix) corresponding to 6 layers.

In some embodiments, if there are 5 layers at the terminal device 110, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 1, 2, 3, or 4) columns may be mapped with length-4 vectors, and 5-r1 column may be mapped with length-2 vectors, and with ports swapped.

In other embodiments, the antenna structure may be 4+1+1+1+1, which means that 4 antenna ports can be coherent. In this case, r1 (for example, 1 or 2 or 3 or 4) columns may be with length-4 vectors, 5-r1 columns may be with 1 on one element, and rows can be swap.

In some embodiments, the antenna structure may be 4+2+1+1, which means that 4 antenna ports can be coherent and 2 antenna ports can be coherent. For example, r1 (for example, 1 or 2 or 3 or 4) columns may be with length-4 vectors, and r2 (for example, 0,1,2) columns may be with length-2 vectors, and 5-r1-r2 columns may be with 1 on one element.

In some other embodiments, the antenna structure may be 2+2+1+1+1+1, which means that 2 antenna ports can be coherent and 2 antenna ports can be coherent. For example, r1 (for example, 1 or 2 or 3 or 4) columns may be with length-2 vectors, and 5-r1 columns may be with 1 on one element.

In some embodiments, the terminal device 110 is indicated with the number of layers as 4, there may be a first set of precoding matrixes corresponding to 4 layers (e.g. a first set of full coherent precoding matrixes). In some embodiments, a full coherent precoding matrix may be represented as

$${W}_{l , {l}^{′} , m , {m}^{′} , n}^{( 4 )} .$$

In some embodiments,

$${W}_{l , {l}^{′} , m , {m}^{′} , n}^{( 4 )}$$

may be

$$\frac{1}{\sqrt{4 * P}} [ \begin{matrix}{v}_{l , m} & {v}_{{l}^{′} , {m}^{′}} & {v}_{l , m} & {v}_{{l}^{′} , {m}^{′}} \\ {φ}_{n} * {v}_{l , m} & {φ}_{n} * {v}_{{l}^{′} , {m}^{′}} & - {φ}_{n} * {v}_{l , m} & - {φ}_{n} * {v}_{{l}^{′} , {m}^{′}}\end{matrix} ] .$$

In some embodiments, P may be 8 or 12 or 16. In some embodiments, l may be a non-negative integer. For example, 0 l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, O₁, 2O₁, 3O₁}. For another example, k₁ may be 0. In some embodiments, k₂ may be a non-negative integer. For example, k₂ may at least one of {0, O₂}. In some embodiments, k₂ may be 0.

In some embodiments, there may be a parameter i_{1,3}, and the value of k₁ and/or k₂ may be based on the value of i_{1,3}, and i_{1,3} may be anon-negative integer. For example, i_{1,3} may be at least one of {0,1,2,3}. For another example, i_{1,3} may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=O₁ and/or k₂=0. In some embodiments, in case of N₁=4 and N₂=1, and in case of i_{1,3}=2, k₁=2O₁ and/or k₂=0. In some embodiments, in case of N₁=4 and N₂=1, and in case of i_{1,3}=3, k₁=3O₁ and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=O₁ and/or k₂=0.

In some embodiments, there may be more than one subset of precoding matrixes corresponding to 4 layers. In some embodiments, the first set of precoding matrixes corresponding to 4 layers may comprise more than one subset. For example, there may be two or three or four subsets of precoding matrixes.

In some embodiments, there may be a first subset of precoding matrixes corresponding to 4 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 4 layers may be 128 or 64 or 32 or 16 or 8 or 4 or 2.

In some embodiments, there may be a second subset of precoding matrixes corresponding to 4 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 4 layers may be 256 or 128 or 32 or 16 or 8 or 4 or 2.

In some embodiments, N₁ may equal to 4, N₂ equals to 1, O₁ may equal to 4 or 2 or 1 and O₂ may equal to 1 and i_{1,1} may be one of {0, . . . N₁O₁−1} or {0, 2, 4, 6} or {0, 4} or {0, 1} or 0 or {0, . . . N₁O₁/2−1} or {0, 2}. The first subset of precoding matrixes corresponding to 4 layers, e.g. “Set_f4_1” may comprise 16 precoding matrixes. In some embodiments, the first subset of precoding matrixes “Set_f4_1” may comprise 8 precoding matrixes. Alternatively, the first subset of precoding matrixes “Set_f4_1” may comprise 4 precoding matrixes. In other embodiments, the first subset of precoding matrixes “Set_f4_1” may comprise 2 precoding matrixes.

Alternatively, N₁ may equal to 2, N₂ may equal to 2, O₁ may equal to 1 or 2 or 4, and O₂ may equal to 1 or 2 or 4, i_{1,3} may be 0 or 1 or 2 or 3, i_{1,1} or i_{1, 2} may be one of {0, . . . 3} or {0, 2} or 0. In some embodiments, the second subset of precoding matrixes corresponding to 4 layers, e.g. “Set_f4_2” may comprise 32 precoding matrixes. Alternatively, the second subset of precoding matrixes “Set_f4_2” may comprise 8 precoding matrixes. In other embodiments, the second subset of precoding matrixes “Set_f4_2” may comprise 2 precoding matrixes.

In some embodiments, there may be a second factor ap. In some embodiments,

$${a}_{p} = {e}^{j \frac{π}{4}} * {e}^{j \frac{π p}{2}} .$$

In some embodiments, p may be a non-negative integer. For example, p may be at least one of {0, 1, 2, 3}. For another example, p may be 0 or 1. For another example, p may be 0 or 2. For another example, p may be 0.

In some embodiments, if the terminal device 110 is indicated with the number of layers as 4, there may be a third subset or a fourth subset of precoding matrixes. In some embodiments, there may be a third factor b1_{b}. In some embodiments,

$${b}_{n \_ b} = {e}^{- j \frac{π}{4}} * {e}^{j \frac{π n \_ b}{2}} .$$

In some embodiments, n_b may be a non-negative integer. For example, n_b may be at least one of {0, 1, 2, 3}. For another example, n_b may be 0 or 1. For another example, n_b may be 0 or 2. For another example, n_b may be 0.

In some embodiments, there may be a third vector

$${W}_{l , m , p , n}^{1 , 2 , 1} .$$

In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

there may be a fourth vector

$${W}_{l , m , p , n}^{2 , 2 , 1} .$$

In some embodiments,

$${W}_{l , m , p , n}^{2 , 2 , 1} = \frac{1}{\sqrt{8}} [ {v}_{l , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of k₁ and/or k₂ may be based on the value of i_{1,3}, and i_{1,3} may be anon-negative integer. For example, i_{1,3} may be at least one of {0,1}. For another example, i_{1,3} may be 0. In some embodiments, in case of N₁=2 and N₂=1, and in case of i_{1,3}=0, k₁=O₁ and/or k₂=0.

In some embodiments, there may be a third subset of precoding matrixes corresponding to 4 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 4 layers may be 64 or 32 or 16 or 8 or 4 or 2. In some embodiments, the terminal device 110 may be indicated with the number of layers as 4, a precoding matrix in the third subset of precoding matrixes corresponding to 4 layers may be represented as

$${W}_{l , {l}^{′} , m , {m}^{′} , p , n}^{( 4 )} .$$

In some embodiments,

$${W}_{l , {l}^{′} , m , {m}^{′} , p , n}^{( 4 )}$$

may be

$$\frac{1}{\sqrt{4}} [ {W}_{l , m , p , n}^{1 , 2 , 1} {W}_{{l}^{′} , {m}^{′} , p , n}^{1 , 2 , 1} {W}_{l , m , p , n}^{2 , 2 , 1} {W}_{{l}^{′} , {m}^{′} , p , n}^{2 , 2 , 1} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p₁.

In some embodiments, there may be a fifth vector

$${W}_{l , m , p , n}^{1 , 2 , 2} .$$

In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments, there may be a sixth vector

$${W}_{l , m , p , n}^{2 , 2 , 2} .$$

In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 4 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 4 layers may be 64 or 32 or 16 or 8 or 4 or 2. In some embodiments, the terminal device 110 may be indicated with the number of layers as 4, a precoding matrix in the fourth subset of precoding matrixes corresponding to 4 layers may be represented as

$${W}_{l , {l}^{′} , m , {m}^{′} , p , n}^{( 4 )} .$$

In some embodiments,

$${W}_{l , {l}^{′} , m , {m}^{′} , p , n}^{( 4 )}$$

may be

$$\frac{1}{\sqrt{4}} [ \begin{matrix}{W}_{l , m , p , n}^{1 , 2 , 2} & {W}_{{l}^{′} , {m}^{′} , p , n}^{1 , 2 , 2} & {W}_{l , m , p , n}^{2 , 2 , 2} & {W}_{{l}^{′} , {m}^{′} , p , n}^{2 , 2 , 2}\end{matrix} ] .$$

In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110 is indicated with the number of layers is indicated as 4, there may be a second set of precoding matrixes corresponding to 4 layers (e.g. a second set of partial coherent precoding matrixes). For example, if the terminal device 110 has 8 antenna ports or if a PUSCH transmission of the terminal device 110 is associated with 8 antenna ports or if a PUSCH transmission of the terminal device 110 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 4 layers, for example, represented as “Set_p4_1”, and the size of a partial coherent precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C2 columns or rows out of the 4 columns or rows (e.g. a first set of C2 columns or rows. For example, C2 may be 1 or 2 or 3 or 4) in the precoding matrix, and in each column, the non-zero value may be mapped on 4 out of 8 elements and 0 for the other 4 elements. For example, the indexes of the 4 elements with non-zero values may be same in the first set of C2 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group. For example, idx_1 may be {0,1,2,3} or {0,2,4,6} or {1,2,3,4} or {1,3,5,7}. In some embodiments, for the other 4-C2 column, 4-C2 of the first set or second set of length-4 vectors may be selected. In some embodiments, for the other 4-C2 columns or rows out of the 4 columns or rows (e.g. a second set of 4-C2 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 4-C2 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the second group. For example, idx_2 may be {4,5,6,7} or {1,3,5,7} or {5,6,7,8} or {2,4,6,8}. In some embodiments, any value of idx_1 may be different from any value of idx_2. In some embodiments, C2 may be 4 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments, examples of a precoding matrix of the second set of precoding matrixes corresponding to 4 layers may be as:

$$\frac{1}{\sqrt{{s}_{4}}} [ \begin{matrix}a 1 & b 1 & c 1 & d 1 \\ a 2 & b 2 & c 2 & d 2 \\ a 3 & b 3 & c 3 & d 3 \\ a 4 & b 4 & c 4 & d 4 \\ 0 & 0 & 0 & 0 \\ 0 & 0 & 0 & 0 \\ 0 & 0 & 0 & 0 \\ 0 & 0 & 0 & 0\end{matrix} ] or \frac{1}{\sqrt{{s}_{4}}} [ \begin{matrix}a 1 & b 1 & c 1 & 0 \\ a 2 & b 2 & c 2 & 0 \\ a 3 & b 3 & c 3 & 0 \\ a 4 & b 4 & c 4 & 0 \\ 0 & 0 & 0 & d 1 \\ 0 & 0 & 0 & d 2 \\ 0 & 0 & 0 & d 3 \\ 0 & 0 & 0 & d 4\end{matrix} ] or$$

$$\frac{1}{\sqrt{{s}_{4}}} [ \begin{matrix}a 1 & b 1 & 0 & 0 \\ a 2 & b 2 & 0 & 0 \\ a 3 & b 3 & 0 & 0 \\ a 4 & b 4 & 0 & 0 \\ 0 & 0 & c 1 & e 1 \\ 0 & 0 & c 2 & e 2 \\ 0 & 0 & c 3 & e 3 \\ 0 & 0 & c 4 & e 4\end{matrix} ] or \frac{1}{\sqrt{{s}_{4}}} [ \begin{matrix}a 1 & 0 & 0 & 0 \\ a 2 & 0 & 0 & 0 \\ a 3 & 0 & 0 & 0 \\ a 4 & 0 & 0 & 0 \\ 0 & b 1 & c 1 & d 1 \\ 0 & b 2 & c 2 & d 2 \\ 0 & b 3 & c 3 & d 3 \\ 0 & b 4 & c 4 & d 4\end{matrix} ] .$$

For example, rows or columns can be swapped. For example, rows or columns can be swapped. For example, each of [a1, a2, a3, a4], [b1, b2, b3, b4], [c1, c2, c3, c4] and [d1, d2, d3, d4] may be one of the length-4 vectors in the first set of length-4 vectors or in the second set of length-4 vectors. For example, [a1, a2, a3, a4], [b1, b2, b3, b4], [c1, c2, c3, c4] and [d1, d2, d3, d4] may be [1; 1; 1; 1], [1; −1; 1; −1], [1; 1; −1; −1] and [1; −1; −1; 1], respectively. For another example, [a1, a2, a3, a4], [b1, b2, b3, b4], [c1, c2, c3, c4] and [d1, d2, d3, d4] may be [1; 1; j; j], [1; −1; j; −j], [1; 1; −j; −j] and [1; −1; −j; j], respectively. For example, each of [a1, a2, a3, a4], [b1, b2, b3, b4], [c1, c2, c3, c4] may be one of the length-4 vectors in the first set of length-4 vectors or in the second set of length-4 vectors. For example, [d1, d2, d3, d4] may be one of the length-4 vectors in the first set of length-4 vectors or in the second set of length-4 vectors. For example, [a1, a2, a3, a4], [b1, b2, b3, b4], may be two vectors out of [1; 1; 1; 1], [1; −1; 1; −1], [1; 1; −1; −1] and [1; −1; −1; 1]. For another example, [a1, a2, a3, a4], [b1, b2, b3, b4], may be two of [1; 1; j; j], [1; −1; j; −j], [1; 1; −j; −j] and [1; −1; −j; j]. For example, [c1, c2, c3, c4], [d1, d2, d3, d4] may be 2 vectors out of [1; 1; 1; 1], [1; −1; 1; −1], [1; 1; −1; −1] and [1; −1; −1; 1]. For another example, [c1, c2, c3, c4], [d1, d2, d3, d4] may be 2 vectors out of [1; 1; j; j], [1; −1; j; −j], [1; 1; −j; −j] and [1; −1; −j; j].

In some embodiments, s₄ may a positive integer. For example, 1≤s₄≤64. For example, s₄ may be 64 or 32 or 16 or 8 or 4 or 2 or 32 or 16 or 8.

In some embodiments, N_{g} may equal to 2, N₁ may equal to 2, N₂ equals to 1, O₁ may equal to 2 or 4, i_{1,3} may be 0, and i_{1,1} may be one of {0, . . . N₁O₁−1} or {0, 2, 4, 6} or {0, 4} or {0,2} or {0,1} or 0, or i_{1,4}, may be one of {0, 1, 2, 3} or {0,2} or 0. In some embodiments, the third subset of precoding matrixes corresponding to 4 layers, e.g. “Set_f4_3” may comprise 64 precoding matrixes. In some embodiments, the third subset of precoding matrixes “Set_f4_3” may comprise 32 precoding matrixes. The third subset of precoding matrixes “Set_f4_3” may comprise 16 precoding matrixes. In some embodiments, the third subset of precoding matrixes “Set_f4_3” may comprise 8 precoding matrixes. Alternatively, the third subset of precoding matrixes “Set_f4_3” may comprise 4 precoding matrixes. In other embodiments, the third subset of precoding matrixes “Set_f4_3” may comprise 2 precoding matrixes.

In some embodiments, N_{g} may equal to 2, N₁ may equal to 2, N₂ equals to 1, O₁ may equal to 2 or 4, i_{1,3} may be 0, and i_{1,1} may be one of {0, . . . N₁O₁−1} or {0, 2, 4, 6} or {0, 4} or {0, 2} or {0, 1}, or i_{1,4,q} may be one of {0, 1, 2, 3} or {0,2} or 0, where q may be 0 or 1. In some embodiments, the fourth subset of precoding matrixes corresponding to 4 layers, e.g. “Set_f44” may comprise 256 precoding matrixes. In some embodiments, the fourth subset of precoding matrixes “Set_f4_4” may comprise 128 precoding matrixes. In some embodiments, the fourth subset of precoding matrixes “Set_f4_4” may comprise 64 precoding matrixes. In some embodiments, the fourth subset of precoding matrixes “Set_f4_4” may comprise 32 precoding matrixes. The fourth subset of precoding matrixes “Set_f4_4” may comprise 16 precoding matrixes. In some embodiments, the fourth subset of precoding matrixes “Set_f4_4” may comprise 8 precoding matrixes. Alternatively, the fourth subset of precoding matrixes “Set_f4_4” may comprise 4 precoding matrixes. In other embodiments, the fourth subset of precoding matrixes “Set_f4_4” may comprise 2 precoding matrixes.

In some embodiments, if the terminal device 110 is indicated with the number of layers is indicated as 4, there may be a third set of precoding matrixes (e.g. a third set of partial coherent precoding matrixes) corresponding to 4 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p4_2”, and the size of a precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 4 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group. For example, idx_1 may be {0,1} or {0, 2} or {1, 2} or {1, 3} or {0, 4} or {1, 5}. In some embodiments, there may be 1 or 2 columns or rows out of the 4 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of remaining two of the 4 antenna ports in the first group. In some embodiments, the 2 values of idx_2 may be based on the indexes of the 2 antenna ports in the fourth group. For example, idx_2 may be {2,3} or {1,3} or {3,4} or {2,4} or {1,5} or {2,6}. In some embodiments, there may be 1 or 2 columns or rows out of the 4 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. In some embodiments, the 2 values of idx_3 may be based on the indexes of two out of the 4 antenna ports in the second group. In some embodiments, the 2 values of idx_3 may be based on the indexes of the 2 antenna ports in the fifth group. For example, idx_3 may be {4,5} or {4,6} or {5,6} or {5,7} or {2,6} or {3,7}. In some embodiments, there may be 1 or 2 columns or rows out of the 4 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two out of the 4 antenna ports in the second group. In some embodiments, the 2 values of idx_4 may be based on the indexes of the 2 antenna ports in the sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, the total number of columns or rows in the first set and/or the second set and/or the third set and/or the fourth set may be 4. In some embodiments, there may be the first set and the second set, and each set with 2 columns or rows. In some embodiments, there may be the first set, the second set and the third set, and each of two of the three sets with 2 columns or rows, and one of the three sets with 1 column or row. In some embodiments, there may be the first set, the second set, the third set and the fourth set, and each set with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 4 layers, e.g. Set_p4_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in a column or row of the precoding matrix. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 4 layers may be as:

$$\frac{1}{\sqrt{{s}_{4}}} [ \begin{matrix}a 1 & b 1 & 0 & 0 \\ a 2 & b 2 & 0 & 0 \\ 0 & 0 & c 1 & d 1 \\ 0 & 0 & c 2 & d 2 \\ 0 & 0 & 0 & 0 \\ 0 & 0 & 0 & 0 \\ 0 & 0 & 0 & 0 \\ 0 & 0 & 0 & 0\end{matrix} ] or \frac{1}{\sqrt{{s}_{4}}} [ \begin{matrix}a 1 & b 1 & 0 & 0 \\ a 2 & b 2 & 0 & 0 \\ 0 & 0 & c 1 & 0 \\ 0 & 0 & c 2 & 0 \\ 0 & 0 & 0 & d 1 \\ 0 & 0 & 0 & d 2 \\ 0 & 0 & 0 & 0 \\ 0 & 0 & 0 & 0\end{matrix} ] or \frac{1}{\sqrt{{s}_{4}}} [ \begin{matrix}a 1 & 0 & 0 & 0 \\ a 2 & 0 & 0 & 0 \\ 0 & b 1 & 0 & 0 \\ 0 & b 2 & 0 & 0 \\ 0 & 0 & c 1 & 0 \\ 0 & 0 & c 2 & 0 \\ 0 & 0 & 0 & d 1 \\ 0 & 0 & 0 & d 2\end{matrix} ] .$$

For example, rows or columns can be swapped. For example, each of [a1, a2], [b1, b2] may be one of the length-2 vectors in the first set of length-2 vectors or in the second set of length-2 vectors. For example, each of [c1, c2] and [d1, d2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [c1, c2] and [d1, d2] may be [1; 1], [1; −1], respectively. For another example, [c1, c2] and [d1, d2] may be [1; j], [1; −j], respectively. For example, [a1, a2], [b1, b2], [c1, c2], [d1, d2] may be any one of [1; 1], [1; −1], [1; j], [1; −j].

In some embodiments, if the terminal device 110 is indicated with the number of layers is indicated as 4, there may be a fourth set of precoding matrixes (e.g. a fourth set of non-coherent precoding matrixes) corresponding to 4 layers. For example, each one of 8 antenna ports may be non-coherent with each other. In some embodiments, there may be a fourth set of precoding matrixes (e.g. a fourth set of non-coherent precoding matrixes), for example, represented as “Set_n4_1”, and the size of a precoding matrix may be 4 multiplies 8 or 8 multiplies 4. In some embodiments, there may be 4 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 4 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3, idx_4 for the first, second, third, fourth column or row of the precoding matrix, respectively, and for each one of idx_1, idx_2, idx_3, idx_4, the value may be 1 value out of {0,1,2,3,4,5,6,7} or {1,2,3,4,5,6,7,8}. For example, the value of idx_1, idx_2, idx_3, idx_4 may be {0, 1, 2, 3} or {0,2,4,6} or {4,5,6,7} or {1,3,5,7}, respectively. For another example, the value of idx_1, idx_2, idx_3, idx_4 may be {1, 2, 3, 4} or {5,6,7,8} or {1,3,5,7} or {2,4,6,8}, respectively. For example, the value of idx_1, idx_2, idx_3, idx_4 may be different from each other. In some embodiments, the values of idx_1, idx_2, idx_3, idx_4 may be based on the indexes of the 4 antenna ports in the first group or the second group.

In some embodiments, if the terminal device 110 is indicated with number of layers as 4 there may be a fourth set of precoding matrixes corresponding to 4 layers. For example, there may be one or two or four precoding matrixes in the fourth set (e.g. non-coherent precoding matrix) corresponding to 4 layers.

In some embodiments, if there are 4 layers at the terminal device 110, a mixed partial coherent matrix may be supported. For example, the antenna structure may be 4+2+2, which means that 4 antenna ports can be coherent, 2 antenna ports can be coherent, and the other 2 antenna ports can be coherent. In this case, r1 (for example, 1, 2, or 3) columns may be mapped with length-4 vectors, and 4-r1 column may be mapped with length-2 vectors, and with ports swapped.

In other embodiments, the antenna structure may be 4+1+1+1+1, which means that 4 antenna ports can be coherent. In this case, r1 (for example, 1 or 2 or 3) columns may be with length-4 vectors, 4-r1 columns may be with 1 on one element, and rows can be swap.

In some embodiments, the antenna structure may be 4+2+1+1, which means that 4 antenna ports can be coherent and 2 antenna ports can be coherent. For example, r1 (for example, 1 or 2) columns may be with length-4 vectors, and r2 (for example, 1 or 2) columns may be with length-2 vectors, and 4-r1-r2 columns may be with 1 on one element.

In some other embodiments, the antenna structure may be 2+2+1+1+1+1, which means that 2 antenna ports can be coherent and 2 antenna ports can be coherent. For example, r1 (for example, 1 or 2 or 3) columns may be with length-2 vectors, and 4-r1 columns may be with 1 on one element. In some other embodiments, the antenna structure may be 2+1+1+1+1+1+1. Alternatively, the antenna structure may be 2+2+2+1+1.

In some embodiments, the terminal device 110 is indicated with the number of layers as 3, there may be a first set of precoding matrixes corresponding to 3 layers (e.g. a first set of full coherent precoding matrixes). In some embodiments, a full coherent precoding matrix may be represented as W

$${W}_{l , {l}^{′} , m , {m}^{′} , n}^{( 3 )} .$$

In some embodiments,

$${W}_{l , {l}^{′} , m , {m}^{′} , n}^{( 3 )}$$

may be

$$\frac{1}{\sqrt{3 * P}} [ \begin{matrix}{v}_{l , m} & {v}_{{l}^{′} , {m}^{′}} & {v}_{l , m} \\ {φ}_{n} * {v}_{l , m} & {φ}_{n} * {v}_{{l}^{′} , {m}^{′}} & - {φ}_{n} * {v}_{l , m}\end{matrix} ] .$$

In some embodiments, P may be 8 or 12 or 16. In some embodiments, l may be a non-negative integer. For example, 0 l≤O₁N₁. For another example, 0≤l≤O₁N₁/2. For another example, l may be at least one of {0, 2, 4, 6, 8}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6, 8}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, O₁, 2O₁, 3O₁}. For another example, k₁ may be 0. In some embodiments, k₂ may be a non-negative integer. For example, k₂ may at least one of {0, 0₂}. In some embodiments, k₂ may be 0.

In some embodiments, there may be a parameter i_{1,3}, and the value of k₁ and/or k₂ may be based on the value of i_{1,3}, and i_{1,3} may be anon-negative integer. For example, i₁₃ may be at least one of {0,1,2,3}. For another example, i₁₃ may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=O₁ and/or k₂=0. In some embodiments, in case of N₁=4 and N₂=1, and in case of i₁,3=2, k₁=2O₁ and/or k₂=0. In some embodiments, in case of N₁=4 and N₂=1, and in case of i_{1,3}=3, k₁=3O₁ and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=O₁ and/or k₂=0.

In some embodiments, there may be more than one subset of precoding matrixes corresponding to 3 layers. In some embodiments, the first set of precoding matrixes corresponding to 3 layers may comprise more than one subset. For example, there may be two or three or four subsets of precoding matrixes.

In some embodiments, there may be a first subset of precoding matrixes corresponding to 3 layers, and corresponding to the first subset of precoding matrixes, the value of “N₁” may be 4, the value of “N2” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 3 layers may be 128 or 64 or 32 or 16 or 8 or 4 or 2.

In some embodiments, there may be a second subset of precoding matrixes corresponding to 3 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 3 layers may be 256 or 128 or 32 or 16 or 8 or 4 or 2.

In some embodiments, if the terminal device 110 is indicated with the number of layers as 3, there may be a third subset of precoding matrixes. In some embodiments, In some embodiments, there may be a third vector

$${W}_{l , m , p , n}^{1 , 2 , 1} .$$

In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, there may be a fourth vector

$${W}_{l , m , p , n}^{2 , 2 , 1} .$$

In some embodiments,

$${W}_{l , m , p , n}^{2 , 2 , 1} = \frac{1}{\sqrt{8}} [ {v}_{l , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of k₁ and/or k₂ may be based on the value of i_{1,3}, and i_{1,3} may be anon-negative integer. For example, i_{1,3} may be at least one of {0,1}. For another example, i_{1,3} may be 0. In some embodiments, in case of N₁=2 and N₂=1, and in case of i_{1,3}=0, k₁=O₁ and/or k₂=0.

In some embodiments, there may be a third subset of precoding matrixes corresponding to 3 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 3 layers may be 64 or 32 or 16 or 8 or 4 or 2.

In some embodiments, the terminal device 110 may be indicated with the number of layers as 3, a precoding matrix in the third subset of precoding matrixes corresponding to 3 layers may be represented as

$${W}_{l , {l}^{′} , m , {m}^{′} , p , n}^{( 3 )} .$$

In some embodiments,

$${W}_{l , {l}^{′} , m , {m}^{′} , p , n}^{( 3 )}$$

may be

$$\frac{1}{\sqrt{3}} [ {W}_{l , m , p , n}^{1 , 2 , 1} {W}_{{l}^{′} , {m}^{′} , p , n}^{1 , 2 , 1} {W}_{l , m , p , n}^{2 , 2 , 1} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p₁.

In some embodiments, if the terminal device 110 is indicated with the number of layers as 3, there may be a fourth subset of precoding matrixes. In some embodiments, In some embodiments, there may be a fifth vector

$${W}_{l , m , p , n}^{1 , 2 , 2} .$$

In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments, there may be a sixth vector

$${W}_{l , m , p , n}^{2 , 2 , 2} .$$

In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ]$$

N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 3 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 3 layers may be 64 or 32 or 16 or 8 or 4 or 2.

In some embodiments, the terminal device 110 may be indicated with the number of layers as 3, a precoding matrix in the fourth subset of precoding matrixes corresponding to 3 layers may be represented as

$${W}_{l , {l}^{′} , m , {m}^{′} , p , n}^{( 3 )} .$$

In some embodiments,

$${W}_{l , {l}^{′} , m , {m}^{′} , p , n}^{( 3 )}$$

may be

$$\frac{1}{\sqrt{3}} [ {W}_{l , m , p , n}^{1 , 2 , 2} {W}_{{l}^{′} , {m}^{′} , p , n}^{1 , 2 , 2} {W}_{l , m , p , n}^{2 , 2 , 2} ] .$$

In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110 is indicated with the number of layers is indicated as 3, there may be a second set of precoding matrixes corresponding to 3 layers (e.g. a second set of partial coherent precoding matrixes). For example, if the terminal device 110 has 8 antenna ports or if a PUSCH transmission of the terminal device 110 is associated with 8 antenna ports or if a PUSCH transmission of the terminal device 110 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 3 layers, for example, represented as “Set_p3_1”, and the size of a partial coherent precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C3 columns or rows out of the 3 columns or rows (e.g. a first set of C3 columns or rows. For example, C3 may be 1 or 2 or 3) in the precoding matrix, and in each column, the non-zero value may be mapped on 4 out of 8 elements and 0 for the other 4 elements. For example, the indexes of the 4 elements with non-zero values may be same in the first set of C3 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or the second group. For example, idx_1 may be {0,1,2,3} or {0,2,4,6} or {1,2,3,4} or {1,3,5,7}. In some embodiments, for the other 3-C3 column, 3-C3 of the first set or second set of length-4 vectors may be selected. In some embodiments, for the other 3-C3 columns or rows out of the 3 columns or rows (e.g. a second set of 3-C3 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 3-C3 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group or the second group. For example, idx_2 may be {4,5,6,7} or {1,3,5,7} or {5,6,7,8} or {2,4,6,8}. In some embodiments, any value of idx_1 may be different from any value of idx_2. In some embodiments, C3 may be 3 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix.

In some embodiments, examples of a precoding matrix of the second set of precoding matrixes corresponding to 3 layers may be as:

$$\frac{1}{\sqrt{{s}_{3}}} [ \begin{matrix}a 1 & b 1 & c 1 \\ a 2 & b 2 & c 2 \\ a 3 & b 3 & c 3 \\ a 4 & b 4 & c 4 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}a 1 & b 1 & 0 \\ a 2 & b 2 & 0 \\ a 3 & b 3 & 0 \\ a 4 & b 4 & 0 \\ 0 & 0 & c 1 \\ 0 & 0 & c 2 \\ 0 & 0 & c 3 \\ 0 & 0 & c 4\end{matrix} ] or \frac{1}{\sqrt{{s}_{3}}} [ \begin{matrix}a 1 & 0 & 0 \\ a 2 & 0 & 0 \\ a 3 & 0 & 0 \\ a 4 & 0 & 0 \\ 0 & b 1 & c 1 \\ 0 & b 2 & c 2 \\ 0 & b 3 & c 3 \\ 0 & b 4 & c 4\end{matrix} ] .$$

For example, rows or columns can be swapped. For example, rows or columns can be swapped. For example, each of [a1, a2, a3, a4], [b1, b2, b3, b4], [c1, c2, c3, c4] may be one of the length-4 vectors in the first set of length-4 vectors or in the second set of length-4 vectors. For example, [a1, a2, a3, a4], [b1, b2, b3, b4], [c1, c2, c3, c4] may be three out of [1; 1; 1; 1], [1; −1; 1; −1], [1; 1; −1; −1] and [1; −1; −1; 1]. For another example, [a1, a2, a3, a4], [b1, b2, b3, b4], [c1, c2, c3, c4] may be three out of [1; 1; j; j], [1; −1; j; −j], [1; 1; −j; −j] and [1; −1; −j; j]. For example, each of [a1, a2, a3, a4], [b1, b2, b3, b4], [c1, c2, c3, c4] may be one of the length-4 vectors in the first set of length-4 vectors or in the second set of length-4 vectors. For example, [a1, a2, a3, a4], [b1, b2, b3, b4], may be two vectors out of [1; 1; 1; 1], [1; −1; 1; −1], [1; 1; −1; −1] and [1; −1; −1; 1]. For another example, [a1, a2, a3, a4], [b1, b2, b3, b4], may be two of [1; 1; j; j], [1; −1; j; −j], [1; 1; −j; −j] and [1; −1; −j; j]. For example, [c1, c2, c3, c4] may be 1 vector out of [1; 1; 1; 1], [1; −1; 1; −1], [1; 1; −1; −1] and [1; −1; −1; 1]. For another example, [c1, c2, c3, c4] may be 1 vector out of [1; 1; j; j], [1; −1; j; −j], [1; 1; −j; −j] and [1; −1; −j; j].

In some embodiments, s₃ may a positive integer. For example, 1≤s₃≤64. For example, s₃ may be 64 or 32 or 16 or 8 or 4 or 2 or 24 or 12 or 6 or 3.

In some embodiments, if the terminal device 110 is indicated with the number of layers is indicated as 3, there may be a third set of precoding matrixes (e.g. a third set of partial coherent precoding matrixes) corresponding to 3 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p3_2”, and the size of a precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 3 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group. In some embodiments, the 2 values of idx_1 may be based on the indexes of the 2 antenna ports in the third group or fourth group or fifth group or sixth group. For example, idx_1 may be {0,1} or {0, 2} or {1, 2} or {1, 3} or {0, 4} or {1, 5}. In some embodiments, there may be 1 or 2 columns or rows out of the 3 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 2 values out of {0,1,2,3,4,5,6,7} or {1,2,3,4,5,6,7,8}. In some embodiments, the 2 values of idx_2 may be based on the indexes of two out of the 4 antenna ports in the first group or second group. In some embodiments, the 2 values of idx_2 may be based on the indexes of the 2 antenna ports in the third group or fourth group or fifth group or sixth group. For example, idx_2 may be {2,3} or {1,3} or {3,4} or {2,4} or {1,5} or {2,6}. In some embodiments, there may be 1 or 2 columns or rows out of the 3 columns or rows (e.g. a third set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the third set of 1 or 2 columns or rows. For example, the indexes of the 2 elements with non-zero values may be idx_3, and idx_3 may be 2 values out of {0,1,2,3,4,5,6,7} or {1,2,3,4,5,6,7,8}. For example, idx_3 may be {4,5} or {4,6} or {5,6} or {5,7} or {2,6} or {3,7}. In some embodiments, the 2 values of idx_3 may be based on the indexes of two out of the 4 antenna ports in the first group or second group. In some embodiments, the 2 values of idx_3 may be based on the indexes of the 2 antenna ports in the third group or fourth group or fifth group or sixth group. In some embodiments, there may be 1 or 2 columns or rows out of the 3 columns or rows (e.g. a fourth set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the fourth set of 1 or 2 columns or rows. For example, the indexes of the 2 elements with non-zero values may be idx_4, and idx_4 may be 2 values out of {0,1,2,3,4,5,6,7} or {1,2,3,4,5,6,7,8}. In some embodiments, the 2 values of idx_4 may be based on the indexes of remaining two out of the 4 antenna ports in the first group or second group. In some embodiments, the 2 values of idx_4 may be based on the indexes of the 2 antenna ports in the third group or fourth group or fifth group or sixth group. For example, idx_4 may be {6,7} or {5,7} or {7,8} or {6,8} or {3,7} or {4,8}. In some embodiments, any value of idx_1, any value of idx_2, any value of idx_3 and any value of idx_4 may be different from each other. In some embodiments, there may be three out of the first set and the second set and the third set and the fourth set. In some embodiments, the total number of columns or rows in the first set and/or the second set and/or the third set and/or the fourth set may be 3. In some embodiments, there may be two out of the four sets, and one set with 2 columns or rows, and the other set with 1 column or row. In some embodiments, there may be three of the four sets, and each set with 1 column or row.

In some embodiments, there may be a set of 4 length-2 vectors, and each one of the length-2 vector may be applied as the two non-zero values in a column or row of the precoding matrix. In some embodiments, for the third set of precoding matrix corresponding to 3 layers, e.g. Set_p3_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in a column or row of the precoding matrix. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 3 layers may be as:

$$\frac{1}{\sqrt{{s}_{3}}} [ \begin{matrix}a 1 & b 1 & 0 \\ a 2 & b 2 & 0 \\ 0 & 0 & c 1 \\ 0 & 0 & c 2 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}a 1 & 0 & 0 \\ a 2 & 0 & 0 \\ 0 & b 1 & 0 \\ 0 & b 2 & 0 \\ 0 & 0 & c 1 \\ 0 & 0 & c 2 \\ 0 & 0 & 0 \\ 0 & 0 & 0\end{matrix} ] or \frac{1}{\sqrt{{s}_{3}}} [ \begin{matrix}0 & 0 & 0 \\ 0 & 0 & 0 \\ 0 & 0 & 0 \\ 0 & 0 & 0 \\ a 1 & b 1 & 0 \\ a 2 & b 2 & 0 \\ 0 & 0 & c 1 \\ 0 & 0 & c 2\end{matrix} ] .$$

For example, rows or columns can be swapped. For example, each of [a1, a2], [b1, b2], [c1, c2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [a1, a2], [b1, b2], [c1, c2] may be any one of [1; 1], [1; −1], [1; j], [1; −j].

In some embodiments, if the terminal device 110 is indicated with the number of layers is indicated as 3, there may be a fourth set of precoding matrixes (e.g. a fourth set of non-coherent precoding matrixes) corresponding to 3 layers. For example, each one of 8 antenna ports may be non-coherent with each other. In some embodiments, there may be a fourth set of precoding matrixes (e.g. a fourth set of non-coherent precoding matrixes), for example, represented as “Set_n3_1”, and the size of a precoding matrix may be 3 multiplies 8 or 8 multiplies 3. In some embodiments, there may be 3 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 3 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2, idx_3 for the first, second, third column or row of the precoding matrix, respectively, and for each one of idx_1, idx_2, idx_3, the value may be 1 value out of {0,1,2,3,4,5,6,7} or {1,2,3,4,5,6,7,8}. In some embodiments, the values of idx_1, idx_2 and idx_3 may be based on the indexes of three out of the 4 antenna ports in the first group or second group. In some embodiments, the values of idx_1, idx_2 and idx_3 may be based on the indexes of the 2 antenna ports in the third group or fourth group or fifth group or sixth group and based on an index of one out of 2 antenna ports in the third group or fourth group or fifth group. For example, the value of idx_1, idx_2, idx_3 may be one value out of {0, 1, 2, 3} or {0,2,4,6} or {4,5,6,7} or {1,3,5,7}, respectively. For another example, the value of idx_1, idx_2, idx_3 may be one value out of {1, 2, 3, 4} or {5,6,7,8} or {1,3,5,7} or {2,4,6,8}, respectively. For example, the value of idx_1, idx_2, idx_3 may be different from each other.

In some embodiments, if the terminal device 110 is indicated with number of layers as 3 there may be a fourth set of precoding matrixes corresponding to 3 layers. For example, there may be one or two or four precoding matrixes in the fourth set (e.g. non-coherent precoding matrix) corresponding to 3 layers. For example, a precoding matrix in the fourth set of precoding matrixes corresponding to 3 layers may be

$$\frac{1}{\sqrt{{s}_{3}}} [ \begin{matrix}1 & 0 & 0 \\ 0 & 1 & 0 \\ 0 & 0 & 1 \\ 0 & 0 & 0 \\ 0 & 0 & 0 \\ 0 & 0 & 0 \\ 0 & 0 & 0 \\ 0 & 0 & 0\end{matrix} ] or \frac{1}{\sqrt{{s}_{3}}} [ \begin{matrix}0 & 0 & 0 \\ 0 & 0 & 0 \\ 0 & 0 & 0 \\ 0 & 0 & 0 \\ 1 & 0 & 0 \\ 0 & 1 & 0 \\ 0 & 0 & 1 \\ 0 & 0 & 0\end{matrix} ] .$$

In some embodiments, the terminal device 110 is indicated with the number of layers as 2, there may be a first set of precoding matrixes corresponding to 2 layers (e.g. a first set of full coherent precoding matrixes). In some embodiments, a full coherent precoding matrix may be represented as

$${W}_{l , {l}^{′} , m , {m}^{′} , n}^{( 2 )} .$$

In some embodiments,

$${W}_{l , {l}^{′} , m , {m}^{′} , n}^{( 2 )}$$

may be

$$\frac{1}{\sqrt{2 * P}} [ \begin{matrix}{v}_{l , m} & {v}_{{l}^{′} , {m}^{′}} \\ {φ}_{n} * {v}_{l , m} & - {φ}_{n} * {v}_{{l}^{′} , {m}^{′}}\end{matrix} ] .$$

In some embodiments, P may be 8 or 12 or 16. In some embodiments, l may be a non-negative integer. For example, 0≤l≤O₁N₁. For another example, 0≤l≤O₁N₁/2. For another example, l may be at least one of {0, 2, 4, 6}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0. In some embodiments, l′=l+k₁. In some embodiments, m′=m+k₂. In some embodiments, k₁ may be a non-negative integer. For example, k₁ may at least one of {0, O₁, 2O₁, 3O₁}. For another example, k₁ may be 0. In some embodiments, k₂ may be a non-negative integer. For example, k₂ may at least one of {0, 0₂}. In some embodiments, k₂ may be 0.

In some embodiments, there may be a parameter i_{1,3}, and the value of k₁ and/or k₂ may be based on the value of i_{1,3}, and i_{1,3} may be anon-negative integer. For example, i_{1,3} may be at least one of {0,1,2,3}. For another example, i_{1,3} may be 0 or 1. For another example, i_{1,3} may be 0. In some embodiments, in case of N₁=4 and N₂=1, and in case of i_{1,3}=0, k₁=0 and/or k₂=0. In some embodiments, in case of N₁=4 and N₂=1, and in case of i_{1,3}=1, k₁=O₁ and/or k₂=0. In some embodiments, in case of N₁=4 and N₂=1, and in case of i₁,3=2, k₁=2O₁ and/or k₂=0. In some embodiments, in case of N₁=4 and N₂=1, and in case of i_{1,3}=3, k₁=3O₁ and/or k₂=0. In some embodiments, in case of N₁=2 and N₂=2, and in case of i_{1,3}=0, k₁=0 and/or k₂=0. In some embodiments, in case of N₁=2 and N₂=2, and in case of i_{1,3}=1, k₁=O₁ and/or k₂=0.

In some embodiments, there may be more than one subset of precoding matrixes corresponding to 2 layers. In some embodiments, the first set of precoding matrixes corresponding to 2 layers may comprise more than one subset. For example, there may be two or three or four subsets of precoding matrixes.

In some embodiments, there may be a first subset of precoding matrixes corresponding to 2 layers, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{O}_{1} {N}_{1}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 2 layers may be 128 or 64 or 32 or 16 or 8 or 4 or 2.

In some embodiments, there may be a second subset of precoding matrixes corresponding to 2 layers, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l′=l+k₁. In some embodiments, corresponding to the second subset, m′=m+k₂. In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 2 layers may be 256 or 128 or 32 or 16 or 8 or 4 or 2.

In some embodiments, if the terminal device 110 is indicated with the number of layers as 2, there may be a third subset of precoding matrixes. In some embodiments, In some embodiments, there may be a third vector

$${W}_{l , m , p , n}^{1 , 2 , 1} .$$

In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, there may be a fourth vector

$${W}_{l , m , p , n}^{2 , 2 , 1} .$$

In some embodiments,

$${W}_{l , m , p , n}^{2 , 2 , 1} = \frac{1}{\sqrt{8}} [ {v}_{l , m} ; - {φ}_{n} * {v}_{l , m} ; {φ}_{{p}_{1}} * {v}_{l , m} ; - {φ}_{n} * {φ}_{{p}_{1}} * {v}_{l , m} ] .$$

In some embodiments, N₁×2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a parameter i_{1,3}, and the value of k₁ and/or k₂ may be based on the value of i_{1,3}, and i_{1,3} may be anon-negative integer. For example, i_{1,3} may be at least one of {0,1}. For another example, i_{1,3} may be 0. In some embodiments, in case of N₁=2 and N₂=1, and in case of i_{1,3}=0, k₁=O₁ and/or k₂=0.

In some embodiments, there may be a third subset of precoding matrixes corresponding to 2 layers, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, m and m′ may be 0. In some embodiments, corresponding to the third subset, l′=l+k₁. In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 2 layers may be 64 or 32 or 16 or 8 or 4 or 2.

In some embodiments, the terminal device 110 may be indicated with the number of layers as 2, a precoding matrix in the third subset of precoding matrixes corresponding to 2 layers may be represented as

$${W}_{l , {l}^{′} , m , {m}^{′} , p , n}^{( 2 )} .$$

In some embodiments,

$${W}_{l , {l}^{′} , m , {m}^{′} , p , n}^{( 2 )}$$

may be

$$\frac{1}{\sqrt{2}} [ {W}_{l , m , p , n}^{1 , 2 , 1} {W}_{{l}^{′} , {m}^{′} , p , n}^{2 , 2 , 1} ] .$$

In some embodiments, corresponding to the third subset, l′=l+k₁. In some embodiments, k₁ may be O₁ or 0. In some embodiments, corresponding to the third subset, m′=m+k₂. In some embodiments, k₂ may be 0. In some embodiments, p may be p₁.

In some embodiments, if the terminal device 110 is indicated with the number of layers as 2, there may be a fourth subset of precoding matrixes. In some embodiments, In some embodiments, there may be a fifth vector

$${W}_{l , m , p , n}^{1 , 2 , 2} .$$

In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments, there may be a sixth vector

$${W}_{l , m , p , n}^{2 , 2 , 2} .$$

In some embodiments,

$${W}_{l , m , p , n}^{2 , 2 , 2} = \frac{1}{\sqrt{8}} [ {v}_{l , m} ; - {φ}_{{n}_{0}} * {v}_{l , m} ; {a}_{{p}_{1}} * {b}_{{n}_{1}} * {v}_{l , m} ; - {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0. In some embodiments, l′=l+k₁. In some embodiments, k₁ may be O₁ or 0. In some embodiments, m′=m+k₂. In some embodiments, k₂ may be 0. In some embodiments, m and m′ may be 0.

In some embodiments, there may be a fourth subset of precoding matrixes corresponding to 2 layers, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, m and m′ may be 0. In some embodiments, corresponding to the fourth subset, l′=l+k₁. In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 2 layers may be 64 or 32 or 16 or 8 or 4 or 2.

In some embodiments, the terminal device 110 may be indicated with the number of layers as 2, a precoding matrix in the fourth subset of precoding matrixes corresponding to 2 layers may be represented as

$${W}_{l , {l}^{′} , m , {m}^{′} , p , n}^{( 2 )} .$$

In some embodiments,

$${W}_{l , {l}^{′} , m , {m}^{′} , p , n}^{( 2 )}$$

may be

$$\frac{1}{\sqrt{2}} [ {{W}_{l , m , p , n}^{1 , 2 , 2} ( W )}_{{l}^{′} , {m}^{′} , p , n}^{2 , 2 , 2} ] .$$

In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, corresponding to the fourth subset, l′=l+k₁. In some embodiments, k₁ may be O₁ or 0. In some embodiments, corresponding to the fourth subset, m′=m+k₂. In some embodiments, k₂ may be 0. In some embodiments, m and m′ may be 0. In some embodiments, p may be [p₁ p₂]. In some embodiments, n may be [n₀ n₁ n₂].

In some embodiments, if the terminal device 110 is indicated with the number of layers is indicated as 2, there may be a second set of precoding matrixes corresponding to 2 layers (e.g. a second set of partial coherent precoding matrixes). For example, if the terminal device 110 has 8 antenna ports or if a PUSCH transmission of the terminal device 110 is associated with 8 antenna ports or if a PUSCH transmission of the terminal device 110 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 2 layers, for example, represented as “Set_p2_1”, and the size of a partial coherent precoding matrix may be 2 multiplies 8 or 8 multiplies 2. In some embodiments, there may be 2 columns or rows of the precoding matrix. In some embodiments, there may be 8 elements in a column or row of the precoding matrix. In some embodiments, for a column or a row of the partial coherent precoding matrix, 4 elements out of 8 elements in the partial coherent matrix may be with non-zero value. And the other 4 elements in the partial coherent precoding matrix may be with value of 0. In some embodiments, there may be C4 columns or rows out of the 2 columns or rows (e.g. a first set of C4 columns or rows. For example, C4=1 or 2) in the precoding matrix, and in each column, the non-zero value may be mapped on 4 out of 8 elements and 0 for the other 4 elements. For example, the indexes of the 4 elements with non-zero values may be same in the first set of C4 columns or rows. For example, the indexes of the 4 elements with non-zero values may be idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or second group. For example, idx_1 may be {0,1,2,3} or {0,2,4,6} or {1,2,3,4} or {1,3,5,7}. In some embodiments, for the other 2-C4 column or row, 2-C4 of the first set or second set of length-4 vectors may be selected. In some embodiments, for the other 2-C4 columns or rows out of the 2 columns or rows (e.g. a second set of 2-C4 columns or rows) in the precoding matrix, in each column or row, non-zero values may be mapped on 4 out of 8 elements and 0 may be mapped on the other 4 elements. For example, the indexes of the 4 elements with non-zero values may be same in the second set of 2-C4 columns or rows. For example, the indexes of the 4 elements with non-zero values may be idx_2, and idx_2 may be 4 values out of {0,1,2,3,4,5,6,7} or {1,2,3,4,5,6,7,8}. In some embodiments, the 4 values of idx_2 may be based on the indexes of the 4 antenna ports in the first group or second group. For example, idx_2 may be {4,5,6,7} or {1,3,5,7} or {5,6,7,8} or {2,4,6,8}. In some embodiments, any value of idx_1 may be different from any value of idx_2. In some embodiments, C4 may be 2 and there may be no second set of columns or rows.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [1; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in a column or row of the precoding matrix. In some embodiments,

In some embodiments, examples of a precoding matrix of the second set of precoding matrixes corresponding to 2 layers may be as:

$$\frac{1}{\sqrt{{s}_{2}}} [ \begin{matrix}a 1 & 0 \\ a 2 & 0 \\ a 3 & 0 \\ a 4 & 0 \\ 0 & b 1 \\ 0 & b 2 \\ 0 & b 3 \\ 0 & b 4\end{matrix} ] \text{} or \text{} \frac{1}{\sqrt{{s}_{2}}} [ \begin{matrix}a 1 & b 1 \\ a 2 & b 2 \\ a 3 & b 3 \\ a 4 & b 4 \\ 0 & 0 \\ 0 & 0 \\ 0 & 0 \\ 0 & 0\end{matrix} ] .$$

For example, rows or columns can be swapped. For example, rows or columns can be swapped. For example, each of [a1, a2, a3, a4], [b1, b2, b3, b4] may be one of the length-4 vectors in the first set of length-4 vectors or in the second set of length-4 vectors. For example, [a1, a2, a3, a4], [b1, b2, b3, b4] may be two out of [1; 1; 1; 1], [1; −1; 1; −1], [1; 1; −1; −1] and [1; −1; −1; 1]. For another example, [a1, a2, a3, a4], [b1, b2, b3, b4] may be two out of [1; 1; j; j], [1; −1; j; −j], [1; 1; −j; −j] and [1; −1; −j; j]. For example, each of [a1, a2, a3, a4], [b1, b2, b3, b4] may be one of the length-4 vectors in the first set of length-4 vectors or in the second set of length-4 vectors.

In some embodiments, s₂ may a positive integer. For example, 1≤s₂≤64. For example, s₂ may be 64 or 32 or 16 or 8 or 4 or 2.

In some embodiments, if the terminal device 110 is indicated with the number of layers as 2, there may be a third set of precoding matrixes (e.g. a third set of partial coherent precoding matrixes) corresponding to 2 layers. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p2_2”, and the size of a precoding matrix may be 2 multiplies 8 or 8 multiplies 2. In some embodiments, there may be 2 columns or rows of the precoding matrix. In some embodiments, there may be 8 elements in a column or row of the precoding matrix. In some embodiments, for a column or a row of the precoding matrix, 2 elements out of 8 elements in the precoding matrix may be with non-zero value. And the other 6 elements in the precoding matrix may be with value of 0. In some embodiments, there may be 1 or 2 columns or rows out of the 2 columns or rows (e.g. a first set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the first set of 1 or 2 columns or rows. For example, the indexes of the 2 elements with non-zero values may be idx_1, and idx_1 may be 1 or 2 values out of {0,1,2,3,4,5,6,7} or {1,2,3,4,5,6,7,8}. In some embodiments, the 2 values of idx_1 may be based on the indexes of two out of the 4 antenna ports in the first group or second group. In some embodiments, the 2 values of idx_1 may be based on the indexes of the 2 antenna ports in the third group or fourth group or fifth group or sixth group. For example, idx_1 may be {0,1} or {0, 2} or {1, 2} or {1, 3} or {0, 4} or {1, 5}. In some embodiments, there may be 1 or 2 columns or rows out of the 2 columns or rows (e.g. a second set of 1 or 2 columns or rows) in the precoding matrix, and in each column or row, non-zero values may be mapped on 2 out of 8 elements and 0 may be mapped on the other 6 elements. For example, the indexes of the 2 elements with non-zero values may be same in the second set of 1 or 2 columns or rows. For example, the indexes of the 2 elements with non-zero values may be idx_2, and idx_2 may be 1 or 2 values out of {0,1,2,3,4,5,6,7} or {1,2,3,4,5,6,7,8}. In some embodiments, the 2 values of idx_2 may be based on the indexes of remaining two out of the 4 antenna ports in the first group or second group. In some embodiments, the 2 values of idx_2 may be based on the indexes of the 2 antenna ports in the third group or fourth group or fifth group or sixth group. For example, idx_2 may be {2,3} or {1,3} or {3,4} or {2,4} or {1,5} or {2,6}. In some embodiments, any value of idx_1 and any value of idx_2 may be different from each other. In some embodiments, the total number of columns or rows in the first set and/or the second set may be 2. In some embodiments, there may be the first set and the second set, and each set with 1 column or row. In some embodiments, there may be only one first set, and the first set with 2 columns or rows.

In some embodiments, there may be a set of 4 length-2 vectors, and each one of the length-2 vector may be applied as the two non-zero values in a column or row of the precoding matrix. In some embodiments, for the third set of precoding matrix corresponding to 2 layers, e.g. Set_p2_2, two length-2 vectors can be selected from the 4 length-2 vectors, and the 2 values in each vector may be mapped on 2 out of 8 elements, and 0 may be mapped on other elements in a column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in a column or row of the precoding matrix. In some embodiments, for the first set of 2 columns or rows and/or for the second set of 1 or 2 columns or rows and/or for the third set of 1 or 2 columns or rows and/or for the fourth set of 1 or 2 columns or rows, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 2 layers may be as:

$$\frac{1}{\sqrt{{s}_{2}}} [ \begin{matrix}a 1 & b 1 \\ a 2 & b 2 \\ 0 & 0 \\ 0 & 0 \\ 0 & 0 \\ 0 & 0 \\ 0 & 0 \\ 0 & 0\end{matrix} ] \text{} or \text{} \frac{1}{\sqrt{{s}_{2}}} [ \begin{matrix}a 1 & 0 \\ a 2 & 0 \\ 0 & b 1 \\ 0 & b 2 \\ 0 & 0 \\ 0 & 0 \\ 0 & 0 \\ 0 & 0\end{matrix} ] .$$

For example, rows or columns can be swapped. For example, each of [a1, a2], [b1, b2] may be one of the length-2 vectors in the first set of length-2 vectors or in the second set of length-2 vectors. For example, [a1, a2], [b1, b2] may be [1; 1], [1; −1], respectively. For another example, [a1, a2], [b1, b2] may be [1; j], [1; −j], respectively. For example, [a1, a2], [b1, b2] may be any one of [1; 1], [1; −1], [1; j], [1; −j].

In some embodiments, if the terminal device 110 is indicated with the number of layers is indicated as 2, there may be a fourth set of precoding matrixes (e.g. a fourth set of non-coherent precoding matrixes) corresponding to 2 layers. For example, each one of 8 antenna ports may be non-coherent with each other. In some embodiments, there may be a fourth set of precoding matrixes (e.g. a fourth set of non-coherent precoding matrixes), for example, represented as “Set_n2_1”, and the size of a precoding matrix may be 2 multiplies 8 or 8 multiplies 2. In some embodiments, there may be 2 columns or rows of the precoding matrix. In some embodiments, there may be 8 elements in a column or row of the precoding matrix. In some embodiments, for a column or a row of the precoding matrix, 1 elements out of 8 elements in the precoding matrix may be with non-zero value. For example, the non-zero value may be 1. And the other 7 elements in the precoding matrix may be with value of 0. In some embodiments, for each column or row of the 2 columns or rows in the precoding matrix, the non-zero value may be mapped on 1 out of 8 elements and 0 may be mapped on the other 7 elements. For example, the indexes of the element with non-zero value may be different in each row or column of the precoding matrix. For example, the index of the 1 element with non-zero value may be idx_1, idx_2 for the first, second column or row of the precoding matrix, respectively, and for each one of idx_1, idx_2, the value may be 1 value out of {0,1,2,3,4,5,6,7} or {1,2,3,4,5,6,7,8}. In some embodiments, the values of idx_1 and idx_2 may be based on the indexes of two out of the 4 antenna ports in the first group or second group. In some embodiments, the values of idx_1 and idx_2 may be based on the indexes of the 2 antenna ports in the third group or fourth group or fifth group or sixth group. For example, the value of idx_1, idx_2 may be one value of {0, 1, 2, 3} or {0,2,4,6} or {4,5,6,7} or {1,3,5,7}, respectively. For another example, the value of idx_1, idx_2 may be {1, 2}{3, 4} or {5,6}, {7,8} or {1,3}, {5,7} or {2,4}, {6,8}. For example, the value of idx_1, idx_2 may be different from each other.

In some embodiments, if the terminal device 110 is indicated with number of layers as 2, there may be a fourth set of precoding matrixes corresponding to 2 layers. For example, there may be one or two or four or six or twelve precoding matrixes in the fourth set (e.g. non-coherent precoding matrix) corresponding to 2 layers. For example, a precoding matrix in the fourth set of precoding matrixes corresponding to 2 layers may be

$$\frac{1}{\sqrt{{s}_{2}}} [ \begin{matrix}1 & 0 \\ 0 & 1 \\ 0 & 0 \\ 0 & 0 \\ 0 & 0 \\ 0 & 0 \\ 0 & 0 \\ 0 & 0\end{matrix} ] \text{} or \text{} \frac{1}{\sqrt{{s}_{2}}} [ \begin{matrix}1 & 0 \\ 0 & 0 \\ 0 & 1 \\ 0 & 0 \\ 0 & 0 \\ 0 & 0 \\ 0 & 0 \\ 0 & 0\end{matrix} ] or \text{} \frac{1}{\sqrt{{s}_{2}}} [ \begin{matrix}0 & 0 \\ 0 & 0 \\ 1 & 0 \\ 0 & 1 \\ 0 & 0 \\ 0 & 0 \\ 0 & 0 \\ 0 & 0\end{matrix} ] \text{} or \frac{1}{\sqrt{{s}_{2}}} [ \begin{matrix}1 & 0 \\ 0 & 0 \\ 0 & 0 \\ 0 & 1 \\ 0 & 0 \\ 0 & 0 \\ 0 & 0 \\ 0 & 0\end{matrix} ] or \text{} \frac{1}{\sqrt{{s}_{2}}} [ \begin{matrix}0 & 0 \\ 1 & 0 \\ 0 & 0 \\ 0 & 1 \\ 0 & 0 \\ 0 & 0 \\ 0 & 0 \\ 0 & 0\end{matrix} ] or \frac{1}{\sqrt{{s}_{2}}} [ \begin{matrix}0 & 0 \\ 1 & 0 \\ 0 & 0 \\ 0 & 1 \\ 0 & 0 \\ 0 & 0 \\ 0 & 0 \\ 0 & 0\end{matrix} ] .$$

For example, s₂=8.

In some embodiments, the terminal device 110 is indicated with the number of layers as 1, there may be a first set of precoding matrixes corresponding to 1 layer (e.g. a first set of full coherent precoding matrixes). In some embodiments, a full coherent precoding matrix may be represented as

$${W}_{l , m , n}^{( 1 )} .$$

In some embodiments,

$${W}_{l , m , n}^{( 1 )} may be \frac{1}{\sqrt{P}} [ \begin{matrix}{v}_{l , m} \\ {φ}_{n} ⋆ {v}_{l , m}\end{matrix} ] .$$

In some embodiments, P may be 8 or 12 or 16. In some embodiments, l may be a non-negative integer. For example, 0 l≤O₁N₁. For another example, 0≤l≤O₁N₁/2. For another example, l may be at least one of {0, 2, 4, 6}. For another example, l may be at least one of {0, 1, 2, 3}. For another example, l may be 0 or 1. In some embodiments, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, n may be a non-negative integer. For example, n may be at least one of {0, 1, 2, 3}. For another example, n may be 0 or 1. For another example, n may be 0 or 2. For another example, n may be 0.

In some embodiments, there may be more than one subset of precoding matrixes corresponding to 1 layer. In some embodiments, the first set of precoding matrixes corresponding to 1 layer may comprise more than one subset. For example, there may be two or three or four subsets of precoding matrixes.

In some embodiments, there may be a first subset of precoding matrixes corresponding to 1 layer, and corresponding to the first subset of precoding matrixes, the value of “N₁” may be 4, the value of “N₂” may be 1, and the value of “O₁” may be 4 or 2 or 1. For example, the value of “O₂” may be 1. In some embodiments, corresponding to the first subset,

$${v}_{l , m} = {[ 1 , {e}^{j \frac{2 π l}{{O}_{1} {N}_{1}}} , {e}^{j \frac{2 π l * 2}{{O}_{1} {N}_{1}}} , {e}^{j \frac{2 π l * 3}{{{O}_{1} {N}_{1}}_{}}} ]}^{T} .$$

In some embodiments, corresponding to the first subset, m and m′ may be 0. In some embodiments, corresponding to the first subset, l′=l+k₁. In some embodiments, corresponding to the first subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, the number of precoding matrixes in the first subset corresponding to 1 layer may be 32 or 16 or 8 or 4 or 2.

In some embodiments, there may be a second subset of precoding matrixes corresponding to 1 layer, and corresponding to the second subset of precoding matrixes, the value of “N₁” may be 2, the value of “N₂” may be 2, and the value of “O₁” may be 4 or 2 or 1. For example, the value of “O₂” may be 4 or 2 or 1. In some embodiments, corresponding to the second subset,

$${v}_{l , m} = {[ 1 , {e}^{j \frac{2 π m}{{O}_{2} {N}_{2}}} , {e}^{j \frac{2 π l}{{O}_{1} {N}_{1}}} , {e}^{j \frac{2 π m}{{O}_{2} {N}_{2}}} * {e}^{j \frac{2 π l}{{O}_{1} {N}_{1}}} ]}^{T} .$$

In some embodiments, corresponding to the second subset, l may be a non-negative integer, 0≤l≤O₁N₁. For example, l may be at least one of {0, 2, 4, 6}. For another example, l may be at least one of {0, 1, 2, 3}. For another example, l may be 0 or 1. For another example, l may be 0 or 2. In some embodiments, corresponding to the second subset, m may be a non-negative integer. For example, 0≤m≤O₂N₂. For another example, m may be at least one of {0, 2, 4, 6}. For another example, m may be at least one of {0, 1, 2, 3}. For another example, m may be 0 or 1. For another example, m may be 0. In some embodiments, the number of precoding matrixes in the second subset corresponding to 1 layer may be 256 or 128 or 32 or 16 or 8 or 4 or 2.

In some embodiments, if the terminal device 110 is indicated with the number of layers as 1, there may be a third subset of precoding matrixes. In some embodiments, In some embodiments, there may be a third vector

$${W}_{l , m , p , n}^{1 , 2 , 1} .$$

In some embodiments,

$${W}_{l , m , p , n}^{1 , 2 , 1} = \frac{1}{\sqrt{8}} [ {v}_{l , m} ; {φ}_{n} * {v}_{l , m} ; {φ}_{{p}_{1}} * {v}_{l , m} ; {φ}_{n} * {φ}_{{p}_{1}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0≤l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n may be at least one of {0,1,2,3} or {0,1} or {0,2}. In some embodiments, the value of n may be 0.

In some embodiments, there may be a third subset of precoding matrixes corresponding to 1 layer, and corresponding to the third subset of precoding matrixes, the value of “N₁” may be 2, the value of “N₂” may be 1, and the value of “O₁” may be 4 or 2 or 1. For example, the value of “O₂” may be 1. In some embodiments, corresponding to the third subset,

$${v}_{l , m} = {[ 1 , {e}^{j \frac{2 π l}{{O}_{1} {N}_{1}}} ]}^{T} .$$

In some embodiments, corresponding to the third subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the third subset corresponding to 1 layer may be 256 or 128 or 64 or 32 or 16 or 8 or 4 or 2.

In some embodiments, the terminal device 110 may be indicated with the number of layers as 1, a precoding matrix in the third subset of precoding matrixes corresponding to 1 layer may be represented as

$${W}_{l , m , p , n}^{( 1 )} .$$

In some embodiments,

$${W}_{l , m , p , n}^{( 1 )}$$

may be

$$[ {W}_{l , m , p , n}^{1 , 2 , 1} ] .$$

In some embodiments, p may be p₁.

In some embodiments, if the terminal device 110 is indicated with the number of layers as 1, there may be a fourth subset of precoding matrixes. In some embodiments, In some embodiments, there may be a fifth vector

$${W}_{l , m , p , n}^{1 , 2 , 2} .$$

In some embodiments,

$${W}_{l , m , p , n}^{1 , 2 , 2} = \frac{1}{\sqrt{8}} [ {v}_{l , m} ; {φ}_{{n}_{0}} * {v}_{l , m} ; {a}_{{p}_{1}} * {b}_{{n}_{1}} * {v}_{l , m} ; {a}_{{p}_{2}} * {b}_{{n}_{2}} * {v}_{l , m} ] .$$

In some embodiments, N₁=2 and N₂=1,

$${v}_{l , m} = {[ 1 , {e}^{j \frac{2 π l}{{O}_{1} {N}_{1}}} ]}^{T} .$$

In some embodiments, l may be a non-negative integer. For example, 0 l≤O₁N₁. For another example, l may be at least one of {0, 2}. For another example, l may be at least one of {0, 1, 2, 3}. For another example, l may be 0 or 1. In some embodiments, the value of p₁ may be at least one of {0,1,2,3} or {0,1} or {0,2}. In some embodiments, the value of p₁ may be 0. In some embodiments, the value of n₀ may be at least one of {0,1,2,3} or {0,1} or {0,2}. In some embodiments, the value of n₀ may be 0. In some embodiments, the value of n₁ may be at least one of {0,1,2,3} or {0,1} or {0,2}. In some embodiments, the value of n₁ may be 0. In some embodiments, the value of n₂ may be at least one of {0,1,2,3} or {0,1} or {0,2}. In some embodiments, the value of n₂ may be 0.

In some embodiments, there may be a fourth subset of precoding matrixes corresponding to 1 layer, and corresponding to the fourth subset of precoding matrixes, the value of “N₁” may be 2, the value of “N₂” may be 1, and the value of “O₁” may be 4 or 2 or 1. For example, the value of “O₂” may be 1. In some embodiments, corresponding to the fourth subset,

$${v}_{l , m} = {[ 1 , {e}^{j \frac{2 π l}{{O}_{1} {N}_{1}}} ]}^{T} .$$

In some embodiments, corresponding to the fourth subset, l may be a non-negative integer, 0≤l≤O₁N₁. For example, l may be at least one of {0, 1, 2, 3}. For another example, l may be 0 or 1. For another example, l may be 0 or 2. In some embodiments, the number of precoding matrixes in the fourth subset corresponding to 1 layer may be 256 or 128 or 64 or 32 or 16 or 8 or 4 or 2.

In some embodiments, the terminal device 110 may be indicated with the number of layers as 1, a precoding matrix in the fourth subset of precoding matrixes corresponding to 1 layer may be represented as

$${W}_{l , m , p , n}^{( 1 )} .$$

In some embodiments,

$${W}_{l , m , p , n}^{( 1 )}$$

may be

$$[ {W}_{l , m , p , n}^{1 , 2 , 2} ] .$$

In some embodiments, p may be [p₁ p₂]. In some embodiments, n may be [n₀ n₁ n₂].

In some embodiments, if the terminal device 110 is indicated with the number of layers is indicated as 1, there may be a second set of precoding matrixes corresponding to 1 layers (e.g. a second set of partial coherent precoding matrixes). For example, if the terminal device 110 has 8 antenna ports or if a PUSCH transmission of the terminal device 110 is associated with 8 antenna ports or if a PUSCH transmission of the terminal device 110 is associated with SRS with 8 ports, 4 antenna ports (e.g. a first set of 4 ports) may be coherent and the other 4 antenna ports (e.g. a second set of 4 ports) may be coherent. For example, the first set of 4 ports may not be coherent with the second set of 4 ports. In some embodiments, there may be a second set of precoding matrixes (e.g. a second set of partial coherent precoding matrixes) corresponding to 2 layers, for example, represented as “Set_p1_1”, and the size of a partial coherent precoding matrix may be 1 multiplies 8 or 8 multiplies 1. In some embodiments, there may be 1 column or row of the precoding matrix. In some embodiments, there may be 8 elements in the column or row of the precoding matrix. In some embodiments, for the column or row of the partial coherent precoding matrix, 4 elements out of 8 elements in the partial coherent matrix may be with non-zero value. And the other 4 elements in the partial coherent precoding matrix may be with value of 0. In some embodiments, in the precoding matrix, and in the column or row, the non-zero value may be mapped on 4 out of 8 elements and 0 for the other 4 elements. For example, the indexes of the 4 elements with non-zero values idx_1, and idx_1 may be 4 values out of {0,1,2,3,4,5,6,7} or {1,2,3,4,5,6,7,8}. In some embodiments, the 4 values of idx_1 may be based on the indexes of the 4 antenna ports in the first group or second group. For example, idx_1 may be {0,1,2,3} or {0,2,4,6} or {1,2,3,4} or {1,3,5,7} or {4,5,6,7} or {1,3,5,7} or {5,6,7,8} or {2,4,6,8}.

In some embodiments, there may be two sets of length-4 vectors, and each set may include 4 length-4 vectors. In some embodiments, the values in a length-4 vector may be applied for the 4 non-zero values mapping on 4 elements in a column or row of the precoding matrix. For example, the first set of length-4 vectors may be {[1; 1; 1; 1], [1; −1; 1; −1], [1; 1; −1; −1], [1; −1; −1; 1]}. For another example, the second set of length-4 vectors may be {[1; 1; j; j], [; −1; j; −j], [1; 1; −j; −j], [1; −1; −j; j]}. In some embodiments, the 4 values in each vector of the first set or of the second set may be mapped on the 4 out of 8 elements, and 0 may be mapped on other 4 elements in the column or row of the precoding matrix.

In some embodiments, examples of a precoding matrix of the second set of precoding matrixes corresponding to 1 layer 1 may be as:

$$\frac{1}{\sqrt{{s}_{1}}} [ \begin{matrix}a 1 \\ a 2 \\ a 3 \\ a 4 \\ 0 \\ 0 \\ 0 \\ 0\end{matrix} ] or \frac{1}{\sqrt{{s}_{1}}} [ \begin{matrix}0 \\ 0 \\ 0 \\ 0 \\ a 1 \\ a 2 \\ a 3 \\ a 4\end{matrix} ] .$$

For example, rows or columns can be swapped. For example, rows or columns can be swapped. For example, each of [a1, a2, a3, a4] may be one of the length-4 vectors in the first set of length-4 vectors or in the second set of length-4 vectors. For example, [a1, a2, a3, a4] may be one of [1; 1; 1; 1], [1; −1; 1; −1], [1; 1; −1; −1], [1; −1; −1; 1], [1; 1; j; j], [1; −1; j; −j], [1; 1; −j; −j] and [1; −1; −j; j].

In some embodiments, s₁ may a positive integer. For example, 1≤s₁≤64. For example, s₁ may be 64 or 32 or 16 or 8 or 4 or 2 or 1.

In some embodiments, if the terminal device 110 is indicated with the number of layers as 1, there may be a third set of precoding matrixes (e.g. a third set of partial coherent precoding matrixes) corresponding to 1 layer. For example, the structure of the 8 ports may be 2+2+2+2, which means that there are 4 groups, each group including 2 antenna ports and in each group, 2 antenna ports can be coherent. For example, between the groups, the antenna ports may not be coherent. In some embodiments, there may be a third set of precoding matrixes (e.g. a third set of partial coherent precoding matrixes), for example, represented as “Set_p1_2”, and the size of a precoding matrix may be 1 multiplies 8 or 8 multiplies 1. In some embodiments, there may be 1 column or row of the precoding matrix. In some embodiments, there may be 8 elements in the column or row of the precoding matrix. In some embodiments, for the column or the row of the precoding matrix, 2 elements out of 8 elements in the precoding matrix may be with non-zero value. And the other 6 elements in the precoding matrix may be with value of 0. In some embodiments, in the column or row of the precoding matrix, non-zero values may be mapped on 2 out of 8 elements and 0 may be mapped on the other 6 elements. For example, the indexes of the 2 elements with non-zero values may be idx_1, and idx_1 may be 2 values out of {0,1,2,3,4,5,6,7} or {1,2,3,4,5,6,7,8}. In some embodiments, the 2 values of idx_1 may be based on the indexes of two out of the 4 antenna ports in the first group or second group. In some embodiments, the 2 values of idx_1 may be based on the indexes of the 2 antenna ports in the third group or fourth group or fifth group or sixth group.

In some embodiments, there may be a set of 4 length-2 vectors, and each one of the length-2 vector may be applied as the two non-zero values in a column or row of the precoding matrix. In some embodiments, for the third set of precoding matrix corresponding to 1 layer, e.g. Set_p1_2, two length-2 vectors can be selected from the 4 length-2 vectors, and the 2 values in each vector may be mapped on 2 out of 8 elements, and 0 may be mapped on other elements in the column or row of the precoding matrix. In some embodiments, there may be two sets of length-2 vectors, and each set may include 2 length-2 vectors. In some embodiments, the two values in a length-2 vector may be applied as the two non-zero values mapping on 2 elements in a column or row of the precoding matrix. For example, the first set of the length-2 vectors may be {[1; 1], [1; −1]}. For another example, the second set of the length-2 vectors may be {[1; j], [1; −j]}. In some embodiments, the 2 values in each vector of the first set or of the second set may be mapped on 2 out of 8 elements, and 0 may be mapped on other 6 elements in the column or row of the precoding matrix. In some embodiments, for the column or row, the two vectors selected for mapping to 2 non-zero values on 2 elements out of 8 elements in each column or row may be {[1; 1] and [1; −1]} or {[1; j] and [1; −j]}.

In some embodiments, examples of a precoding matrix of the third set of precoding matrixes corresponding to 1 layer may be as:

$$\frac{1}{\sqrt{{s}_{1}}} [ \begin{matrix}a 1 \\ a 2 \\ 0 \\ 0 \\ 0 \\ 0 \\ 0 \\ 0\end{matrix} ] or \frac{1}{\sqrt{{s}_{1}}} [ \begin{matrix}0 \\ 0 \\ a 1 \\ a 2 \\ 0 \\ 0 \\ 0 \\ 0\end{matrix} ] or \frac{1}{\sqrt{{s}_{1}}} [ \begin{matrix}a 1 \\ 0 \\ a 2 \\ 0 \\ 0 \\ 0 \\ 0 \\ 0\end{matrix} ] or$$

$$\frac{1}{\sqrt{{s}_{1}}} [ \begin{matrix}0 \\ 0 \\ 0 \\ 0 \\ a 1 \\ a 2 \\ 0 \\ 0\end{matrix} ] or \frac{1}{\sqrt{{s}_{1}}} [ \begin{matrix}0 \\ 0 \\ 0 \\ 0 \\ a 1 \\ 0 \\ a 2 \\ 0\end{matrix} ] or \frac{1}{\sqrt{{s}_{1}}} [ \begin{matrix}0 \\ 0 \\ 0 \\ 0 \\ 0 \\ 0 \\ a 1 \\ a 2\end{matrix} ] .$$

For example, rows or columns can be swapped. For example, [a1, a2], may be one of the length-2 vectors in the first set of length-2 vectors or in the second set of length-2 vectors. For example, [a1, a2] may be any one of [1; 1], [1; −1], [1; j], [1; −j].

In some embodiments, if the terminal device 110 is indicated with the number of layers is indicated as 1, there may be a fourth set of precoding matrixes (e.g. a fourth set of non-coherent precoding matrixes) corresponding to 1 layer. For example, each one of 8 antenna ports may be non-coherent with each other. In some embodiments, there may be a fourth set of precoding matrixes (e.g. a fourth set of non-coherent precoding matrixes), for example, represented as “Set_n1_1”, and the size of a precoding matrix may be 1 multiplies 8 or 8 multiplies 1. In some embodiments, there may be 1 column or row of the precoding matrix. In some embodiments, there may be 8 elements in a column or row of the precoding matrix. In some embodiments, for the column or row of the precoding matrix, 1 elements out of 8 elements in the precoding matrix may be with non-zero value. For example, the non-zero value may be 1. And the other 7 elements in the precoding matrix may be with value of 0. In some embodiments, the indexes of the element with non-zero value may be in the row or column of the precoding matrix may be idx_1, and idx_1 may be 1 value out of {0,1,2,3,4,5,6,7} or {1,2,3,4,5,6,7,8}. In some embodiments, the value of idx_1 may be based on the indexes of one out of the 4 antenna ports in the first group or second group. In some embodiments, the values of idx_1 may be based on the indexes of one of the 2 antenna ports in the third group or fourth group or fifth group or sixth group.

In some embodiments, if the terminal device 110 is indicated with number of layers as 1, there may be a fourth set of precoding matrixes corresponding to 1 layer. For example, there may be one or two or four or eight precoding matrixes in the fourth set (e.g. non-coherent precoding matrix) corresponding to 1 layer. For example, a precoding matrix in the fourth set of precoding matrixes corresponding to 1 layer may be

$$\frac{1}{\sqrt{{s}_{1}}} [ \begin{matrix}1 \\ 0 \\ 0 \\ 0 \\ 0 \\ 0 \\ 0 \\ 0\end{matrix} ] or \frac{1}{\sqrt{{s}_{1}}} [ \begin{matrix}0 \\ 1 \\ 0 \\ 0 \\ 0 \\ 0 \\ 0 \\ 0\end{matrix} ] or \frac{1}{\sqrt{{s}_{1}}} [ \begin{matrix}0 \\ 0 \\ 1 \\ 0 \\ 0 \\ 0 \\ 0 \\ 0\end{matrix} ] or \frac{1}{\sqrt{{s}_{1}}} [ \begin{matrix}0 \\ 0 \\ 0 \\ 1 \\ 0 \\ 0 \\ 0 \\ 0\end{matrix} ] or$$

$$\frac{1}{\sqrt{{s}_{1}}} [ \begin{matrix}0 \\ 0 \\ 0 \\ 0 \\ 1 \\ 0 \\ 0 \\ 0\end{matrix} ] or \frac{1}{\sqrt{{s}_{1}}} [ \begin{matrix}0 \\ 0 \\ 0 \\ 0 \\ 0 \\ 1 \\ 0 \\ 0\end{matrix} ] or \frac{1}{\sqrt{{s}_{1}}} [ \begin{matrix}0 \\ 0 \\ 0 \\ 0 \\ 0 \\ 0 \\ 1 \\ 0\end{matrix} ] or \frac{1}{\sqrt{{s}_{1}}} [ \begin{matrix}0 \\ 0 \\ 0 \\ 0 \\ 0 \\ 0 \\ 0 \\ 1\end{matrix} ] .$$

For example, s₁=8.

Alternatively or in addition, the terminal device 110 may transmit capability information to the network device 120. In some embodiments, the capability information may indicate a capability of precoding matrix supported by the terminal device 110. For example, the capability information may indicate a type of precoding matrix supported by the terminal device 110. In some embodiments, the capability information may comprise at least one of: a full coherent, a partial coherent, a first partial coherent, a second partial coherent, a non coherent.

In some embodiments, the capability information may indicate the full coherent, the set of precoding matrix (for example, one of the set of precoding matrixes corresponding to v_ri layers can be indicated by the network device or one or more of the set of precoding matrixes can be configured by the network device) may comprise at least one of the first set (or at least one of the first subset, or at least one of the second subset or at least one of the third subset or at least one of fourth subset) of precoding matrixes corresponding to v_ri layers (e.g. a full-coherent precoding matrix type). For example, the set of precoding matrix may further comprise at least one of the second set of precoding matrixes corresponding to v_ri layers (e.g. a first partial-coherent precoding matrix type). For another example, the set of precoding matrixes may further comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the partial coherent or indicate the first partial coherent, the set of precoding matrix corresponding to v_ri layers (for example, one of the set of precoding matrixes can be indicated by the network device or one or more of the set of precoding matrixes can be configured by the network device) may comprise at least one of the second set of precoding matrixes corresponding to v_ri layers (e.g. a first partial-coherent precoding matrix type). For another example, the set of precoding matrixes may further comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the second partial coherent, the set of precoding matrix corresponding to v_ri layers (for example, one of the set of precoding matrixes can be indicated by the network device or one or more of the set of precoding matrixes can be configured by the network device) may comprise at least one of the third set of precoding matrixes corresponding to v_ri layers (e.g. a second partial-coherent precoding matrix type). For another example, the set of precoding matrixes may further comprise at least one of the fourth set of precoding matrixes corresponding to v_ri layers (e.g. a non-coherent precoding matrix type).

In some embodiments, the capability information may indicate the non coherent, the set of precoding matrix corresponding to v_ri layers (for example, one of the set of precoding matrixes can be indicated by the network device or one or more of the set of precoding matrixes can be configured by the network device) may comprise at least one of the fourth set of precoding matrixes corresponding to v_ri layers (e.g. a non-coherent precoding matrix type).

In some embodiments, the capability information may comprise any one or combination of the above precoding matrix types. In some embodiments, the capability information may be transmitted via radio resource control (RRC) signaling.

In some embodiments, the network device 120 may configure the type of precoding matrixes or at least one set of precoding matrixes corresponding to v_ri layers which can be indicated or configured to the terminal device 110. In some embodiments, corresponding to v_ri layers, the at least one configuration may configure at least one of the first subset of precoding matrixes corresponding to v_ri layers, the second subset of precoding matrixes corresponding to v_ri layers, the third subset of precoding matrixes corresponding to v_ri layers, the fourth subset of precoding matrixes corresponding to v_ri layers, the first set of precoding matrixes corresponding to v_ri layers, the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the full coherent, corresponding to v_ri layers, the at least one configuration may configure at least one of the first subset of precoding matrixes corresponding to v_ri layers, the second subset of precoding matrixes corresponding to v_ri layers, the third subset of precoding matrixes corresponding to v_ri layers, the fourth subset of precoding matrixes corresponding to v_ri layers, the first set of precoding matrixes corresponding to v_ri layers, the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the partial coherent or the first partial coherent, corresponding to v_ri layers, the at least one configuration may configure at least one of the second set of precoding matrixes corresponding to v_ri layers, the third set of precoding matrixes corresponding to v_ri layers and the fourth set of precoding matrixes corresponding to v_ri layers.

In some embodiments, if the capability information is indicated as the second partial coherent, corresponding to v_ri layers, the at least one configuration may configure at least one of the third set of precoding matrixes corresponding to v_ri layers and the fourth set of precoding matrixes corresponding to v_ri layers.

In some embodiments, if the capability information is indicated as the non coherent, corresponding to v_ri layers, the at least one configuration may configure at least one of the fourth set of precoding matrixes corresponding to v_ri layers.

In some embodiments, the network device 120 may determine the type of precoding matrix which can be supported by the terminal device. In this case, the network device 120 may transmit an indication of the type of the precoding matrix. The type of the precoding matrix may be any one or combination of: a full-coherent precoding matrix type, a full-coherent and partial-coherent and non-coherent precoding matrix type, a partial-coherent precoding matrix type, a partial-coherent and a non-coherent precoding matrix type or a non-coherent precoding matrix type.

In some embodiments, the network device 120 may transmit at least one configuration associated with precoding matrix to the terminal device 110. In some embodiments, the terminal device 110 may transmit the at least one configuration associated with precoding matrix to the network device 120. In some embodiments, the at least one configuration may comprise one or more configurations of antenna port groups. Alternatively or in addition, the at least one configuration may comprise at least one antenna port group. In other embodiments, the at least one configuration may comprise one or more configurations of antenna pattern. In some other embodiments, the at least one configuration may comprise one or more configurations of precoding matrix type. Alternatively or in addition, the at least one configuration may comprise one or more configurations of precoding matrix subsets. In some embodiments, the at least one configuration may comprise the number of antenna port groups. In other embodiments, the at least one configuration may comprise the number of antenna ports in an antenna port group.

In some embodiments, the at least one configuration may comprise a first number of antenna groups and each of the antenna groups may comprise 4 antenna ports. For example, the first number may be 0 or 1 or 2. In this case, the first number may be a first integer which is not larger than 2. Alternatively or in addition, the at least one configuration may comprise a second number of antenna groups and each of the antenna groups may comprise 2 antenna ports. For example, the second number may be 0 or 1 or 2 or 3 or 4. In this case, the second number may be a second integer which is not larger than 4. In some other embodiments, the at least one configuration may comprise a third number of antenna groups and each of the antenna groups may comprise 1 antenna port. The third number may be a third integer which is not larger than 8. In another embodiment, the at least one configuration may comprise at least one of: a subset of full-coherent precoding matrixes, a subset of partial-coherent precoding matrixes, or a subset of non-coherent precoding matrixes.

Only as an example, the terminal device 110 may be configured with 8Tx for uplink or 8 ports SRS, (e.g. AP_0, AP_1, AP_2, AP_3, AP_4, AP_5, AP_6, AP_7). In some embodiments, the at least one configuration may include N groups where each group comprises 4 antenna ports, (N may be 0, 1, 2) and/or M groups where each group comprises 2 antenna ports, (M is integer, and 0<=M<=(8−N*4)/2 or 0<=M<=4)), and/or L groups where each group comprises 1 antenna port (or L antenna ports) (L is integer, and 0<=L<=8−N*4−M*2 or 0<=L<=8). Alternatively, the at least one configuration may indicate a subset of full-coherent and/or partial-coherent and/or a first partial-coherent (e.g. partial-coherent4) and/or a second partial-coherent (e.g. partial-coherent2) and/or non-coherent precoding matrix.

In some embodiments, the at least one configuration may be configured per value of number of layers or per precoder type. For example, N1, M1 may be configured for the first set of precoding matrixes corresponding to v_ri layers or for the full coherent precoding matrixes, N2, M2 may be configured for the second or the third set of precoding matrixes corresponding to v_ri layers or for the partial coherent precoding matrixes, N3, M3 may be configured for the fourth set of precoding matrixes corresponding to v_ri layers or for the non-coherent precoding matrixes.

In some embodiments, the 8 antenna ports for PUSCH transmission or the 8 antenna ports of the 8-port SRS may be {AP0, AP1, AP2, AP3, AP4, AP5, AP6, AP7}. And AP0 or AP1 or AP2 or AP3 or AP4 or AP5 or AP6 or AP7 may be any one of {0, 1, 2,3, 4, 5, 6, 7} or any one of {1000, 1001, 1002, 1003, 1004, 1005, 1006, 1007} or any one of {3000,3001, 3002, 3003, 3004, 3005, 3006, 3007}. In some embodiments, the values of AP0 or AP1 or AP2 or AP3 or AP4 or AP5 or AP6 or AP7 may be different from each other.

In some embodiments, in each group, 1 or 2 or 4 of {AP_a, AP_b, AP_c, AP_d, AP_e, AP_f, AP_g, AP_h} can be included. The {a,b,c,d,e,f,g,h}, {AP_a, AP_b, AP_c, AP_d, AP_e, AP_f, AP_g, AP_h} may integer and can be {0, 1, 2, 3,4,5,6,7}. The numbers may be different from each other. For example, there are several port grouping configurations (4 ports in a group), {0, 1, 2, 3}, {4,5,6,7} or {0,2,4,6}, {1,3,5,7}. As another embodiment, there are several port grouping configurations (2 ports in a group), {0, 1}, {2,3}, {4,5}, {6,7} or {0,2}, {1,3}, {4,6}, {5,7}.

In some embodiments, the at least one configuration may indicate one of the port grouping configurations. For example, DMRS ports in same group may share a same PTRS port. In some embodiments, the precoding matrix may be an 8*v matrix, where v represents number of layers, v may be integer and 1<=v<=8 or 4<=v<=8. In some embodiments, v may be same as v_ri.

In some embodiments, the terminal device 110 may be configured with 8Tx for uplink transmission or configured with PUSCH transmission associated with SRS with 8 ports. The at least one configuration may include at least one of: values for i_{1,1}, values for i_{1,2}, values for i_{1,3}, values for i₂, values for i_{1,4,1}, values for i_{1,4,2}, values for i_{2,0}, values for i_{2,1}, values for i_{2,2}, values for Ng, values for N₁, values for N₂, values for O₁, values for O₂, and a configuration pattern (e.g. for antenna ports). The configuration pattern and/or the values may be applied at least for full-coherent precoding matrixes.

In some embodiments, the at least one configuration may indicate the first subset or the second subset or the third subset or the fourth subset of precoding matrixes corresponding to v_ri layers may be applied for the PUSCH transmission. For example, the DCI may indicate one of the applicable precoding matrixes for the PUSCH transmission.

In some embodiments, the at least one configuration may indicate two groups of antenna ports, and each group may comprise 4 antenna ports, and based on the at least one configuration, a DCI may indicate one precoding matrix of the first subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the second subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the third subset of precoding matrixes corresponding to v_ri layers for the PUSCH transmission. In some embodiments, the at least one configuration may indicate four groups of antenna ports, and each group comprises 2 antenna ports, and based on the at least one configuration, a DCI may indicate one precoding matrix of the fourth subset of precoding matrixes corresponding to v_ri layers for the PUSCH transmission.

In some embodiments, the at least one configuration may indicate one or two groups of antenna ports, and each group may comprise 4 antenna ports, and based on the at least one configuration, a DCI may indicate one precoding matrix from the second subset of precoding matrixes corresponding to v_ri layers for the PUSCH transmission.

In some embodiments, in a column or row of a precoding matrix in the second subset of precoding matrixes corresponding to v_ri layers, the indexes of the 4 non-zero values may be based on the indexes of antenna port indexes in a group. For example, the non-zero values in a column or row may be only mapped on indexes based on the index of antenna ports in the one or two groups. In some embodiments, a first group may comprise 4 antenna ports, and the 4 antenna ports may be {AP0, AP1, AP2, AP3}. In some embodiments, a second group may comprise 4 antenna ports, and the 4 antenna ports may be {AP4, AP5, AP6, AP7}.

In some embodiments, in a column or row of the precoding matrix, one of length-4 vectors in the first set or second set of length-4 vectors may be mapped on the indexes of elements based on the antenna port indexes in the first group and/or the second group.

In some embodiments, for the second set of precoding matrixes corresponding to 8 layers, for a first set of 4 columns or rows (e.g. the first 4 columns or rows), a set of length-4 vectors may be mapped on element with indexes based on the 4 antenna ports in the first group, and for a second set of 4 columns or rows (e.g. the remaining or last 4 columns or rows), a set of length-4 vectors may be mapped on elements with indexes based on the 4 antenna ports in the second group.

In some embodiments, for the third set of precoding matrixes corresponding to 8 layers, for a first set of 2 columns or rows (e.g. the first and second columns or rows), a set of length-2 vectors may be mapped on elements with indexes based on two out of the 4 antenna ports in the first group, and for a second set of 2 columns or rows (e.g. the third and fourth columns or rows), a set of length-2 vectors may be mapped on elements with indexes based on remaining two antenna ports in the first group, and for a third set of 2 columns or rows (e.g. the fifth and sixth columns or rows), a set of length-2 vectors may be mapped on element with indexes based on two out of the 4 antenna ports in the second group, and for a fourth set of 2 columns or rows (e.g. the seventh and eighth columns or rows), a set of length-2 vectors may be mapped on elements with indexes based on remaining two antenna ports in the second group.

In some embodiments, in a column or row of a precoding matrix in the third subset of precoding matrixes corresponding to v_ri layers, the indexes of the 2 non-zero values may be based on the indexes of two out of the four antenna port indexes in a group. For example, the non-zero values in a column or row may be only mapped on indexes based on the index of antenna ports in the one or two groups. For example, a first group with 4 antenna ports may be {AP0, AP1, AP2, AP3}. For another example, a second group with 4 antenna ports may be {AP4, AP5, AP6, AP7}. In some embodiments, in a column or row of the precoding matrix, one of length-2 vectors in the first set or second set of length-2 vectors may be mapped on the indexes of elements based on two out of 4 antenna port indexes in the first group and/or the second group.

In some embodiments, in a column or row of a precoding matrix in the fourth subset of precoding matrixes corresponding to v_ri layers, the indexes of the 1 non-zero value (with value 1) may be based on the indexes of one out of the four antenna port indexes in a group. For example, the non-zero values in a column or row may be only mapped on indexes based on the index of antenna ports in the one or two groups. For example, a first group with 4 antenna ports may be {AP0, AP1, AP2, AP3}. For another example, a second group with 4 antenna ports may be {AP4, AP5, AP6, AP7}. In some embodiments, in a column or row of the precoding matrix, the value 1 may be mapped on the index of elements based on one out of 4 antenna port indexes in the first group and/or the second group.

In some embodiments, the at least one configuration may indicate one or two or three or four groups of antenna ports, and each group may comprise 2 antenna ports, and based on the at least one configuration, a DCI may indicate one precoding matrix from the second subset of precoding matrixes corresponding to v_ri layers for the PUSCH transmission. In some embodiments, in a column or row of the precoding matrix, the indexes of the 2 non-zero values may be based on the indexes of antenna port indexes in a group. For example, the non-zero values in a column or row may be only mapped on indexes based on the index of antenna ports in the one or two or three or four groups.

In some embodiments, there may be a third group, and the third group may comprise 2 antenna ports with indexes {AP0, AP1}. In some embodiments, there may be a fourth group, and the fourth group may comprise 2 antenna ports with indexes {AP2, AP3}. In some embodiments, there may be a fifth group, and the fifth group may comprise 2 antenna ports with indexes {AP4, AP5}. In some embodiments, there may be a sixth group, and the sixth group may comprise 2 antenna ports with indexes {AP6, AP7}. In some embodiments, in a column or row of the precoding matrix, one of length-2 vectors in the first set or second set of length-2 vectors may be mapped on the indexes of elements based on the antenna port indexes in the third group and/or the fourth group and/or the fifth group and/or the sixth group.

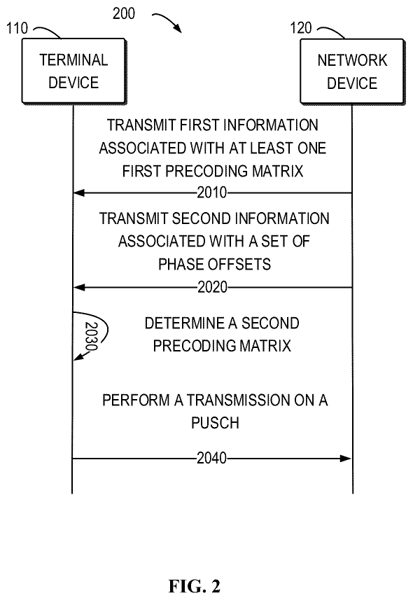

Example embodiments of the present disclosure will be described in detail below. Reference is first made to FIG. 2, which shows a signaling chart illustrating process 200 among the terminal device and the network device according to some example embodiments of the present disclosure. Only for the purpose of discussion, the process 200 will be described with reference to FIG. 1. For example, the process 200 may involve the terminal device 110 and the network device 120.

The network device 120 transmits 2010 first information associated with at least one first precoding matrix to the terminal device 110. In some embodiments, the first information may be included in a downlink control information (DCI) field. In this case, the DCI field may indicate an index of the at least one first precoding matrix. In some embodiments, the first precoding matrix may be a discrete Fourier transform (DFT) based precoding matrix. Alternatively, the first precoding matrix may be a first downlink type precoding matrix. For example, the first precoding matrix may be Rel-15 DL typeI precoder.

The network device 120 transmits 2020 second information to the terminal device 110. The second information is associated with a set of phase offsets for the at least one first precoding matrix. In some embodiments, a phase offset in the set of phase offsets may be between antennas of the terminal device 110. The terms “antenna” and “antenna ports” can be used interchangeable. In some embodiments, the second information may be transmitted via medium access control (MAC) signaling. Alternatively, the second information may be transmitted via radio resource control (RRC) signaling.

In some embodiments, the number of phase offsets in the set of phase offsets may be less than the number of rows or the number of columns in each one of the at least one first precoding matrix. In some embodiments, the number of phase offsets may be one of: 7, 6, 3, or 2.

In an example embodiment, the set of phase offsets may be same for layers of each one of the at least one first precoding matrix. Alternatively, the set of phase offsets may be layer common.

In some examples, a phase offset in the set of phase offsets may be at least one of: {1, j, −1, −j}. In some other embodiments, a phase offset in the set of phase offsets may be e^{j*2π*m/M}, where M is at least one of {4, 8, 16}, and m is an integer from 0 to M−1.

In some embodiments, a default value of a phase offset may be a predetermined value. For example, without indication of the phase offset), the value of the phase offset may be 1.

In an example embodiment, the network device 120 may transmit a configuration indicating a valid duration for the set of phase offsets to the terminal device 110. For example, the terminal device 110 may be configured with a valid duration for the phase offset. In some embodiments, the configuration may be transmitted via RRC signaling. Alternatively, the configuration may be transmitted via MAC signaling.

In some embodiments, the number of the set of phase offsets may be 7. For example, {e^{j*2π*b(0)}, e^{j*2π*b(1)}, e^{j*2π*b(2)}, e^{j*2π*b(3)}, e^{j*2π*b(4)}, e^{j*2π*b(5)}, e^{j*2π*b(6)}}. In some embodiments, at least one of the values of {b(0), b(1), b(2), b(3), b(4), b(5), b(6)} may be fixed as 0. For example, no need of configuration/indication for the values fixed as 0. In some embodiments, the value of b(3) may be fixed as 0. In some embodiments, the value of b(0) and/or the value of the value of b(1) and/or the value of the value of b(3) and/or the value of the value of b(5) may be fixed as 0. In some embodiments, the value of b(0) and/or the value of the value of b(1) and/or the value of the value of b(2) and/or the value of the value of b(3) and/or the value of the value of b(5) may be fixed as 0. In some embodiments, the value of b(0) and/or the value of the value of b(1) and/or the value of the value of b(2) and/or the value of the value of b(4) and/or the value of the value of b(5) may be fixed as 0.

The terminal device 110 determine 2030 a second precoding matrix based on the at least one first precoding matrix and the second information. The terminal device 110 performs 2040 a transmission to the network device on a physical uplink shared channel (PUSCH) based on the second precoding matrix. In this way, the overhead can be reduced.

In some embodiments, the terminal device 110 may be configured with at least one of Table 1 or Table 2 as below.

TABLE 1
Mapping of i_{1, 3} to k₁ and k₂ for 2-layer CSI reporting

| | N₁ > N₂ > 1 | | N₁ = N₂ | | N₁ = 2, N₂ = 1 | | N₁ > 2, N₂ = 1 | |
|---|---|---|---|---|---|---|---|---|
| i_{1, 3} | k₁ | k₂ | k₁ | k₂ | k₁ | k₂ | k₁ | k₂ |
| 0 | 0 | 0 | 0 | 0 | 0 | 0 | 0 | 0 |
| 1 | O₁ | 0 | O₁ | 0 | O₁ | 0 | O₁ | 0 |
| 2 | 0 | O₂ | 0 | O₂ | | | 2 O₁ | 0 |
| 3 | 2 O₁ | 0 | O₁ | O₂ | | | 3O₁ | 0 |

TABLE 2
Mapping of i_{1, 3} to k₁ and k₂ for 3-layer
and 4-layer CSI reporting when P_{CSI-RS} < 16

| | N₁ = 2, N₂ = 1 | | N₁ = 4, N₂ = 1 | | N₁ = 6, N₂ = 1 | | N₁ = 2, N₂ = 2 | | N₁ = 3, N₂ = 2 | |
|---|---|---|---|---|---|---|---|---|---|---|
| i_{1, 3} | k₁ | k₂ | k₁ | k₂ | k₁ | k₂ | k₁ | k₂ | k₁ | k₂ |
| 0 | O₁ | 0 | O₁ | 0 | O₁ | 0 | O₁ | 0 | O₁ | 0 |
| 1 | | | 2 O₁ | 0 | 2 O₁ | 0 | 0 | O₂ | 0 | O₂ |
| 2 | | | 3O₁ | 0 | 3O₁ | 0 | O₁ | O₂ | O₁ | O₂ |
| 3 | | | | | 4 O₁ | 0 | | | 2 O₁ | 0 |

In some embodiments, cp which is a phase difference for cross polarization may be φ=e^{j*2π*g}. In some embodiments, g may be one of:

$$0 , \frac{1}{4} , \frac{1}{2} , \frac{3}{4} .$$

### Alternatively, g may be one of:

$$0 , \frac{1}{8} , \frac{1}{4} , \frac{3}{8} , \frac{1}{2} , \frac{5}{8} , \frac{3}{4} , \frac{7}{8} .$$

By way of an example, for 1-layer precoder, the first precoding matrix may be one precoder/precoding matrix of Rel-15 DL TypeI codebook. In some embodiments, the first precoding matrix may be:

$$\frac{1}{\sqrt{8}} [ \begin{matrix}{e}^{j * 2 π * a ( 0 )} \\ {e}^{j * 2 π * a ( 1 )} \\ {e}^{j * 2 π * a ( 2 )} \\ {e}^{j * 2 π * a ( 3 )} \\ {e}^{j * 2 π * g} * {e}^{j * 2 π * a ( 0 )} \\ {e}^{j * 2 π * g} * {e}^{j * 2 π * a ( 1 )} \\ {e}^{j * 2 π * g} * {e}^{j * 2 π * a ( 2 )} \\ {e}^{j * 2 π * g} * {e}^{j * 2 π * a ( 3 )}\end{matrix} ] .$$

In this case, the second precoding matrix may be:

$${W}^{( 1 )} = \frac{1}{\sqrt{8}} [ \begin{matrix}p ( 0 ) \\ p ( 1 ) * {e}^{j * 2 π * b ( 0 )} \\ p ( 2 ) * {e}^{j * 2 π * b ( 1 )} \\ p ( 3 ) * {e}^{j * 2 π * b ( 2 )} \\ φ * p ( 0 ) * {e}^{j * 2 π * b ( 3 )} \\ φ * p ( 1 ) * {e}^{j * 2 π * b ( 4 )} \\ φ * p ( 2 ) * {e}^{j * 2 π * b ( 5 )} \\ φ * p ( 3 ) * {e}^{j * 2 π * b ( 6 )}\end{matrix} ] = \frac{1}{\sqrt{8}} [ \begin{matrix}{e}^{j * 2 π * a ( 0 )} \\ {e}^{j * 2 π * a ( 1 )} * {e}^{j * 2 π * b ( 0 )} \\ {e}^{j * 2 π * a ( 2 )} * {e}^{j * 2 π * b ( 1 )} \\ {e}^{j * 2 π * a ( 3 )} * {e}^{j * 2 π * b ( 2 )} \\ {e}^{j * 2 π * g} * {e}^{j * 2 π * a ( 0 )} * {e}^{j * 2 π * b ( 3 )} \\ {e}^{j * 2 π * g} * {e}^{j * 2 π * a ( 1 )} * {e}^{j * 2 π * b ( 4 )} \\ {e}^{j * 2 π * g} * {e}^{j * 2 π * a ( 2 )} * {e}^{j * 2 π * b ( 5 )} \\ {e}^{j * 2 π * g} * {e}^{j * 2 π * a ( 3 )} * {e}^{j * 2 π * b ( 6 )}\end{matrix} ] ,$$

where φ may represent a phase difference for cross polarization, e^{j*2π*b(m)} may represent the m-th phase offset. In some embodiments,

$$[ \begin{matrix}a ( 0 ) & a ( 1 ) & a ( 2 ) & a ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}, for example, for (N1,N2)=(4,1). In some embodiments,

$$[ \begin{matrix}a ( 0 ) & a ( 1 ) & a ( 2 ) & a ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}, for example, for (N1,N2)=(2,2).

In some embodiments, for 2-layer precoder, the second precoding matrix may be:

$${W}^{( 2 )} = \frac{1}{\sqrt{2 * 8}} [ \begin{matrix}{p}_{1} ( 0 ) \\ {p}_{1} ( 1 ) * {e}^{j * 2 π * b ( 0 )} \\ {p}_{2} ( 2 ) * {e}^{j * 2 π * b ( 1 )} \\ {p}_{3} ( 3 ) * {e}^{j * 2 π * b ( 2 )} \\ φ * {p}_{1} ( 0 ) * {e}^{j * 2 π * b ( 3 )} \\ φ * {p}_{1} ( 1 ) * {e}^{j * 2 π * b ( 4 )} \\ φ * {p}_{1} ( 2 ) * {e}^{j * 2 π * b ( 5 )} \\ φ * {p}_{1} ( 3 ) * {e}^{j * 2 π * b ( 6 )}\end{matrix} \begin{matrix}{p}_{2} ( 0 ) \\ {p}_{2} ( 1 ) * {e}^{j * 2 π * b ( 0 )} \\ {p}_{2} ( 2 ) * {e}^{j * 2 π * b ( 1 )} \\ {p}_{2} ( 3 ) * {e}^{j * 2 π * b ( 2 )} \\ - φ * {p}_{2} ( 0 ) * {e}^{j * 2 π * b ( 3 )} \\ - φ * {p}_{2} ( 1 ) * {e}^{j * 2 π * b ( 4 )} \\ - φ * {p}_{2} ( 2 ) * {e}^{j * 2 π * b ( 5 )} \\ - φ * {p}_{2} ( 3 ) * {e}^{j * 2 π * b ( 6 )}\end{matrix} ] = \frac{1}{\sqrt{2 * 8}} [ \begin{matrix}{e}^{j * 2 π * {a}_{1} ( 0 )} \\ {e}^{j * 2 π * {a}_{1} ( 1 )} * {e}^{j * 2 π * b ( 0 )} \\ {e}^{j * 2 π * {a}_{1} ( 2 )} * {e}^{j * 2 π * b ( 1 )} \\ {e}^{j * 2 π * {a}_{1} ( 3 )} * {e}^{j * 2 π * b ( 2 )} \\ {e}^{j * 2 π * g} * {e}^{j * 2 π * {a}_{1} ( 0 )} * {e}^{j * 2 π * b ( 3 )} \\ {e}^{j * 2 π * g} * {e}^{j * 2 π * {a}_{1} ( 1 )} * {e}^{j * 2 π * b ( 4 )} \\ {e}^{j * 2 π * g} * {e}^{j * 2 π * {a}_{1} ( 2 )} * {e}^{j * 2 π * b ( 5 )} \\ {e}^{j * 2 π * g} * {e}^{j * 2 π * {a}_{1} ( 3 )} * {e}^{j * 2 π * b ( 6 )}\end{matrix} \begin{matrix}{e}^{j * 2 π * {a}_{2} ( 0 )} \\ {e}^{j * 2 π * {a}_{2} ( 1 )} * {e}^{j * 2 π * b ( 0 )} \\ {e}^{j * 2 π * {a}_{2} ( 2 )} * {e}^{j * 2 π * b ( 1 )} \\ {e}^{j * 2 π * {a}_{2} ( 3 )} * {e}^{j * 2 π * b ( 2 )} \\ {e}^{j * 2 π * g} * {e}^{j * 2 π * {a}_{2} ( 0 )} * {e}^{j * 2 π * b ( 3 )} \\ {e}^{j * 2 π * g} * {e}^{j * 2 π * {a}_{2} ( 1 )} * {e}^{j * 2 π * b ( 4 )} \\ {e}^{j * 2 π * g} * {e}^{j * 2 π * {a}_{2} ( 2 )} * {e}^{j * 2 π * b ( 5 )} \\ {e}^{j * 2 π * g} * {e}^{j * 2 π * {a}_{2} ( 3 )} * {e}^{j * 2 π * b ( 6 )}\end{matrix} ] .$$

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+k1. In this case, k1 may be at least one of 0, O₁, 2O₁, 3O₁.

In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+k₁, m′=m+k2 In this case, k1 may be at least one of 0, O₁, 2O₁, 3O₁ and k2 may be at least one of 0, O₂.

In other embodiments, for 3-layer precoder, the second precoding matrix may be:

$${W}^{( 3 )} = \frac{1}{\sqrt{3 * 8}} [ \begin{matrix}{p}_{1} ( 0 ) \\ {p}_{1} ( 1 ) * {e}^{j * 2 π * b ( 0 )} \\ {p}_{2} ( 2 ) * {e}^{j * 2 π * b ( 1 )} \\ {p}_{3} ( 3 ) * {e}^{j * 2 π * b ( 2 )} \\ φ * {p}_{1} ( 0 ) * {e}^{j * 2 π * b ( 3 )} \\ φ * {p}_{1} ( 1 ) * {e}^{j * 2 π * b ( 4 )} \\ φ * {p}_{1} ( 2 ) * {e}^{j * 2 π * b ( 5 )} \\ φ * {p}_{1} ( 3 ) * {e}^{j * 2 π * b ( 6 )}\end{matrix} \begin{matrix}{p}_{2} ( 0 ) \\ {p}_{2} ( 1 ) * {e}^{j * 2 π * b ( 0 )} \\ {p}_{2} ( 2 ) * {e}^{j * 2 π * b ( 1 )} \\ {p}_{2} ( 3 ) * {e}^{j * 2 π * b ( 2 )} \\ φ * {p}_{2} ( 0 ) * {e}^{j * 2 π * b ( 3 )} \\ φ * {p}_{2} ( 1 ) * {e}^{j * 2 π * b ( 4 )} \\ φ * {p}_{2} ( 2 ) * {e}^{j * 2 π * b ( 5 )} \\ φ * {p}_{2} ( 3 ) * {e}^{j * 2 π * b ( 6 )}\end{matrix} \begin{matrix}{p}_{1} ( 0 ) \\ {p}_{1} ( 1 ) * {e}^{j * 2 π * b ( 0 )} \\ {p}_{1} ( 2 ) * {e}^{j * 2 π * b ( 1 )} \\ {p}_{1} ( 3 ) * {e}^{j * 2 π * b ( 2 )} \\ - φ * {p}_{1} ( 0 ) * {e}^{j * 2 π * b ( 3 )} \\ - φ * {p}_{1} ( 1 ) * {e}^{j * 2 π * b ( 4 )} \\ - φ * {p}_{1} ( 2 ) * {e}^{j * 2 π * b ( 5 )} \\ - φ * {p}_{1} ( 3 ) * {e}^{j * 2 π * b ( 6 )}\end{matrix} ] = \frac{1}{\sqrt{2 * 8}} [ \text{} \begin{matrix}{e}^{j * 2 π * {a}_{1} ( 0 )} \\ {e}^{j * 2 π * {a}_{1} ( 1 )} * {e}^{j * 2 π * b ( 0 )} \\ {e}^{j * 2 π * {a}_{1} ( 2 )} * {e}^{j * 2 π * b ( 1 )} \\ {e}^{j * 2 π * {a}_{1} ( 3 )} * {e}^{j * 2 π * b ( 2 )} \\ {e}^{j * 2 π * g} * {e}^{j * 2 π * {a}_{1} ( 0 )} * {e}^{j * 2 π * b ( 3 )} \\ {e}^{j * 2 π * g} * {e}^{j * 2 π * {a}_{1} ( 1 )} * {e}^{j * 2 π * b ( 4 )} \\ {e}^{j * 2 π * g} * {e}^{j * 2 π * {a}_{1} ( 2 )} * {e}^{j * 2 π * b ( 5 )} \\ {e}^{j * 2 π * g} * {e}^{j * 2 π * {a}_{1} ( 3 )} * {e}^{j * 2 π * b ( 6 )}\end{matrix} \begin{matrix}{e}^{j * 2 π * {a}_{2} ( 0 )} \\ {e}^{j * 2 π * {a}_{2} ( 1 )} * {e}^{j * 2 π * b ( 0 )} \\ {e}^{j * 2 π * {a}_{2} ( 2 )} * {e}^{j * 2 π * b ( 1 )} \\ {e}^{j * 2 π * {a}_{2} ( 3 )} * {e}^{j * 2 π * b ( 2 )} \\ {e}^{j * 2 π * g} * {e}^{j * 2 π * {a}_{2} ( 0 )} * {e}^{j * 2 π * b ( 3 )} \\ {e}^{j * 2 π * g} * {e}^{j * 2 π * {a}_{2} ( 1 )} * {e}^{j * 2 π * b ( 4 )} \\ {e}^{j * 2 π * g} * {e}^{j * 2 π * {a}_{2} ( 2 )} * {e}^{j * 2 π * b ( 5 )} \\ {e}^{j * 2 π * g} * {e}^{j * 2 π * {a}_{2} ( 3 )} * {e}^{j * 2 π * b ( 6 )}\end{matrix} \begin{matrix}{e}^{j * 2 π * {a}_{1} ( 0 )} \\ {e}^{j * 2 π * {a}_{1} ( 1 )} * {e}^{j * 2 π * b ( 0 )} \\ {e}^{j * 2 π * {a}_{1} ( 2 )} * {e}^{j * 2 π * b ( 1 )} \\ {e}^{j * 2 π * {a}_{1} ( 3 )} * {e}^{j * 2 π * b ( 2 )} \\ - {e}^{j * 2 π * g} * {e}^{j * 2 π * {a}_{1} ( 0 )} * {e}^{j * 2 π * b ( 3 )} \\ - {e}^{j * 2 π * g} * {e}^{j * 2 π * {a}_{1} ( 1 )} * {e}^{j * 2 π * b ( 4 )} \\ - {e}^{j * 2 π * g} * {e}^{j * 2 π * {a}_{1} ( 2 )} * {e}^{j * 2 π * b ( 5 )} \\ - {e}^{j * 2 π * g} * {e}^{j * 2 π * {a}_{1} ( 3 )} * {e}^{j * 2 π * b ( 6 )}\end{matrix} \text{?}$$

$$\text{?} \text{indicates text missing or illegible when filed}$$

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈={0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+k1. In this case, k1 may be at least one of 0, O₁, 2O₁, 3O₁. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0, 1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+k1, m′=m+k2. In this case, k1 may be at least one of 0, O₁, 2O₁, 3O₁ and k2 may be at least one of 0, O₂, for example, {k1,k2}={O₁,0} or {0,O₂}, {O₁,O}.

In embodiments, for 4-layer precoder, the second precoding matrix may beW⁽⁴⁾=

$$1 / \sqrt{4 * 8} [ \begin{matrix}{p}_{1} ( 0 ) & {p}_{2} ( 0 ) & {p}_{1} ( 0 ) & {p}_{2} ( 0 ) \\ {p}_{1} ( 1 ) * {e}^{j * 2 π * b ( 0 )} & {p}_{2} ( 1 ) * {e}^{j * 2 π * b ( 0 )} & {p}_{1} ( 1 ) * {e}^{j * 2 π * b ( 0 )} & {p}_{2} ( 1 ) * {e}^{j * 2 π * b ( 0 )} \\ {p}_{1} ( 2 ) * {e}^{j * 2 π * b ( 1 )} & {p}_{2} ( 2 ) * {e}^{j * 2 π * b ( 1 )} & {p}_{1} ( 2 ) * {e}^{j * 2 π * b ( 1 )} & {p}_{2} ( 2 ) * {e}^{j * 2 π * b ( 1 )} \\ {p}_{1} ( 3 ) * {e}^{j * 2 π * b ( 2 )} & {p}_{2} ( 3 ) * {e}^{j * 2 π * b ( 2 )} & {p}_{1} ( 3 ) * {e}^{j * 2 π * b ( 2 )} & {p}_{2} ( 3 ) * {e}^{j * 2 π * b ( 2 )} \\ φ * {p}_{1} ( 0 ) * {e}^{j * 2 π * b ( 3 )} & φ * {p}_{2} ( 0 ) * {e}^{j * 2 π * b ( 3 )} & - φ * {p}_{1} ( 0 ) * {e}^{j * 2 π * b ( 3 )} & - φ * {p}_{2} ( 0 ) * {e}^{j * 2 π * b ( 3 )} \\ φ * {p}_{1} ( 1 ) * {e}^{j * 2 π * b ( 4 )} & φ * {p}_{2} ( 1 ) * {e}^{j * 2 π * b ( 4 )} & - φ * {p}_{1} ( 1 ) * {e}^{j * 2 π * b ( 4 )} & - φ * {p}_{2} ( 1 ) * {e}^{j * 2 π * b ( 4 )} \\ φ * {p}_{1} ( 2 ) * {e}^{j * 2 π * b ( 5 )} & φ * {p}_{2} ( 2 ) * {e}^{j * 2 π * b ( 5 )} & - φ * {p}_{1} ( 2 ) * {e}^{j * 2 π * b ( 5 )} & - φ * {p}_{2} ( 2 ) * {e}^{j * 2 π * b ( 5 )} \\ φ * {p}_{1} ( 3 ) * {e}^{j * 2 π * b ( 6 )} & φ * {p}_{2} ( 3 ) * {e}^{j * 2 π * b ( 6 )} & - φ * {p}_{1} ( 3 ) * {e}^{j * 2 π * b ( 6 )} & - φ * {p}_{2} ( 3 ) * {e}^{j * 2 π * b ( 6 )}\end{matrix} ] = 1 / \sqrt{4 * 8} [ \begin{matrix}{e}^{j * 2 π * {a}_{1} ( 0 )} & {e}^{j * 2 π * {a}_{2} ( 0 )} & {e}^{j * 2 π * {a}_{1} ( 0 )} & {e}^{j * 2 π * {a}_{2} ( 0 )} \\ {e}^{j * 2 π * {a}_{1} ( 1 )} * {e}^{j * 2 π * b ( 0 )} & {e}^{j * 2 π * {a}_{2} ( 1 )} * {e}^{j * 2 π * b ( 0 )} & {e}^{j * 2 π * {a}_{1} ( 1 )} * {e}^{j * 2 π * b ( 0 )} & {e}^{j * 2 π * {a}_{1} ( 1 )} * {e}^{j * 2 π * b ( 0 )} \\ {e}^{j * 2 π * {a}_{1} ( 2 )} * {e}^{j * 2 π * b ( 1 )} & {e}^{j * 2 π * {a}_{2} ( 2 )} * {e}^{j * 2 π * b ( 1 )} & {e}^{j * 2 π * {a}_{1} ( 2 )} * {e}^{j * 2 π * b ( 1 )} & {e}^{j * 2 π * {a}_{1} ( 2 )} * {e}^{j * 2 π * b ( 1 )} \\ {e}^{j * 2 π * {a}_{1} ( 3 )} * {e}^{j * 2 π * b ( 2 )} & {e}^{j * 2 π * {a}_{2} ( 3 )} * {e}^{j * 2 π * b ( 2 )} & {e}^{j * 2 π * {a}_{1} ( 3 )} * {e}^{j * 2 π * b ( 2 )} & {e}^{j * 2 π * {a}_{1} ( 3 )} * {e}^{j * 2 π * b ( 2 )} \\ {e}^{j * 2 π * g} * {e}^{j * 2 π * {a}_{1} ( 0 )} * {e}^{j * 2 π * b ( 3 )} & {e}^{j * 2 π * g} * {e}^{j * 2 π * {a}_{2} ( 0 )} * {e}^{j * 2 π * b ( 3 )} & - {e}^{j * 2 π * g} * {e}^{j * 2 π * {a}_{1} ( 0 )} * {e}^{j * 2 π * b ( 3 )} & - {e}^{j * 2 π * g} * {e}^{j * 2 π * {a}_{2} ( 0 )} * {e}^{j * 2 π * b ( 3 )} \\ {e}^{j * 2 π * g} * {e}^{j * 2 π * {a}_{1} ( 1 )} * {e}^{j * 2 π * b ( 4 )} & {e}^{j * 2 π * g} * {e}^{j * 2 π * {a}_{2} ( 1 )} * {e}^{j * 2 π * b ( 4 )} & - {e}^{j * 2 π * g} * {e}^{j * 2 π * {a}_{1} ( 1 )} * {e}^{j * 2 π * b ( 4 )} & - {e}^{j * 2 π * g} * {e}^{j * 2 π * {a}_{2} ( 1 )} * {e}^{j * 2 π * b ( 4 )} \\ {e}^{j * 2 π * g} * {e}^{j * 2 π * {a}_{1} ( 2 )} * {e}^{j * 2 π * b ( 5 )} & {e}^{j * 2 π * g} * {e}^{j * 2 π * {a}_{2} ( 2 )} * {e}^{j * 2 π * b ( 5 )} & - {e}^{j * 2 π * g} * {e}^{j * 2 π * {a}_{1} ( 2 )} * {e}^{j * 2 π * b ( 5 )} & - {e}^{j * 2 π * g} * {e}^{j * 2 π * {a}_{2} ( 2 )} * {e}^{j * 2 π * b ( 5 )} \\ {e}^{j * 2 π * g} * {e}^{j * 2 π * {a}_{1} ( 3 )} * {e}^{j * 2 π * b ( 6 )} & {e}^{j * 2 π * g} * {e}^{j * 2 π * {a}_{2} ( 3 )} * {e}^{j * 2 π * b ( 6 )} & - {e}^{j * 2 π * g} * {e}^{j * 2 π * {a}_{1} ( 3 )} * {e}^{j * 2 π * b ( 6 )} & - {e}^{j * 2 π * g} * {e}^{j * 2 π * {a}_{2} ( 3 )} * {e}^{j * 2 π * b ( 6 )}\end{matrix} ] .$$

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+k₁. In this case, in some embodiments, k1 may be at least one of 0, O1, 2O1, 3O1. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0, 1, . . . O₁N₁−1}, m∈{0,1, . . . O₂N₂−1}. l′=l+k1, m′=m+k2. In this case, k1 may be at least one of 0, O1, 2O1, 3O1 and k2 may be at least one of 0, O2, for example, {k1,k2}={O1,0} or {0,O2}, {O1,O2}.

In embodiments, for 5-layer precoder, the second precoding matrix may be:

$${W}^{( 5 )} = 1 / \sqrt{5 * 8} [ \begin{matrix}{p}_{1} ( 0 ) & {p}_{1} ( 0 ) & {p}_{2} ( 0 ) & {p}_{2} ( 0 ) & {p}_{3} ( 0 ) \\ {p}_{1} ( 1 ) * {e}^{j * 2 π * b ( 0 )} & {p}_{1} ( 1 ) * {e}^{j * 2 π * b ( 0 )} & {p}_{2} ( 1 ) * {e}^{j * 2 π * b ( 0 )} & {p}_{2} ( 1 ) * {e}^{j * 2 π * b ( 0 )} & {p}_{3} ( 1 ) * {e}^{j * 2 π * b ( 0 )} \\ {p}_{1} ( 2 ) * {e}^{j * 2 π * b ( 1 )} & {p}_{1} ( 2 ) * {e}^{j * 2 π * b ( 1 )} & {p}_{2} ( 2 ) * {e}^{j * 2 π * b ( 1 )} & {p}_{2} ( 2 ) * {e}^{j * 2 π * b ( 1 )} & {p}_{3} ( 2 ) * {e}^{j * 2 π * b ( 1 )} \\ {p}_{1} ( 3 ) * {e}^{j * 2 π * b ( 2 )} & {p}_{1} ( 3 ) * {e}^{j * 2 π * b ( 2 )} & {p}_{2} ( 3 ) * {e}^{j * 2 π * b ( 2 )} & {p}_{2} ( 3 ) * {e}^{j * 2 π * b ( 2 )} & {p}_{3} ( 3 ) * {e}^{j * 2 π * b ( 2 )} \\ φ * {p}_{1} ( 0 ) * {e}^{j * 2 π * b ( 3 )} & - φ * {p}_{1} ( 0 ) * {e}^{j * 2 π * b ( 3 )} & {p}_{2} ( 0 ) * {e}^{j * 2 π * b ( 3 )} & - {p}_{2} ( 0 ) * {e}^{j * 2 π * b ( 3 )} & {p}_{3} ( 0 ) * {e}^{j * 2 π * b ( 3 )} \\ φ * {p}_{1} ( 1 ) * {e}^{j * 2 π * b ( 4 )} & - φ * {p}_{1} ( 1 ) * {e}^{j * 2 π * b ( 4 )} & {p}_{2} ( 1 ) * {e}^{j * 2 π * b ( 4 )} & - {p}_{2} ( 1 ) * {e}^{j * 2 π * b ( 4 )} & {p}_{3} ( 1 ) * {e}^{j * 2 π * b ( 4 )} \\ φ * {p}_{1} ( 2 ) * {e}^{j * 2 π * b ( 5 )} & - φ * {p}_{1} ( 2 ) * {e}^{j * 2 π * b ( 5 )} & {p}_{2} ( 2 ) * {e}^{j * 2 π * b ( 5 )} & - {p}_{2} ( 2 ) * {e}^{j * 2 π * b ( 5 )} & {p}_{3} ( 2 ) * {e}^{j * 2 π * b ( 5 )} \\ φ * {p}_{1} ( 3 ) * {e}^{j * 2 π * b ( 6 )} & - φ * {p}_{1} ( 3 ) * {e}^{j * 2 π * b ( 6 )} & {p}_{2} ( 3 ) * {e}^{j * 2 π * b ( 6 )} & - {p}_{2} ( 3 ) * {e}^{j * 2 π * b ( 6 )} & {p}_{3} ( 3 ) * {e}^{j * 2 π * b ( 6 )}\end{matrix} ] ,$$

where [p₃(0) p₃(1) p₃(2) p₃(3)]=[e^{j*2π*a}^{₃}⁽⁰⁾ e^{j*2π*a}^{₃}⁽¹⁾ e^{j*2π*a}^{₃}⁽²⁾ e^{j*2π*a}^{₃}⁽³⁾].

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+O₁. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{″}}{{O}_{1} {N}_{1}} , \frac{2 {l}^{″}}{{O}_{1} {N}_{1}} , \frac{3 {l}^{″}}{{O}_{1} {N}_{1}} ] ,$$

l′=l+2O₁. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0, 1, . . . O₁N₁−1}, m∈{0,1, . . . O₂N₂−1}. l′=l+O₁, m′=m. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}, m∈{0,1, . . . O₂N₂−1}. l″=l+O₁, m″=m+O₂.

In some embodiments, for 6-layer precoder, the second precoding matrix may be:

$${W}^{( 6 )} = \frac{1}{\sqrt{6 * 8}} [ \begin{matrix}{p}_{1} ( 0 ) & {p}_{1} ( 0 ) & {p}_{2} ( 0 ) & {p}_{2} ( 0 ) & {p}_{3} ( 0 ) & {p}_{3} ( 0 ) \\ {p}_{1} ( 1 ) * {e}^{j * 2 π * b ( 0 )} & {p}_{1} ( 1 ) * {e}^{j * 2 π * b ( 0 )} & {p}_{2} ( 1 ) * {e}^{j * 2 π * b ( 0 )} & {p}_{2} ( 1 ) * {e}^{j * 2 π * b ( 0 )} & {p}_{3} ( 1 ) * {e}^{j * 2 π * b ( 0 )} & {p}_{3} ( 1 ) * {e}^{j * 2 π * b ( 0 )} \\ {p}_{1} ( 2 ) * {e}^{j * 2 π * b ( 1 )} & {p}_{1} ( 2 ) * {e}^{j * 2 π * b ( 1 )} & {p}_{2} ( 2 ) * {e}^{j * 2 π * b ( 1 )} & {p}_{2} ( 2 ) * {e}^{j * 2 π * b ( 1 )} & {p}_{3} ( 2 ) * {e}^{j * 2 π * b ( 1 )} & {p}_{3} ( 2 ) * {e}^{j * 2 π * b ( 1 )} \\ {p}_{1} ( 3 ) * {e}^{j * 2 π * b ( 2 )} & {p}_{1} ( 3 ) * {e}^{j * 2 π * b ( 2 )} & {p}_{2} ( 3 ) * {e}^{j * 2 π * b ( 2 )} & {p}_{2} ( 3 ) * {e}^{j * 2 π * b ( 2 )} & {p}_{3} ( 3 ) * {e}^{j * 2 π * b ( 2 )} & {p}_{3} ( 3 ) * {e}^{j * 2 π * b ( 2 )} \\ φ * {p}_{1} ( 0 ) * {e}^{j * 2 π * b ( 3 )} & - φ * {p}_{1} ( 0 ) * {e}^{j * 2 π * b ( 3 )} & φ * {p}_{2} ( 0 ) * {e}^{j * 2 π * b ( 3 )} & - φ * {p}_{2} ( 0 ) * {e}^{j * 2 π * b ( 3 )} & {p}_{3} ( 0 ) * {e}^{j * 2 π * b ( 3 )} & - {p}_{3} ( 0 ) * {e}^{j * 2 π * b ( 3 )} \\ φ * {p}_{1} ( 1 ) * {e}^{j * 2 π * b ( 4 )} & - φ * {p}_{1} ( 1 ) * {e}^{j * 2 π * b ( 4 )} & φ * {p}_{2} ( 1 ) * {e}^{j * 2 π * b ( 4 )} & - φ * {p}_{2} ( 1 ) * {e}^{j * 2 π * b ( 4 )} & {p}_{3} ( 1 ) * {e}^{j * 2 π * b ( 4 )} & - {p}_{3} ( 1 ) * {e}^{j * 2 π * b ( 4 )} \\ φ * {p}_{1} ( 2 ) * {e}^{j * 2 π * b ( 5 )} & - φ * {p}_{1} ( 2 ) * {e}^{j * 2 π * b ( 5 )} & φ * {p}_{2} ( 2 ) * {e}^{j * 2 π * b ( 5 )} & - φ * {p}_{2} ( 2 ) * {e}^{j * 2 π * b ( 5 )} & {p}_{3} ( 2 ) * {e}^{j * 2 π * b ( 5 )} & - {p}_{3} ( 2 ) * {e}^{j * 2 π * b ( 5 )} \\ φ * {p}_{1} ( 3 ) * {e}^{j * 2 π * b ( 6 )} & - φ * {p}_{1} ( 3 ) * {e}^{j * 2 π * b ( 6 )} & φ * {p}_{2} ( 3 ) * {e}^{j * 2 π * b ( 6 )} & - φ * {p}_{2} ( 3 ) * {e}^{j * 2 π * b ( 6 )} & {p}_{3} ( 3 ) * {e}^{j * 2 π * b ( 6 )} & - {p}_{3} ( 3 ) * {e}^{j * 2 π * b ( 6 )}\end{matrix} ] ,$$

where [p₃(0) p₃(1) p₃(2) p₃(3)]=[e^{j*2π*a}^{₃}⁽⁰⁾ e^{j*2π*a}^{₃}⁽¹⁾ e^{j*2π*a}^{₃}⁽²⁾ e^{j*2π*a}^{₃}⁽³⁾].

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′+l+O₁. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{l}^{″}}{{O}_{1} {N}_{1}} , \frac{2 {l}^{″}}{{O}_{1} {N}_{1}} , \frac{3 {l}^{″}}{{O}_{1} {N}_{1}} ] ,$$

l″=l+2O₁. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+O₁, m′=m. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} N} ] ,$$

l∈{0,1, . . . O₁N₁−1}, m∈{0,1, . . . O₂N₂−1}. l″=l+O₁, m″=m+O₂.

In some embodiments, for 7-layer precoder, the second precoding matrix may be:

$${W}^{( 7 )} = \frac{1}{\sqrt{7 * 8}} [ \begin{matrix}{p}_{1} ( 0 ) & {p}_{1} ( 0 ) & {p}_{2} ( 0 ) & {p}_{3} ( 0 ) & {p}_{3} ( 0 ) & {p}_{4} ( 0 ) & {p}_{4} ( 0 ) \\ {p}_{1} ( 1 ) * {e}^{j * 2 π * b ( 0 )} & {p}_{1} ( 1 ) * {e}^{j * 2 π * b ( 0 )} & {p}_{2} ( 1 ) * {e}^{j * 2 π * b ( 0 )} & {p}_{3} ( 1 ) * {e}^{j * 2 π * b ( 0 )} & {p}_{3} ( 1 ) * {e}^{j * 2 π * b ( 0 )} & {p}_{4} ( 1 ) * {e}^{j * 2 π * b ( 0 )} & {p}_{4} ( 1 ) * {e}^{j * 2 π * b ( 0 )} \\ {p}_{1} ( 2 ) * {e}^{j * 2 π * b ( 1 )} & {p}_{1} ( 2 ) * {e}^{j * 2 π * b ( 1 )} & {p}_{2} ( 2 ) * {e}^{j * 2 π * b ( 1 )} & {p}_{3} ( 2 ) * {e}^{j * 2 π * b ( 1 )} & {p}_{3} ( 2 ) * {e}^{j * 2 π * b ( 1 )} & {p}_{4} ( 2 ) * {e}^{j * 2 π * b ( 1 )} & {p}_{4} ( 2 ) * {e}^{j * 2 π * b ( 1 )} \\ {p}_{1} ( 3 ) * {e}^{j * 2 π * b ( 2 )} & {p}_{1} ( 3 ) * {e}^{j * 2 π * b ( 2 )} & {p}_{2} ( 3 ) * {e}^{j * 2 π * b ( 2 )} & {p}_{3} ( 3 ) * {e}^{j * 2 π * b ( 2 )} & {p}_{3} ( 3 ) * {e}^{j * 2 π * b ( 2 )} & {p}_{4} ( 3 ) * {e}^{j * 2 π * b ( 2 )} & {p}_{4} ( 3 ) * {e}^{j * 2 π * b ( 2 )} \\ φ * {p}_{1} ( 0 ) * {e}^{j * 2 π * b ( 3 )} & - φ * {p}_{1} ( 0 ) * {e}^{j * 2 π * b ( 3 )} & φ * {p}_{2} ( 0 ) * {e}^{j * 2 π * b ( 3 )} & {p}_{3} ( 0 ) * {e}^{j * 2 π * b ( 3 )} & - {p}_{3} ( 0 ) * {e}^{j * 2 π * b ( 3 )} & {p}_{4} ( 0 ) * {e}^{j * 2 π * b ( 3 )} & - {p}_{4} ( 0 ) * {e}^{j * 2 π * b ( 3 )} \\ φ * {p}_{1} ( 1 ) * {e}^{j * 2 π * b ( 4 )} & - φ * {p}_{1} ( 1 ) * {e}^{j * 2 π * b ( 4 )} & φ * {p}_{2} ( 1 ) * {e}^{j * 2 π * b ( 4 )} & {p}_{3} ( 1 ) * {e}^{j * 2 π * b ( 4 )} & - {p}_{3} ( 1 ) * {e}^{j * 2 π * b ( 4 )} & {p}_{4} ( 1 ) * {e}^{j * 2 π * b ( 4 )} & - {p}_{4} ( 1 ) * {e}^{j * 2 π * b ( 4 )} \\ φ * {p}_{1} ( 2 ) * {e}^{j * 2 π * b ( 5 )} & - φ * {p}_{1} ( 2 ) * {e}^{j * 2 π * b ( 5 )} & φ * {p}_{2} ( 2 ) * {e}^{j * 2 π * b ( 5 )} & {p}_{3} ( 2 ) * {e}^{j * 2 π * b ( 5 )} & - {p}_{3} ( 2 ) * {e}^{j * 2 π * b ( 5 )} & {p}_{4} ( 2 ) * {e}^{j * 2 π * b ( 5 )} & - {p}_{4} ( 2 ) * {e}^{j * 2 π * b ( 5 )} \\ φ * {p}_{1} ( 3 ) * {e}^{j * 2 π * b ( 6 )} & - φ * {p}_{1} ( 3 ) * {e}^{j * 2 π * b ( 6 )} & φ * {p}_{2} ( 3 ) * {e}^{j * 2 π * b ( 6 )} & {p}_{3} ( 3 ) * {e}^{j * 2 π * b ( 6 )} & - {p}_{3} ( 3 ) * {e}^{j * 2 π * b ( 6 )} & {p}_{4} ( 3 ) * {e}^{j * 2 π * b ( 6 )} & - {p}_{4} ( 3 ) * {e}^{j * 2 π * b ( 6 )}\end{matrix} ] ,$$

where [p₃(0) p₃(1) p₃(2) p₃(3)]=[e^{j*2π*a}^{₃}⁽⁰⁾ e^{j*2π*a}^{₃}⁽¹⁾ e^{j*2π*a}^{₃}⁽²⁾ e^{j*2π*a}^{₃}⁽³⁾].

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0, 1, . . . O₁N₁/2−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+O₁. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{l}^{″}}{{O}_{1} {N}_{1}} , \frac{2 {l}^{″}}{{O}_{1} {N}_{1}} , \frac{3 {l}^{″}}{{O}_{1} {N}_{1}} ] ,$$

l″=l+2O₁. In some embodiments,

$$[ \begin{matrix}{a}_{4} ( 0 ) & {a}_{4} ( 1 ) & {a}_{4} ( 2 ) & {a}_{4} ( 3 )\end{matrix} ] = [ 1 , \frac{{l}^{′′′}}{{O}_{1} {N}_{1}} , \frac{2 {l}^{′′′}}{{O}_{1} {N}_{1}} , \frac{3 {l}^{′′′}}{{O}_{1} {N}_{1}} ] ,$$

l″=l+O₁. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+O₁, m′=m. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}, m∈{0,1, . . . O₂N₂−1}. l″=l, m″=m+O₂. In some embodiments,

$$[ \begin{matrix}{a}_{4} ( 0 ) & {a}_{4} ( 1 ) & {a}_{4} ( 2 ) & {a}_{4} ( 3 )\end{matrix} ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}, m∈{0,1, . . . O₂N₂−1}. l″=l+O₁, m″=m+O₂.

In some embodiments, for 8-layer precoder, the second precoding matrix may be:

$${W}^{( 8 )} = 1 / \sqrt{8 * 8} [ \begin{matrix}{p}_{1} ( 0 ) & {p}_{1} ( 0 ) & {p}_{2} ( 0 ) & {p}_{2} ( 0 ) & {p}_{3} ( 0 ) & {p}_{3} ( 0 ) & {p}_{4} ( 0 ) & {p}_{4} ( 0 ) \\ {p}_{1} ( 1 ) * {e}^{j * 2 π * b ( 0 )} & {p}_{1} ( 1 ) * {e}^{j * 2 π * b ( 0 )} & {p}_{2} ( 1 ) * {e}^{j * 2 π * b ( 0 )} & {p}_{2} ( 1 ) * {e}^{j * 2 π * b ( 0 )} & {p}_{3} ( 1 ) * {e}^{j * 2 π * b ( 0 )} & {p}_{3} ( 1 ) * {e}^{j * 2 π * b ( 0 )} & {p}_{4} ( 1 ) * {e}^{j * 2 π * b ( 0 )} & {p}_{4} ( 1 ) * {e}^{j * 2 π * b ( 0 )} \\ {p}_{1} ( 2 ) * {e}^{j * 2 π * b ( 1 )} & {p}_{1} ( 2 ) * {e}^{j * 2 π * b ( 1 )} & {p}_{2} ( 2 ) * {e}^{j * 2 π * b ( 1 )} & {p}_{2} ( 2 ) * {e}^{j * 2 π * b ( 1 )} & {p}_{3} ( 2 ) * {e}^{j * 2 π * b ( 1 )} & {p}_{3} ( 2 ) * {e}^{j * 2 π * b ( 1 )} & {p}_{4} ( 2 ) * {e}^{j * 2 π * b ( 1 )} & {p}_{4} ( 2 ) * {e}^{j * 2 π * b ( 1 )} \\ {p}_{1} ( 3 ) * {e}^{j * 2 π * b ( 2 )} & {p}_{1} ( 3 ) * {e}^{j * 2 π * b ( 2 )} & {p}_{2} ( 3 ) * {e}^{j * 2 π * b ( 2 )} & {p}_{2} ( 3 ) * {e}^{j * 2 π * b ( 2 )} & {p}_{3} ( 3 ) * {e}^{j * 2 π * b ( 2 )} & {p}_{3} ( 3 ) * {e}^{j * 2 π * b ( 2 )} & {p}_{4} ( 3 ) * {e}^{j * 2 π * b ( 2 )} & {p}_{4} ( 3 ) * {e}^{j * 2 π * b ( 2 )} \\ φ * {p}_{1} ( 0 ) * {e}^{j * 2 π * b ( 3 )} & - φ * {p}_{1} ( 0 ) * {e}^{j * 2 π * b ( 3 )} & φ * {p}_{2} ( 0 ) * {e}^{j * 2 π * b ( 3 )} & - φ * {p}_{2} ( 0 ) * {e}^{j * 2 π * b ( 3 )} & {p}_{3} ( 0 ) * {e}^{j * 2 π * b ( 3 )} & - {p}_{3} ( 0 ) * {e}^{j * 2 π * b ( 3 )} & {p}_{4} ( 0 ) * {e}^{j * 2 π * b ( 3 )} & - {p}_{4} ( 0 ) * {e}^{j * 2 π * b ( 3 )} \\ φ * {p}_{1} ( 1 ) * {e}^{j * 2 π * b ( 4 )} & - φ * {p}_{1} ( 1 ) * {e}^{j * 2 π * b ( 4 )} & φ * {p}_{2} ( 1 ) * {e}^{j * 2 π * b ( 4 )} & - φ * {p}_{2} ( 1 ) * {e}^{j * 2 π * b ( 4 )} & {p}_{3} ( 1 ) * {e}^{j * 2 π * b ( 4 )} & - {p}_{3} ( 1 ) * {e}^{j * 2 π * b ( 4 )} & {p}_{4} ( 1 ) * {e}^{j * 2 π * b ( 4 )} & - {p}_{4} ( 1 ) * {e}^{j * 2 π * b ( 4 )} \\ φ * {p}_{1} ( 2 ) * {e}^{j * 2 π * b ( 5 )} & - φ * {p}_{1} ( 2 ) * {e}^{j * 2 π * b ( 5 )} & φ * {p}_{2} ( 2 ) * {e}^{j * 2 π * b ( 5 )} & - φ * {p}_{2} ( 2 ) * {e}^{j * 2 π * b ( 5 )} & {p}_{3} ( 2 ) * {e}^{j * 2 π * b ( 5 )} & - {p}_{3} ( 2 ) * {e}^{j * 2 π * b ( 5 )} & {p}_{4} ( 2 ) * {e}^{j * 2 π * b ( 5 )} & - {p}_{4} ( 2 ) * {e}^{j * 2 π * b ( 5 )} \\ φ * {p}_{1} ( 3 ) * {e}^{j * 2 π * b ( 6 )} & - φ * {p}_{1} ( 3 ) * {e}^{j * 2 π * b ( 6 )} & φ * {p}_{2} ( 3 ) * {e}^{j * 2 π * b ( 6 )} & - φ * {p}_{2} ( 3 ) * {e}^{j * 2 π * b ( 6 )} & {p}_{3} ( 3 ) * {e}^{j * 2 π * b ( 6 )} & - {p}_{3} ( 3 ) * {e}^{j * 2 π * b ( 6 )} & {p}_{4} ( 3 ) * {e}^{j * 2 π * b ( 6 )} & - {p}_{4} ( 3 ) * {e}^{j * 2 π * b ( 6 )}\end{matrix} ]$$

where [p₃(0) p₃(1) p₃(2) p₃(3)]=[e^{j*2π*a}^{₃}⁽⁰⁾ e^{j*2π*a}^{₃}⁽¹⁾ e^{j*2π*a}^{₃}⁽²⁾ e^{j*2π*a}^{₃}⁽³⁾].

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁/2−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+O₁. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{l}^{″}}{{O}_{1} {N}_{1}} , \frac{2 {l}^{″}}{{O}_{1} {N}_{1}} , \frac{3 {l}^{″}}{{O}_{1} {N}_{1}} ] ,$$

l″=l+2O₁. In some embodiments,

$$[ \begin{matrix}{a}_{4} ( 0 ) & {a}_{4} ( 1 ) & {a}_{4} ( 2 ) & {a}_{4} ( 3 )\end{matrix} ] = [ 1 , \frac{{l}^{′′′}}{{O}_{1} {N}_{1}} , \frac{2 {l}^{′′′}}{{O}_{1} {N}_{1}} , \frac{3 {l}^{′′′}}{{O}_{1} {N}_{1}} ] ,$$

l″=l+3O₁. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+O₁, m′=m. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}, m∈{0,1, . . . O₂N₂−1}. l″=l, m″=m+O₂. In some embodiments,

$$[ \begin{matrix}{a}_{4} ( 0 ) & {a}_{4} ( 1 ) & {a}_{4} ( 2 ) & {a}_{4} ( 3 )\end{matrix} ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}, m∈{0,1, . . . O₂N₂−1}. l″=l+O₁, m″=m+O₂.

In some embodiments, the number of phase offsets may be 6. For example, when the value of the phase offset is at least one of {1, j, −1, −j}, the number of phase offsets may be 6, as φ can already adjust the phase difference. By way of example, the second precoding matrix may be:

$${W}^{( 1 )} = 1 / \sqrt{8} [ \begin{matrix}p ( 0 ) \\ p ( 1 ) * {e}^{j * 2 π * b ( 0 )} \\ p ( 2 ) * {e}^{j * 2 π * b ( 1 )} \\ p ( 3 ) * {e}^{j * 2 π * b ( 2 )} \\ φ * p ( 0 ) \\ φ * p ( 1 ) * {e}^{j * 2 π * b ( 3 )} \\ φ * p ( 2 ) * {e}^{j * 2 π * b ( 4 )} \\ φ * p ( 3 ) * {e}^{j * 2 π * b ( 5 )}\end{matrix} ] .$$

In some embodiments, the number of phase offsets may be 3 or 2, for example, at least for (N1,N2)=(2,2). By way of example, when the value of the phase offset is at least one of {1, j, −1, −j}, the number of phase offsets may be 3 or 2. In some embodiments, the second precoding matrix may be:

$${W}^{( 1 )} = 1 / \sqrt{8} [ \begin{matrix}p ( 0 ) \\ p ( 1 ) \\ p ( 2 ) \\ p ( 3 ) * {e}^{j * 2 π * b ( 0 )} \\ φ * p ( 0 ) \\ φ * p ( 1 ) * {e}^{j * 2 π * b ( 1 )} \\ φ * p ( 2 ) \\ φ * p ( 3 ) * {e}^{j * 2 π * b ( 2 )}\end{matrix} ] .$$

In some other embodiments, the second precoding matrix may be:

$${W}^{( 1 )} = 1 / \sqrt{8} [ \begin{matrix}p ( 0 ) \\ p ( 1 ) \\ p ( 2 ) \\ p ( 3 ) \\ φ * p ( 0 ) \\ φ * p ( 1 ) * {e}^{j * 2 π * b ( 0 )} \\ φ * p ( 2 ) \\ φ * p ( 3 ) * {e}^{j * 2 π * b ( 1 )}\end{matrix} ] .$$

In some other embodiments, the second precoding matrix may be:

$${W}^{( 1 )} = 1 / \sqrt{8} [ \begin{matrix}p ( 0 ) \\ p ( 1 ) \\ p ( 2 ) \\ p ( 3 ) * {e}^{j * 2 π * b ( 0 )} \\ φ * p ( 0 ) \\ φ * p ( 1 ) \\ φ * p ( 2 ) \\ φ * p ( 3 ) * {e}^{j * 2 π * b ( 1 )}\end{matrix} ] .$$

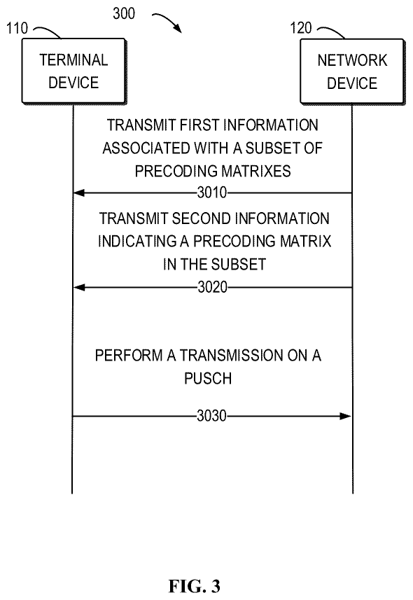

Embodiments of the present disclosure will be described in detail below. Reference is first made to FIG. 3, which shows a signaling chart illustrating process 300 among the terminal device and the network device according to some example embodiments of the present disclosure. Only for the purpose of discussion, the process 300 will be described with reference to FIG. 1. For example, the process 300 may involve the terminal device 110 and the network device 120.

The network device 120 transmits 3010 first information associated with a subset of precoding matrixes to the terminal device 110. In some embodiments, precoding matrixes in the subset may be based on a plurality of discrete Fourier transform (DFT) based precoding matrixes. Alternatively, the precoding matrixes in the subset may be based on first downlink type precoding matrixes and a set of phase offsets between antennas of the terminal device. In some embodiments, the first information may be transmitted via MAC signaling. Alternatively, the first information may be transmitted via RRC signaling.

In some embodiments, the subset may comprise the precoding matrix as described with reference to FIG. 2. For example, the subset may comprise one or more of: 1-layer precoder, 2-layer precoder, 3-layer precoder, 4-layer precoder, 5-layer precoder, 6-layer precoder, 7-layer precoder, or 8-layer precoder.

The network device 120 transmits 3020 second information indicating a precoding matrix in the subset of precoding matrixes to the terminal device 110. In this case, a bit size for indicating the second information may be based on the number of precoding matrixes in the subset of first precoding matrixes. In some embodiments, the number of candidate values for indicating the codebook subset may be one of: 28, 24, 12, or 8. For example, the bitsize may be ceil(log 2(Nc)), where Nc represents the candidate value.

The terminal device 110 performs 3030 a transmission based on the indicated precoding matrix. By way of example, the indicated precoding matrix may be based on two precoding matrixes and a phase offset between the two precoding matrixes. In this way, it can reduce the DCI overhead and solve the TAE issue.

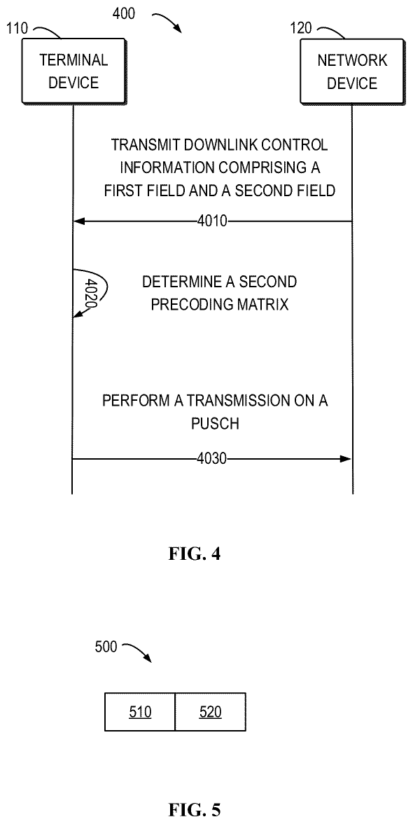

Embodiments of the present disclosure will be described in detail below. Reference is first made to FIG. 4, which shows a signaling chart illustrating process 400 among the terminal device and the network device according to some example embodiments of the present disclosure. Only for the purpose of discussion, the process 400 will be described with reference to FIG. 1. For example, the process 400 may involve the terminal device 110 and the network device 120.

The network device 120 transmits 4010 DCI to the terminal device 110. The DCI includes a first field that indicates a first precoding matrix. The DCI also includes a second field that indicates a parameter which is based on the first field. In some embodiments, the first field may be a transmission precoding matrix indicator (TPMI) field. The first field may be any proper field in DCI. For example, as shown in FIG. 5, the DCI 500 may comprise the first field 510 and the second field 520. It is noted that FIG. 5 is only an example not limitation.

In some embodiments, if the terminal device reports capability of supporting first full coherent precoder, the terminal device may be configured with at least one first full coherent precoder. In some embodiments, if the terminal device reports capability of supporting second full coherent precoder, the terminal device may be configured with at least one second full coherent precoder.

The terminal device 110 determines 4020 a second precoding matrix based on the first precoding matrix and the parameter. The terminal device 110 performs 4030 a transmission based on the second precoding matrix. In this way, it can reduce the DCI overhead.

In some embodiments, the terminal device 110 may be configured with a sounding reference signal (SRS) resource set for 8 antenna transmission. The SRS resource set may comprise at least one SRS resource. Each SRS resource in the SRS resource set may comprise 8 ports.

In some embodiments, if the first precoding matrix is a full coherent precoding matrix or a value of the first field is in a first range, the second field may indicate at least one phase offset between antennas. For example, if the first field indicates a full coherent precoder or the value of the first field is in a first range, the second field may indicate the phase offset from {1, j, −1, −j}. In this case, the terminal device 110 may determine the second precoding matrix based on the full coherent precoder indicated in the first field and the phase offset indicated in the second field.

Only as an example, if the first field indicates the first precoding matrix

$$[ \begin{matrix}p ( 0 ) \\ p ( 1 ) \\ p ( 2 ) \\ p ( 3 )\end{matrix} ] ,$$

the second field may indicate φ. The second precoding matrix for 1-layer determined by the terminal device 110 may be

$${W}^{( 1 )} = 1 / \sqrt{8} [ \begin{matrix}p ( 0 ) \\ p ( 1 ) \\ p ( 2 ) \\ p ( 3 ) \\ φ * p ( 0 ) \\ φ * p ( 1 ) \\ φ * p ( 2 ) \\ φ * p ( 3 )\end{matrix} ] .$$

In some other embodiments, if the first field indicates the first precoding matrix described with reference to FIG. 2, the second field may indicate field indicates b(po). In this case, the second precoding matrix determined by the terminal device 110 may be same as the second precoding matrix described with reference to FIG. 2. By way of an example, for 1-layer precoder, the first precoding matrix may be one precoder/precoding matrix of Rel-15 DL TypeI codebook. In some embodiments, the first precoding matrix may be:

$$1 / \sqrt{8} [ \begin{matrix}{e}^{j * 2 π + a ( 0 )} \\ {e}^{j * 2 π + a ( 1 )} \\ {e}^{j * 2 π + a ( 2 )} \\ {e}^{j * 2 π + a ( 3 )} \\ {e}^{j * 2 π * g} * {e}^{j * 2 π + a ( 0 )} \\ {e}^{j * 2 π * g} * {e}^{j * 2 π + a ( 1 )} \\ {e}^{j * 2 π * g} * {e}^{j * 2 π + a ( 2 )} \\ {e}^{j * 2 π * g} * {e}^{j * 2 π + a ( 3 )}\end{matrix} ] .$$

In this case, the second precoding matrix may be:

$${W}^{( 1 )} = 1 / \sqrt{8} [ \begin{matrix}p ( 0 ) \\ p ( 1 ) * {e}^{j * 2 π + b ( 1 )} \\ p ( 2 ) * {e}^{j * 2 π + b ( 2 )} \\ p ( 3 ) * {e}^{j * 2 π + b ( 3 )} \\ φ * p ( 0 ) * {e}^{j * 2 π + b ( 3 )} \\ φ * p ( 1 ) * {e}^{j * 2 π + b ( 4 )} \\ φ * p ( 2 ) * {e}^{j * 2 π + b ( 5 )} \\ φ * p ( 3 ) * {e}^{j * 2 π + b ( 6 )}\end{matrix} ] = 1 / \sqrt{8} [ \begin{matrix}{e}^{j * 2 π + a ( 0 )} \\ {e}^{j * 2 π + a ( 1 )} * {e}^{j * 2 π + b ( 0 )} \\ {e}^{j * 2 π + a ( 2 )} * {e}^{j * 2 π + b ( 1 )} \\ {e}^{j * 2 π + a ( 3 )} * {e}^{j * 2 π + b ( 2 )} \\ {e}^{j * 2 π * g} * {e}^{j * 2 π + a ( 0 )} * {e}^{j * 2 π + b ( 3 )} \\ {e}^{j * 2 π * g} * {e}^{j * 2 π + a ( 1 )} * {e}^{j * 2 π + b ( 4 )} \\ {e}^{j * 2 π * g} * {e}^{j * 2 π + a ( 2 )} * {e}^{j * 2 π + b ( 5 )} \\ {e}^{j * 2 π * g} * {e}^{j * 2 π + a ( 3 )} * {e}^{j * 2 π + b ( 6 )}\end{matrix} ] ,$$

where φ may represent a phase difference for cross polarization, e^{j*2π*b(m)} may represent the m-th phase offset. In some embodiments,

$$[ \begin{matrix}a ( 0 ) & a ( 1 ) & a ( 2 ) & a ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}, for example, for (N1,N2)=(4,1). In some embodiments,

$$[ \begin{matrix}a ( 0 ) & a ( 1 ) & a ( 2 ) & a ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}, for example, for (N1,N2)=(2,2).

In some embodiments, for 2-layer precoder, the second precoding matrix may be:

$${W}^{( 2 )} = 1 / \sqrt{2 * 8} [ \begin{matrix}{p}_{1} ( 0 ) & {p}_{2} ( 0 ) \\ {p}_{1} ( 1 ) * {e}^{j * 2 π + b ( 0 )} & {p}_{2} ( 1 ) * {e}^{j * 2 π + b ( 0 )} \\ {p}_{1} ( 2 ) * {e}^{j * 2 π + b ( 1 )} & {p}_{2} ( 2 ) * {e}^{j * 2 π + b ( 1 )} \\ {p}_{1} ( 3 ) * {e}^{j * 2 π + b ( 2 )} & {p}_{2} ( 3 ) * {e}^{j * 2 π + b ( 2 )} \\ φ * {p}_{1} ( 0 ) * {e}^{j * 2 π + b ( 3 )} & - φ * {p}_{2} ( 0 ) * {e}^{j * 2 π + b ( 3 )} \\ φ * {p}_{1} ( 1 ) * {e}^{j * 2 π + b ( 4 )} & - φ * {p}_{2} ( 1 ) * {e}^{j * 2 π + b ( 4 )} \\ φ * {p}_{1} ( 2 ) * {e}^{j * 2 π + b ( 5 )} & - φ * {p}_{2} ( 2 ) * {e}^{j * 2 π + b ( 5 )} \\ φ * {p}_{1} ( 3 ) * {e}^{j * 2 π + b ( 6 )} & - φ * {p}_{2} ( 3 ) * {e}^{j * 2 π + b ( 6 )}\end{matrix} ] = 1 / \sqrt{2 * 8} [ \begin{matrix}{e}^{j * 2 π + {a}_{1} ( 0 )} & {e}^{j * 2 π + {a}_{2} ( 0 )} \\ {e}^{j * 2 π + {a}_{1} ( 1 )} * {e}^{j * 2 π + b ( 0 )} & {e}^{j * 2 π + {a}_{2} ( 1 )} * {e}^{j * 2 π + b ( 0 )} \\ {e}^{j * 2 π + {a}_{1} ( 2 )} * {e}^{j * 2 π + b ( 1 )} & {e}^{j * 2 π + {a}_{2} ( 2 )} * {e}^{j * 2 π + b ( 1 )} \\ {e}^{j * 2 π + {a}_{1} ( 3 )} * {e}^{j * 2 π + b ( 2 )} & {e}^{j * 2 π + {a}_{2} ( 3 )} * {e}^{j * 2 π + b ( 2 )} \\ {e}^{j * 2 π * g} * {e}^{j * 2 π + {a}_{1} ( 0 )} * {e}^{j * 2 π + b ( 3 )} & {e}^{j * 2 π * g} * {e}^{j * 2 π + {a}_{2} ( 0 )} * {e}^{j * 2 π + b ( 3 )} \\ {e}^{j * 2 π * g} * {e}^{j * 2 π + {a}_{1} ( 1 )} * {e}^{j * 2 π + b ( 4 )} & {e}^{j * 2 π * g} * {e}^{j * 2 π + {a}_{2} ( 1 )} * {e}^{j * 2 π + b ( 4 )} \\ {e}^{j * 2 π * g} * {e}^{j * 2 π + {a}_{1} ( 2 )} * {e}^{j * 2 π + b ( 5 )} & {e}^{j * 2 π * g} * {e}^{j * 2 π + {a}_{2} ( 2 )} * {e}^{j * 2 π + b ( 5 )} \\ {e}^{j * 2 π * g} * {e}^{j * 2 π + {a}_{1} ( 3 )} * {e}^{j * 2 π + b ( 6 )} & {e}^{j * 2 π * g} * {e}^{j * 2 π + {a}_{2} ( 3 )} * {e}^{j * 2 π + b ( 6 )}\end{matrix} ] .$$

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+k1. In this case, k1 may be at least one of 0, O₁, 2O₁, 3O₁.

In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+k₁, m′=m+k2 In this case, k1 may be at least one of 0, O₁, 2O₁, 3O₁ and k2 may be at least one of 0, O₂.

In other embodiments, for 3-layer precoder, the second precoding matrix may be:

$${W}^{( 3 )} = 1 / \sqrt{3 * 8} [ \begin{matrix}{p}_{1} ( 0 ) & {p}_{2} ( 0 ) & {p}_{1} ( 0 ) \\ {p}_{1} ( 1 ) * {e}^{j * 2 π + b ( 0 )} & {p}_{2} ( 1 ) * {e}^{j * 2 π + b ( 0 )} & {p}_{1} ( 1 ) * {e}^{j * 2 π + b ( 0 )} \\ {p}_{1} ( 2 ) * {e}^{j * 2 π + b ( 1 )} & {p}_{2} ( 2 ) * {e}^{j * 2 π + b ( 1 )} & {p}_{1} ( 2 ) * {e}^{j * 2 π + b ( 1 )} \\ {p}_{1} ( 3 ) * {e}^{j * 2 π + b ( 2 )} & {p}_{2} ( 3 ) * {e}^{j * 2 π + b ( 2 )} & {p}_{1} ( 3 ) * {e}^{j * 2 π + b ( 2 )} \\ φ * {p}_{1} ( 0 ) * {e}^{j * 2 π + b ( 3 )} & - φ * {p}_{2} ( 0 ) * {e}^{j * 2 π + b ( 3 )} & - φ * {p}_{1} ( 0 ) * {e}^{j * 2 π + b ( 3 )} \\ φ * {p}_{1} ( 1 ) * {e}^{j * 2 π + b ( 4 )} & - φ * {p}_{2} ( 1 ) * {e}^{j * 2 π + b ( 4 )} & - φ * {p}_{1} ( 1 ) * {e}^{j * 2 π + b ( 4 )} \\ φ * {p}_{1} ( 2 ) * {e}^{j * 2 π + b ( 5 )} & - φ * {p}_{2} ( 2 ) * {e}^{j * 2 π + b ( 5 )} & - φ * {p}_{1} ( 2 ) * {e}^{j * 2 π + b ( 5 )} \\ φ * {p}_{1} ( 3 ) * {e}^{j * 2 π + b ( 6 )} & - φ * {p}_{2} ( 3 ) * {e}^{j * 2 π + b ( 6 )} & - φ * {p}_{1} ( 3 ) * {e}^{j * 2 π + b ( 6 )}\end{matrix} ] = 1 / \sqrt{3 * 8} [ \begin{matrix}{e}^{j * 2 π + {a}_{1} ( 0 )} & {e}^{j * 2 π + {a}_{2} ( 0 )} & {e}^{j * 2 π + {a}_{1} ( 0 )} \\ {e}^{j * 2 π + {a}_{1} ( 1 )} * {e}^{j * 2 π + b ( 0 )} & {e}^{j * 2 π + {a}_{2} ( 1 )} * {e}^{j * 2 π + b ( 0 )} & {e}^{j * 2 π + {a}_{1} ( 1 )} * {e}^{j * 2 π + b ( 0 )} \\ {e}^{j * 2 π + {a}_{1} ( 2 )} * {e}^{j * 2 π + b ( 1 )} & {e}^{j * 2 π + {a}_{2} ( 2 )} * {e}^{j * 2 π + b ( 1 )} & {e}^{j * 2 π + {a}_{1} ( 2 )} * {e}^{j * 2 π + b ( 1 )} \\ {e}^{j * 2 π + {a}_{1} ( 3 )} * {e}^{j * 2 π + b ( 2 )} & {e}^{j * 2 π + {a}_{2} ( 3 )} * {e}^{j * 2 π + b ( 2 )} & {e}^{j * 2 π + {a}_{1} ( 3 )} * {e}^{j * 2 π + b ( 2 )} \\ {e}^{j * 2 π * g} * {e}^{j * 2 π + {a}_{1} ( 0 )} * {e}^{j * 2 π + b ( 3 )} & {e}^{j * 2 π * g} * {e}^{j * 2 π + {a}_{2} ( 0 )} * {e}^{j * 2 π + b ( 3 )} & {e}^{j * 2 π * g} * {e}^{j * 2 π + {a}_{1} ( 0 )} * {e}^{j * 2 π + b ( 3 )} \\ {e}^{j * 2 π * g} * {e}^{j * 2 π + {a}_{1} ( 1 )} * {e}^{j * 2 π + b ( 4 )} & {e}^{j * 2 π * g} * {e}^{j * 2 π + {a}_{2} ( 1 )} * {e}^{j * 2 π + b ( 4 )} & {e}^{j * 2 π * g} * {e}^{j * 2 π + {a}_{1} ( 1 )} * {e}^{j * 2 π + b ( 4 )} \\ {e}^{j * 2 π * g} * {e}^{j * 2 π + {a}_{1} ( 2 )} * {e}^{j * 2 π + b ( 5 )} & {e}^{j * 2 π * g} * {e}^{j * 2 π + {a}_{2} ( 2 )} * {e}^{j * 2 π + b ( 5 )} & {e}^{j * 2 π * g} * {e}^{j * 2 π + {a}_{1} ( 2 )} * {e}^{j * 2 π + b ( 5 )} \\ {e}^{j * 2 π * g} * {e}^{j * 2 π + {a}_{1} ( 3 )} * {e}^{j * 2 π + b ( 6 )} & {e}^{j * 2 π * g} * {e}^{j * 2 π + {a}_{2} ( 3 )} * {e}^{j * 2 π + b ( 6 )} & {e}^{j * 2 π * g} * {e}^{j * 2 π + {a}_{1} ( 3 )} * {e}^{j * 2 π + b ( 6 )}\end{matrix} ]$$

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+k₁. In this case, k1 may be at least one of 0, O₁, 2O₁, 3O₁. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+k₁, m′=m+k2. In this case, k1 may be at least one of 0, O₁, 2O₁, 3O₁ and k2 may be at least one of 0, O₂, for example, {k1,k2}={O₁,0} or {0,O₂}, {O₁,O}.

In embodiments, for 4-layer precoder, the second precoding matrix may beW⁽⁴⁾=

$$\frac{1}{\sqrt{4 * 8}} [ \begin{matrix}{p}_{1} ( 0 ) & {p}_{2} ( 0 ) & {p}_{1} ( 0 ) & {p}_{2} ( 0 ) \\ {p}_{1} ( 1 ) * {e}^{j * 2 π * b ( 0 )} & {p}_{2} ( 1 ) * {e}^{j * 2 π * b ( 0 )} & {p}_{1} ( 1 ) * {e}^{j * 2 π * b ( 0 )} & {p}_{2} ( 1 ) * {e}^{j * 2 π * b ( 0 )} \\ {p}_{1} ( 2 ) * {e}^{j * 2 π * b ( 1 )} & {p}_{2} ( 2 ) * {e}^{j * 2 π * b ( 1 )} & {p}_{1} ( 2 ) * {e}^{j * 2 π * b ( 1 )} & {p}_{2} ( 2 ) * {e}^{j * 2 π * b ( 1 )} \\ {p}_{1} ( 3 ) * {e}^{j * 2 π * b ( 2 )} & {p}_{2} ( 3 ) * {e}^{j * 2 π * b ( 2 )} & {p}_{1} ( 3 ) * {e}^{j * 2 π * b ( 2 )} & {p}_{2} ( 3 ) * {e}^{j * 2 π * b ( 2 )} \\ φ * {p}_{1} ( 0 ) * {e}^{j * 2 π * b ( 3 )} & φ * {p}_{2} ( 0 ) * {e}^{j * 2 π * b ( 3 )} & - φ * {p}_{1} ( 0 ) * {e}^{j * 2 π * b ( 3 )} & - φ * {p}_{2} ( 0 ) * {e}^{j * 2 π * b ( 3 )} \\ φ * {p}_{1} ( 1 ) * {e}^{j * 2 π * b ( 4 )} & φ * {p}_{2} ( 1 ) * {e}^{j * 2 π * b ( 4 )} & - φ * {p}_{1} ( 1 ) * {e}^{j * 2 π * b ( 4 )} & - φ * {p}_{2} ( 1 ) * {e}^{j * 2 π * b ( 4 )} \\ φ * {p}_{1} ( 2 ) * {e}^{j * 2 π * b ( 5 )} & φ * {p}_{2} ( 2 ) * {e}^{j * 2 π * b ( 5 )} & - φ * {p}_{1} ( 2 ) * {e}^{j * 2 π * b ( 5 )} & - φ * {p}_{2} ( 2 ) * {e}^{j * 2 π * b ( 5 )} \\ φ * {p}_{1} ( 3 ) * {e}^{j * 2 π * b ( 6 )} & φ * {p}_{2} ( 3 ) * {e}^{j * 2 π * b ( 6 )} & - φ * {p}_{1} ( 3 ) * {e}^{j * 2 π * b ( 6 )} & - φ * {p}_{2} ( 3 ) * {e}^{j * 2 π * b ( 6 )}\end{matrix} ] = \frac{1}{\sqrt{4 * 8}} [ \begin{matrix}{e}^{j * 2 π * {a}_{1} ( 0 )} & {e}^{j * 2 π * {a}_{2} ( 0 )} & {e}^{j * 2 π * {a}_{1} ( 0 )} & {e}^{j * 2 π * {a}_{2} ( 0 )} \\ {e}^{j * 2 π * {a}_{1} ( 1 )} * {e}^{j * 2 π * b ( 0 )} & {e}^{j * 2 π * {a}_{2} ( 1 )} * {e}^{j * 2 π * b ( 0 )} & {e}^{j * 2 π * {a}_{1} ( 1 )} * {e}^{j * 2 π * b ( 0 )} & {e}^{j * 2 π * {a}_{2} ( 1 )} * {e}^{j * 2 π * b ( 0 )} \\ {e}^{j * 2 π * {a}_{1} ( 2 )} * {e}^{j * 2 π * b ( 1 )} & {e}^{j * 2 π * {a}_{2} ( 2 )} * {e}^{j * 2 π * b ( 1 )} & {e}^{j * 2 π * {a}_{1} ( 2 )} * {e}^{j * 2 π * b ( 1 )} & {e}^{j * 2 π * {a}_{2} ( 2 )} * {e}^{j * 2 π * b ( 1 )} \\ {e}^{j * 2 π * {a}_{1} ( 3 )} * {e}^{j * 2 π * b ( 2 )} & {e}^{j * 2 π * {a}_{2} ( 3 )} * {e}^{j * 2 π * b ( 2 )} & {e}^{j * 2 π * {a}_{1} ( 3 )} * {e}^{j * 2 π * b ( 2 )} & {e}^{j * 2 π * {a}_{2} ( 3 )} * {e}^{j * 2 π * b ( 2 )} \\ {e}^{j * 2 π * g} * {e}^{j * 2 π * {a}_{1} ( 0 )} * {e}^{j * 2 π * b ( 3 )} & {e}^{j * 2 π * g} * {e}^{j * 2 π * {a}_{2} ( 0 )} * {e}^{j * 2 π * b ( 3 )} & - {e}^{j * 2 π * g} * {e}^{j * 2 π * {a}_{1} ( 0 )} * {e}^{j * 2 π * b ( 3 )} & - {e}^{j * 2 π * g} * {e}^{j * 2 π * {a}_{2} ( 0 )} * {e}^{j * 2 π * b ( 3 )} \\ {e}^{j * 2 π * g} * {e}^{j * 2 π * {a}_{1} ( 1 )} * {e}^{j * 2 π * b ( 4 )} & {e}^{j * 2 π * g} * {e}^{j * 2 π * {a}_{2} ( 1 )} * {e}^{j * 2 π * b ( 4 )} & - {e}^{j * 2 π * g} * {e}^{j * 2 π * {a}_{1} ( 1 )} * {e}^{j * 2 π * b ( 4 )} & - {e}^{j * 2 π * g} * {e}^{j * 2 π * {a}_{2} ( 1 )} * {e}^{j * 2 π * b ( 4 )} \\ {e}^{j * 2 π * g} * {e}^{j * 2 π * {a}_{1} ( 2 )} * {e}^{j * 2 π * b ( 5 )} & {e}^{j * 2 π * g} * {e}^{j * 2 π * {a}_{2} ( 2 )} * {e}^{j * 2 π * b ( 5 )} & - {e}^{j * 2 π * g} * {e}^{j * 2 π * {a}_{1} ( 2 )} * {e}^{j * 2 π * b ( 5 )} & - {e}^{j * 2 π * g} * {e}^{j * 2 π * {a}_{2} ( 2 )} * {e}^{j * 2 π * b ( 5 )} \\ {e}^{j * 2 π * g} * {e}^{j * 2 π * {a}_{1} ( 3 )} * {e}^{j * 2 π * b ( 6 )} & {e}^{j * 2 π * g} * {e}^{j * 2 π * {a}_{2} ( 3 )} * {e}^{j * 2 π * b ( 6 )} & - {e}^{j * 2 π * g} * {e}^{j * 2 π * {a}_{1} ( 3 )} * {e}^{j * 2 π * b ( 6 )} & - {e}^{j * 2 π * g} * {e}^{j * 2 π * {a}_{2} ( 3 )} * {e}^{j * 2 π * b ( 6 )}\end{matrix} ] .$$

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+k1. In this case, in some embodiments, k1 may be at least one of 0, O₁, 2O₁, 3O₁. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N1−1}, m∈{0,1, . . . O₂N₂−1}. l′=l+k₁, m′=m+k2. In this case, k1 may be at least one of 0, O1, 2O1, 3O1 and k2 may be at least one of 0, O2, for example, {k1,k2}={O1,0} or {0,O2}, {O1,O2}.

In embodiments, for 5-layer precoder, the second precoding matrix may be:

$${W}^{( 5 )} = \frac{1}{\sqrt{5 * 8}} [ \begin{matrix}{p}_{1} ( 0 ) & {p}_{1} ( 0 ) & {p}_{2} ( 0 ) & {p}_{2} ( 0 ) & {p}_{3} ( 0 ) \\ {p}_{1} ( 1 ) * {e}^{j * 2 π * b ( 0 )} & {p}_{1} ( 1 ) * {e}^{j * 2 π * b ( 0 )} & {p}_{2} ( 1 ) * {e}^{j * 2 π * b ( 0 )} & {p}_{2} ( 1 ) * {e}^{j * 2 π * b ( 0 )} & {p}_{3} ( 1 ) * {e}^{j * 2 π * b ( 0 )} \\ {p}_{1} ( 2 ) * {e}^{j * 2 π * b ( 1 )} & {p}_{1} ( 2 ) * {e}^{j * 2 π * b ( 1 )} & {p}_{2} ( 2 ) * {e}^{j * 2 π * b ( 1 )} & {p}_{2} ( 2 ) * {e}^{j * 2 π * b ( 1 )} & {p}_{3} ( 2 ) * {e}^{j * 2 π * b ( 1 )} \\ {p}_{1} ( 3 ) * {e}^{j * 2 π * b ( 2 )} & {p}_{1} ( 3 ) * {e}^{j * 2 π * b ( 2 )} & {p}_{2} ( 3 ) * {e}^{j * 2 π * b ( 2 )} & {p}_{2} ( 3 ) * {e}^{j * 2 π * b ( 2 )} & {p}_{3} ( 3 ) * {e}^{j * 2 π * b ( 2 )} \\ φ * {p}_{1} ( 0 ) * {e}^{j * 2 π * b ( 3 )} & - φ * {p}_{1} ( 0 ) * {e}^{j * 2 π * b ( 3 )} & {p}_{2} ( 0 ) * {e}^{j * 2 π * b ( 3 )} & - {p}_{2} ( 0 ) * {e}^{j * 2 π * b ( 3 )} & {p}_{3} ( 0 ) * {e}^{j * 2 π * b ( 3 )} \\ φ * {p}_{1} ( 1 ) * {e}^{j * 2 π * b ( 4 )} & - φ * {p}_{1} ( 1 ) * {e}^{j * 2 π * b ( 4 )} & {p}_{2} ( 1 ) * {e}^{j * 2 π * b ( 4 )} & - {p}_{2} ( 1 ) * {e}^{j * 2 π * b ( 4 )} & {p}_{3} ( 1 ) * {e}^{j * 2 π * b ( 4 )} \\ φ * {p}_{1} ( 2 ) * {e}^{j * 2 π * b ( 5 )} & - φ * {p}_{1} ( 2 ) * {e}^{j * 2 π * b ( 5 )} & {p}_{2} ( 2 ) * {e}^{j * 2 π * b ( 5 )} & - {p}_{2} ( 2 ) * {e}^{j * 2 π * b ( 5 )} & {p}_{3} ( 2 ) * {e}^{j * 2 π * b ( 5 )} \\ φ * {p}_{1} ( 3 ) * {e}^{j * 2 π * b ( 6 )} & - φ * {p}_{1} ( 3 ) * {e}^{j * 2 π * b ( 6 )} & {p}_{2} ( 3 ) * {e}^{j * 2 π * b ( 6 )} & - {p}_{2} ( 3 ) * {e}^{j * 2 π * b ( 6 )} & {p}_{3} ( 3 ) * {e}^{j * 2 π * b ( 6 )}\end{matrix} ] ,$$

where [p₃(0) p₃(1) p₃(2) p₃(3)]=[e^{j*2π*a}^{₃}⁽⁰⁾ e^{j*2π*a}^{₃}⁽¹⁾ e^{j*2π*a}^{₃}⁽²⁾ e^{j*2π*a}^{₃}⁽³⁾].

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+O₁. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{l}^{″}}{{O}_{1} {N}_{1}} , \frac{2 {l}^{″}}{{O}_{1} {N}_{1}} , \frac{3 {l}^{″}}{{O}_{1} {N}_{1}} ] ,$$

l″=l+2O₁. In some embodiments, for (N1,N2)=(2,2),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ \begin{matrix}{a}_{2} ( 0 ) & {a}_{2} ( 1 ) & {a}_{2} ( 2 ) & {a}_{2} ( 3 )\end{matrix} ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+O₁, m′=m. In some embodiments,

$$[ \begin{matrix}{a}_{3} ( 0 ) & {a}_{3} ( 1 ) & {a}_{3} ( 2 ) & {a}_{3} ( 3 )\end{matrix} ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}, m∈{0,1, . . . O₂N₂−1}. l″=l+O₁, m″=m+O₂.

In some embodiments, for 6-layer precoder, the second precoding matrix may be:

$${W}^{( 6 )} = \frac{1}{\sqrt{6 * 8}} [ \begin{matrix}{p}_{1} ( 0 ) & {p}_{1} ( 0 ) & {p}_{2} ( 0 ) & {p}_{2} ( 0 ) & {p}_{3} ( 0 ) & {p}_{3} ( 0 ) \\ {p}_{1} ( 1 ) * {e}^{j * 2 π * b ( 0 )} & {p}_{1} ( 1 ) * {e}^{j * 2 π * b ( 0 )} & {p}_{2} ( 1 ) * {e}^{j * 2 π * b ( 0 )} & {p}_{2} ( 1 ) * {e}^{j * 2 π * b ( 0 )} & {p}_{3} ( 1 ) * {e}^{j * 2 π * b ( 0 )} & {p}_{3} ( 1 ) * {e}^{j * 2 π * b ( 0 )} \\ {p}_{1} ( 2 ) * {e}^{j * 2 π * b ( 1 )} & {p}_{1} ( 2 ) * {e}^{j * 2 π * b ( 1 )} & {p}_{2} ( 2 ) * {e}^{j * 2 π * b ( 1 )} & {p}_{2} ( 2 ) * {e}^{j * 2 π * b ( 1 )} & {p}_{3} ( 2 ) * {e}^{j * 2 π * b ( 1 )} & {p}_{3} ( 2 ) * {e}^{j * 2 π * b ( 1 )} \\ {p}_{1} ( 3 ) * {e}^{j * 2 π * b ( 2 )} & {p}_{1} ( 3 ) * {e}^{j * 2 π * b ( 2 )} & {p}_{2} ( 3 ) * {e}^{j * 2 π * b ( 2 )} & {p}_{2} ( 3 ) * {e}^{j * 2 π * b ( 2 )} & {p}_{3} ( 3 ) * {e}^{j * 2 π * b ( 2 )} & {p}_{3} ( 3 ) * {e}^{j * 2 π * b ( 2 )} \\ φ * {p}_{1} ( 0 ) * {e}^{j * 2 π * b ( 3 )} & - φ * {p}_{1} ( 0 ) * {e}^{j * 2 π * b ( 3 )} & {p}_{2} ( 0 ) * {e}^{j * 2 π * b ( 3 )} & - {p}_{2} ( 0 ) * {e}^{j * 2 π * b ( 3 )} & {p}_{3} ( 0 ) * {e}^{j * 2 π * b ( 3 )} & - {p}_{3} ( 0 ) * {e}^{j * 2 π * b ( 3 )} \\ φ * {p}_{1} ( 1 ) * {e}^{j * 2 π * b ( 4 )} & - φ * {p}_{1} ( 1 ) * {e}^{j * 2 π * b ( 4 )} & {p}_{2} ( 1 ) * {e}^{j * 2 π * b ( 4 )} & - {p}_{2} ( 1 ) * {e}^{j * 2 π * b ( 4 )} & {p}_{3} ( 1 ) * {e}^{j * 2 π * b ( 4 )} & - {p}_{3} ( 1 ) * {e}^{j * 2 π * b ( 4 )} \\ φ * {p}_{1} ( 2 ) * {e}^{j * 2 π * b ( 5 )} & - φ * {p}_{1} ( 2 ) * {e}^{j * 2 π * b ( 5 )} & {p}_{2} ( 2 ) * {e}^{j * 2 π * b ( 5 )} & - {p}_{2} ( 2 ) * {e}^{j * 2 π * b ( 5 )} & {p}_{3} ( 2 ) * {e}^{j * 2 π * b ( 5 )} & - {p}_{3} ( 2 ) * {e}^{j * 2 π * b ( 5 )} \\ φ * {p}_{1} ( 3 ) * {e}^{j * 2 π * b ( 6 )} & - φ * {p}_{1} ( 3 ) * {e}^{j * 2 π * b ( 6 )} & {p}_{2} ( 3 ) * {e}^{j * 2 π * b ( 6 )} & - {p}_{2} ( 3 ) * {e}^{j * 2 π * b ( 6 )} & {p}_{3} ( 3 ) * {e}^{j * 2 π * b ( 6 )} & - {p}_{3} ( 3 ) * {e}^{j * 2 π * b ( 6 )}\end{matrix} ] ,$$

where [p₃(0) p₃(1) p₃(2) p₃(3)]=[e^{j*2π*a}^{₃}⁽⁰⁾ e^{j*2π*a}^{₃}⁽¹⁾ e^{j*2π*a}^{₃}⁽²⁾ e^{j*2π*a}^{₃}⁽³⁾].

In some embodiments, for (N1,N2)=(4,1),

$$[ \begin{matrix}{a}_{1} ( 0 ) & {a}_{1} ( 1 ) & {a}_{1} ( 2 ) & {a}_{1} ( 3 )\end{matrix} ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁−1}. In some embodiments,

$$[ {a}_{2} ( 0 ) {a}_{2} ( 1 ) {a}_{2} ( 2 ) {a}_{2} ( 3 ) ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+O₁. In some embodiments,

$$[ {a}_{3} ( 0 ) {a}_{3} ( 1 ) {a}_{3} ( 2 ) {a}_{3} ( 3 ) ] = [ 1 , \frac{{l}^{″}}{{O}_{1} {N}_{1}} , \frac{2 {l}^{″}}{{O}_{1} {N}_{1}} , \frac{3 {l}^{″}}{{O}_{1} {N}_{1}} ] ,$$

l″=l+2O₁. In some embodiments, for (N1,N2)=(2,2),

$$[ {a}_{1} ( 0 ) {a}_{1} ( 1 ) {a}_{1} ( 2 ) {a}_{1} ( 3 ) ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ {a}_{2} ( 0 ) {a}_{2} ( 1 ) {a}_{2} ( 2 ) {a}_{2} ( 3 ) ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+O₁, m′=m. In some embodiments,

$$[ {a}_{3} ( 0 ) {a}_{3} ( 1 ) {a}_{3} ( 2 ) {a}_{3} ( 3 ) ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}, m∈{0,1, . . . O₂N₂−1}. l″=l+O₁, m″=m+O₂.

In some embodiments, for 7-layer precoder, the second precoding matrix may be:

$${W}^{( 7 )} = 1 / \sqrt{7 * 8} [ \begin{matrix}{p}_{1} ( 0 ) & {p}_{1} ( 0 ) & {p}_{2} ( 0 ) & {p}_{3} ( 0 ) & {p}_{3} ( 0 ) & {p}_{4} ( 0 ) & {p}_{4} ( 0 ) \\ \begin{matrix}{p}_{1} ( 1 ) * \\ {e}^{j * 2 π * b ( 0 )}\end{matrix} & \begin{matrix}{p}_{1} ( 1 ) * \\ {e}^{j * 2 π * b ( 0 )}\end{matrix} & \begin{matrix}{p}_{2} ( 1 ) * \\ {e}^{j * 2 π * b ( 0 )}\end{matrix} & \begin{matrix}{p}_{3} ( 1 ) * \\ {e}^{j * 2 π * b ( 0 )}\end{matrix} & \begin{matrix}{p}_{3} ( 1 ) * \\ {e}^{j * 2 π * b ( 0 )}\end{matrix} & \begin{matrix}{p}_{4} ( 1 ) * \\ {e}^{j * 2 π * b ( 0 )}\end{matrix} & \begin{matrix}{p}_{4} ( 1 ) * \\ {e}^{j * 2 π * b ( 0 )}\end{matrix} \\ \begin{matrix}{p}_{1} ( 2 ) * \\ {e}^{j * 2 π * b ( 1 )}\end{matrix} & \begin{matrix}{p}_{1} ( 2 ) * \\ {e}^{j * 2 π * b ( 1 )}\end{matrix} & \begin{matrix}{p}_{2} ( 2 ) * \\ {e}^{j * 2 π * b ( 1 )}\end{matrix} & \begin{matrix}{p}_{3} ( 2 ) * \\ {e}^{j * 2 π * b ( 1 )}\end{matrix} & \begin{matrix}{p}_{3} ( 2 ) * \\ {e}^{j * 2 π * b ( 1 )}\end{matrix} & \begin{matrix}{p}_{4} ( 2 ) * \\ {e}^{j * 2 π * b ( 1 )}\end{matrix} & \begin{matrix}{p}_{4} ( 2 ) * \\ {e}^{j * 2 π * b ( 1 )}\end{matrix} \\ \begin{matrix}{p}_{1} ( 3 ) * \\ {e}^{j * 2 π * b ( 2 )}\end{matrix} & \begin{matrix}{p}_{1} ( 3 ) * \\ {e}^{j * 2 π * b ( 2 )}\end{matrix} & \begin{matrix}{p}_{2} ( 3 ) * \\ {e}^{j * 2 π * b ( 2 )}\end{matrix} & \begin{matrix}{p}_{3} ( 3 ) * \\ {e}^{j * 2 π * b ( 2 )}\end{matrix} & \begin{matrix}{p}_{3} ( 3 ) * \\ {e}^{j * 2 π * b ( 2 )}\end{matrix} & \begin{matrix}{p}_{4} ( 3 ) * \\ {e}^{j * 2 π * b ( 2 )}\end{matrix} & \begin{matrix}{p}_{4} ( 3 ) * \\ {e}^{j * 2 π * b ( 2 )}\end{matrix} \\ \begin{matrix}φ * {p}_{1} ( 0 ) * \\ {e}^{j * 2 π * b ( 3 )}\end{matrix} & \begin{matrix}- φ * {p}_{1} ( 0 ) * \\ {e}^{j * 2 π * b ( 3 )}\end{matrix} & \begin{matrix}φ * {p}_{2} ( 0 ) * \\ {e}^{j * 2 π * b ( 3 )}\end{matrix} & \begin{matrix}{p}_{3} ( 0 ) * \\ {e}^{j * 2 π * b ( 3 )}\end{matrix} & \begin{matrix}- {p}_{3} ( 0 ) * \\ {e}^{j * 2 π * b ( 3 )}\end{matrix} & \begin{matrix}{p}_{4} ( 0 ) * \\ {e}^{j * 2 π * b ( 3 )}\end{matrix} & \begin{matrix}- {p}_{4} ( 0 ) * \\ {e}^{j * 2 π * b ( 3 )}\end{matrix} \\ \begin{matrix}φ * {p}_{1} ( 1 ) * \\ {e}^{j * 2 π * b ( 4 )}\end{matrix} & \begin{matrix}- φ * {p}_{1} ( 1 ) * \\ {e}^{j * 2 π * b ( 4 )}\end{matrix} & \begin{matrix}φ * {p}_{2} ( 1 ) * \\ {e}^{j * 2 π * b ( 4 )}\end{matrix} & \begin{matrix}{p}_{3} ( 1 ) * \\ {e}^{j * 2 π * b ( 4 )}\end{matrix} & \begin{matrix}- {p}_{3} ( 1 ) * \\ {e}^{j * 2 π * b ( 4 )}\end{matrix} & \begin{matrix}{p}_{4} ( 1 ) * \\ {e}^{j * 2 π * b ( 4 )}\end{matrix} & \begin{matrix}- {p}_{4} ( 1 ) * \\ {e}^{j * 2 π * b ( 4 )}\end{matrix} \\ \begin{matrix}φ * {p}_{1} ( 2 ) * \\ {e}^{j * 2 π * b ( 5 )}\end{matrix} & \begin{matrix}- φ * {p}_{1} ( 2 ) * \\ {e}^{j * 2 π * b ( 5 )}\end{matrix} & \begin{matrix}φ * {p}_{2} ( 2 ) * \\ {e}^{j * 2 π * b ( 5 )}\end{matrix} & \begin{matrix}{p}_{3} ( 2 ) * \\ {e}^{j * 2 π * b ( 5 )}\end{matrix} & \begin{matrix}- {p}_{3} ( 2 ) * \\ {e}^{j * 2 π * b ( 5 )}\end{matrix} & \begin{matrix}{p}_{4} ( 2 ) * \\ {e}^{j * 2 π * b ( 5 )}\end{matrix} & \begin{matrix}- {p}_{4} ( 2 ) * \\ {e}^{j * 2 π * b ( 5 )}\end{matrix} \\ \begin{matrix}φ * {p}_{1} ( 3 ) * \\ {e}^{j * 2 π * b ( 6 )}\end{matrix} & \begin{matrix}- φ * {p}_{1} ( 3 ) * \\ {e}^{j * 2 π * b ( 6 )}\end{matrix} & \begin{matrix}φ * {p}_{2} ( 3 ) * \\ {e}^{j * 2 π * b ( 6 )}\end{matrix} & \begin{matrix}{p}_{3} ( 3 ) * \\ {e}^{j * 2 π * b ( 6 )}\end{matrix} & \begin{matrix}- {p}_{3} ( 3 ) * \\ {e}^{j * 2 π * b ( 6 )}\end{matrix} & \begin{matrix}{p}_{4} ( 3 ) * \\ {e}^{j * 2 π * b ( 6 )}\end{matrix} & \begin{matrix}- {p}_{4} ( 3 ) * \\ {e}^{j * 2 π * b ( 6 )}\end{matrix}\end{matrix} ]$$

where [p₃(0) p₃(1) p₃(2) p₃(3)]=[e^{j*2π*a}^{₃}⁽⁰⁾ e^{j*2π*a}^{₃}⁽¹⁾ e^{j*2π*a}^{₃}⁽²⁾ e^{j*2π*a}^{₃}⁽³⁾].

In some embodiments, for (N1,N2)=(4,1),

$$[ {a}_{1} ( 0 ) {a}_{1} ( 1 ) {a}_{1} ( 2 ) {a}_{1} ( 3 ) ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁/2−1}. In some embodiments,

$$[ {a}_{2} ( 0 ) {a}_{2} ( 1 ) {a}_{2} ( 2 ) {a}_{2} ( 3 ) ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+O₁. In some embodiments,

$$[ {a}_{3} ( 0 ) {a}_{3} ( 1 ) {a}_{3} ( 2 ) {a}_{3} ( 3 ) ] = [ 1 , \frac{{l}^{″}}{{O}_{1} {N}_{1}} , \frac{2 {l}^{″}}{{O}_{1} {N}_{1}} , \frac{3 {l}^{″}}{{O}_{1} {N}_{1}} ]$$

l″=l+2O₁. In some embodiments,

$$[ {a}_{4} ( 0 ) {a}_{4} ( 1 ) {a}_{4} ( 2 ) {a}_{4} ( 3 ) ] = [ 1 , \frac{{l}^{′′′}}{{O}_{1} {N}_{1}} , \frac{2 {l}^{′′′}}{{O}_{1} {N}_{1}} , \frac{3 {l}^{′′′}}{{O}_{1} {N}_{1}} ] ,$$

l″=l+3O₁. In some embodiments, for (N1,N2)=(2,2),

$$[ {a}_{1} ( 0 ) {a}_{1} ( 1 ) {a}_{1} ( 2 ) {a}_{1} ( 3 ) ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ {a}_{2} ( 0 ) {a}_{2} ( 1 ) {a}_{2} ( 2 ) {a}_{2} ( 3 ) ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+O₁, m′=m. In some embodiments,

$$[ {a}_{3} ( 0 ) {a}_{3} ( 1 ) {a}_{3} ( 2 ) {a}_{3} ( 3 ) ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}, m∈{0,1, . . . O₂N₂−1}l″=l, m″=m+O₂. In some embodiments,

$$[ {a}_{4} ( 0 ) {a}_{4} ( 1 ) {a}_{4} ( 2 ) {a}_{4} ( 3 ) ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0,1, . . . O₁N₁−1}. m∈{0,1, . . . O₂N₂−1}. l″=l+O₁, m″=m+O₂.

In some embodiments, for 8-layer precoder, the second precoding matrix may be:

$${W}^{( 8 )} = 1 / \sqrt{8 * 8} [ \begin{matrix}{p}_{1} ( 0 ) & {p}_{1} ( 0 ) & {p}_{2} ( 0 ) & {p}_{2} ( 0 ) & {p}_{3} ( 0 ) & {p}_{3} ( 0 ) & {p}_{4} ( 0 ) & {p}_{4} ( 0 ) \\ \begin{matrix}{p}_{1} ( 1 ) * \\ {e}^{j * 2 π * b ( 0 )}\end{matrix} & \begin{matrix}{p}_{1} ( 1 ) * \\ {e}^{j * 2 π * b ( 0 )}\end{matrix} & \begin{matrix}{p}_{2} ( 1 ) * \\ {e}^{j * 2 π * b ( 0 )}\end{matrix} & \begin{matrix}{p}_{2} ( 1 ) * \\ {e}^{j * 2 π * b ( 0 )}\end{matrix} & \begin{matrix}{p}_{3} ( 1 ) * \\ {e}^{j * 2 π * b ( 0 )}\end{matrix} & \begin{matrix}{p}_{3} ( 1 ) * \\ {e}^{j * 2 π * b ( 0 )}\end{matrix} & \begin{matrix}{p}_{4} ( 1 ) * \\ {e}^{j * 2 π * b ( 0 )}\end{matrix} & \begin{matrix}{p}_{4} ( 1 ) * \\ {e}^{j * 2 π * b ( 0 )}\end{matrix} \\ \begin{matrix}{p}_{1} ( 2 ) * \\ {e}^{j * 2 π * b ( 1 )}\end{matrix} & \begin{matrix}{p}_{1} ( 2 ) * \\ {e}^{j * 2 π * b ( 1 )}\end{matrix} & \begin{matrix}{p}_{2} ( 2 ) * \\ {e}^{j * 2 π * b ( 1 )}\end{matrix} & \begin{matrix}{p}_{2} ( 2 ) * \\ {e}^{j * 2 π * b ( 1 )}\end{matrix} & \begin{matrix}{p}_{3} ( 2 ) * \\ {e}^{j * 2 π * b ( 1 )}\end{matrix} & \begin{matrix}{p}_{3} ( 2 ) * \\ {e}^{j * 2 π * b ( 1 )}\end{matrix} & \begin{matrix}{p}_{4} ( 2 ) * \\ {e}^{j * 2 π * b ( 1 )}\end{matrix} & \begin{matrix}{p}_{4} ( 2 ) * \\ {e}^{j * 2 π * b ( 1 )}\end{matrix} \\ \begin{matrix}{p}_{1} ( 3 ) * \\ {e}^{j * 2 π * b ( 2 )}\end{matrix} & \begin{matrix}{p}_{1} ( 3 ) * \\ {e}^{j * 2 π * b ( 2 )}\end{matrix} & \begin{matrix}{p}_{2} ( 3 ) * \\ {e}^{j * 2 π * b ( 2 )}\end{matrix} & \begin{matrix}{p}_{2} ( 3 ) * \\ {e}^{j * 2 π * b ( 2 )}\end{matrix} & \begin{matrix}{p}_{3} ( 3 ) * \\ {e}^{j * 2 π * b ( 2 )}\end{matrix} & \begin{matrix}{p}_{3} ( 3 ) * \\ {e}^{j * 2 π * b ( 2 )}\end{matrix} & \begin{matrix}{p}_{4} ( 3 ) * \\ {e}^{j * 2 π * b ( 2 )}\end{matrix} & \begin{matrix}{p}_{4} ( 3 ) * \\ {e}^{j * 2 π * b ( 2 )}\end{matrix} \\ \begin{matrix}φ * {p}_{1} ( 0 ) * \\ {e}^{j * 2 π * b ( 3 )}\end{matrix} & \begin{matrix}- φ * {p}_{1} ( 0 ) * \\ {e}^{j * 2 π * b ( 3 )}\end{matrix} & \begin{matrix}φ * {p}_{2} ( 0 ) * \\ {e}^{j * 2 π * b ( 3 )}\end{matrix} & \begin{matrix}- φ * {p}_{2} ( 0 ) * \\ {e}^{j * 2 π * b ( 3 )}\end{matrix} & \begin{matrix}{p}_{3} ( 0 ) * \\ {e}^{j * 2 π * b ( 3 )}\end{matrix} & \begin{matrix}- {p}_{3} ( 0 ) * \\ {e}^{j * 2 π * b ( 3 )}\end{matrix} & \begin{matrix}{p}_{4} ( 0 ) * \\ {e}^{j * 2 π * b ( 3 )}\end{matrix} & \begin{matrix}- {p}_{4} ( 0 ) * \\ {e}^{j * 2 π * b ( 3 )}\end{matrix} \\ \begin{matrix}φ * {p}_{1} ( 1 ) * \\ {e}^{j * 2 π * b ( 4 )}\end{matrix} & \begin{matrix}- φ * {p}_{1} ( 1 ) * \\ {e}^{j * 2 π * b ( 4 )}\end{matrix} & \begin{matrix}φ * {p}_{2} ( 1 ) * \\ {e}^{j * 2 π * b ( 4 )}\end{matrix} & \begin{matrix}- φ * {p}_{2} ( 1 ) * \\ {e}^{j * 2 π * b ( 4 )}\end{matrix} & \begin{matrix}{p}_{3} ( 1 ) * \\ {e}^{j * 2 π * b ( 4 )}\end{matrix} & \begin{matrix}- {p}_{3} ( 1 ) * \\ {e}^{j * 2 π * b ( 4 )}\end{matrix} & \begin{matrix}{p}_{4} ( 1 ) * \\ {e}^{j * 2 π * b ( 4 )}\end{matrix} & \begin{matrix}- {p}_{4} ( 1 ) * \\ {e}^{j * 2 π * b ( 4 )}\end{matrix} \\ \begin{matrix}φ * {p}_{1} ( 2 ) * \\ {e}^{j * 2 π * b ( 5 )}\end{matrix} & \begin{matrix}- φ * {p}_{1} ( 2 ) * \\ {e}^{j * 2 π * b ( 5 )}\end{matrix} & \begin{matrix}φ * {p}_{2} ( 2 ) * \\ {e}^{j * 2 π * b ( 5 )}\end{matrix} & \begin{matrix}- φ * {p}_{2} ( 2 ) * \\ {e}^{j * 2 π * b ( 5 )}\end{matrix} & \begin{matrix}{p}_{3} ( 2 ) * \\ {e}^{j * 2 π * b ( 5 )}\end{matrix} & \begin{matrix}- {p}_{3} ( 2 ) * \\ {e}^{j * 2 π * b ( 5 )}\end{matrix} & \begin{matrix}{p}_{4} ( 2 ) * \\ {e}^{j * 2 π * b ( 5 )}\end{matrix} & \begin{matrix}- {p}_{4} ( 2 ) * \\ {e}^{j * 2 π * b ( 5 )}\end{matrix} \\ \begin{matrix}φ * {p}_{1} ( 3 ) * \\ {e}^{j * 2 π * b ( 6 )}\end{matrix} & \begin{matrix}- φ * {p}_{1} ( 3 ) * \\ {e}^{j * 2 π * b ( 6 )}\end{matrix} & \begin{matrix}φ * {p}_{2} ( 3 ) * \\ {e}^{j * 2 π * b ( 6 )}\end{matrix} & \begin{matrix}- φ * {p}_{2} ( 3 ) * \\ {e}^{j * 2 π * b ( 6 )}\end{matrix} & \begin{matrix}{p}_{3} ( 3 ) * \\ {e}^{j * 2 π * b ( 6 )}\end{matrix} & \begin{matrix}- {p}_{3} ( 3 ) * \\ {e}^{j * 2 π * b ( 6 )}\end{matrix} & \begin{matrix}{p}_{4} ( 3 ) * \\ {e}^{j * 2 π * b ( 6 )}\end{matrix} & \begin{matrix}- {p}_{4} ( 3 ) * \\ {e}^{j * 2 π * b ( 6 )}\end{matrix}\end{matrix} ]$$

where [p₃(0) p₃(1) p₃(2) p₃ (3)]=[e^{j*2π*a}^{₃}⁽⁰⁾ e^{j*2π*a}^{₃}⁽¹⁾ e^{j*2π*a}^{₃}⁽²⁾ e^{j*2π*a}^{₃}⁽³⁾].

In some embodiments, for (N1,N2)=(4,1),

$$[ {a}_{1} ( 0 ) {a}_{1} ( 1 ) {a}_{1} ( 2 ) {a}_{1} ( 3 ) ] = [ 1 , \frac{l}{{O}_{1} {N}_{1}} , \frac{2 l}{{O}_{1} {N}_{1}} , \frac{3 l}{{O}_{1} {N}_{1}} ] ,$$

l∈{0,1, . . . O₁N₁/2−1}. In some embodiments,

$$[ {a}_{2} ( 0 ) {a}_{2} ( 1 ) {a}_{2} ( 2 ) {a}_{2} ( 3 ) ] = [ 1 , \frac{{l}^{′}}{{O}_{1} {N}_{1}} , \frac{2 {l}^{′}}{{O}_{1} {N}_{1}} , \frac{3 {l}^{′}}{{O}_{1} {N}_{1}} ] ,$$

l′=l+O₁. In some embodiments,

$$[ {a}_{3} ( 0 ) {a}_{3} ( 1 ) {a}_{3} ( 2 ) {a}_{3} ( 3 ) ] = [ 1 , \frac{{l}^{″}}{{O}_{1} {N}_{1}} , \frac{2 {l}^{″}}{{O}_{1} {N}_{1}} , \frac{3 {l}^{″}}{{O}_{1} {N}_{1}} ] ,$$

l″=l+2O₁. In some embodiments,

$$[ {a}_{3} ( 0 ) {a}_{4} ( 1 ) {a}_{4} ( 2 ) {a}_{4} ( 3 ) ] = [ 1 , \frac{{l}^{′′′}}{{O}_{1} {N}_{1}} , \frac{2 {l}^{′′′}}{{O}_{1} {N}_{1}} , \frac{3 {l}^{′′′}}{{O}_{1} {N}_{1}} ] ,$$

l″+3O₁. In some embodiments, for (N1,N2)=(2,2),

$$[ {a}_{1} ( 0 ) {a}_{1} ( 1 ) {a}_{1} ( 2 ) {a}_{1} ( 3 ) ] = [ 1 , \frac{m}{{O}_{2} {N}_{2}} , \frac{l}{{O}_{1} {N}_{1}} , \frac{m}{{O}_{1} {N}_{1}} \frac{l}{{O}_{1} {N}_{1}} ] ,$$

l∈{0,1, . . . O₁N₁−1}, m∈{0,1, . . . O₂N₂−1}. In some embodiments,

$$[ {a}_{2} ( 0 ) {a}_{2} ( 1 ) {a}_{2} ( 2 ) {a}_{2} ( 3 ) ] = [ 1 , \frac{{m}^{′}}{{O}_{2} {N}_{2}} , \frac{{l}^{′}}{{O}_{1} {N}_{1}} , \frac{{m}^{′}}{{O}_{1} {N}_{1}} \frac{{l}^{′}}{{O}_{1} {N}_{1}} ] ,$$

l∈{0,1, . . . O₁N₁−1}, m∈{0,1, . . . O₂N₂−1}. l′=l+O₁, m′=m. In some embodiments,

$$[ {a}_{3} ( 0 ) {a}_{3} ( 1 ) {a}_{3} ( 2 ) {a}_{3} ( 3 ) ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0, 1, . . . O₁N₁−1}, m∈{0,1, . . . O₂N₂−1}. l″=l, m″=m+O₂. In some embodiments,

$$[ {a}_{4} ( 0 ) {a}_{4} ( 1 ) {a}_{4} ( 2 ) {a}_{4} ( 3 ) ] = [ 1 , \frac{{m}^{″}}{{O}_{2} {N}_{2}} , \frac{{l}^{″}}{{O}_{1} {N}_{1}} , \frac{{m}^{″}}{{O}_{1} {N}_{1}} \frac{{l}^{″}}{{O}_{1} {N}_{1}} ] ,$$

l∈{0, 1, . . . O₁N₁−1}, m∈{0,1, . . . O₂N₂−1}. l″=l+O₁, m″=m+O₂.

In some embodiments, the number of phase offsets may be 6. For example, when the value of the phase offset is at least one of {1, j, −1, −j}, the number of phase offsets may be 6, as φ can already adjust the phase difference. By way of example, the second precoding matrix may be:

$${W}^{( 1 )} = 1 / \sqrt{8} [ \begin{matrix}p ( 0 ) \\ p ( 1 ) * {e}^{j * 2 π * b ( 0 )} \\ p ( 2 ) * {e}^{j * 2 π * b ( 1 )} \\ p ( 3 ) * {e}^{j * 2 π * b ( 2 )} \\ φ * p ( 0 ) \\ φ * p ( 1 ) * {e}^{j * 2 π * b ( 3 )} \\ φ * p ( 2 ) * {e}^{j * 2 π * b ( 4 )} \\ φ * p ( 3 ) * {e}^{j * 2 π * b ( 5 )}\end{matrix} ] .$$

In some embodiments, the number of phase offsets may be 3 or 2, for example, at least for (N1,N2)=(2,2). By way of example, when the value of the phase offset is at least one of {1, j, −1, −j}, the number of phase offsets may be 3 or 2. In some embodiments, the second precoding matrix may be:

$${W}^{( 1 )} = 1 / \sqrt{8} [ \begin{matrix}p ( 0 ) \\ p ( 1 ) \\ p ( 2 ) \\ p ( 3 ) * {e}^{j * 2 π * b ( 0 )} \\ φ * p ( 0 ) \\ φ * p ( 1 ) * {e}^{j * 2 π * b ( 1 )} \\ φ * p ( 2 ) \\ φ * p ( 3 ) * {e}^{j * 2 π * b ( 2 )}\end{matrix} ] .$$

In some other embodiments, the second precoding matrix may be:

$${W}^{( 1 )} = 1 / \sqrt{8} [ \begin{matrix}p ( 0 ) \\ p ( 1 ) \\ p ( 2 ) \\ p ( 3 ) \\ φ * p ( 0 ) \\ φ * p ( 1 ) * {e}^{j * 2 π * b ( 0 )} \\ φ * p ( 2 ) \\ φ * p ( 3 ) * {e}^{j * 2 π * b ( 1 )}\end{matrix} ] .$$

In some embodiments, if the first precoding matrix is a partial coherent precoding matrix or a value of the first field is in at least one of: a second range or a third range, the second field may indicate an index of a group of antennas and the first precoding matrix is mapped on rows or columns corresponding to the group of antennas. For example, if the first precoding matrix is a partial coherent precoding matrix or a non-coherent precoding matrix with length 2, the group of antennas may be from 4 groups of antennas, and each group may include 2 antennas. In this case, the second field may indicate the index of antenna port group from {group 0, group 1, group 2, group 3}. Alternatively, if the first precoding matrix is a partial coherent precoding matrix or a non coherent precoding matrix with length 4, the group of antennas may be from 2 groups of antennas, and each group may include 4 antennas. In this case, the second field may indicate the index of antenna port group from {group 0, group 1}. In other words, if the first field indicates a length-4 or length-2 vector, the second field may indicate a group with the 4 or 2 antenna ports to be mapped with the vector. By way of example, the first field may indicate the fir precoding matrix indicates

$$[ \begin{matrix}pc ( 0 ) \\ pc ( 1 ) \\ pc ( 2 ) \\ pc ( 3 )\end{matrix} ]$$

(e.g. one of 4Tx UL codebook), and the second field may indicate group 0 or group 1. In this case, the second precoding matrix for 1-layer may be

$${W}^{( 1 )} = 1 / \sqrt{8} [ \begin{matrix}pc ( 0 ) \\ pc ( 1 ) \\ 0 \\ 0 \\ pc ( 2 ) \\ pc ( 3 ) \\ 0 \\ 0\end{matrix} ] ,$$

if coherent group is {0,1,4,5}{2,3,6,7}, and group 0 is indicated.

In some embodiments, if the first precoding matrix is a non-coherent precoding matrix or a value of the first field is in a fourth range, the second field may indicate an index of a group of antennas and the first precoding matrix is mapped on rows or columns corresponding to the group of antennas. For example, if the first precoding matrix is a non-coherent precoding matrix or a value of the first field is in a fourth range, the second field may indicate the antenna port group from {group 0, group 1} or {group 0, group 1, group 2, group 3}. Alternatively, the second field may indicate the antenna port index from {port 0, port 1, port 2, port 3, port 4, port 5, port 6, port 7, port 8}. By way of example, the first field may indicate the first precoding matrix

$$[ \begin{matrix}1 \\ 0 \\ 0 \\ 0\end{matrix} ]$$

(e.g. one of 4Tx UL non-coherent codebook), and the second field may indicate group 0 or group 1. In this case, in some embodiments, if coherent group is {0,1,4,5}{2,3,6,7}, and group 0 is indicated, the second precoding matrix for 1-layer may be:

$${W}^{( 1 )} = 1 / \sqrt{8} [ \begin{matrix}1 \\ 0 \\ 0 \\ 0 \\ 0 \\ 0 \\ 0 \\ 0\end{matrix} ] .$$

Alternatively, if there is only one codepoint (or value) in the first field to indicate non-coherent codebook, the second field may indicate which one of the 8 ports.

In some embodiments, the terminal device 110 may be configured with at least four 2-port SRS resources or at least two 4-port SRS resources. The at least four 2-port SRS resource may be within one or a plurality of SRS resource set, and the at least two 4-port SRS resources may be within one or a plurality of SRS resource set. In this case, in some embodiments, the second field may be a SRS resource indicator field.

In some embodiments, if the first precoding is a full coherent precoding matrix or a value of the first field is in a first range, the second field may be ignored. Alternatively, if the first precoding is a full coherent precoding matrix or a value of the first field is in a first range, the second field may indicate at least one phase offset between antennas.

In some embodiments, if the first precoding matrix is a partial coherent precoding matrix or a value of the first field is in at least one of: a second range or a third range, the second field may indicate an index of a SRS resource. In this case, in some embodiment, the first precoding matrix may be mapped on rows or columns corresponding to a group of antennas associated with the SRS resource.

In some embodiments, if the first precoding matrix is a non-coherent precoding matrix or a value of the first field is in a fourth range, the second field may indicate an index of a SRS resource. In this case, in some embodiment, the first precoding matrix may be mapped on rows or columns corresponding to a group of antennas associated with the SRS resource.

In some embodiments, the terminal device may be configured with at least 4 SRS resource sets where each RSR resource set comprises at least one 2-port SRS resource. Alternatively, the terminal device may be configured with at least 2 SRS resource sets where each SRS resource set comprises at least 4-port SRS resource. In this case, in some embodiments, if the first precoding matrix is a full coherent precoding matrix or a value of the first field in is a first range, the second field may be ignored. Alternatively, the second field may indicate an index of SRS resource in each SRS resource set.

In some embodiments, if the first precoding matrix is a partial coherent precoding matrix or a value of the first field in is at least one of: a second range or a third range, the second field may indicate an index of a SRS resource set. In this case, in some embodiments, the first precoding matrix may be mapped on rows or columns corresponding to a group of antennas associated with the SRS resource set.

In some embodiments, if the first precoding matrix is a non-coherent precoding matrix or a value of the first field is in a fourth range, the second field may indicate an index of a SRS resource set. In this case, in some embodiments, the first precoding matrix is mapped on rows or columns corresponding to a group of antennas associated with the SRS resource set.

In some embodiments, the DCI may indicate which full coherent precoding matrixes for the terminal device 110. In some embodiments, the at least one configuration comprises none or at least one of: a first full coherent precoding matrix or a second full coherent precoding matrix. For example, the at least one configuration may indicate none or one or both of Set_fv_1 and Set_fv_2. Alternatively, the at least one configuration comprises one or more of a number of antenna ports in a first dimension, a number of antenna ports in a second dimension, a first DFT oversampling in the first dimension, or a second DFT oversampling in the second dimension. For example, the at least one configuration may indicate candidate values for at least one of N1, N2, i1,1, O1, O2, i1,2, i1,3 to generate the precoding matrix.

In some embodiments, the DCI may indicate which partial coherent precoding matrixes for the terminal device 110. In some embodiments, the at least one configuration may indicate that if there is at least one antenna port group with 4 antenna ports, at least one column or at least one row of the precoding matrix is with 4 non-zero values on 4 of the 8 elements. The indexes of the 4 elements may be based on the indexes of the 4 antenna ports in one antenna port group, and zero values on other 4 of the 8 elements in the column or the row. For example, the at least one configuration may indicate that if there is at least one group with 4 ports, at least one column of the precoder can be with 4 non-zero values (mapping on the 4 indexes (AP_i+1)). Otherwise, there may be no such kind of precoders.

In some embodiments, the bit size for the first field and/or for the second field and/or for the third field may be at least one of 1 bit, 2 bits, 3 bits and 4 bits.

In some embodiments, the at least one configuration may indicate that if there is at least one antenna port group with 2 antenna ports, at least one column or at least one row of the precoding matrix is with 2 non-zero values on 2 of the 8 elements. The indexes of the 2 elements may be based on the indexes of the 2 antenna ports in one antenna port group, and zero values on other 6 of the 8 elements in the column or the row. For example, the at least one configuration may indicate that if there is at least one group with 2 ports, at least one column of the precoder can be with 2 non-zero values (mapping on the 2 indexes (AP_i+1)), otherwise, there is no such kind of precoders.

In some embodiments, at least one configuration may indicate that if there is at least one antenna port group with 1 antenna port, at least one column or at least one row of the precoding matrix is with 1 non-zero value on 1 of the 8 elements, and the non-zero value is 1. The index of the 1 element may be based on the index of the antenna port in one antenna port group, and zero values on other 7 of the 8 elements in the column or the row.

In some embodiments, if the third number is no larger than the fourth number, a set of non-coherent precoding matrixes associated with the fourth number may be available for the PUSCH. In this case, each column or each row of the non-coherent precoding matrix may be with 1 non-zero value on 1 of the 8 elements. The non-zero value may be 1. The index of the 1 element may be based on the index of the antenna port in one antenna port group, and zero values on other 7 of the 8 elements in the column or the row. The indexes of the 1 element in different columns or different rows may be based on different antenna port groups.

Alternatively or in addition, if the third number is larger than the fourth number, a set of non-coherent precoding matrixes associated with the fourth number may not be available for the PUSCH. Alternatively, if the third number is not configured, the set of non-coherent precoding matrixes may be not available for the PUSCH. In some embodiments, if the third number is at least one of: 1, 2, 3, 4, 5, 6, 7, 8, the set of non-coherent precoding matrixes may comprise at least a precoding matrix with each column or each row of the precoding matrix is with 1 non-zero value on 1 of the 8 elements, and the non-zero value is 1. The index of the 1 element may be based on the index of column or row, and zero values on other 7 of the 8 elements in the column or the row. In other embodiments, if the third number is at least one of: 1, 2, 3, 4, the set of non-coherent precoding matrixes may comprise at least a precoding matrix with each column or each row of the precoding matrix is with 1 non-zero value on 1 of the first 4 elements, and the non-zero value is 1. The index of the 1 element may be based on the index of column or row, and zero values on other 7 elements in the column or the row.

In some embodiments, if the third number is same as the fourth number, the set of non-coherent precoding matrixes may comprise that at least a precoding matrix with each column or each row of the precoding matrix is with 1 non-zero value on 1 of the 8 elements, and the non-zero value is 1. The index of the 1 element in each column or row may be based on the index of each antenna port of the third number of antenna ports, and zero values on other 7 of the 8 elements in the column or the row.

Alternatively, if the third number is larger than the fourth number, the set of non-coherent precoding matrixes may comprise that at least a precoding matrix with each column or each row of the precoding matrix is with 1 non-zero value on 1 of the 8 elements, and the non-zero value is 1. The index of the 1 element in each column or row may be based on the index of one antenna port, and the antenna port is one of the fourth number out of the third number of antenna ports, and zero values on other 7 of the 8 elements in the column or the row. In some other embodiments, if the third number is smaller than the fourth number, non-coherent precoding matrix associated with the fourth number may not be available for the PUSCH.

In some embodiments, the at least one configuration may comprise an order of 8 antenna ports. The set of non-coherent precoding matrixes associated with the fourth number may comprise that at least a precoding matrix with each column or each row of the precoding matrix is with 1 non-zero value on 1 of the 8 elements, and the non-zero value is 1. The index of the 1 element in each column or row may be based on the index of one antenna port, and the antenna port is one of first fourth number of antenna ports out of the order of 8 antenna ports, and zero values on other 7 of the 8 elements in the column or the row. Alternatively, the at least one configuration may indicate precoding matrixes with that a first set of antenna port elements in a 4-antenna port group is mapped with non-zero values.

In some embodiments, if the number of antenna port elements in the first set of antenna port element is smaller than the third number, the at least one configuration may indicate that precoding matrixes with that a second set of antenna port elements in a 2-antenna port group is mapped with non-zero values. Alternatively or in addition, if the number of antenna port elements in the first and second sets of antenna port elements is smaller than the third number, the at least one configuration may indicate that the precoding matrixes with that a third set of antenna port elements which is not in the 4-antenna port group or 2-antenna port group is mapped with non-zero values. In other embodiments, the at least one configuration may indicate that precoding matrixes with that the first third number of antenna ports elements are used for mapping non-zero values in the third number of columns in the precoding matrix.

In some embodiments, if the number of layers is 8, there may be only one non-coherent precoding matrix (Set_n8_1). The non-coherent precoding matrix may always be included.

In some embodiments, if the number of layers (represented as “v”) is 7, there may be only one non-coherent precoding matrix. The non-coherent precoding matrix may always be included.

For example, if the fourth number (represented as “L”) of columns of the precoding matrix with non-zero values is 7, the non-zero value may be mapped on the 7 AP_i+1 indexes. If L is 8, the non-zero value may be mapped on C(L, 7) AP_i+1 indexes. Otherwise the non-coherent precoder p_n7_1 is included. In some embodiments, the values of AP_i included in a 4-port group may be used firstly, then values of AP_i included in a 2-port group may be used, then values of AP_i not included in any one of 4-port group or 2-port group may be used. And if there are more than 7 available values of AP_i the lowest 7 indexes are used. For example, if N₁ is 2 or N₂ is 2, p_n7_1 may be included. Alternatively, if N₁ is 1 or N₂ is 1, and M₁ is 1, AP_i included in the 4-port group and the two 2-port groups may be used, and the one with lower value in remaining two APs may be used. In some embodiments, if N₁ is 1 or N₂ is 1, and M₁ is 0, AP_i included in the 4-port group may be used, and the three ones with lower values in remaining four APs may be used. Alternatively, the first 7 APs in config_n1 may be used for mapping the value 1 in 7 columns.

In some embodiments, if the number of layers (represented as “v”) is 6, there may be only one non-coherent precoding matrix. The non-coherent precoding matrix may always be included.

For example, if the fourth number (represented as “L”) of columns of the precoding matrix with non-zero values is 6, the non-zero value may be mapped on the 6 AP_i+1 indexes. In some embodiments, if L is larger than 6, the non-zero values may be mapped on C(L, 6) AP_i+1 indexes. Otherwise the non-coherent p_n6_1 precoder may be included. Alternatively, the values of AP_i included in a 4-port group may be used firstly, then values of AP_i included in a 2-port group may be used, then values of AP_i not included in any one of 4-port group or 2-port group may be used. And if there are more than 6 available values of AP_i, the lowest 6 indexes may be used. In some other embodiments, the first 6 APs in config_n1 may be used for mapping the value 1 in 6 columns.

In some embodiments, if the number of layers (represented as “v”) is 5, there may be only one non-coherent precoding matrix. The non-coherent precoding matrix may always be included.

For example, if the fourth number (represented as “L”) of columns of the precoding matrix with non-zero values is 5, the non-zero value may be mapped on the 6 AP_i+1 indexes. Alternatively, if L is larger than 5, the non-zero value may be mapped on C(L, 5) AP_i+1 indexes. Otherwise the non-coherent precoder p_n5_1 may be included. In some embodiments, the values of AP_i included in a 4-port group may be used firstly, then values of AP_i included in a 2-port group may be used, then values of AP_i not included in any one of 4-port group or 2-port group may be used. And if there are more than 5 available values of AP_i, the lowest 5 indexes may be used. In some other embodiments, the first 5 APs in config_n1 may be used for mapping the value 1 in 5 columns.

In some embodiments, if the number of layers (represented as “v”) is 4, there may be only one non-coherent precoding matrix. The non-coherent precoding matrix may always be included.

For example, if the fourth number (represented as “L”) of columns of the precoding matrix with non-zero values is 4, the non-zero value may be mapped on the 4 AP_i+1 indexes. Alternatively, if L is larger than 4, the non-zero value may be mapped on C(L, 4) AP_i+1 indexes. Otherwise the non-coherent p_n4_1 precoder may be included.

In some embodiments, the values of AP_i included in a 4-port group may be used firstly, then values of AP_i included in a 2-port group may be used, then values of AP_i not included in any one of 4-port group or 2-port group may be used. And if there are more than 4 available values of AP_i, the lowest 4 indexes are used. For example, if N₁ is 1, N₂ is 2 or N₃ is 2, there may be two non-coherent precoders, each precoder with value one mapping on AP_i+1 index in a column, where AP_i is in one group. As another example, if N₁ is 1 or N₂ is 1 or N₃ is 1, there may be one non-coherent precoder, with value one mapping on AP_i+1 index in a column, and AP_i is in the group. In another embodiment, if N₁/N₂/N₃ is 0, and M₁ or M₂ or M₃ is not smaller than 2, the AP_i included in the M1 or M2 or M3 groups may be used, the non-zero value may be mapped on AP_i included in C(M3, 2) groups. In some other embodiments, the first 4 APs in config_n1 may be used for mapping the value 1 in 4 columns.

In some embodiments, if the number of layers (represented as “v”) is 3, there may be only one non-coherent precoding matrix. The non-coherent precoding matrix may always be included.

For example, if the fourth number (represented as “L”) of columns of the precoding matrix with non-zero values is 3, the non-zero value may be mapped on the 3 AP_i+1 indexes. Alternatively, if L is larger than 3, the non-zero value may be mapped on C(L, 3) AP_i+1 indexes. Otherwise the non-coherent p_n3_1 precoder may be included. Alternatively, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and three values of AP_i may be selected in one group. There may be 2*C(4,3) non-coherent precoders, each precoder with value one mapping on AP_i+1 index in a column, where AP_i is in one group.

Alternatively, if N₁ is 1 or N₂ is 1 or N₃ is 1, there may C(4,3)non-coherent precoders, with value one mapping on AP_i+1 index in a column, and three AP_i selected in the group. In other embodiments, if N₁/N₂/N₃ is 0, and M₁ or M₂ or M₃ is not smaller 2, the AP_i included in the M1 or M2 or M3 groups may be used, the non-zero value may be mapped on AP_i includes in C(M3, 2) groups and C(4,3) AP_i+1 indexes (or three lowest AP_i+1 indexes). In some other embodiments, the first 3 APs in config_n1 may be used for mapping the value 1 in 3 columns.

In some embodiments, if the number of layers (represented as “v”) is 2, there may be only one non-coherent precoding matrix. The non-coherent precoding matrix may always be included.

For example, if the fourth number (represented as “L”) of columns of the precoding matrix with non-zero values is 2, the non-zero value may be mapped on the 2 AP_i+1 indexes. Alternatively, if L is larger than 2, the non-zero value may be mapped on C(L, 2) AP_i+1 indexes. Otherwise the non-coherent p_n2_1 precoders may be included. In some embodiments, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and two values of AP_i may be selected in one group. There may be 2*C(4,2) non-coherent precoders, each precoder with value one mapping on AP_i+1 index in a column, where AP_i is in one group. In some embodiments, if N₁ is 1 or N2 is 1 or N3 is 1, there may be C(4,2) non-coherent precoders, with value one mapping on AP_i+1 index in a column, and two AP_i may be selected in the group. Alternatively, if N₁/N₂/N₃ is 0, and M₁ or M₂ or M₃ is not smaller than 2, the AP_i included in the M₁ or M₂ or M₃ groups may be used, the non-zero value may be mapped on AP_i includes in C(M3, 1) groups and the two AP1+1 indexes. In some embodiments, the first 2 APs in config_n1 may be for mapping the non-zero value in two columns.

In some embodiments, if the number of layers (represented as “v”) is 1, there may be only one non-coherent precoding matrix. The non-coherent precoding matrix may always be included.

In some embodiment, there may be no need of configuration to indicate non-coherent precoders for one layer. There may be 8 precoders, with value 1 mapping on any one of the 8 elements.

For example, if the fourth number (represented as “L”) of columns of the precoding matrix with non-zero values is 1, the non-zero value may be mapped on the AP_i+1 index. Alternatively, if L is larger than 1, the non-zero value may be mapped on C(L, 1) AP_i+1 index. Otherwise the non-coherent p_n1_1 precoders may be included.

In some embodiments, the values of AP_i included in a 4-port group may be used firstly, then values of AP_i included in a 2-port group may be used, then values of AP_i not included in any one of 4-port group or 2-port group may be used. And if there are more than 3 available values of AP_i, the lowest 3 indexes may be used. For example, if N₁ is 2 or N₂ is 2 or N₃ is 2, the non-zero value may be mapped on element with index AP_i+1, and one value of AP_i may be selected in one group. In some embodiments, there may be 2*C(4,1) non-coherent precoders, each precoder with value one mapping on AP_i+1 index in a column, where AP_i is in one group. In some embodiments, if N₁ is 1 or N₂ is 1 or N₃ is 1, there may be C(4,1) non-coherent precoders, with value one mapping on AP_i+1 index in a column, and one AP_i selected in the group. In some other embodiments, if N₁/N₂/N₃ is 0, and M₁ or M₂ or M₃ is not smaller than 2, the AP_i included in the M₁ or M₂ or M₃ groups may be used, the non-zero value may be mapped on AP_i includes in C(M3, 1) groups and the one of the two AP1+1 indexes or fixed to the first one in the group. Alternatively, the first AP in config_n1 may be used for mapping the non-zero value.

As mentioned above, the terminal device 110 may receive information indicating that the PUSCH is scheduled associated with 8 antenna ports or associated with an SRS with 8 antenna ports. In this case, the DCI may indicate the fourth number of layers which is not smaller than a minimum number of layers and the minimum number of layers is one of 4, 5, 6, 7, or 8. The minimum number of layers may be predetermined or configured via higher layer. Alternatively, if the information indicates that the fourth number of layers is one of 1, 2, 3, 4, the terminal device 110 may expect that the PUSCH is scheduled associated with 1 or 2 or 4 antenna ports or associated with an SRS with 1 or 2 or 4 antenna ports.

For example, if the terminal device 110 is configured with 8Tx or 8-port SRS for uplink transmission, the number of layers indicated by a DCI may be at least one of {4, 5, 6, 7, 8}. In some embodiments, the candidate number of layers may be at least 4, for example, Lmin configured by RRC, and Lmin may be any one of {4,5,6,7,8}. In this case, the precoding matrix for PUSCH transmission may be based on the indicated number of layers. Alternatively, PUSCH transmission based on 8-port SRS is not expected to be 1-3 layers.

In some embodiments, for 1-3 or 1-4 layers transmission, the terminal device 110 may be configured with SRS resource set with maximum number of SRS ports to be 1 or 2 or 4. The 4-8 layers transmission with 8-port SRS and 1-3 (or 1-4) layers transmission based on 1/2/4-port SRS may be switched based on RRC or medium access control control element (MAC CE).

In some embodiments, the network device 120 may transmit a configuration of a set of SRS resources to the terminal device 110. In this case, a first subset of SRS resources in the set of SRS resources may be configured with 8 SRS ports, and a second subset of SRS resources in the set of SRS resources may be configured with a number of SRS ports which is not larger than 4.

For example, the terminal device 110 may be configured with a set of SRS resources (N_SRS, N_SRS may be {1, 2, 3, 4}) for codebook uplink transmission, and there may be N_SRS_1 resources configured with 8 ports (N_SRS_1 is integer and 1<=N_SRS_1<=N_SRS), and there may be N_SRS-N_SRS_1 resources configured with 1 or 2 or 4 ports. If the SRI indicates a SRS resource with 8 ports, more than 4 layers transmission may be applied. If the SRI indicates a SRS resource with 1/2/4 ports, 1-3 (or 1-4) layers transmission may be applied. The total bit size may be a maximum value between total size of “Precoding information and number of layers” and “Antenna ports” and a set of MCS/NDI/RV (8 bit) for 1-3 (or 1-4) layers and total size of “Precoding information and number of layers” and “Antenna ports” and two sets of MCS/NDI/RV (16 bits) for PUSCH transmission based on 8-port SRS. In some embodiments, reserved bits or zero padding may be applied for less value.

In some embodiments, 8-port SRS may be configured in a first BWP, and 1/2/4-port SRS may be configured in a second BWP. In this case, switching between uplink transmission based on 8-port SRS and uplink transmission based on 1/2/4-port SRS can be based on BWP switching.

In some embodiments, the network device 120 may transmit information indicating that the PUSCH is scheduled associated with 8 antenna ports or associated with an SRS with 8 antenna ports to the terminal device 110. In this case, the terminal device 110 may apply applying at least one of: a subset of precoding matrixes or a subset of number of layers, before the reception of the at least one configuration.

For example, if the terminal device 110 is configured with 8Tx or 8-port SRS for uplink transmission, a subset of precoders and/or a subset of number of layers may be applied as default. For example, non-coherent precoders may be used as the default precoding matrix. In some embodiment, the bit size for default precoders in DCI may be fixed, and the size is X bits. X can be positive integer, e.g. 5<=X<=11. For example, in case of non-coherent precoders, at least 5 bits may be needed for 1-8 layers.

In some embodiment, the DCI may indicate the fourth number of layers in a separate field or combined in an antenna port field. The DCI may also indicate a precoding matrix based on the fourth number of layers. For example, if the terminal device 110 is configured with 8Tx or 8-port SRS for uplink transmission, the number of layers may be separately indicated in a separate field (e.g. 3 bits) or jointly indicated with antenna ports field. The precoding field may indicate the precoders based on the indicated number of layers. The size of precoding field may be determined based on the maximum value among the number of precoders for different layers. For example, based on number of precoders for 1 layer or 2 layers. In some embodiments, the bit size for precoding field in DCI may be Y bits. Y may be positive integer, e.g. Y may be {5,6,7,8}.

FIG. 6 shows a flowchart of an example method 600 in accordance with an embodiment of the present disclosure. The method 600 can be implemented at any suitable terminal devices. Only for the purpose of illustrations, the method 600 can be implemented at a terminal device 110 as shown in FIG. 1.

At block 610, the terminal device 110 receives first information associated with at least one first precoding matrix from the network device 120. In some embodiments, the first information may be comprised in a downlink control information (DCI) field, and the DCI field may indicate an index of the at least one first precoding matrix. In some embodiments, the at least one first precoding matrix may be a discrete Fourier transform (DFT) based precoding matrix. Alternatively, the at least one first precoding matrix may be a first downlink type precoding matrix.

At block 620, the terminal device 110 receives second information associated with a set of phase offsets for the first precoding matrix from the network device 120. In some embodiments, a phase offset in the set of phase offsets may be between antennas of the terminal device.

In some embodiments, the second information may be transmitted via medium access control (MAC) signaling. In some embodiments, the second information may be transmitted via radio resource control (RRC) signaling.

In some embodiments, the set of phase offsets may be same for layers of each one of the at least one first precoding matrix. In some embodiments, the set of phase offsets are layer common.

In some embodiments, the number of phase offsets in the set of phase offsets may be less than the number of rows or the number of columns in each one of the at least one first precoding matrix. In some embodiments, the number of phase offsets may be one of: 7, 6, 3, or 2.

In some embodiments, a phase offset in the set of phase offsets may be at least one of: {1, j, −1, −j}. In some embodiments, a phase offset in the set of phase offsets may be e^{j*2π*m/M}, and where M is at least one of {4, 8, 16}, and m is an integer from 0 to M−1. In some embodiments, a default value of a phase offset may be a predetermined value.

At block 630, the terminal device 110 determines a second precoding matrix based on the at least one first precoding matrix and the second information. In some embodiments, the terminal device 110 may receive a configuration indicating a valid duration for the set of phase offsets from the network device 120.

At block 640, the terminal device 110 transmits, to the network device 120, physical uplink shared channel (PUSCH) based on the second precoding matrix.

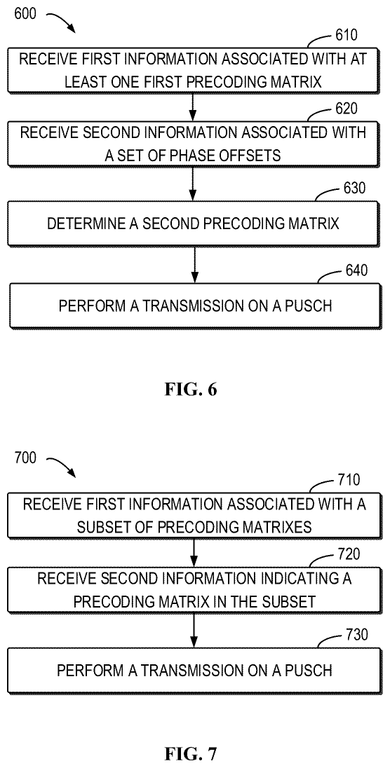

FIG. 7 shows a flowchart of an example method 700 in accordance with an embodiment of the present disclosure. The method 700 can be implemented at any suitable terminal devices. Only for the purpose of illustrations, the method 700 can be implemented at a terminal device 110 as shown in FIG. 1.

At block 710, the terminal device 110 receives first information associated with a subset of precoding matrixes from the network device 120. In some embodiments, precoding matrixes in the subset may be based on a plurality of discrete Fourier transform (DFT) based precoding matrixes. In some embodiments, the precoding matrixes in the subset may be based on first downlink type precoding matrixes and a set of phase offsets between antennas of the terminal device 110.

At block 720, the terminal device 110 receives second information indicating a precoding matrix in the subset of precoding matrixes from the network device 120. A bit size for indicating the second information is based on the number of precoding matrixes in the subset of first precoding matrixes. In some embodiments, a phase offset in the set of phase offsets may be between the first precoding matrixes. In some embodiments, the number of candidate values for indicating the codebook subset may be one of: 28, 24, 12, or 8.

At block 730, the terminal device 110 performs a transmission to the network device 120 on a physical uplink shared channel (PUSCH) based on the indicated precoding matrix.

FIG. 8 shows a flowchart of an example method 800 in accordance with an embodiment of the present disclosure. The method 800 can be implemented at any suitable terminal devices. Only for the purpose of illustrations, the method 800 can be implemented at a terminal device 110 as shown in FIG. 1.

At block 810, the terminal device 110 receives downlink control information from the network device 120. The DCI includes a first field and a second field. The first field indicates a first precoding matrix and the second field indicates a parameter that is based on the first field.

At block 820, the terminal device 110 determines a second precoding matrix based on the first precoding matrix and the parameter. In some embodiments, the terminal device 110 may be configured with a sounding reference signal (SRS) resource set for 8 antenna transmission. In some embodiments, the SRS resource set may comprise at least one SRS resource, and each SRS resource in the SRS resource set may comprise 8 ports.

In some embodiments, if the first precoding matrix is a full coherent precoding matrix or a value of the first field is in a first range, the second field may indicate at least one phase offset between antennas. In some embodiments, if the first precoding matrix is a partial coherent precoding matrix or a value of the first field is in at least one of: a second range or a third range, the second field may indicate an index of a group of antennas and the first precoding matrix may be mapped on rows or columns corresponding to the group of antennas. In some embodiments, f the first precoding matrix is a non-coherent precoding matrix or a value of the first field is in a fourth range, the second field may indicate an index of a group of antennas and the first precoding matrix may be mapped on rows or columns corresponding to the group of antennas.

In some embodiments, if the first precoding matrix is a partial coherent precoding matrix or a non coherent precoding matrix with length 2, the group of antennas may be from 4 groups of antennas and each group may comprise 2 antennas.

In some embodiments, if the first precoding matrix is a partial coherent precoding matrix or a non coherent precoding matrix with length 4, the group of antennas may be from 2 groups of antennas and each group may comprise 4 antennas.

In some embodiments, the terminal device 110 may be configured with at least four 2-port SRS resources or at least two 4-port SRS resources. In some embodiments, the at least four 2-port SRS resource may be within one or a plurality of SRS resource set. In some embodiments, the at least two 4-port SRS resources may be within one or a plurality of SRS resource set.

In some embodiments, if the first precoding is a full coherent precoding matrix or a value of the first field is in a first range, the second field may be ignored. In some embodiments, the second field may indicate at least one phase offset between antennas.

In some embodiments, if the first precoding matrix is a partial coherent precoding matrix or a value of the first field is in at least one of: a second range or a third range, the second field may indicate an index of a SRS resource. In some embodiments, the first precoding matrix may be mapped on rows or columns corresponding to a group of antennas associated with the SRS resource.

In some embodiments, if the first precoding matrix is a non-coherent precoding matrix or a value of the first field is in a fourth range, the second field may indicate an index of a SRS resource. In some embodiments, the first precoding matrix may be mapped on rows or columns corresponding to a group of antennas associated with the SRS resource.

In some embodiments, the terminal device 110 may be configured with at least 4 SRS resource sets where each RSR resource set comprises at least one 2-port SRS resource. In some embodiments, the terminal device 110 may be configured with at least 2 SRS resource sets where each SRS resource set comprises at least 4-port SRS resource.

In some embodiments, if the first precoding matrix is a full coherent precoding matrix or a value of the first field in is a first range, the second field may be ignored. In some embodiments, the second field may indicate an index of SRS resource in each SRS resource set.

In some embodiments, if the first precoding matrix is a partial coherent precoding matrix or a value of the first field in is at least one of: a second range or a third range, the second field may indicate an index of a SRS resource set. In some embodiments, the first precoding matrix may be mapped on rows or columns corresponding to a group of antennas associated with the SRS resource set.

In some embodiments, if the first precoding matrix is a non-coherent precoding matrix or a value of the first field is in a fourth range, the second field may indicate an index of a SRS resource set. In some embodiments, the first precoding matrix may be mapped on rows or columns corresponding to a group of antennas associated with the SRS resource set.

At block 830, the terminal device 110 performs an uplink transmission based on the second precoding matrix.

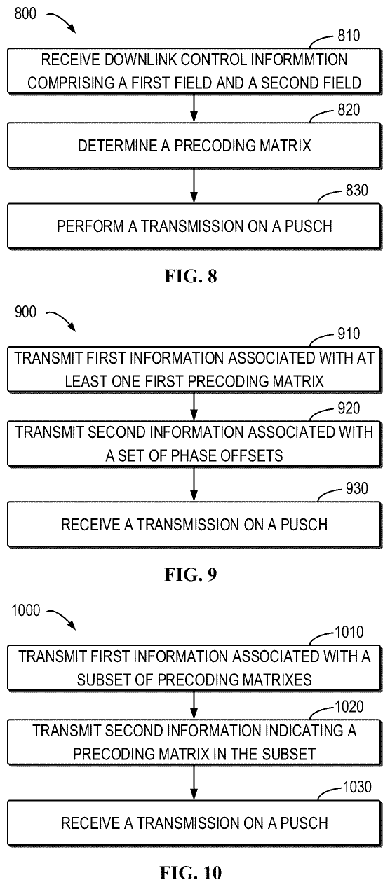

FIG. 9 shows a flowchart of an example method 900 in accordance with an embodiment of the present disclosure. The method 900 can be implemented at any suitable terminal devices. Only for the purpose of illustrations, the method 900 can be implemented at a network device 120 as shown in FIG. 1.

At block 910, the network device 120 transmits first information associated with at least one first precoding matrix to the terminal device 110. In some embodiments, the first information may be comprised in a downlink control information (DCI) field, and the DCI field may indicate an index of the at least one first precoding matrix.

In some embodiments, the at least one first precoding matrix may be a discrete Fourier transform (DFT) based precoding matrix. Alternatively, the at least one first precoding matrix may be a first downlink type precoding matrix.

At block 920, the network device 120 transmits second information associated with a set of phase offsets for the at least one first precoding matrix to the terminal device 110. In some embodiments, a phase offset in the set of phase offsets may be between antennas of the terminal device.

In some embodiments, the second information may be transmitted via medium access control (MAC) signaling. In some embodiments, the second information may be transmitted via radio resource control (RRC) signaling.

In some embodiments, the set of phase offsets may be same for layers of each one of the at least one first precoding matrix. In some embodiments, the set of phase offsets are layer common.

In some embodiments, the number of phase offsets in the set of phase offsets may be less than the number of rows or the number of columns in each one of the at least one first precoding matrix. In some embodiments, the number of phase offsets may be one of: 7, 6, 3, or 2.

In some embodiments, a phase offset in the set of phase offsets may be at least one of: {1, j, −1, −j}. In some embodiments, a phase offset in the set of phase offsets may be e^{j*2π*m/M}, and where M is at least one of {4, 8, 16}, and m is an integer from 0 to M−1. In some embodiments, a default value of a phase offset may be a predetermined value. For example, the default value of the phase offset may be m=0. For another example, the default value of the phase offset may be e^{j*2π*m/M}=1.

At block 930, the network device 120 receives a transmission on a physical uplink shared channel (PUSCH) from the terminal device 110. The transmission is based on a second precoding matrix which is determined based on the at least one first precoding matrix and the second information. In some embodiments, the network device 120 may transmit to the terminal device 110, a configuration indicating a valid duration for the set of phase offsets.

FIG. 10 shows a flowchart of an example method 1000 in accordance with an embodiment of the present disclosure. The method 1000 can be implemented at any suitable terminal devices. Only for the purpose of illustrations, the method 1000 can be implemented at a network device 120 as shown in FIG. 1.

At block 1010, the network device 120 transmits first information associated with a subset of precoding matrixes to the terminal device 110. In some embodiments, precoding matrixes in the subset may be based on a plurality of discrete Fourier transform (DFT) based precoding matrixes. In some embodiments, the precoding matrixes in the subset may be based on first downlink type precoding matrixes and a set of phase offsets between antennas of the terminal device 110.

At block 1020, the network device 120 transmits second information indicating a precoding matrix in the subset of precoding matrixes to the terminal device 110. A bit size for indicating the second information is based on the number of precoding matrixes in the subset of first precoding matrixes. In some embodiments, a phase offset may be between the first precoding matrixes. In some embodiments, the number of candidate values for indicating the codebook subset may be one of: 28, 24, 12, or 8.

At block 1030, the network device 120 receives a transmission on a physical uplink shared channel (PUSCH) from the terminal device 110. The transmission is based on the indicated precoding matrix.

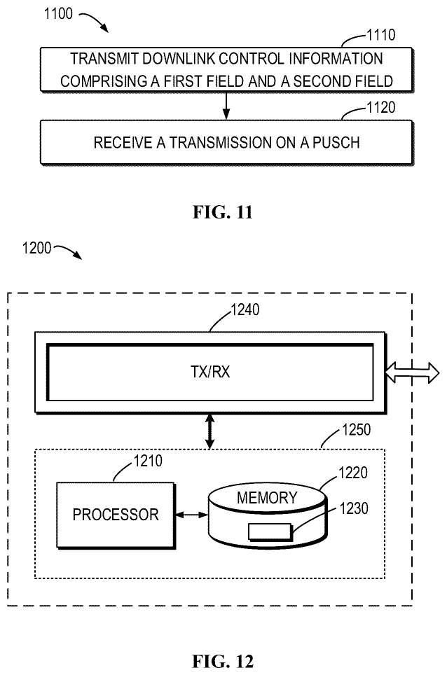

FIG. 11 shows a flowchart of an example method 1100 in accordance with an embodiment of the present disclosure. The method 1100 can be implemented at any suitable terminal devices. Only for the purpose of illustrations, the method 1100 can be implemented at a network device 120 as shown in FIG. 1.

At block 1110, the network device 120 transmits downlink control information to the terminal device 110. The DCI comprises a first field and a second field. The first field indicates a first precoding matrix and the second field indicates a parameter that is based on the first field.

At block 1120, the network device 120 receives a transmission based on a second precoding matrix that is based on the first precoding matrix and the parameter from the terminal device 110.

In some embodiments, if the first precoding matrix is a full coherent precoding matrix or a value of the first field is in a first range, the second field may indicate at least one phase offset between antennas. In some embodiments, if the first precoding matrix is a partial coherent precoding matrix or a value of the first field is in at least one of: a second range or a third range, the second field may indicate an index of a group of antennas and the first precoding matrix may be mapped on rows or columns corresponding to the group of antennas. In some embodiments, if the first precoding matrix is a non-coherent precoding matrix or a value of the first field is in a fourth range, the second field may indicate an index of a group of antennas and the first precoding matrix may be mapped on rows or columns corresponding to the group of antennas.

In some embodiments, if the first precoding matrix is a partial coherent precoding matrix or a non coherent precoding matrix with length 2, the group of antennas may be from 4 groups of antennas and each group may comprise 2 antennas.

In some embodiments, if the first precoding matrix is a partial coherent precoding matrix or a non coherent precoding matrix with length 4, the group of antennas may be from 2 groups of antennas and each group may comprise 4 antennas.

In some embodiments, if the first precoding is a full coherent precoding matrix or a value of the first field is in a first range, the second field may be ignored. In some embodiments, the second field may indicate at least one phase offset between antennas.

In some embodiments, if the first precoding matrix is a partial coherent precoding matrix or a value of the first field is in at least one of: a second range or a third range, the second field may indicate an index of a SRS resource. In some embodiments, the first precoding matrix may be mapped on rows or columns corresponding to a group of antennas associated with the SRS resource.

In some embodiments, if the first precoding matrix is a non-coherent precoding matrix or a value of the first field is in a fourth range, the second field may indicate an index of a SRS resource. In some embodiments, the first precoding matrix may be mapped on rows or columns corresponding to a group of antennas associated with the SRS resource.

In some embodiments, if the first precoding matrix is a full coherent precoding matrix or a value of the first field in is a first range, the second field may be ignored. In some embodiments, the second field may indicate an index of SRS resource in each SRS resource set.

In some embodiments, if the first precoding matrix is a partial coherent precoding matrix or a value of the first field in is at least one of: a second range or a third range, the second field may indicate an index of a SRS resource set. In some embodiments, the first precoding matrix may be mapped on rows or columns corresponding to a group of antennas associated with the SRS resource set.

In some embodiments, if the first precoding matrix is a non-coherent precoding matrix or a value of the first field is in a fourth range, the second field may indicate an index of a SRS resource set. In some embodiments, the first precoding matrix may be mapped on rows or columns corresponding to a group of antennas associated with the SRS resource set.

In some embodiments, a terminal device comprises a circuitry configured to perform: the above methods.

In some embodiments, a network device comprises a circuitry configured to perform the above methods.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In another one, a device of communication comprises: a processor configured to cause the device to perform any of the methods above.

In another solution, a computer readable medium having instructions stored thereon, the instructions, when executed on at least one processor, causing the at least one processor to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a terminal device, the method comprising:
receiving, from a network device, a radio resource control (RRC) message comprising first configuration information; and
determining a precoding matrix based on one or more of a plurality of offset values in response to receiving the first configuration information, wherein the plurality of offset values are respectively associated with a plurality of reference signal (RS) resource sets.

22. The method of claim 21, further comprising:
performing a transmission on a physical uplink shared channel (PUSCH) with information of the precoding matrix.

23. The method of claim 21, wherein the RRC message further comprises a second configuration information associated with a number of layers of a precoder in the precoding matrix;
determining the precoding matrix comprises:
determining the precoding matrix further based on the second configuration information.

24. The method of claim 21, wherein the plurality of offset values comprise an offset value of zero, the offset value of zero is associated with a reference RS resource set in the plurality of RS resource sets.

25. The method of claim 21, wherein the precoding matrix is determined based on e^{j*2π*m}, m is an offset value in the plurality of offset values.

26. The method of claim 21, wherein a number of the plurality of offset values is 2 or 3.

27. The method of claim 21, further comprising:
receiving, from the network device, configuration information of a sounding reference signal (SRS) resource set, wherein the SRS resource set comprises a first SRS resource with 8 ports and a SRS second resource with 4 ports or 2 ports.

28. A method performed by a network device, the method comprising:
transmitting, to a terminal device, a radio resource control (RRC) message comprising first configuration information, wherein the precoding matrix is determined by the terminal device based on one or more of a plurality of offset values in response to receiving the first configuration information, wherein the plurality of offset values are respectively associated with a plurality of reference signal (RS) resource sets.

29. The method of claim 28, further comprising:
performing a reception on a physical uplink shared channel (PUSCH) with information of the precoding matrix.

30. The method of claim 28, wherein the RRC message further comprises a second configuration information associated with a number of layers of a precoder in the precoding matrix, the precoding matrix is further determined based on the second configuration information.

31. The method of claim 28, wherein the plurality of offset values comprise an offset value of zero, the offset value of zero is associated with a reference RS resource set in the plurality of RS resource sets.

32. The method of claim 28, wherein the precoding matrix is determined based on e^{j*2π*m}, m is an offset value in the plurality of offset values.

33. The method of claim 28, wherein a number of the plurality of offset values is 2 or 3.

34. The method of claim 28, further comprising:
transmitting, to the terminal device, configuration information of a sounding reference signal (SRS) resource set, wherein the SRS resource set comprises a first SRS resource with 8 ports and a SRS second resource with 4 ports or 2 ports.

35. A terminal device, comprising:
a processor configured to cause the terminal device to:
receive, from a network device, a radio resource control (RRC) message comprising first configuration information; and
determine a precoding matrix based on one or more of a plurality of offset values in response to receiving the first configuration information, wherein the plurality of offset values are respectively associated with a plurality of reference signal (RS) resource sets.

36. The terminal device of claim 35, the processor is further configured to cause the terminal device to:
perform a transmission on a physical uplink shared channel (PUSCH) with information of the precoding matrix.

37. The terminal device of claim 35, wherein the RRC message further comprises a second configuration information associated with a number of layers of a precoder in the precoding matrix;
the processor is configured to cause the terminal device to determine a precoding matrix by:
determining the precoding matrix further based on the second configuration information.

38. The terminal device of claim 35, wherein the plurality of offset values comprise an offset value of zero and at least one offset value, the offset value of zero is associated with a reference RS resource set in the plurality of RS resource sets.

39. The terminal device of claim 35, wherein the precoding matrix is determined based on e^{j*2π*m}, m is an offset value in the plurality of offset values.

40. The terminal device of claim 35, wherein the processor is further configured to cause the terminal device to:
receive, from the network device, configuration information of a sounding reference signal (SRS) resource set, wherein the SRS resource set comprises a first SRS resource with 8 ports and a SRS second resource with 4 ports or 2 ports
